(19) United States
(12) Patent Application Publication
(10) Pub. No.: US 2005/0049911 A1
(43) Pub. Date: Mar. 3, 2005

(54) Transformation opportunity indicator

(75) Inventors: Patrick Engelking, Chicago, IL (US); Anthony G. Alati, Farmington Hills, MI (US); Kathryn M. Kilgora, Winnetka, IL (US); Elizabeth W. Santini, New York, NY (US); Edward W. Jensen, Cumming, GA (US)

Correspondence Address: ACCENTURE CHICAGO 28164;BRINKS HOFER GILSON & LIONE, P O BOX 10395, CHICAGO, IL, 60610, US

(73) Assignee: Accenture Global Services GmbH.

(21) Appl. No.: 10/651,878

(22) Filed: Aug. 29, 2003

(51) Int. Cl. G06F 17/60

(52) U.S. Cl. 705/11

(57) ABSTRACT

Techniques for identifying a business organization transformation opportunity provide a business with a mechanism for attaining significant cost savings through outsourcing. The techniques include receiving a plurality of business organization data inputs, and analyzing at least one of the business organization data inputs in accordance with at least one industry threshold. A business organization transformation opportunity scenario may be modeled based on the analysis. Further implementations may include providing a survey for use in receiving at least one of the plurality of business organization data inputs, and providing a savings estimate for the business organization if the modeled transformation scenario were to be adopted by the business organization.

### BACKGROUND OF THE INVENTION

1. Technical Field

This invention relates to business organization transformation, and more particularly to a transformation opportunity indicator useful for modeling a transformation opportunity scenario.

2. Related Art

Business organization transformation is a process of transforming a particular business organization function, for example a human resource function, from a current “As-is” state to a future “To-Be” state. The To-Be state of the business organization function typically results in cost savings to the business organization as compared with the As-Is state for the function. The cost savings is usually a result of outsourcing components (sub-function) of the business organization function being analyzed, or of internally restructuring or streamlining the existing function, or some combination of outsourcing and internal streamlining/restructuring. The outsourcing/ internal streamlining/restructuring may further include upgrading a technology aspect (i.e. computer hardware and/or infrastructure as well as any software running thereon) of the business organization. The outsourcing/ internal streamlining/ restructuring may further include project coordination with an external business integration consulting provider.

When determining whether a transformation may be beneficial for the business organization, various economic factors for the business organization should be considered. Failure to examine or properly examine some of the economic factors, or calculation errors while examining the economic factors, may result in a faulty evaluation as to whether a transformation for a particular function of the business organization would be beneficial. Such a faulty evaluation could result in costing the business organization large sums of money without obtaining anticipated offsetting cost savings. Yet, in the Human Resources (HR) area, for example, there is no known tool for evaluating As-Is and To-Be HR states of a business organization function, or for reducing potential errors of calculations, for use in reliably evaluating whether an HR transformation of the function might be beneficial.

### SUMMARY

This invention relates to providing a transformation opportunity indicator, by modeling a transformation scenario for a particular function of a business organization.

In accordance with one embodiment of the invention, a system and method of identifying a business organization transformation opportunity are provided, including receiving a plurality of business organization data inputs at the system, and analyzing at least one of the business organization data inputs in accordance with at least one industry threshold. A business organization transformation opportunity scenario may be modeled with regard to a particular function of the business organization responsive to the analysis. In accordance with a further embodiment, at least one of the plurality of business organization data inputs is received by a user entering the at least one business organization data input at the business organization opportunity indicator. In accordance with another further embodiment, at least one of the plurality of business organization data inputs is received by a user entering the at least one business organization data into a related tool for the business organization opportunity indicator. The related tool may be capable of automatically transferring the at least one of the plurality of received data inputs to the transformation opportunity indicator. In accordance with yet another further embodiment, the modeled transformation scenario includes at least one of a broad-outsourcing, a mixed outsourcing/internal transformation, and internal transformation scenarios. In accordance with another further embodiment, the business organization transformation scenario modeled is a human resources transformation scenario. In a further embodiment yet, the transformation scenario may be modeled using a spreadsheet, for example, executed on a spreadsheet program.

In accordance with another embodiment of the invention, a system for human resource transformation analysis is provided, including a means for receiving information associated with a plurality of financial and business organization function-based metrics of a business organization, and means for providing responses to a set of queries associated with the metrics. The system further includes means for comparing at least one of the metrics with at least one industry threshold for an industry associated with the business organization, and means for modeling a transformation scenario responsive to the means for comparing.

In accordance with yet another embodiment, a memory embodied on a computer readable media is provided, the memory programmed for use on a suitable processor and capable of modeling a business organization transformation scenario, the memory including a first memory portion programmed for receiving a plurality of business organization data inputs. The memory further includes a second memory portion programmed for analyzing at least one of the business organization data inputs in accordance with at least one industry threshold, and a third memory portion programmed for modeling a business organization transformation opportunity scenario with respect to a particular function of the business organization responsive to the analysis.

In accordance with another embodiment of the invention, a user interface for a software tool is provided, the software tool useful for modeling a transformation scenario at an organization, the user interface presented to an individual using a computer executing the software tool, and including a first component including a first set of data fields for receiving a plurality of business organization data inputs, and a second component including a second set of data fields for providing information about an analysis of the plurality of data fields in accordance with at least one industry threshold. The user interface may further include a third component including a third set of data fields for providing information about a modeled transformation scenario for the business organization, where at least one of the data fields of the third component providing information regarding the modeled transformation scenario may be updated as additional of the plurality of business organization data inputs of the first component are received.

### BRIEF DESCRIPTION OF THE DRAWINGS

FIG. 1 is a block diagram of a system for implementing a transformation opportunity indicator in accordance with an embodiment of the invention.

FIG. 2 is a flow chart illustrating operation of the system of FIG. 1 for implementing a transformation opportunity indicator, in accordance with an embodiment of the invention.

FIG. 3 is a flow chart illustrating operation of the system of FIG. 1 for implementing a transformation opportunity indicator in accordance with a first embodiment of the invention.

FIGS. 4A-4E illustrate various exemplary data interface displays that may be utilized by the transformation opportunity indicator in receiving business organization data inputs in accordance with the first embodiment of the invention.

FIG. 5 illustrates an exemplary user interface display showing an As-Is state of the business organization, in accordance with the first embodiment of the invention.

FIG. 6 illustrates an exemplary user interface display showing a To-Be state of the business organization where a transformation scenario is adopted, in accordance with the first embodiment of the invention.

FIG. 7 illustrates an exemplary user interface display showing a transformation scenario model of the transformation opportunity indicator in accordance with the first embodiment of the invention.

FIG. 8 is a flow chart illustrating operation of the transformation opportunity indicator of the system of FIG. 1, in accordance with a second embodiment of the invention.

FIGS. 9A-9H illustrate various exemplary user interface displays that may be utilized in receiving business organization data inputs at the transformation opportunity indicator in accordance with the second embodiment of the invention.

FIG. 10 is a portion of an exemplary user interface display for a survey, that may be utilized by the business opportunity indicator for receiving business organization data inputs in accordance with the second embodiment of the invention.

FIGS. 11A-11C illustrate various exemplary user interface displays that may be utilized in analyzing the at least one business organization data input in light of at least one industry threshold, in accordance with the second embodiment of the invention.

FIGS. 12A-12D illustrate various user interface displays that may be utilized in modeling of a transformation scenario in accordance with the second embodiment of the invention.

### DETAILED DESCRIPTION OF THE INVENTION

This invention relates to a transformation opportunity indicator for modeling and/or identifying transformation opportunities in a business organization.

In one embodiment of the invention, a system is provided for identifying a business organization transformation opportunity, including capabilities for receiving a plurality of business organization data inputs, and analyzing at least one of the business organization data inputs in accordance with at least one industry threshold. A business organization transformation opportunity scenario may be modeled responsive to the analysis.

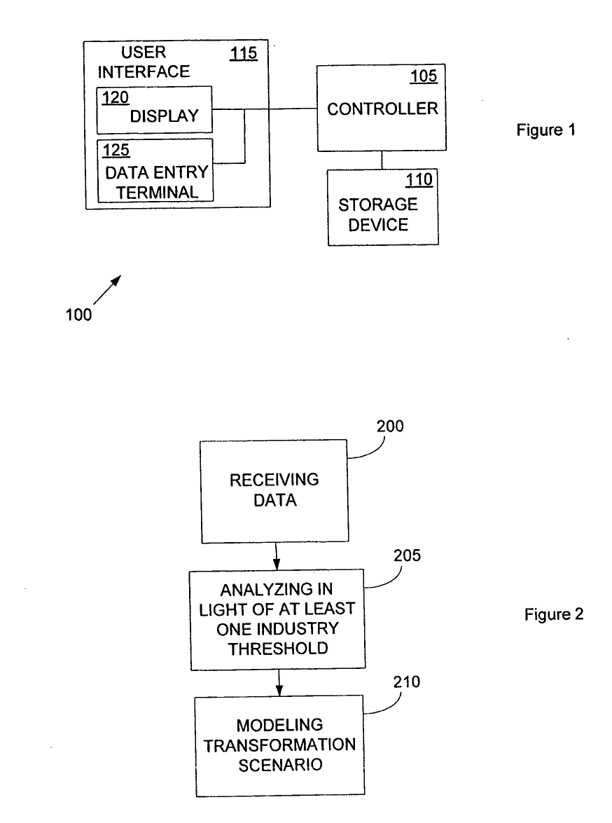

A block diagram of an exemplary system for implementing a transformation opportunity indicator is shown in FIG. 1, in accordance with an embodiment of the invention.

As shown in FIG. 1, a system 100 includes a controller 105, coupled with a storage device 1 10. The controller 105 is further coupled with a user interface 115, which may include a display 120 for providing information to a user of the system 100, and a data entry terminal 125, which is provided for data entry. The system 100 may be implemented on a personal computer (PC) operating as a stand-alone computer, or as part of a computer network (not shown). Alternatively, the system 100 may be implemented on any microprocessor-based device. Further, the system 100 may be coupled with the Internet and/or a company Intranet as a means of providing information to the system 100.

The controller 105 typically is comprised of one or more microprocessors executing suitable programmed code stored in internal memory of the microprocessor (not shown) and/or in the storage device 110. The microprocessor(s) possesses capabilities for providing the functionalities described herein. For example, the microprocessor(s) is sufficiently programmed for, and possess sufficient processing speeds and other hardware requirements to carry out the functionalities described herein. In addition, the controller 105 may be comprised of any combination of hardware devices designed for specific functionalities (including, for example, application specific integrated circuits (ASIC) capable of providing one or more of the functionalities described herein).

The storage device 110 may comprise one or more fixed or removable storage devices including, but not limited to, solid state media, magnetic and optical media. The solid state media may include, but is not limited to, integrated circuits such as ROMs, PROMs, EPROMs, EEPROMs and any type of RAM, as well as removable memory storage devices such as flash media card and any derivative memory systems of these devices. The magnetic media may include, but is not limited to, magnetic tape, magnetic discs, such as floppy diskettes and hard disc drives. The optical media may include, but is not limited to, optical discs such as a Compact Disc. Typically, the storage device 110 includes working memory (RAM) and a program memory portion. The program memory portion may be provided, for example as part of a ROM or PROM or as a portion of a hard disc drive provided in the unit.

The user interface 115 allows the user of the system 100 to view information provided by the system 100, as well as entering information into the system 100. The display 120 is typically a monitor (i.e., CRT or LCD monitor as is typically utilized with a PC) which may be utilized by the controller 105 to display information to the user of the system. However, the display 120 may be any display device capable of providing information to the user. The data entry terminal 125 may include any of an alphanumeric keyboard, a computer mouse, a stylus, or any other data entry device that may be used to enter information into the system 100. Where the controller 105 has voice recognition capabilities, the data entry terminal 125 may include a microphone for accepting a user's voice and voice commands to enter information into the system 100. Further, one skilled would realize that the display 120 and at least a portion of the data entry terminal 125 may be provided as a common device, for example a touch-sensitive display.

The transformation opportunity indicator is typically provided as software running on the controller 105, resident in the storage device 110, to allow the controller 105 to provide the functionalities described herein. As described below, the software may be provided as a spreadsheet, for example as implemented on a spreadsheet program such as Microsoft Excel, however one skilled in the art would realize that the software may be provided as a stand-alone software program (i.e., implemented in any suitable programming language) operating on the controller 105 or any operating system provided therewith, and need not utilize any additional software operating on the system 100. Alternatively, or in addition, the functionalities may be provided as a combination of software and one or more ASICs to provide the functionalities discussed herein.

FIG. 2 is a flow chart illustrating operation of the system 100 for providing business organization transformation opportunity functionality in accordance with an embodiment of the invention. As shown in FIG. 2, the controller 105, operating under software of the storage device 110, is capable of receiving a plurality of business organization data inputs as shown at box 200. The controller 105 may further allow analyzing of at least one of the business organization data inputs in accordance with at least one industry threshold at step 205, and model a business organization transformation scenario responsive to the analysis as shown at step 210.

The plurality of business organization data inputs may be received into the system, for example, by a user of the system 100 entering information through the data entry terminal 125 of the user interface 115. The analyzing may be accomplished, for example, by the controller 105 performing various programmed operations on one or more of the pieces of information entered in accordance with at least one industry threshold. The industry threshold information may include internal benchmark information determined internal to the organization carrying out the transformation modeling based on that organization's previous experiences or determined best practices in similar related situations. Best practices may encompass determined procedures for carrying-out or performing certain actions based at least in part on past experiences with regards to such actions. Certain assumptions, for example, may be made with regard to some of the data or business organization functions (i.e. human resources) as a result of dealings with similar clients in similar situations, and/or previous communications/dealings with the particular business organization being examined for transformation. Further, such assumptions and benchmarks may be made regarding costs for transformation, including equipment and labor costs for transforming the business organization. In addition, or in the alternative, industry threshold information may be provided from an external organization specializing in such information, for example, as an EP-First or a Saratoga industry standard or benchmark (e.g., a human resources benchmark). A business organization (client) transformation scenario may be modeled responsive to the analysis. As will be explained in more detail below, the scenario may include, for example, outsourcing HR to an outsourcing provider that specializes in that form of transformation (e.g., Accenture HR Services) in order to realize significant cost savings. In general, client transformation scenarios include, for example, modeling a broad-outsourcing transformation scenario, an internal transformation scenario, a mixed outsourcing/internal transformation scenario, or any other transformation scenario, as will be described in further detail below.

Various information and data may be received at, and utilized by, the transformation opportunity indicator in modeling a transformation scenario. However, oftentimes at least some of the data and information commonly used for modeling a transformation scenario is not available for performing the analysis. In such instances, assumptions and/or industry benchmarks may be utilized as discussed above. The assumptions may be provided by the transformation organization carrying out the transformation analysis for a business organization being examined for transformation as a result of previous experiences, as discussed above. Alternatively, or in addition, industry benchmarks such as Saratoga benchmarks may be utilized. Such assumptions and benchmarks may include information regarding a number of current-state employees and/or full time equivalents (FTEs) desired or required for particular functions and sub-functions of a business organization, costs associated with FTEs, and costs and/or other information regarding technology, with regard to a particular function(s) and/or sub-function(s) being analyzed for the business organization. Other assumptions and/or benchmarks are possible.

The business opportunity indicator may provide a rapid and standardized approach for identifying a transformation opportunity, where standard input fields may be used to drive established methods of calculation to generate a financial analysis report. The transformation opportunity indicator may further allow for modeling various transformation scenarios to determine one most beneficial for the client. Further, as the transformation opportunity indicator may be provided as a standardized software tool, the transformation opportunity indicator may be readily updated with up-to-date thinking and best practices regarding assessing transformation opportunities, thereby ensuring that the client receives a transformation opportunity scenario in accordance with current (and not outdated) transformation assessment strategic thinking.

The transformation opportunity indicator will be discussed in the context of modeling and/or identifying a human resource transformation scenario, however one skilled in the art would realize that the transformation opportunity indicator may be utilized in modifying and/or identifying transformation opportunities for any aspect of a business organization. For example, the transformation opportunity indicator, in an analogous way to that discussed below, may be utilized to determine a transformation of engineering services, computer repairs/upkeep services, business organization housekeeping such as the janitorial or custodial services, as well as accounting or other services carried-out within a business organization by business organization employees. To that end, in some circumstances, particular data fields and benchmarks of the transformation opportunity indicator may be altered as desired to match the particular industry or business aspect to which the transformation opportunity indicator will be applied.

Two embodiments of the business organization opportunity indicator will be discussed below, with potential alternatives. The embodiments may be utilized in conjunction with one another, or separately. One skilled in the art will realize that other embodiments are possible, using the teachings discussed herein, to achieve at least some of the advantages provided by the business organization opportunity indicator.

Typically, the business organization opportunity indicator is utilized by one or more members of a transformation team. A transformation team is typically one or more people who gather as-is data, make assumptions on to-be data and communicate results back to the client. The transformation team member(s) collect data from a business organization for which transformation is being examined. Such transformation is examined with respect to one or more functions performed within the business organization, for example human resources function.

Information is gathered for the particular business organization, for example, from annual reports published by the business organization, and/or from visits with and evaluations of the business organization. Such visits and evaluations may be 1-2 weeks in length, may be 6-8 weeks in length, or any other length of time necessary to gather data and information for use with the business organization transformation opportunity indicator. Further, or in the alternative, at least some of the information may be provided by the client as a response to questionnaires, interviews, and surveys provided to the business organization. Such questionnaires, interviews, and surveys may be in the form of hard copy (e.g., paper) and/or electronic (e.g., computer-guided HTML or other Internet, Web, or machine hosted surveys) questionnaires, interviews, and surveys, and may be generated by the business organization, a third party such as an outside consultant, or a survey company such as FIRM of Olso, Norway.

When the information and data are received, they are entered into the business organization transformation opportunity indicator. Entering the information may be accomplished by one or more transformation team members, and/or automatic importation of the information. For example, responses to computer-generated questionnaires and surveys may be automatically imported into the appropriate fields of the business organization opportunity indicator. Similarly, hard-copy responses to various interviews and/or questionnaires may be automatically entered through use of, for example, scan-tron forms, and/or optical character recognition or other software capable of analyzing handwriting.

Based on at least some of the information, and at least one industry threshold (i.e. determined internal to the organization carrying-out the transformation analysis or from industry benchmarks provided by, for example, Saratoga), the business organization opportunity indicator is capable of analyzing the data in accordance with at least one industry threshold, and model at least one business organization transformation scenario for the business organization. The business organization transformation scenario modeled may include a comparison between an As-is (current-state) of the business organization function with a To-Be (future-state)of the business organization if the modeled transformation scenario were to be adopted.

The analysis and modeled transformation scenario may account for one or both of a broad function of the business organization (i.e. human resource function), and various sub-functions performed within the broad function. The analysis and modeled transformation may further account for various costs associated with the transformation, including labor, technology/equipment upgrades, etc. necessary for transforming the business organization to the future-state. The modeled transformation scenario is then capable of providing a comparison between the cost to the business organization as it is currently operating, with that of costs (and savings estimates) if a particular modeled transformation scenario is adopted.

The following embodiments will be discussed with respect to the system 100, and corresponding flowcharts for the respective embodiment. However, it will be apparent that other systems may be utilized in providing at least some of the functionalities discussed herein.

### FIRST EMBODIMENT OF THE INVENTION

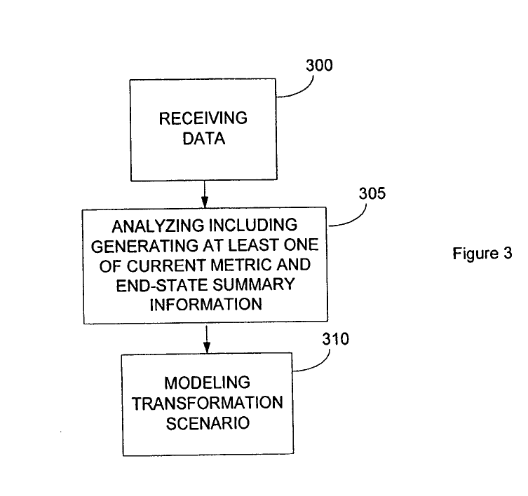

In accordance with a first embodiment of the invention, a transformation opportunity indicator is provided as a spreadsheet running on a spreadsheet program, for example, Microsoft Excel. FIG. 3 is a flowchart illustrating operation of the transformation opportunity indicator of FIG. 1 in accordance with the first embodiment of the invention.

As shown in FIG. 3, the transformation opportunity indicator is capable of identifying a business organization human resource transformation opportunity, including receiving a plurality of business organization data inputs at box 300, and analyzing at least one of the business organization data inputs in accordance with at least one industry threshold as shown at box 305. At box 310, the transformation opportunity indicator is capable of modeling a business organization transformation scenario responsive to the analysis. Business organization transformation opportunity scenarios may include, for example, a broad-outsourcing transformation scenario, an internal transformation scenario, and a mixed outsourcing/internal transformation scenario.

A broad-outsourcing transformation scenario may be modeled as a scenario that outsources approximately 75% of a business organization's particular business function that is being analyzed (i.e., in this embodiment, human resources function), where approximately 75% of the human resource function would be outsourced to a company or other organization which provides the particular function(s), here human resource functions. The broad-outsourcing transformation scenario may further include suggestions for streamlining and/or restructuring the existing human resource function within the business organization to allow increased performance and/or efficiency. An internal transformation scenario model may include a situation where less than 25% of a business organization's particular human resource function, is outsourced to an external company or organization, and may further include suggestions for streamlining and/or restructuring the existing human resource function within the business organization to allow increased performance and/or efficiency. The mixed outsourcing/internal transformation scenario model may include any combination of retained to outsourced business organization human resource function from 25% /75% retained-to-outsourced, to 75% /25% retained-to-outsourced human resource function, as well as may include suggestions for streamlining and/or restructuring retained human resource functions thereby allowing increased human resource performance and/or efficiency. The percentage of retained-to-outsourced function for the transformation scenarios are exemplary only, and one or more of the transformation scenarios may be represented by different pre-selected upper and lower bounds on the retained-to-outsourced function percentage as desired, for example, according to the particular industry on which the transformation tool is applied.

The user of the system 100 may alter various data and information provided/entered to the business opportunity indicator to determine the effect on a particular transformation scenario model. Additionally, or in the alternative, other transformation scenarios may be provided, to examine which model may be beneficial for the business organization to implement. In addition, or in the alternative, a particular transformation scenario may be provided as a decision of the transformation opportunity indicator based on one or more criteria. For example, such criteria may include any of cost-savings estimate for the business organization, a minimization of costs for the business organization, or any other factor/criteria that may be beneficial in accounting for in such a determination.

In accordance with the first embodiment, and referring to FIG. 3, at box 300, a plurality of business organization data inputs are typically received at the transformation opportunity indicator by a user of the transformation opportunity indicator entering various information in data fields of a spreadsheet, for example, running on Microsoft Excel.

Upon receiving a plurality of business organization data inputs, the transformation opportunity indicator is capable, as shown at box 305, of analyzing at least one of the business organization data inputs in accordance with at least one industry threshold. For example, in accomplishing this, the transformation opportunity indicator may determine a performance matrix for a current state of the business organization utilizing at least some of the plurality of business organization data received. The transformation opportunity indicator may additionally determine an end-state summary utilizing at least some of the plurality of business organization data inputs as well as assumptions and/or industry threshold information. The assumptions and/or industry threshold information may be particularly useful where some data desired from the business organization is not provided, or for cost and labor estimates for transforming a particular business organization function.

The end-state summary may indicate the state of a business organization as it would be if the particular modeled transformation scenario were to be implemented, and may include details of expected cost savings to the business organization resulting from implementing the modeled transformation scenario.

As shown at box 315, the transformation opportunity indicator is then capable of generating a model for a business organization transformation opportunity scenario, that may provide current costs, estimated future costs, as well as estimated savings if the specified business organization transformation opportunity scenario were adopted. Further, information such as a return on invested capital improvement, annual economic value add improvement and share price impact may also be provided for a particular transformation scenario.

First Embodiment Data Inputs

Information regarding a specified transformation scenario, along with information provided from the modeling of other transformation scenarios by the transformation opportunity indicator may be utilized in making a determination of whether transformation of a particular business organization service, for example human resource service, is desired. Further, the information provided by the modeled scenarios may be useful in determining to what extent outsourcing of the human resource services is desired, for example whether broad outsourcing, internal transformation, or a mix of outsourcing and internal transformation is desirable.

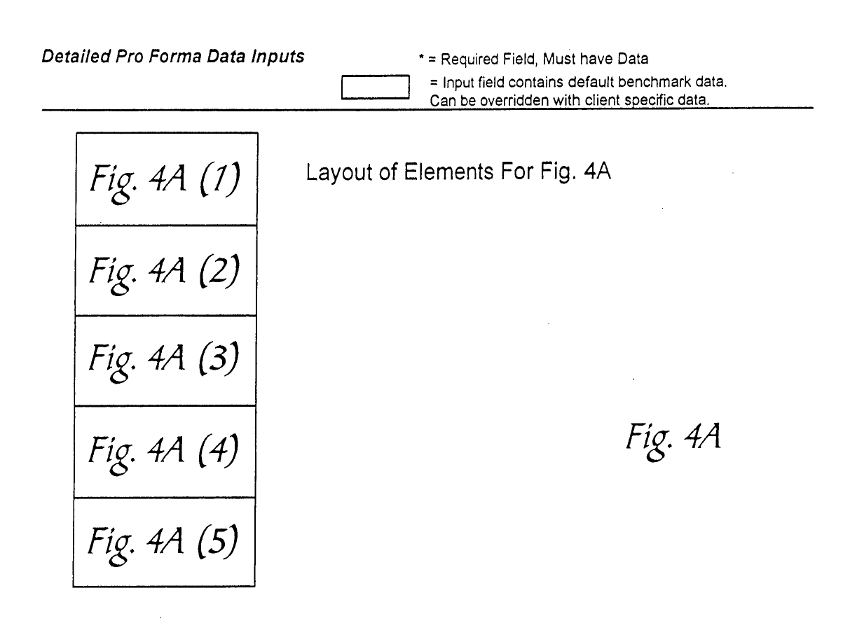

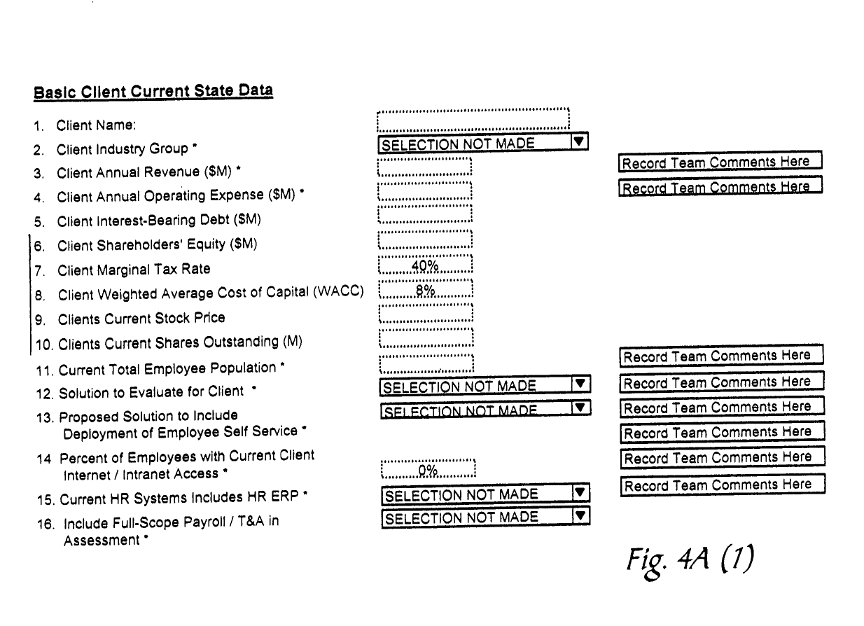

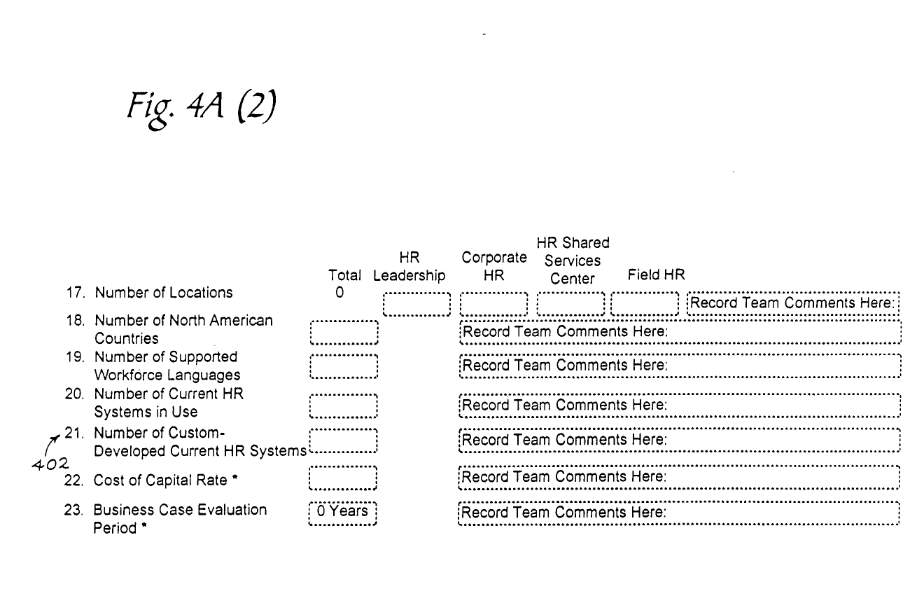

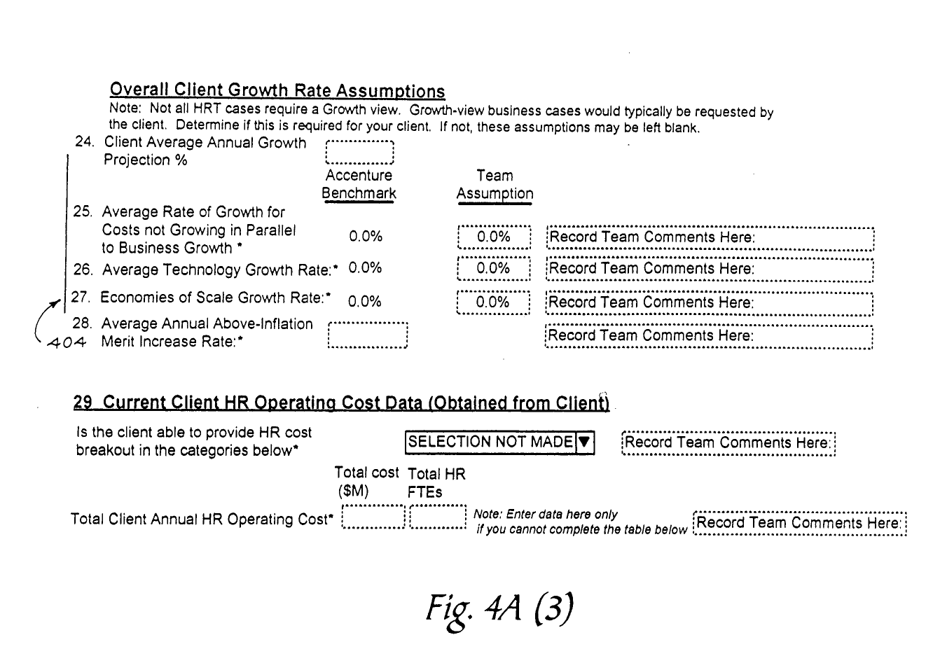

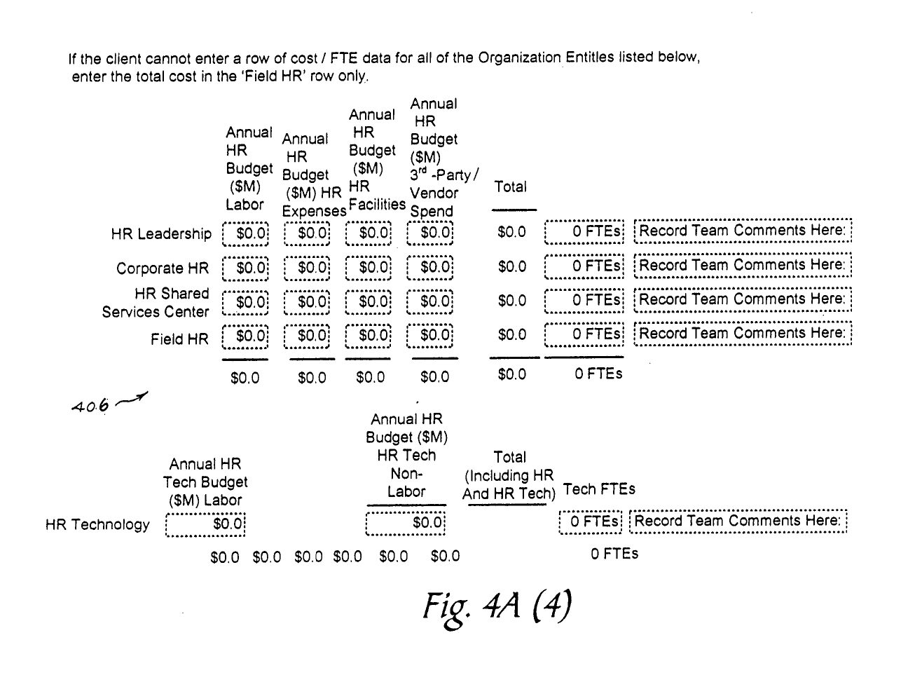

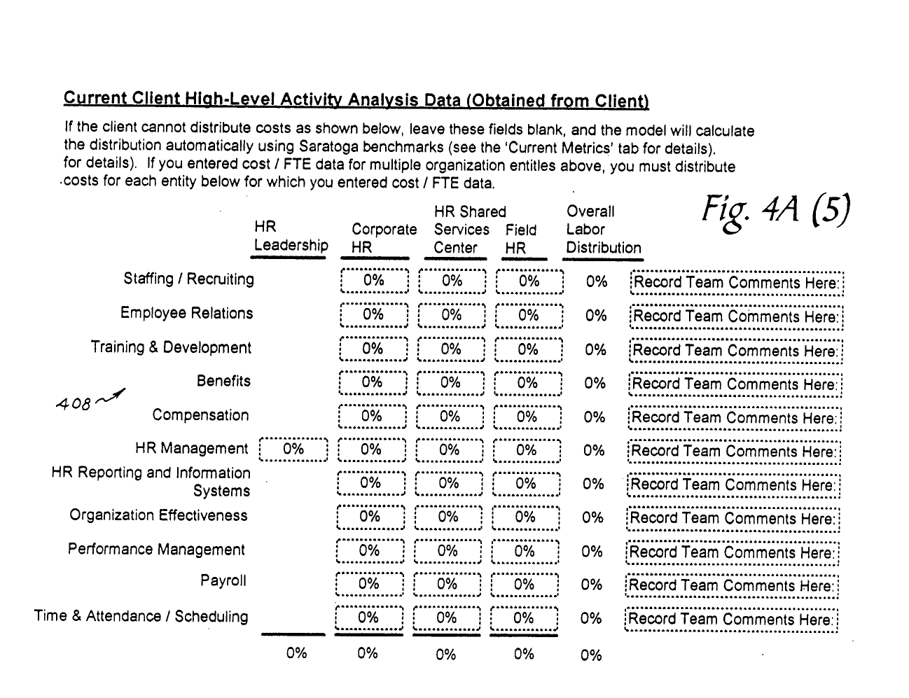

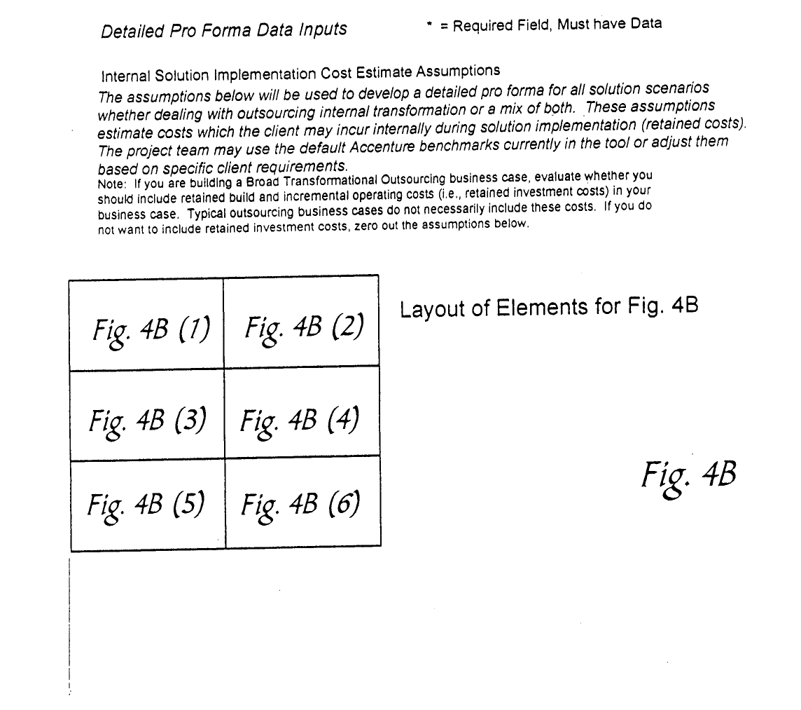

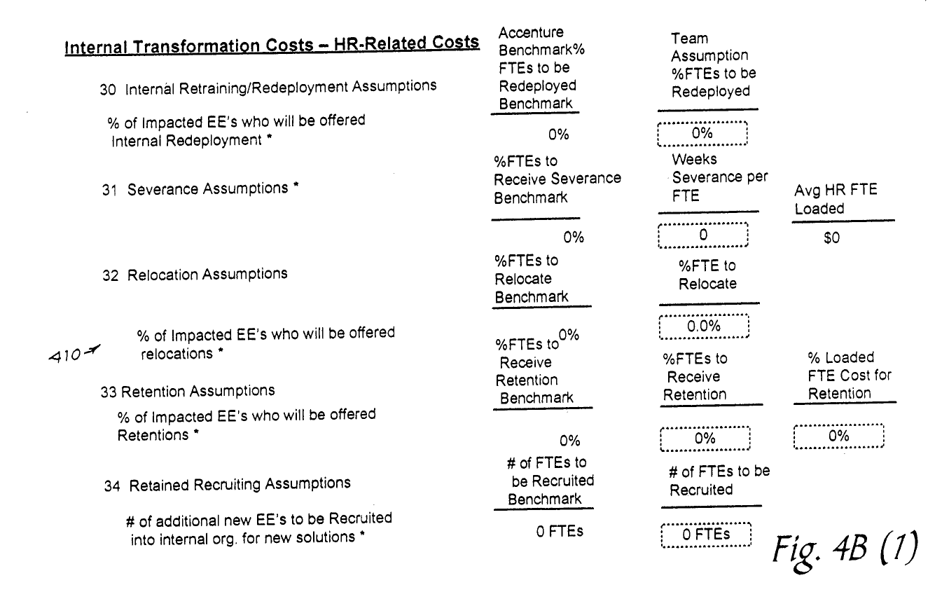

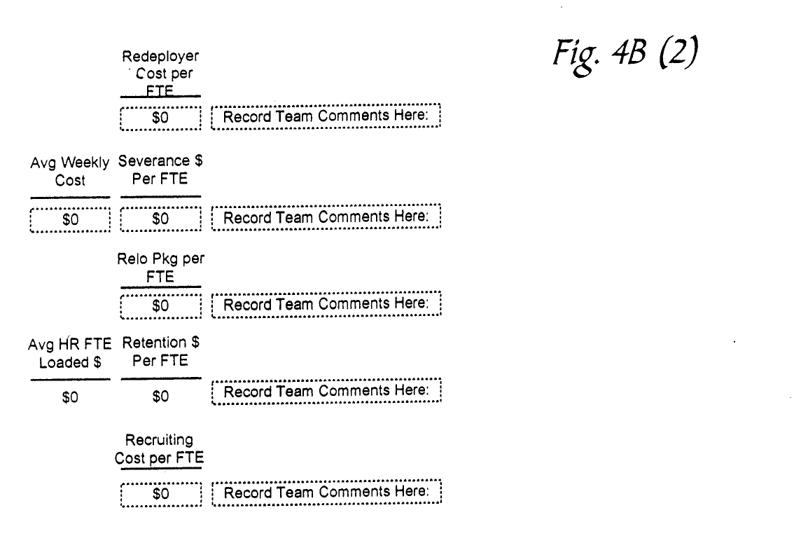

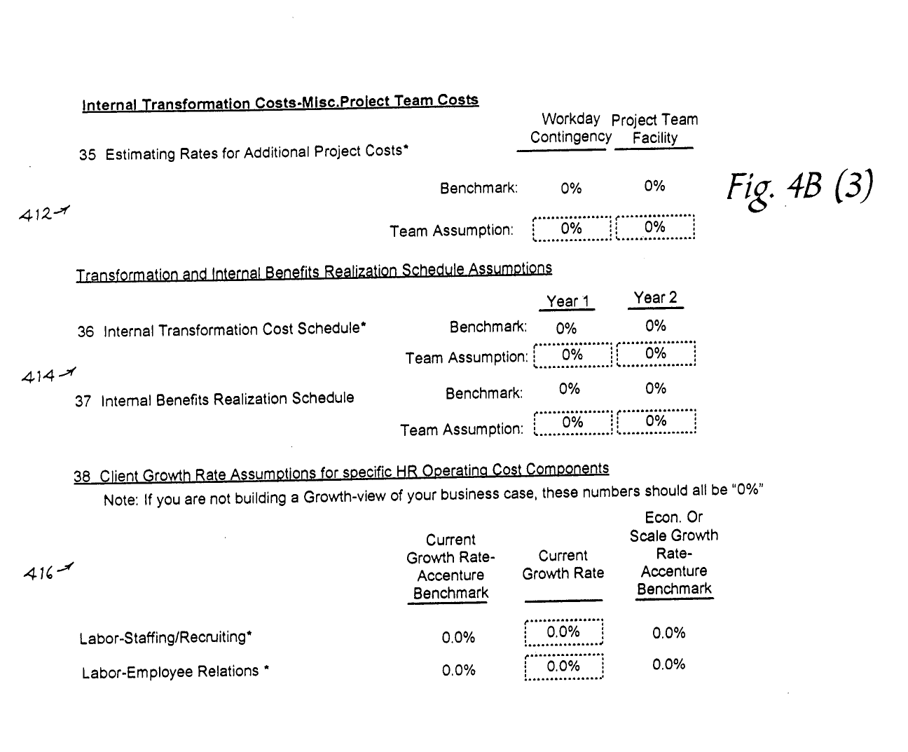

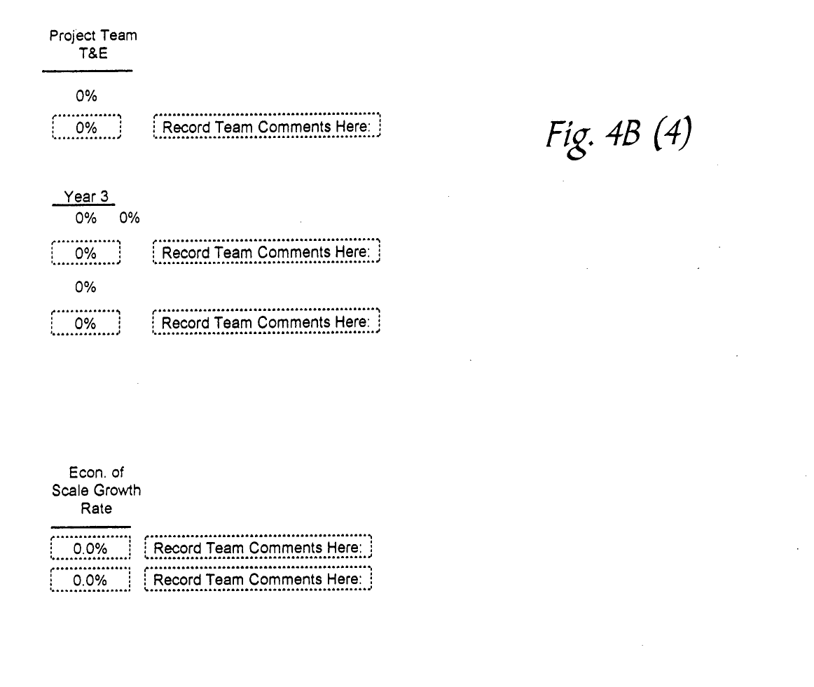

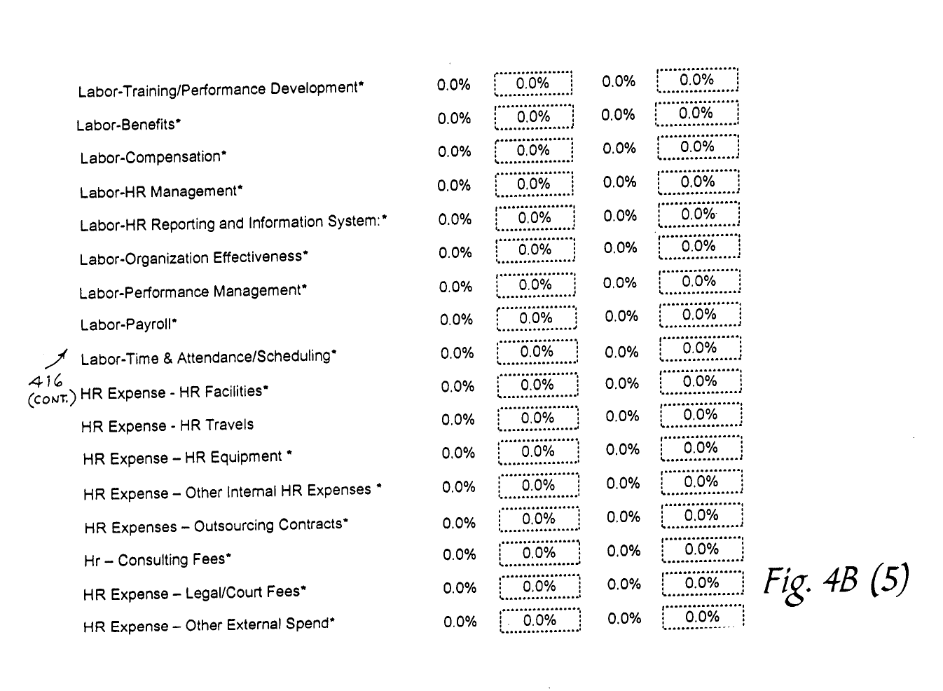

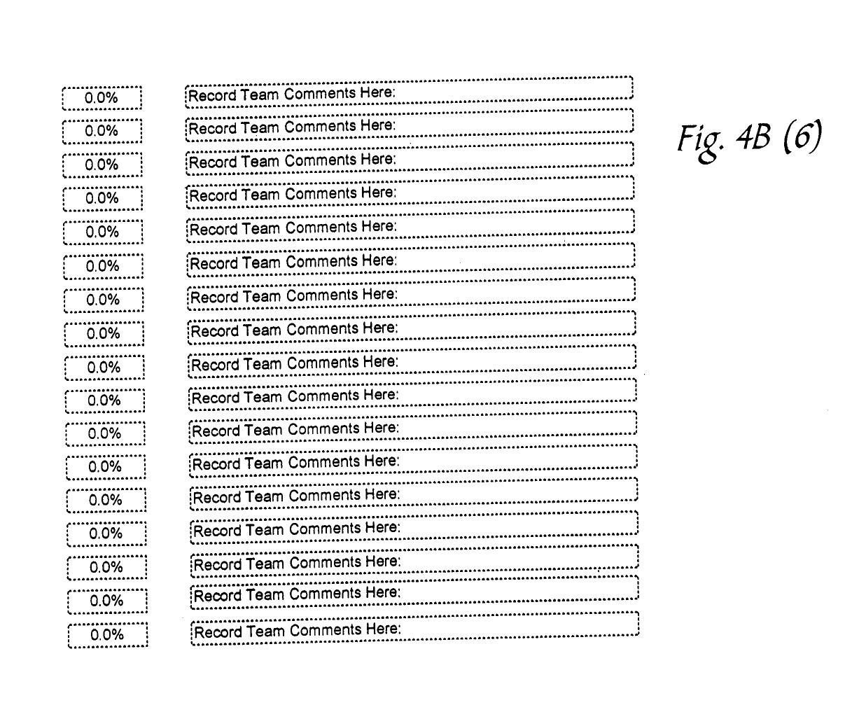

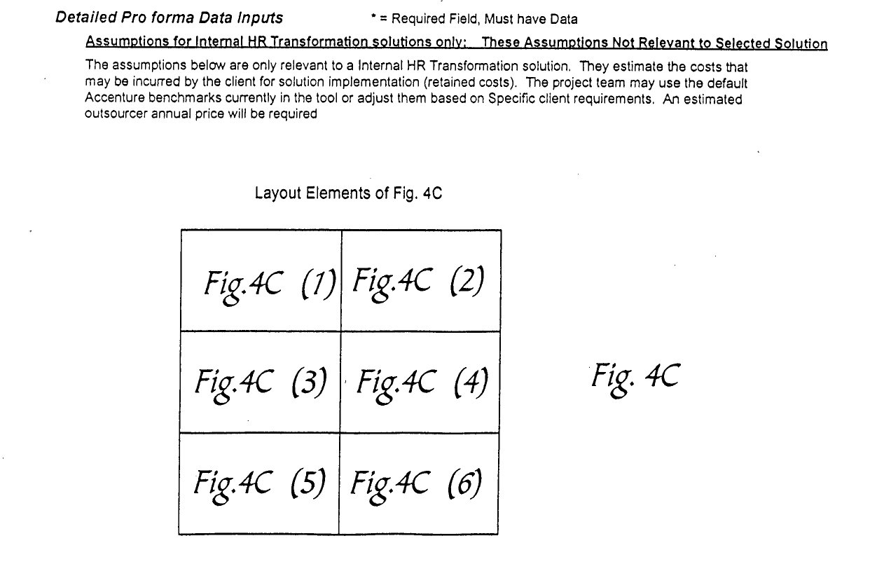

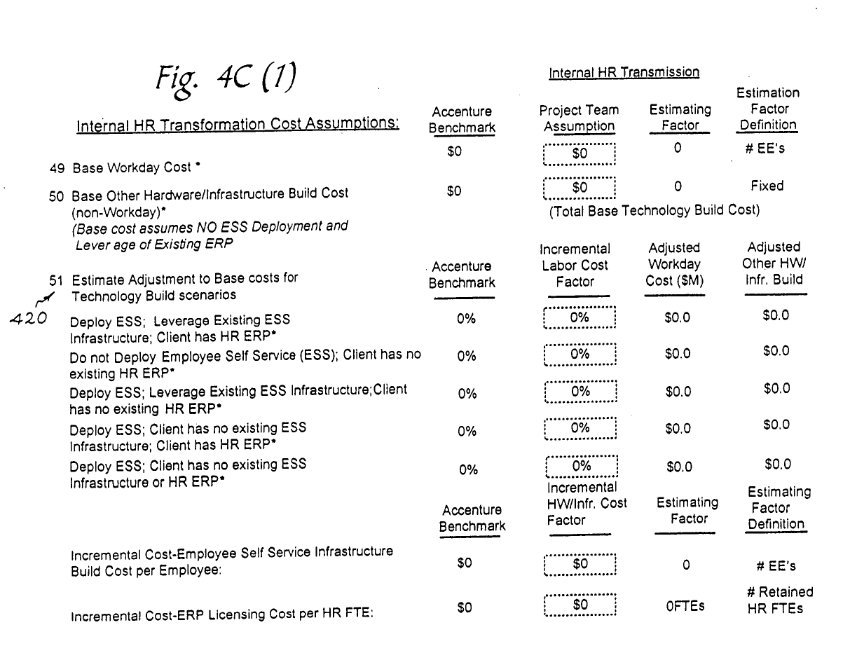

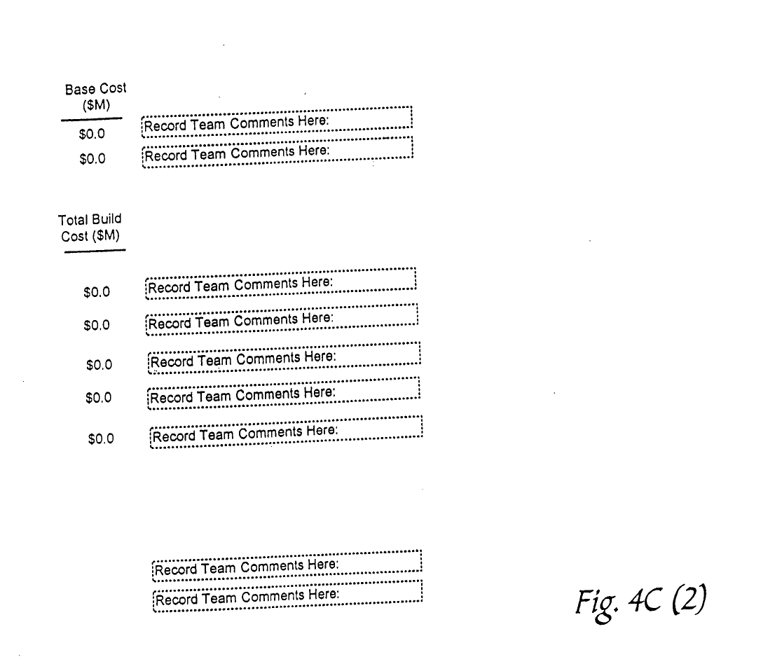

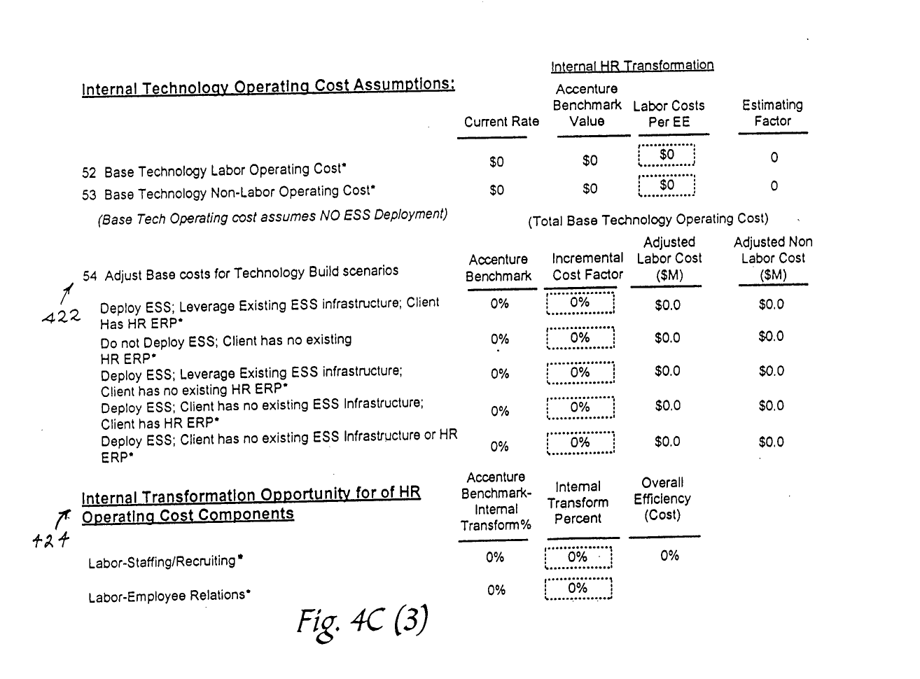

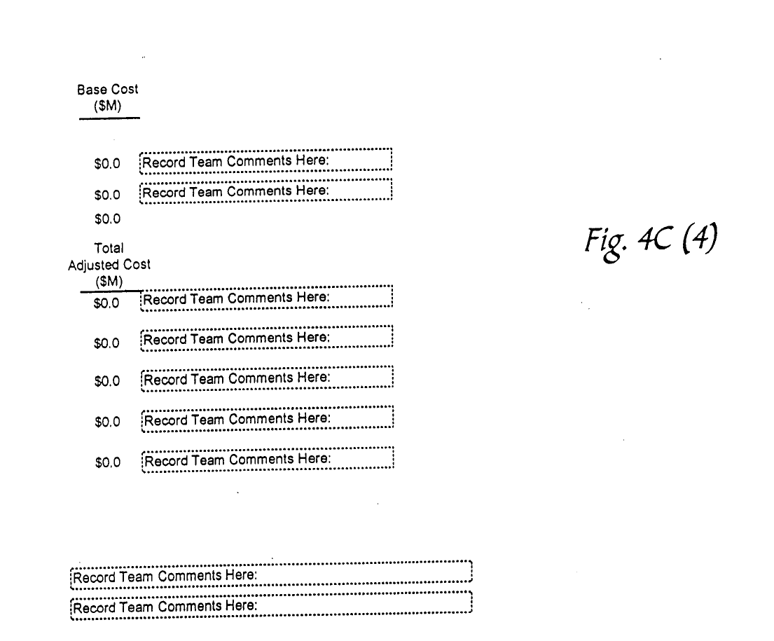

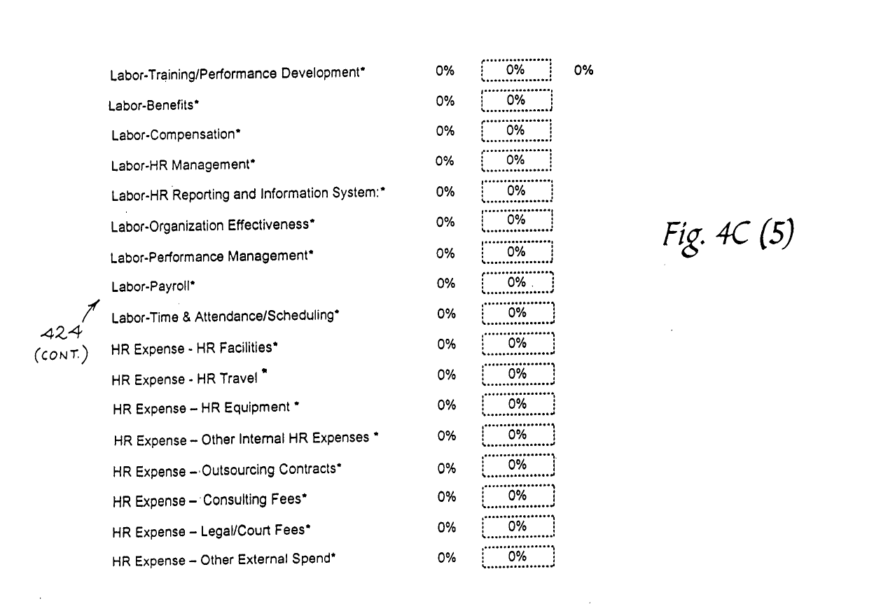

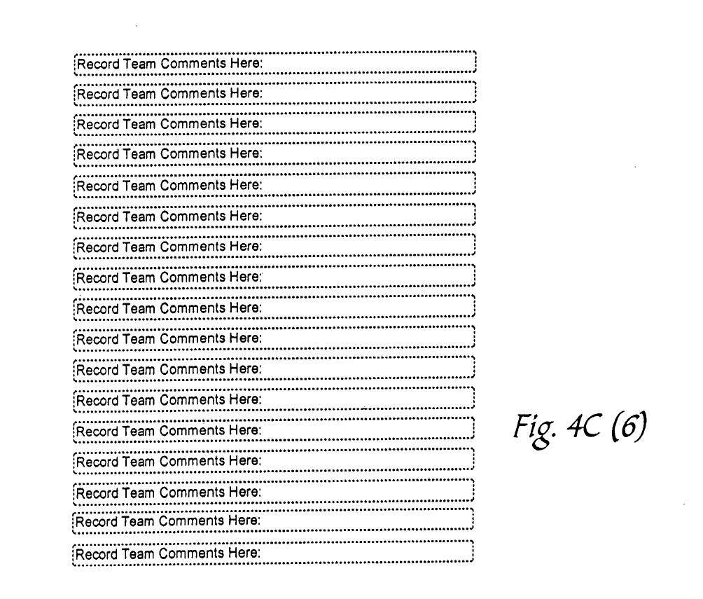

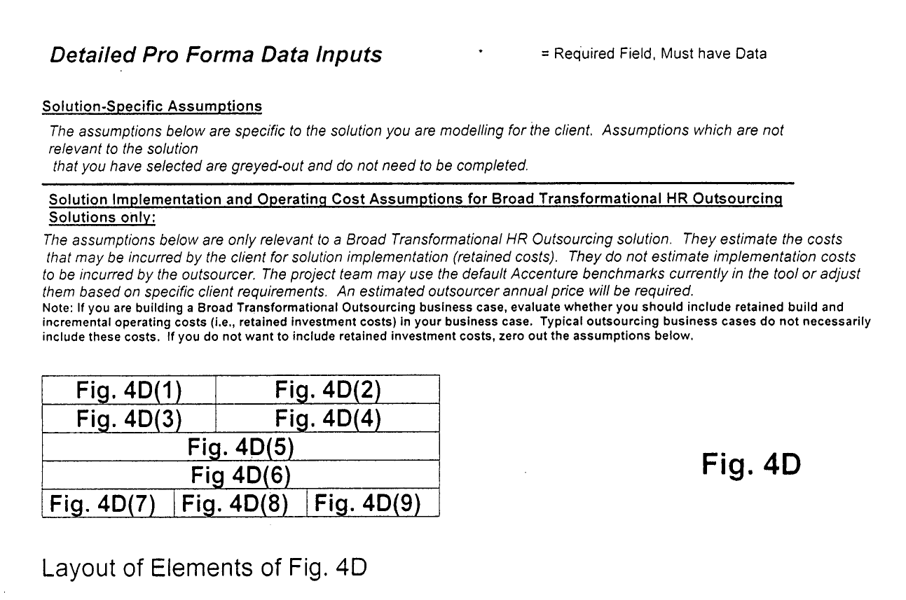

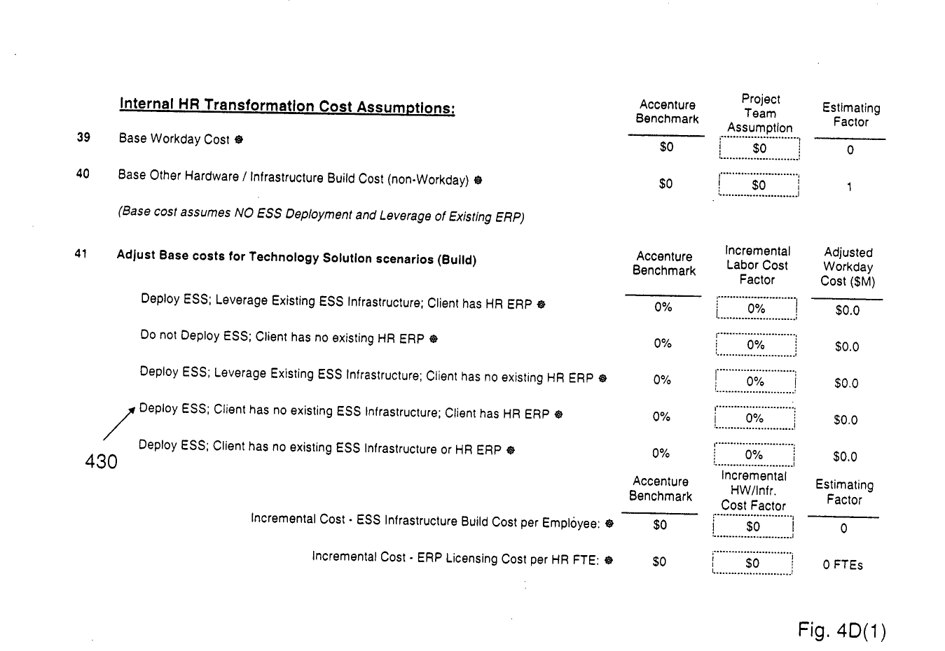

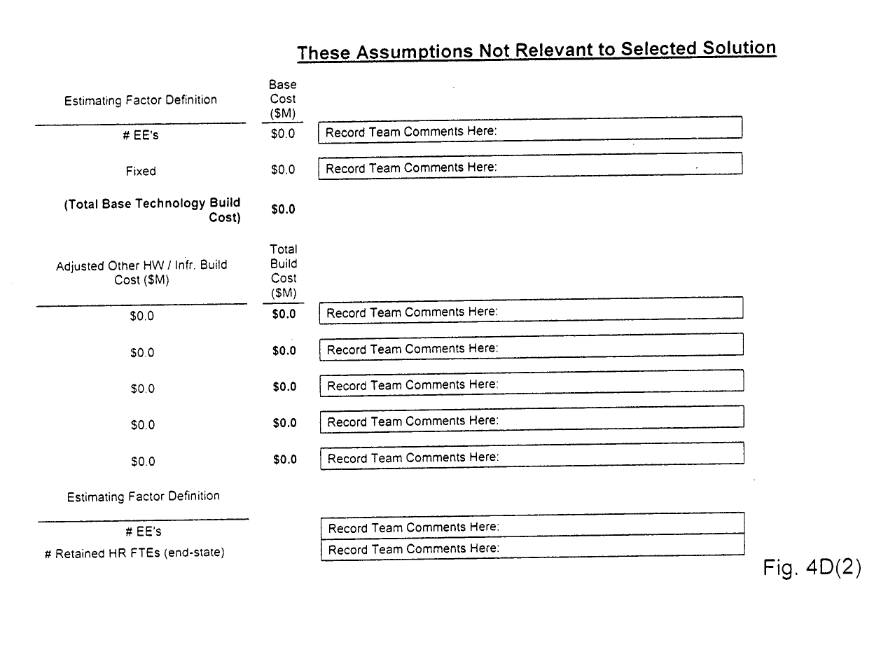

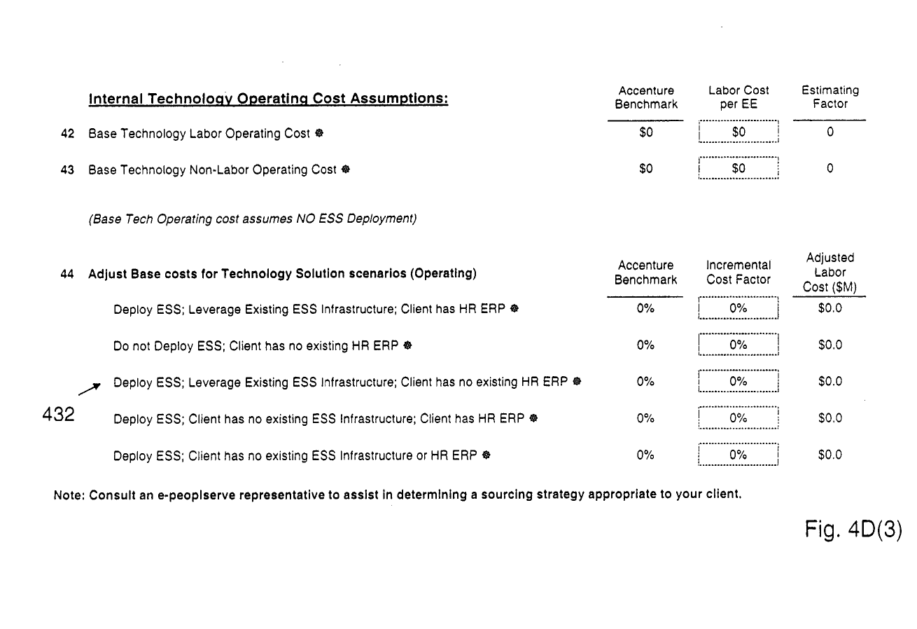

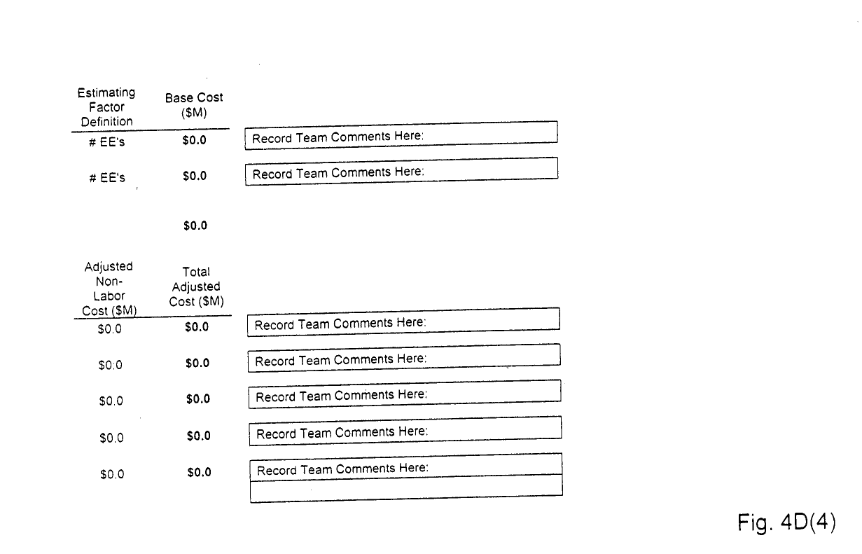

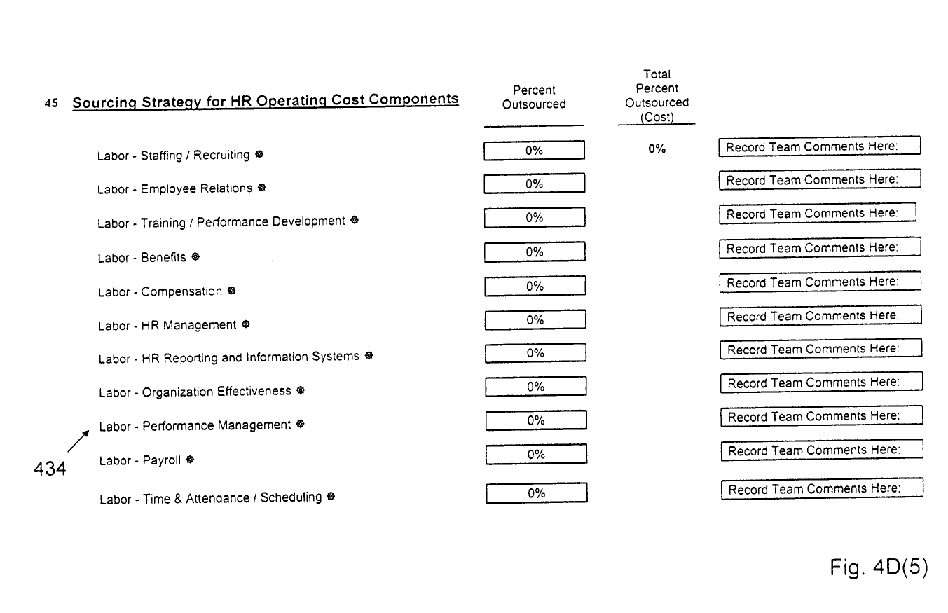

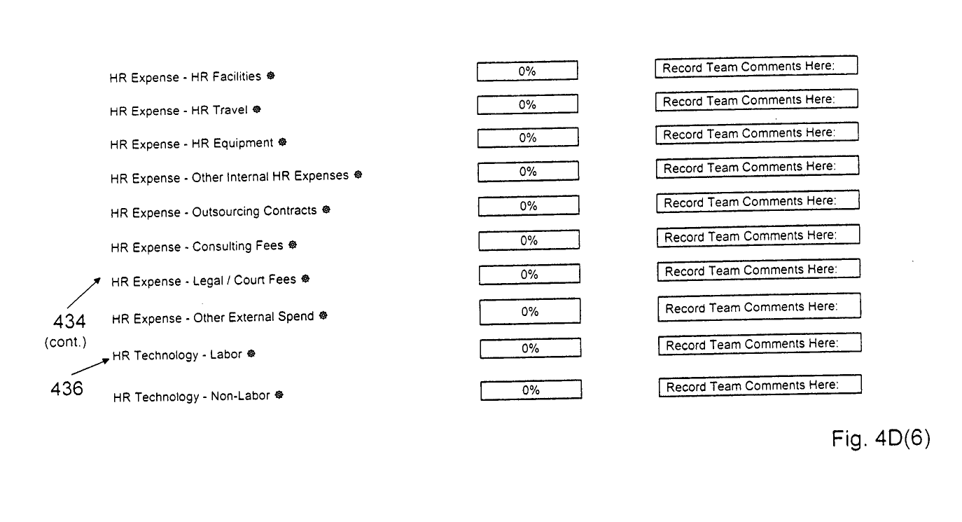

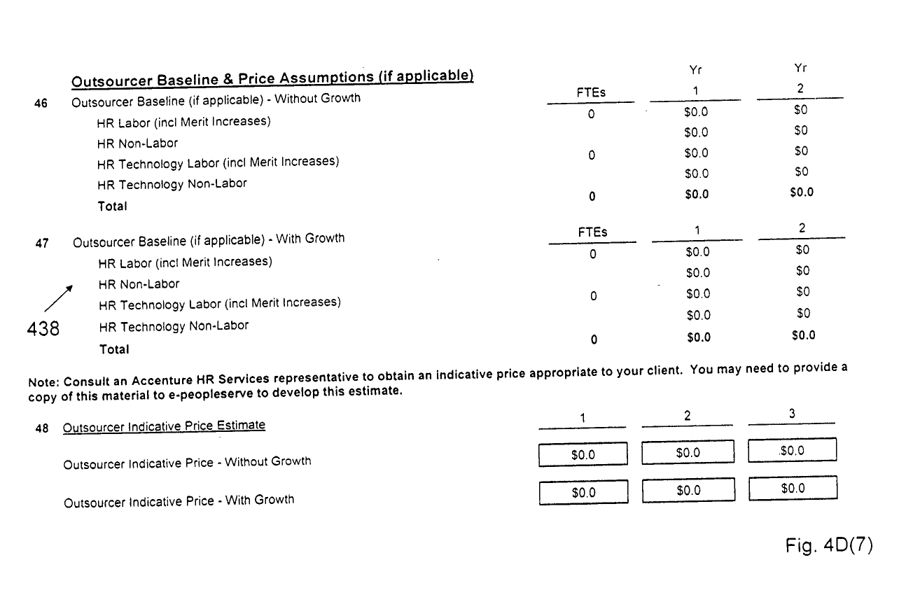

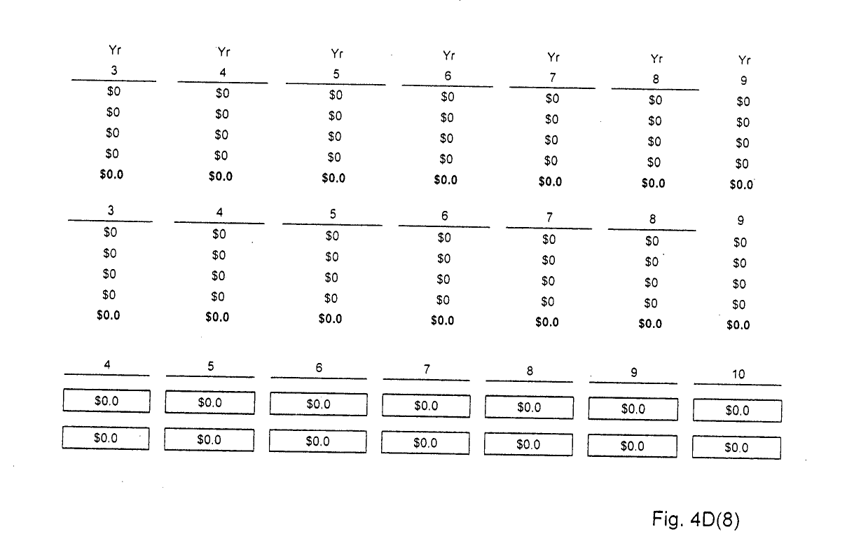

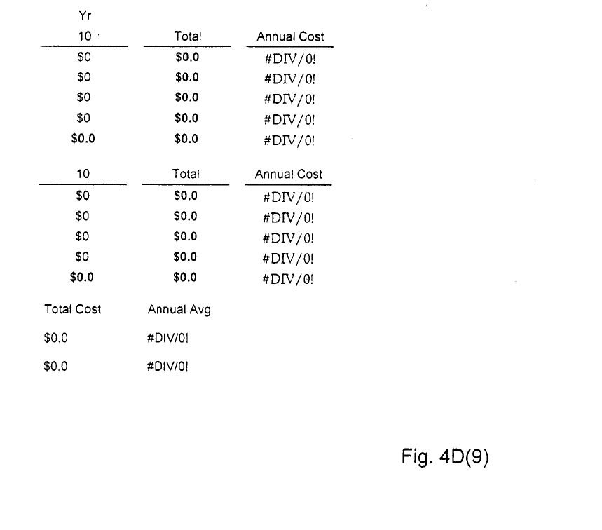

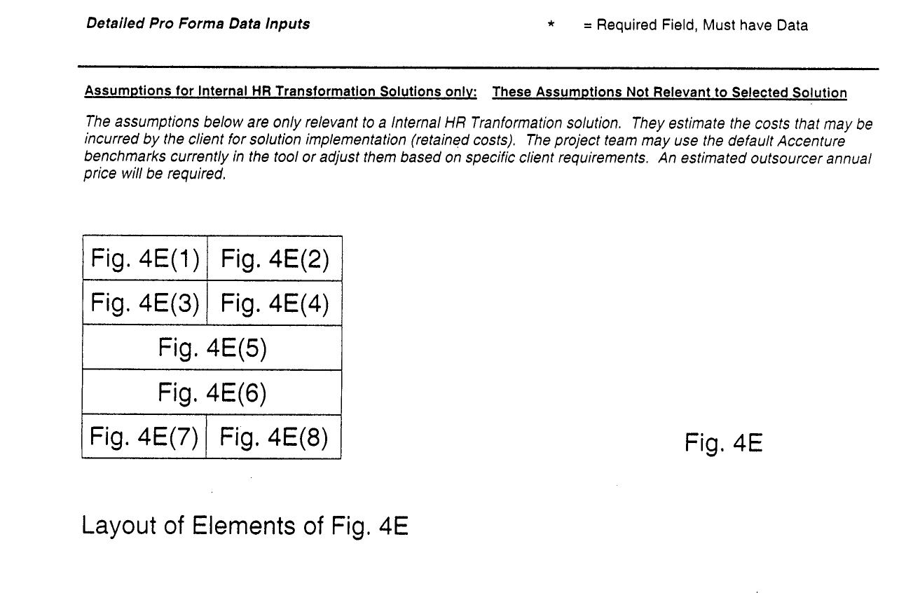

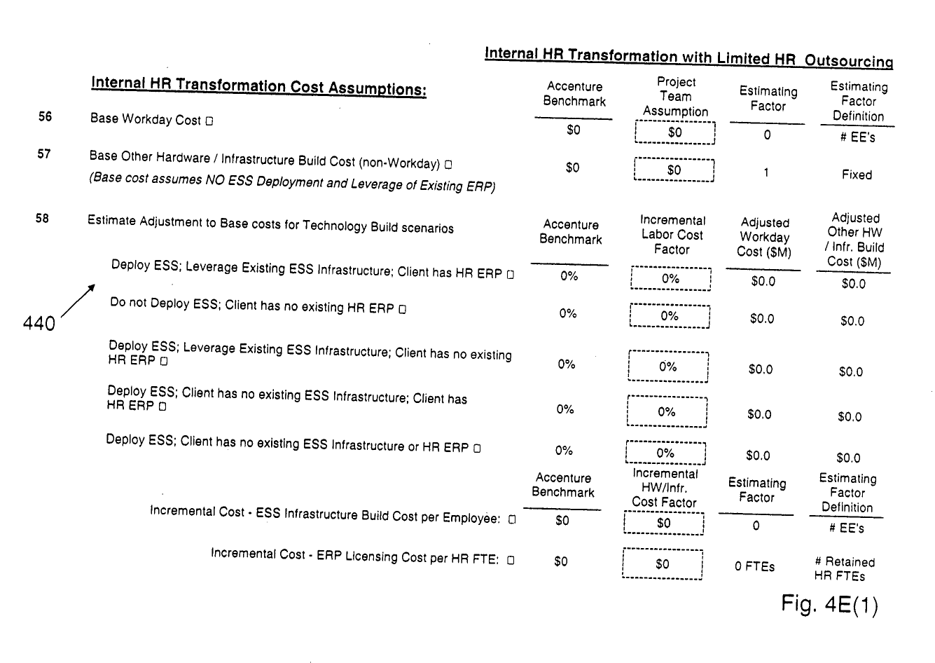

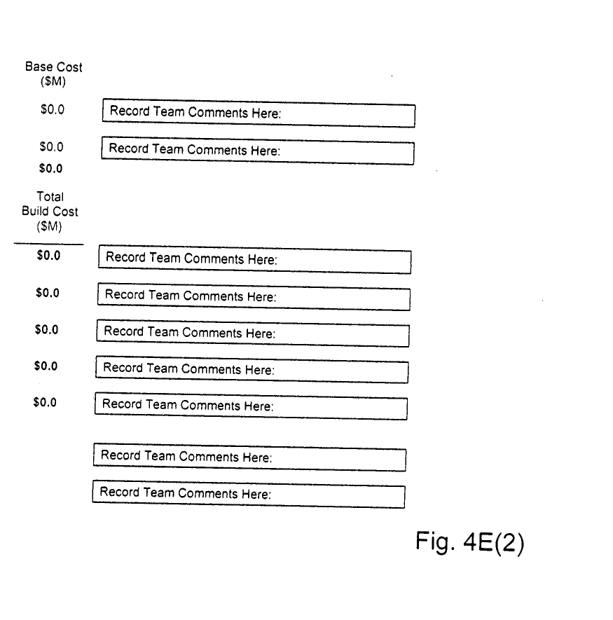

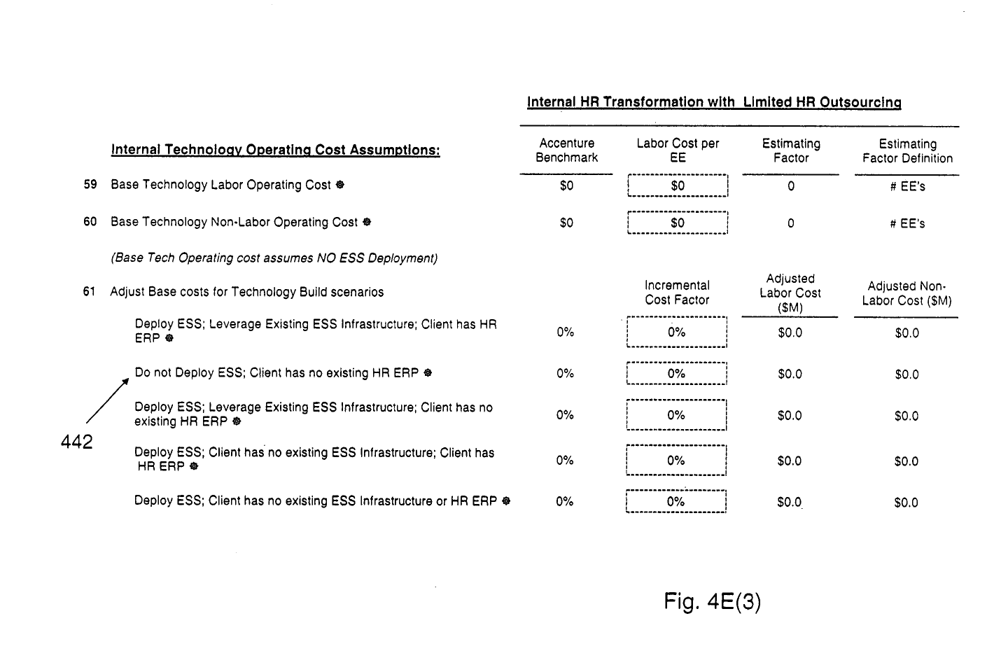

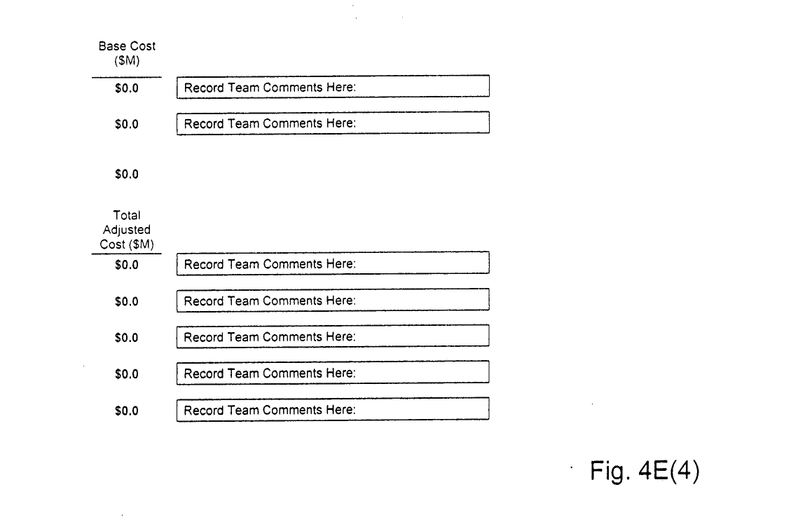

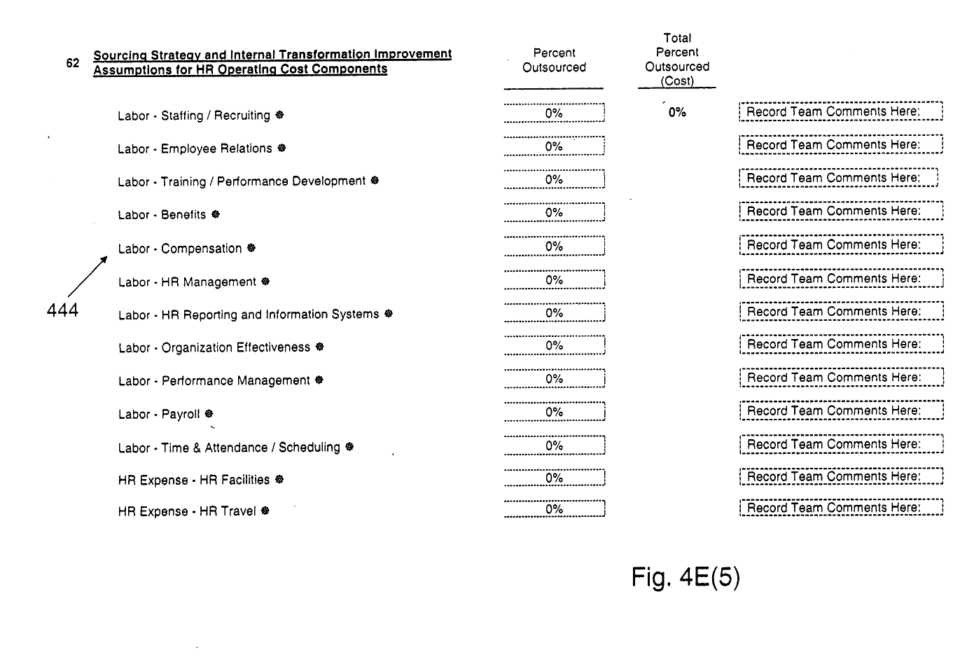

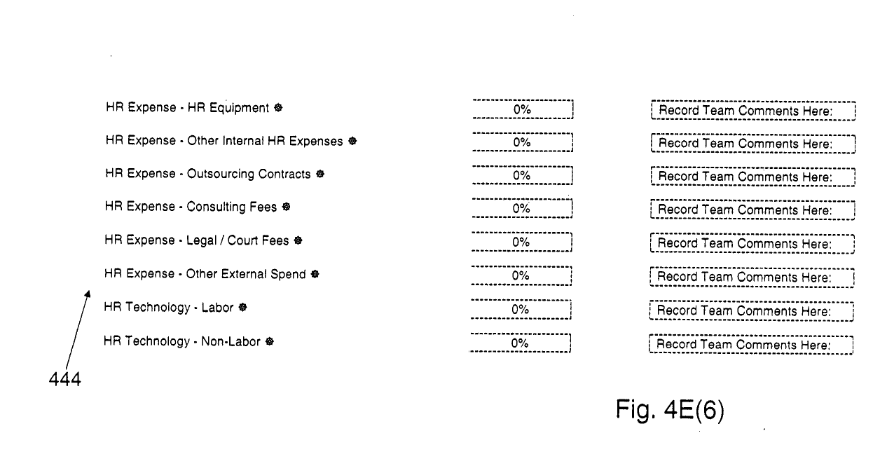

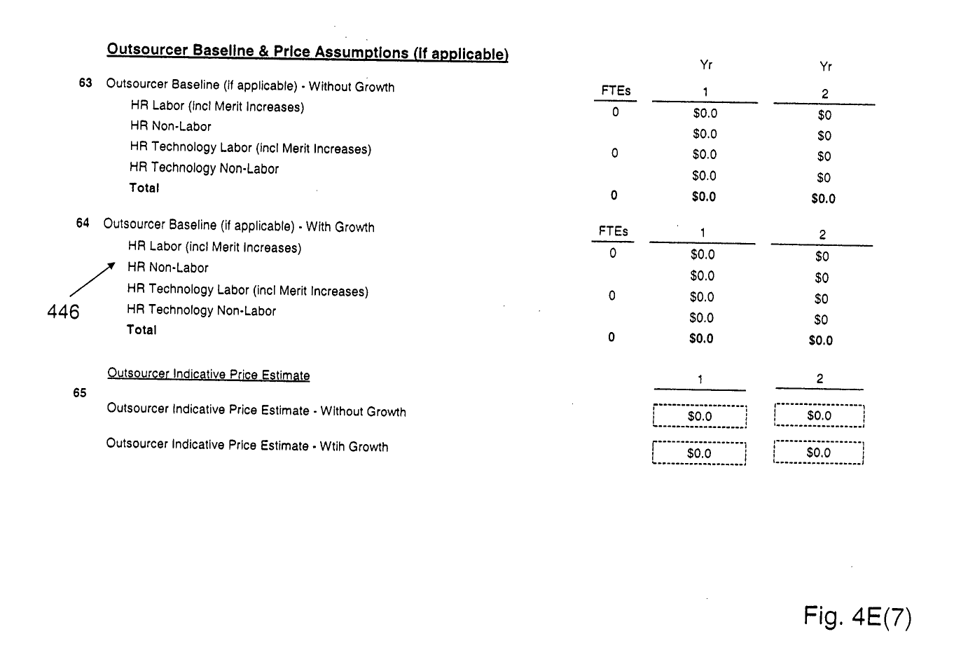

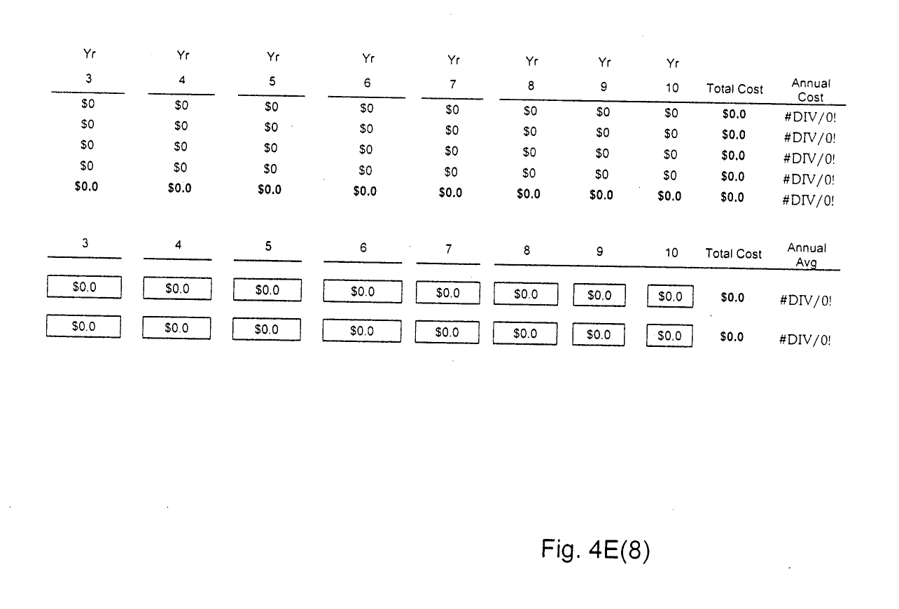

FIGS. 4A-4E illustrate exemplary data interface displays which may be utilized by the business opportunity indicator of the system 100 when receiving data inputs 300 for modeling a particular business organization transformation scenario. Such data inputs are typically received from a user of the system 100 entering data through the data entry terminal 125 of the user interface 115. Such data typically includes the entry of numbers, percentages, and cash values, and any assumptions therefore, with regards to a function(s) of the business organization, where certain data and information may be broken down into further sub-functions as described below. Further, the information representing the displays shown in FIGS. 4A-4E are merely exemplary, and more or less data may be utilized in modeling a business organization transformation scenario. Further, as will be described below, some of the data inputs illustrated in FIGS. 4A-4E may be utilized only where a particular business organization transformation scenario is being modeled. Further, the data and information may be provided by a business organization, or alternatively may be determined based on an assessment of the business organization, for example, as a result of a one to two week interaction with the business organization. Further, some of the assumptions (for example benchmarks) may be entered by a user of the system 100, or alternatively may be automatically imported into the transformation opportunity indicator, and may be utilized, for example, where corresponding information for the business organization is not provided.

As shown in FIGS. 4A-4E, the data input may include basic business organization (client) current state data and assumptions, as well as solution-specific assumptions for various transformation scenarios (i.e. a broad-outsourcing scenario, an internal transformation scenario, and mixed outsourcing/internal transformation scenario).

FIG. 4A illustrates an exemplary user interface display that may be utilized by the business opportunity indicator in receiving general data and assumptions regarding the business organization, in accordance with the first embodiment of the invention. As shown in FIG. 4A, data inputs may include basic client current state data at 402, overall client growth rate assumptions at 404, current client HR operating cost data at 406, and current client high-level activity analysis data at 408.

Basic client current state data 402 may include, for example, information regarding a client name, a client industry group, a client annual revenue, a client annual operating expense, and a client current total employee population. The basic client current state data may further include information regarding client interest-bearing debt, client shareholders' equity, client marginal tax rate, client weighted average cost of capital, client current stock price, and the client's current shares outstanding. Basic client current state data may further include a particular solution scenario to evaluate for the client, whether to include deployment of employee self service as a proposed solution, a percent of employees with current client Internet/Intranet access, an indication whether the current HR system includes HR enterprise resource planning (ERP), and an indication whether to include full-scope payroll/time and attendance (T&A) in the assessment. The basic client current state data may further include a number of locations for the client, a number of North American countries in which the client has a presence, a number of supported work force languages, a number of current HR systems in use by the client, a number of custom-developed current HR systems used by the client, a cost of capital rate for the client, and a period over which the business case is to be evaluated.

The client industry group discussed above may include a selection of various industries including banking, chemicals/petroleum products, computer products, computer software/services, computer products/food & beverage/retail, government agencies/education, hospitals/healthcare, insurance-all lines & P, C, P, insurance-healthcare only, manufacturing, non-bank financial, pharmaceuticals/medical devices/R&D, semiconductors/electronics, services, telecommunications and utilities. Alternate or additional client industry groups may be provided. The solution to evaluate for the client discussed above may include a broad transformational HR outsourcing, internal HR transformation, and mixed outsourcing/internal transformation scenario.

The number of locations data may be broken down with respect to HR leadership, corporate HR, HR shared services center, and field HR.

In some situations, overall client growth rate assumptions, generally indicated at 404, may be provided. Such growth rate assumptions may be utilized where business organization corresponding information is not provided, and may include a client average annual goal projection percentage, an average rate of growth for costs not growing in parallel to business growth, average technology growth rate, economies of scale growth rate, and average annual above-inflation merit increase rates. For some of the growth rate assumptions (i.e. average rate of growth for costs not growing in parallel to business growth, average technology growth rate and economies of scale growth rate), internal benchmark information may be automatically provided, for example based on previous experience and/or best practices, and utilized where a transformation team assumption is not entered.

Information regarding a client current HR operation cost may also be gathered, as generally indicated at 406. For example, such information may include whether a client is able to provide a particular HR cost break down, and a total client annual HR operating cost, which may be further broken down as a total cost and as a total HR full-time equivalents (FTEs). Further, information may be provided regarding HR leadership, corporate HR, HR services center and field HR. Such information may be provided from a point of view of annual HR budgets for labor, HR expenses, HR facilities, 3rd-party/vendor, as well as a number of HR full time equivalents (FTEs). Information regarding HR technology may also be provided, for example with relation to annual HR technology budgets for labor, annual HR technology budget regarding non-labor, and regarding technology FTEs. Where a client is not able to provide a particular HR cost break-down, Accenture or industry benchmark assumptions may be utilized in estimating the particular information called-for.

In addition, information regarding current client high-level activity analysis data 408 may be obtained from the client. Such data may include a percentage break down between corporate HR, HR share service center, and field HR for the various HR sub-functions including staffing/recruiting, employee relations, training and development, benefits, compensation, HR management, HR reporting and information systems, organization effectiveness, performance management, payroll, and time & attendance/scheduling.

FIG. 4B illustrates an exemplary user interface display which may be utilized by the transformation opportunity indicator in receiving information and assumptions regarding internal solution implementation cost estimate assumptions in accordance with the first embodiment. The assumptions may be utilized to develop a detailed proforma for all solution scenarios, whether dealing with outsourcing, internal transformation, or a mixture of both. Such assumptions may be used to estimate costs which the client may incur internally during solution implementation (retained costs). The transformation team may use default internal and/or industry benchmarks provided, or alternatively may adjust the benchmarks based on specific client requirements. In some situations, retained build and incremental operating costs may not be utilized or entered for a particular transformation scenario, for example, a broad -outsourcing transformation scenario.

As shown in FIG. 4B, internal solution implementation cost estimate assumptions may include, for example, internal transformation costs such as HR related costs at 410, internal transformation costs such as miscellaneous transformation team costs at 412, transformation and internal benefits realization schedule assumptions at 414, and client growth rate assumptions for specific HR operating cost components after scenario implementation is achieved at 416.

The internal transformation costs for HR related costs 410 may include various assumptions, for example assumptions regarding internal retraining/redeployment, severance, relocation, retention, and retain recruiting assumptions. The internal retraining/redeployment assumptions may be presented as a % FTEs To-Be redeployed, and redeployment cost per FTE. Severance assumptions may be presented as % FTEs to receive severance, week's severance per FTE, average HR FTE loaded, average weekly cost, and severance per FTE. The relocation assumptions may be presented as % FTEs to receive retention, % loaded FTE cost for retention, average HR FTE loaded, and retention cost per FTE. The retained recruiting assumptions may be presented as numbers of FTEs to be recruited, and recruiting costs per FTE.

The internal transformation costs regarding miscellaneous transformation team costs at 412 may include information such as rates estimated for additional project costs, and may be presented as work day contingency, transformation team facility, and transformation team T&E.

Transformation and internal benefits realization schedule assumptions 414 may include an internal transformation cost schedule and an internal benefits realization schedule for particular periods in time, for example a first year, a second year and a third year.

Client growth rate assumptions for specific HR operating cost components at 416 may include information regarding labor and information regarding HR expenses, and may presented as a current growth rate and an economies of scale growth rate. The labor information may include information regarding staffing/recruiting, employee relations, training/performance developing, benefits, compensation, HR management, HR reporting and information systems, organization effectiveness, performance management, payroll, and time & attendance/scheduling. The HR expenses information may include information regarding HR facilities, HR travel, HR equipment, other internal HR expenses, outsourcing contracts, consulting fees, legal/court fees, and other external spending.

FIGS. 4C-4E illustrate information and assumptions regarding solution-specific transformation scenarios that may be utilized by the transformation opportunity indicator in accordance with the first embodiment. The solution specific information and assumptions are assumptions specific to a particular transformation opportunity scenario being modeled for the business organization. Such assumptions, for example, may include a broad outsourcing transformation scenario, an internal transformation scenario, and a mixed outsourcing/internal transformation scenario. Typically, information and assumptions are entered for the particular scenario being modeled.

FIG. 4C illustrates an exemplary user interface display showing information and assumptions that may be used for an internal HR transformation solution. The assumptions may include internal HR transformation cost assumptions at 420, internal technology operating cost assumptions at 422, and internal transformation opportunity for HR operating cost components at 424.

The internal HR transformation cost assumptions at 420 may include cost assumptions regarding base work day cost, base other hardware/infrastructure build cost (non-work day), estimate adjustment to base costs for technology build scenarios, and incremental cost regarding employee self-service (ESS) infrastructure build cost per employee and incremental cost-ERP licensing cost per HR FTE. Information regarding the base work day cost and non-work day cost may be provided as Accenture benchmark and/or transformation team assumption, estimating factor, estimating factor definition, and base cost. The estimate adjustment to base cost for technology build scenarios may include information regarding deployment of ESS (i.e. leveraging existing ESS infrastructure, where a client has HR ERP(s), ESSs not deployed (where the client has no existing HR ERP), deployment of ESS (leveraging existing ESS infrastructure where client has no existing HR ERP), deployment of ESS (where a client has no existing ESS infrastructure, client has HR ERP), and deployment ESS (where client has no existing ESS infrastructure or HR ERP). The estimate adjustment to base cost for technology build scenarios may further provided as an internal benchmark of the organization analyzing the transformation, incremental labor cost factor, adjusted work day cost, adjusted other HW/infrastructure build cost, and total build cost. The incremental cost regarding ESS infrastructure build cost per employee as well as incremental cost for ERP licensing cost per HR FTE may be provided as Accenture benchmark, incremental HW/infrastructure cost factor, estimating factor, and estimating factor definition.

The internal technology operating cost assumptions at 422 may include base technology labor operating cost, base technology non-labor operating cost, and adjust base cost for technology build scenarios. The base technology labor and non-labor operating cost may be provided as current rate, internal benchmark value, labor cost per employee, estimating factor and base cost. The adjust base cost for technology build scenarios may include information regarding deployment of employee self service (ESS) (i.e. leveraging existing ESS infrastructure, where a client has HR ERP(s), ESSs not deployed (client has no existing HR ERP), deployment of ESS (leveraging existing ESS infrastructure where client has no existing HR ERP), deployment of ESS (where a client has no existing ESS infrastructure, client has HR ERP), and deployment ESS (where client has no existing ESS infrastructure or HR ERP). Information regarding the adjust base cost for technology build scenarios may be provided an internal benchmark, incremental cost factor, adjusted labor cost, adjusted non-labor cost, and total adjusted cost.

The internal transformation opportunity for HR operating cost components at 424 may include labor and HR expense information. Labor information may include information regarding HR sub-functions such as staffing/recruiting, employee relations, training/performance developing, benefits, compensation, HR management, HR reporting and information systems, organization effectiveness, performance management, payroll, and time and attendance/scheduling. The HR expense information may include information regarding HR facilities, HR travel, HR equipment, other internal HR expenses, outsourcing contracts, consulting fees, legal/court fees, and other external spending. The internal transformation for operating cost components may be provided as Accenture benchmark-internal transformation percentages, internal transformation percent information, and/or by overall efficiency cost.

FIG. 4D illustrates an exemplary user interface display regarding operating cost information and assumptions for a broad outsourcing transformation scenario in accordance with the first embodiment. The operating cost information and assumptions for the broad outsourcing transformation scenario may include similar assumptions and information as discussed above with regard to the internal HR transformation scenario of FIG. 4B. For example, the operating cost assumptions and information for a broad outsourcing transformation scenario may include internal HR transformation cost assumptions 430 similar to the internal HR transformation cost assumptions 420 discussed above, internal technology operating cost assumptions 432 similar to the internal technology operating cost assumptions 422 discussed above, and sourcing strategy for HR operating cost component 434 similar to internal transformation opportunity for HR operating cost components 424 discussed above with respect to FIG. 4C.

In addition, assumptions and information for a broad outsourcing transformation scenario may further include additional internal transformation opportunity for HR operating cost components indicated at 436, as well as outsourcer base line and price information and assumptions (where applicable) indicated at 438.

The additional internal transformation opportunity HR operating cost components at 436 further include HR technology with regards to labor and HR technology information with regards to non-labor.

The outsourcer base line and price assumptions at 438 may include outsourcer base line information with and without growth, where applicable, as well as outsourcer indicative price estimates. The outsourcer base line without growth and with growth each include cost and FTE information regarding HR labor (including merit increases), HR non-labor, HR technology labor (including merit increases) and HR technology non-labor. The outsourcer base line with and without growth (i.e. with growth accounting for inflation) may be provided as a number of FTEs, as well as specific costs over a particular period of time, for example, year 1 through year 10, as well as an annual cost. The outsourcer indicative price estimates may include outsourcer and ticketed price with and without growth and also may be broken down by cost over a particular period of time, for example year 1 through year 10 as well as an annual average of costs.

FIG. 4E shows information and assumptions for a mixed outsourcing/internal transformation scenario in accordance with the first embodiment, and includes similar information fields and assumptions as discussed above with respect to the broad outsourcing transformation scenario of FIG. 4D. For example, the mixed outsourcing/internal HR transformation scenario may include internal HR transformation cost assumptions 440 similar to the internal HR transformation cost assumptions 430, internal technology operating cost assumptions 442 similar to the internal technology operating cost assumptions 432 discussed above, sourcing strategy and internal transformation improvement assumptions for HR operating cost components 444 similar to the sourcing strategy for HR operating cost components 434 and 436 discussed above, and outsourcer base and price assumptions 446 similar to the outsourcer baseline and price assumptions 438 discussed above with respect to FIG. 4D.

First Embodiment Analyzing

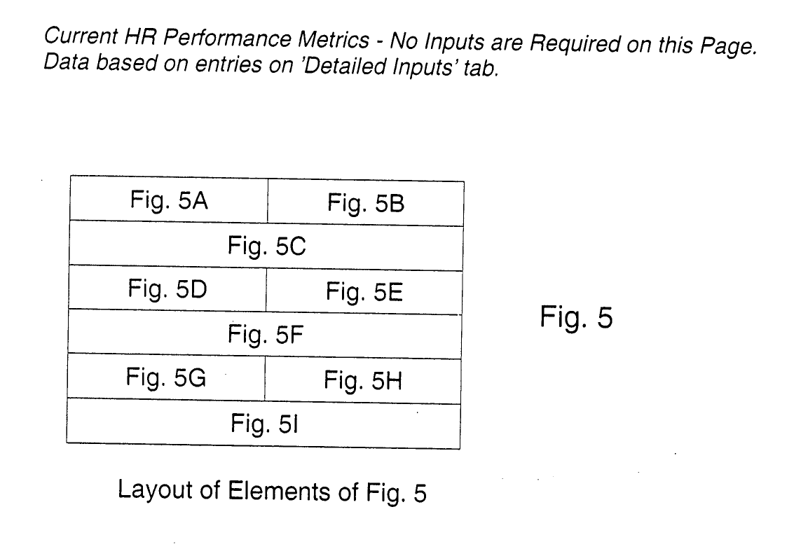

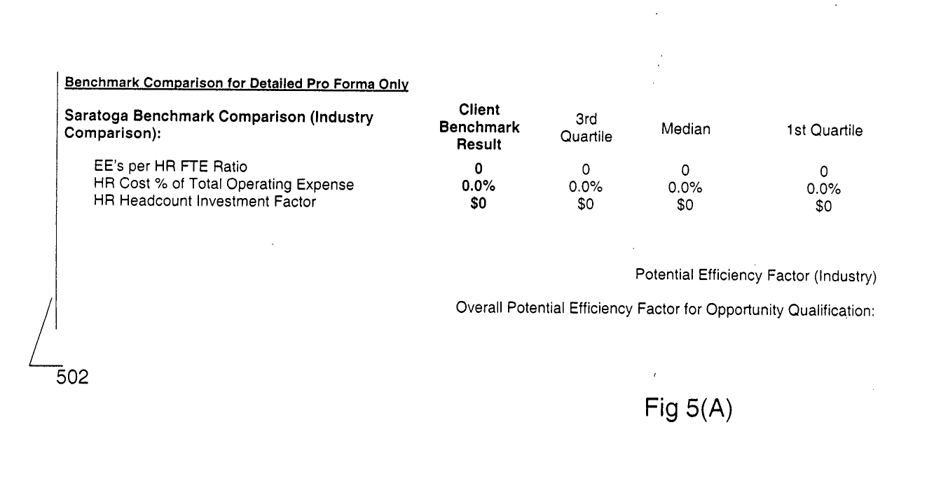

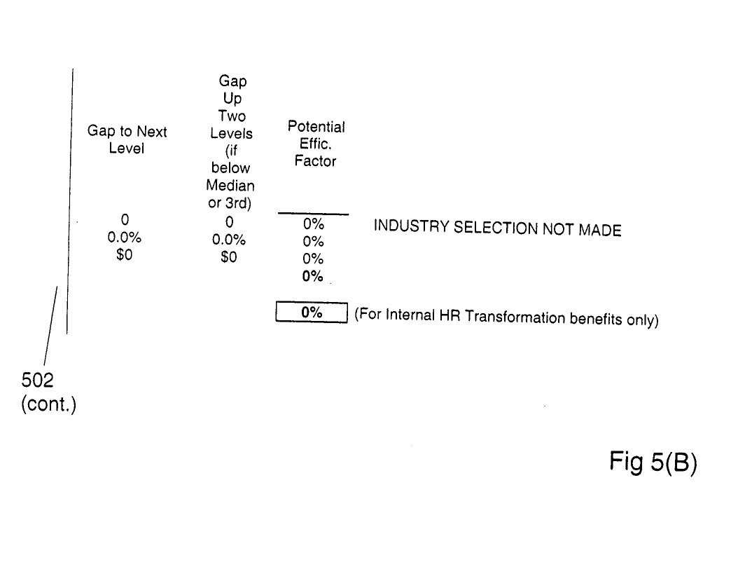

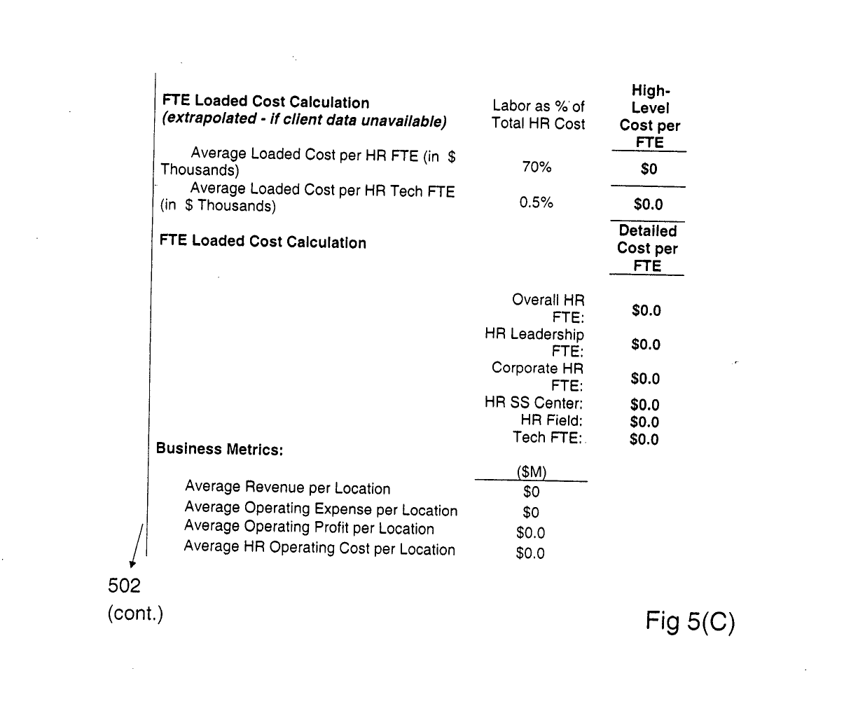

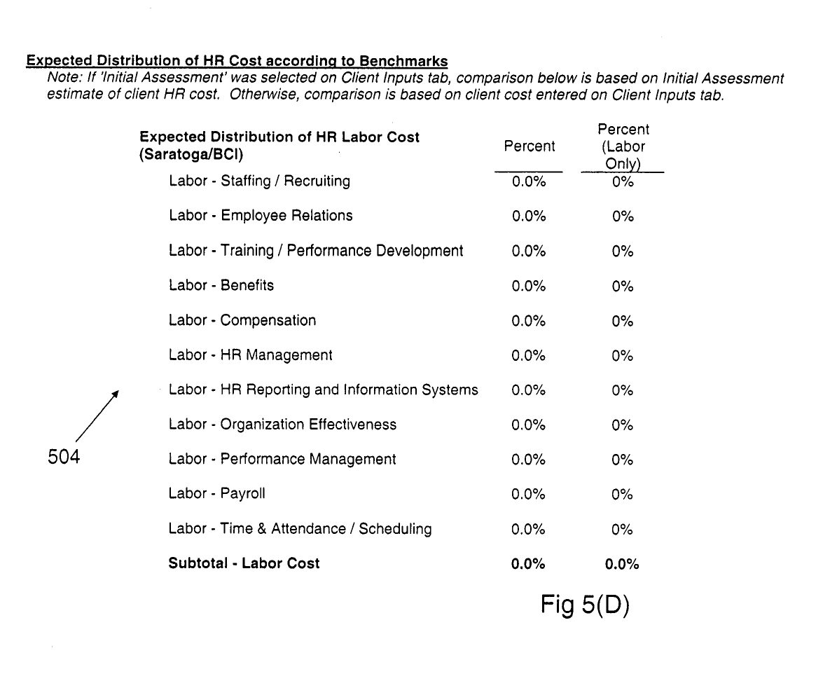

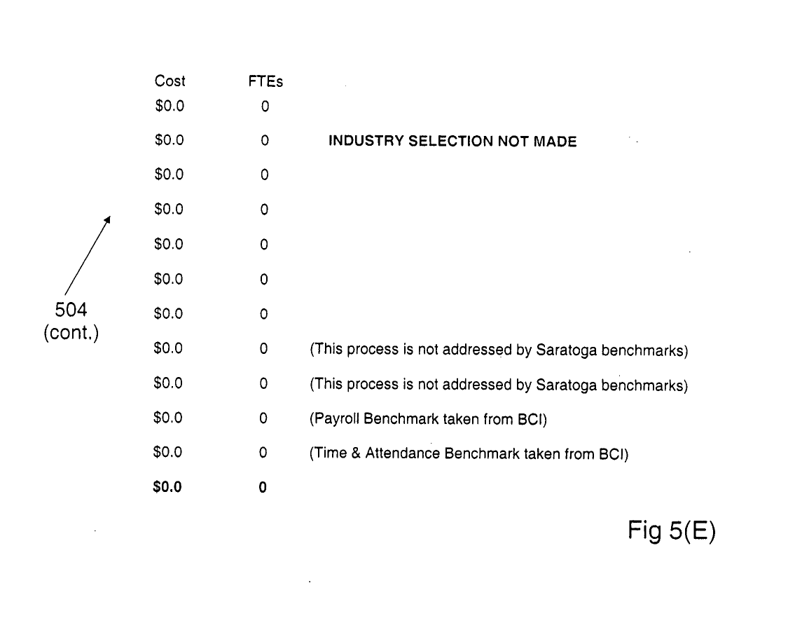

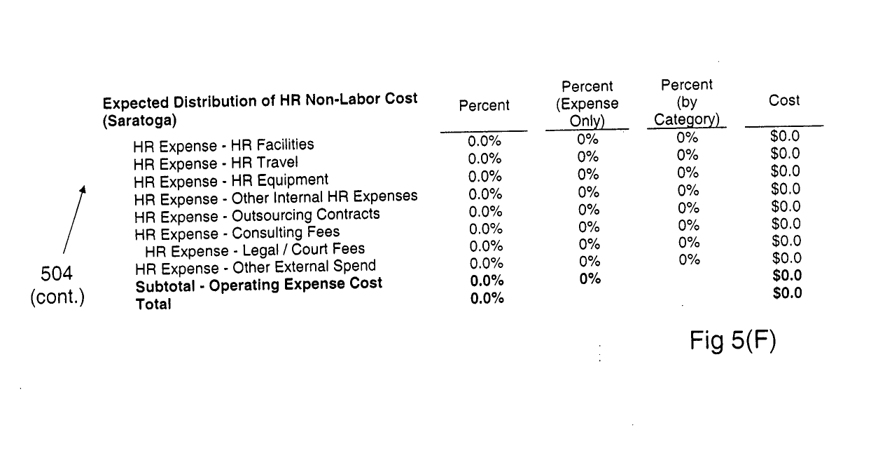

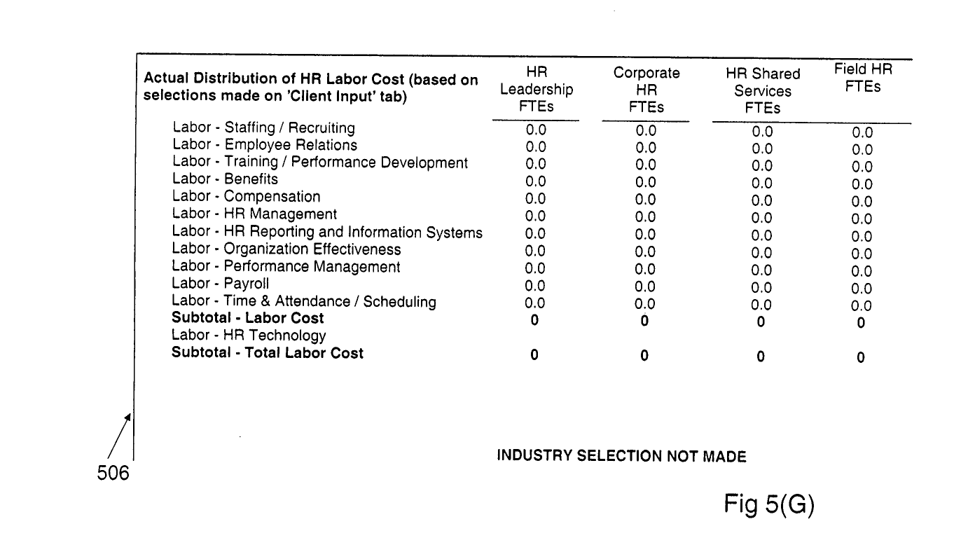

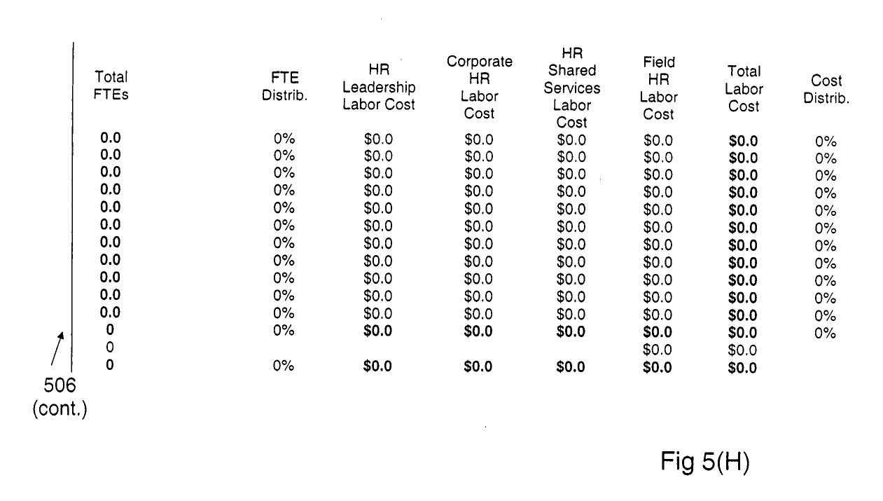

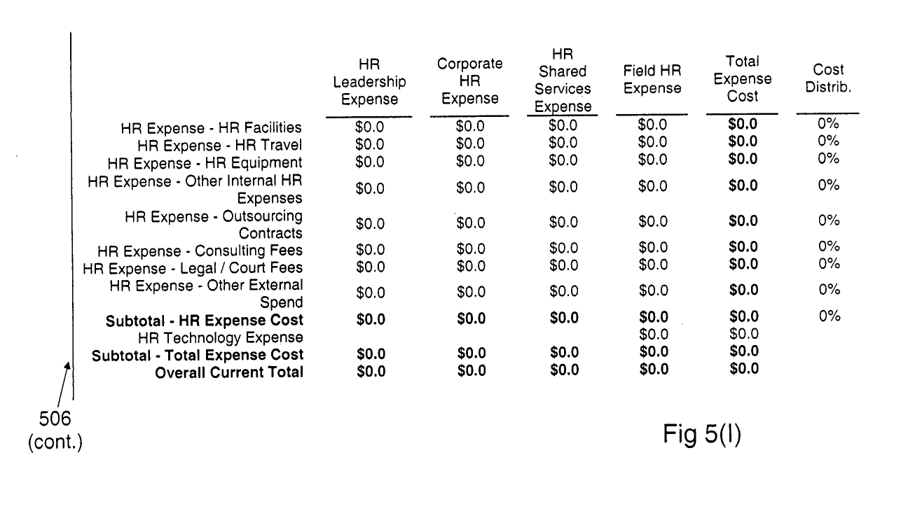

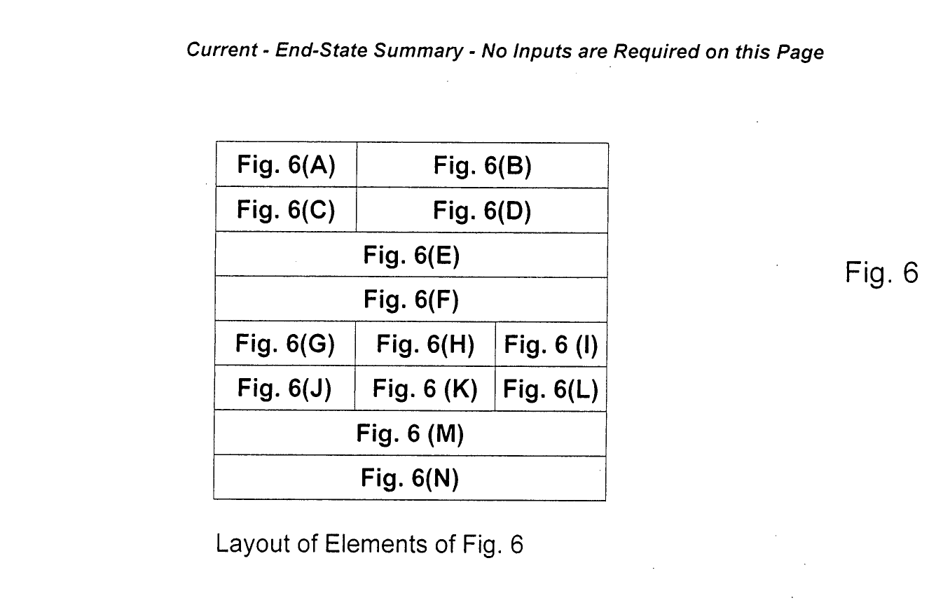

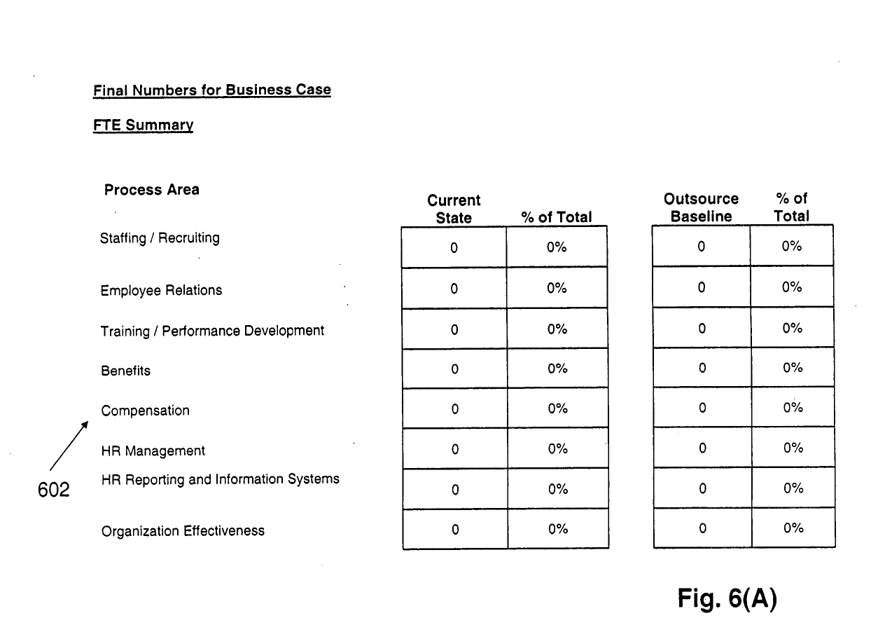

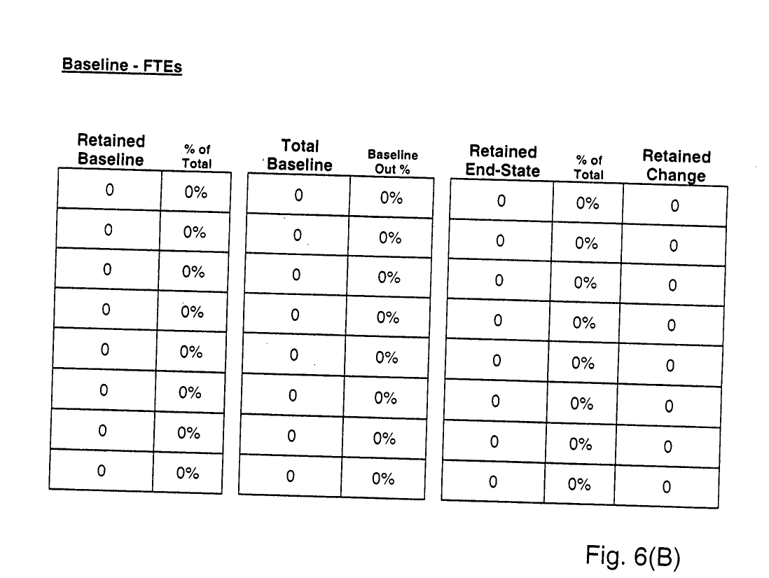

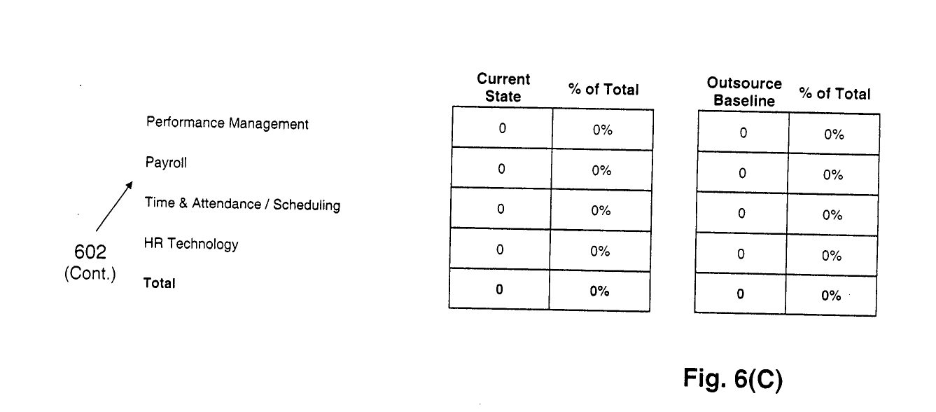

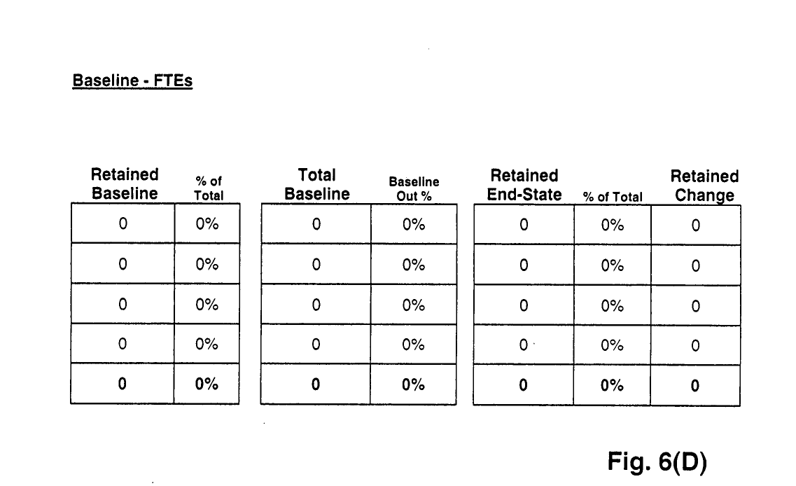

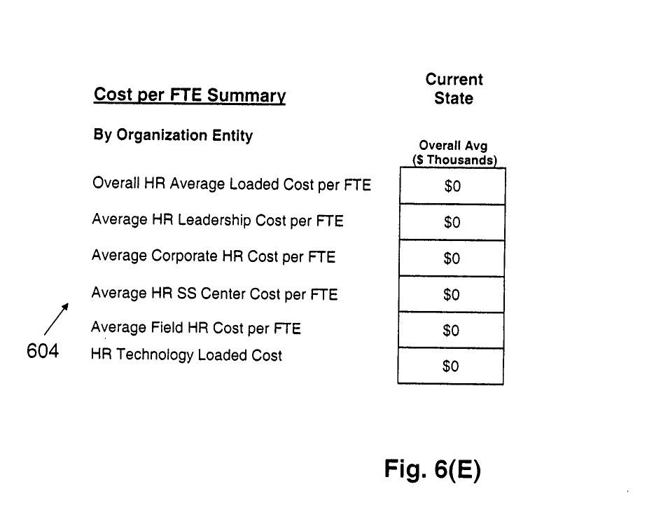

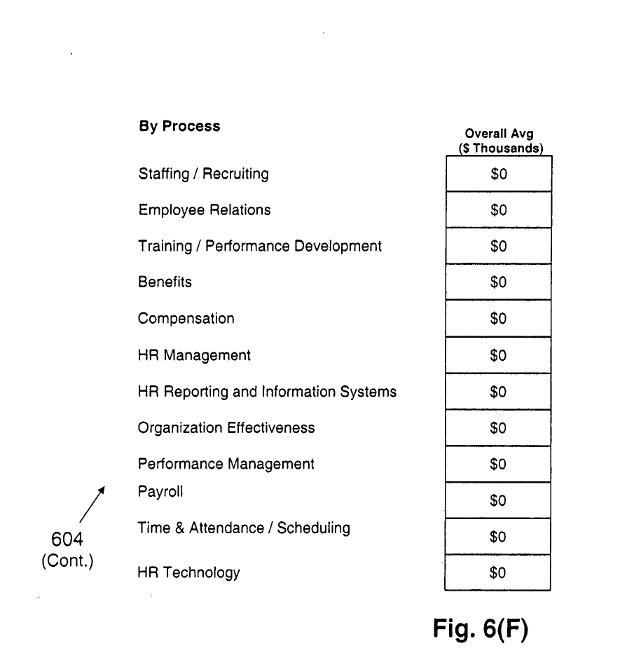

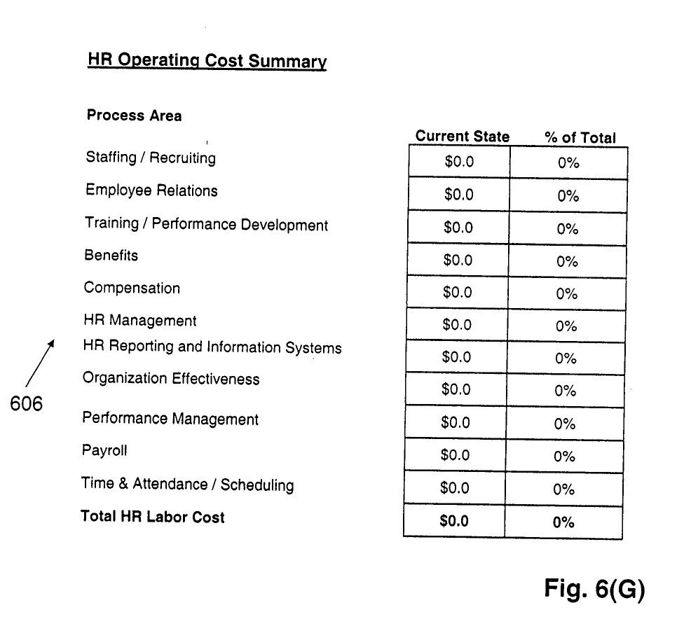

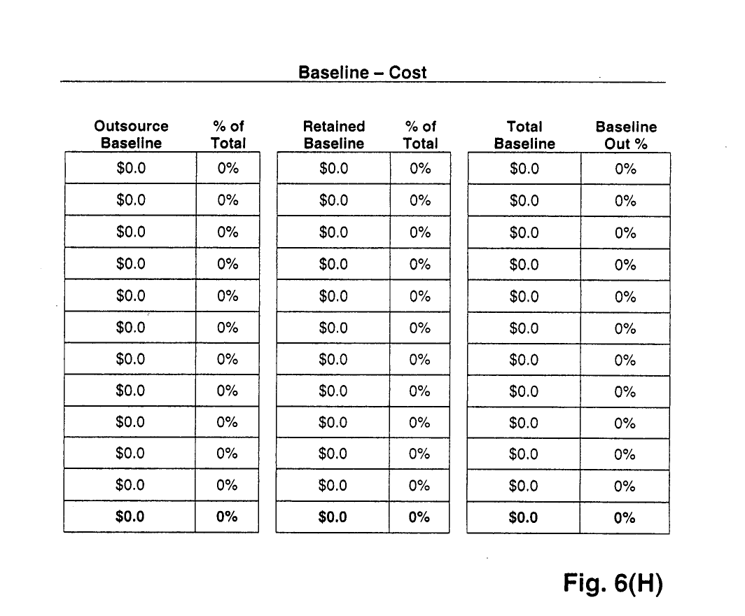

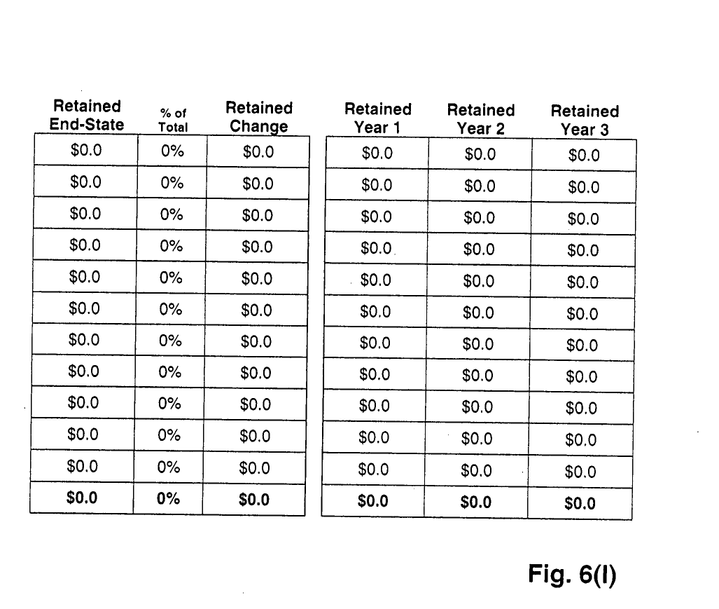

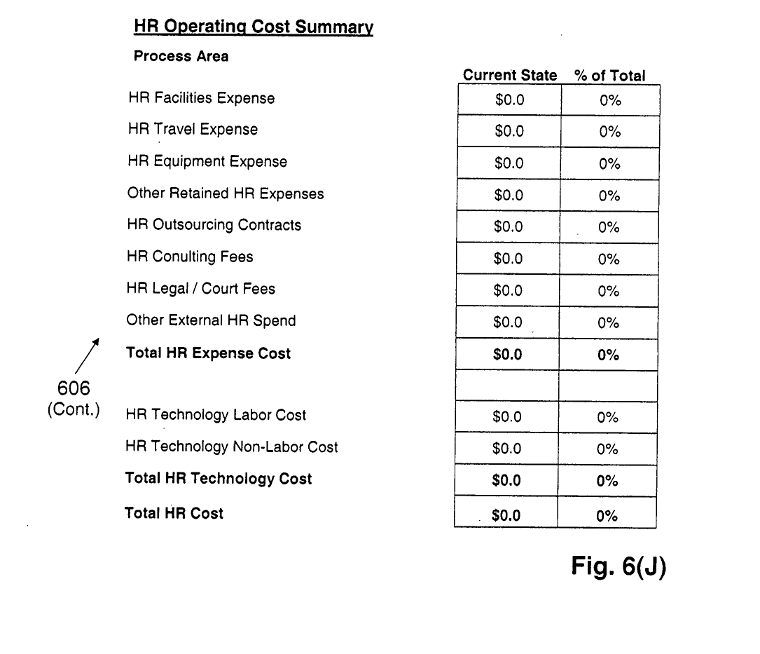

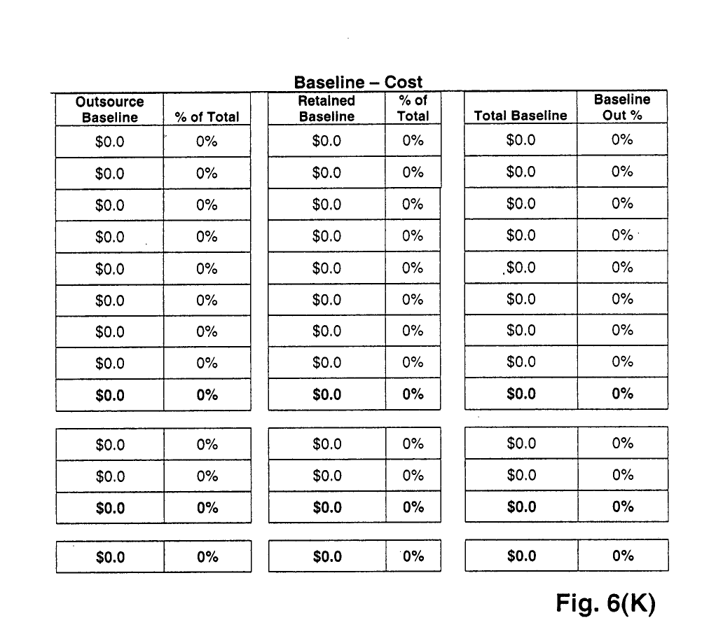

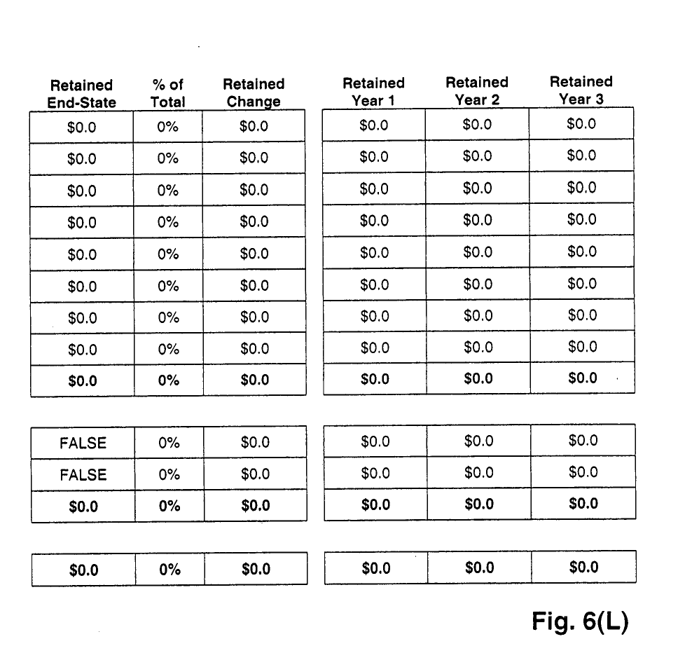

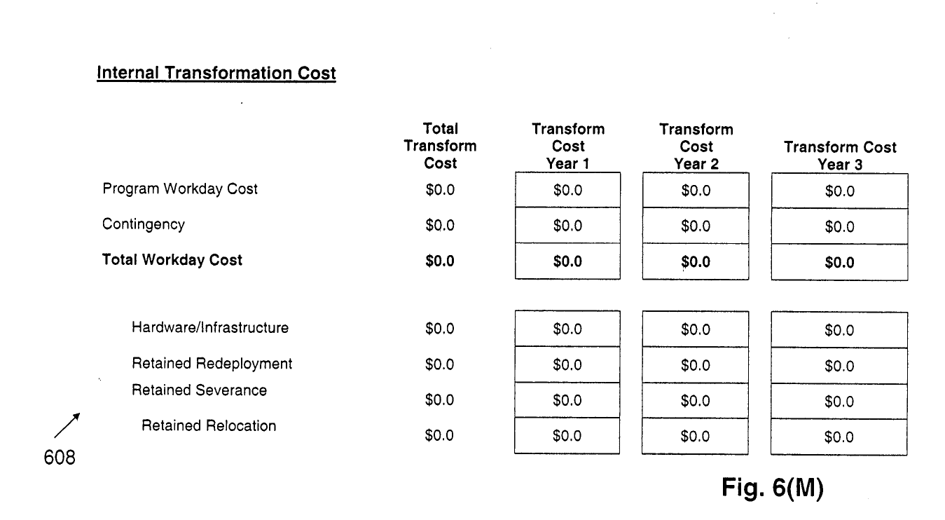

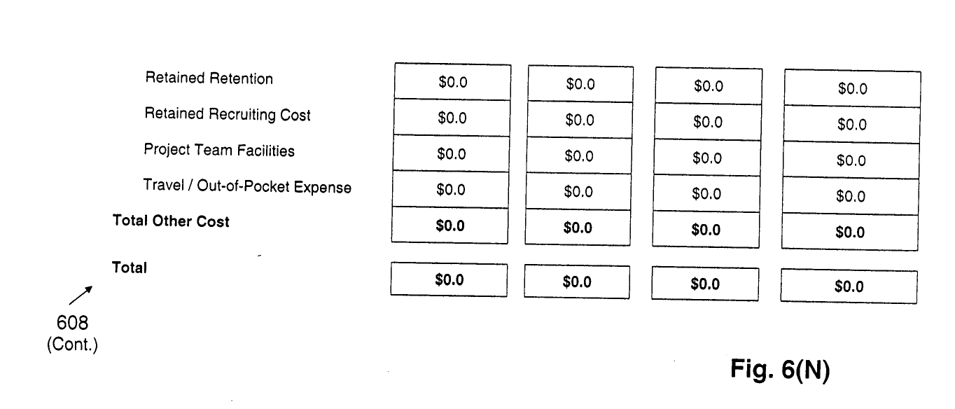

As discussed above with reference to FIG. 3, upon receiving data inputs 300, the system 100 is capable of analyzing at least one received data input in light of at least one industry threshold, at box 305. In accordance with this first embodiment of the invention, the analyzing of box 305 may be accomplished by the system 100 generating information including at least one of a current HR performance matrix indicating a current state of the business organization utilizing at least some of the data inputs described with respect to FIGS. 4A-4E, and an end-state summary indicating a state of the business organization if the specified transformation scenario were to be adopted. FIG. 5 illustrates an exemplary user interface display for a current HR performance metric in accordance with the first embodiment of the invention. FIG. 6 illustrates an exemplary user interface display for an end-state summary in accordance with the first embodiment of the invention. The current metrics of FIG. 5 may, for example, be extracted from the data received via the data inputs from FIGS. 4A-4E, and provide a current state, “As-is” snapshot of the business organization. The end-state summary further may provide information and data gathered via the received data inputs if FIGS. 4A-4E, and provides a future-state, “To-Be” snapshot of the business organization if the particular transformation scenario being analyzed were to be implemented.

Where the transformation opportunity indicator is implemented as a spreadsheet for execution on a spreadsheet program, the analyzing at 305 may include performing one or more calculations between at least one of the data inputs described above with respect to FIGS. 4A-4E and at least one internal or external industry threshold. The result of the calculation(s) may be placed in one of the fields of the current metric and/or end-state summary interfaces, described below, and may be useful in providing a comparison between the As-Is condition of the business organization with respect to the To-Be condition of the business organization.

Referring to FIG. 5, the current HR performance metrics includes information generated from at least one of the data inputs of FIGS. 4A-4E, in light of at least one industry benchmark. As shown in FIG. 5, the current HR performance metrics may include generated information regarding a benchmark comparison for detailed proforma only at 502, expected distribution of HR costs according to benchmarks at 504, and actual distribution of HR labor costs (for example based on various selections made and information entered via the data inputs described with respect to FIGS. 4A-4E) at 506.

The benchmark comparison for detailed proforma only at 502 may include information regarding an industry benchmark comparison including a ratio of employees per HR FTE, the HR cost for the business organization as a percentage of total operating expenses, and an HR headcount investment factor. The industry comparison is provided as a client benchmark result, as well as results regarding a 3rd quartile, median, 1st quartile, gap to next level, gap up two levels, and a potential efficiency factor.

The benchmark comparison for detailed proforma 502 may further include information regarding FTE loaded cost calculation (which may be extrapolated where client data is not available), and may include information regarding average loaded costs per HR FTE as well as for HR tech FTE. Further FTE loaded cost calculations may include information for an overall HR FTE, HR leadership FTE, corporate HR FTE, shared services center HR (SS), HR field, and HR technology FTE. Further, the benchmark comparison for detailed proforma at 502 may include information regarding business metrics, such as average revenue per location, average operating expense per location, average operating profit per location, and average HR operating cost per location. The expected distribution of HR cost according to benchmark at 504 may include information regarding expected distribution of HR labor costs, and expected distribution of HR non-labor cost.

The expected distribution of HR labor cost may include information regarding labor for subfunctions of HR, including staffing/recruiting, employee relations, training/performance development, benefits, compensation, HR management, HR reporting and information systems, organization effectiveness, performance management, payroll, and time & attendance/scheduling. The information regarding expected distribution of HR non-labor cost may include HR expense information such as HR facilities, HR travel, HR equipment, other internal HR expenses, outsourcing contracts, consulting fees, legal/court fees, as well as other external expending.

The actual distribution of HR labor cost at 506 may include various labor information for subfunctions of HR, such as information regarding staffing/recruiting, employee relations, training/performance development, benefits, compensation, HR management, HR reporting and information systems, organization effectiveness, performance management, payroll, time & attendance/scheduling and technology. Such information may be provided as HR leadership FTEs, corporate HR FTEs, HR shared services center FTEs, field HR FTEs and total FTEs. The information may further provided as a percentage of FTE distribution, HR leadership labor costs, corporate HR labor cost, HR shared services center, field HR labor cost, total labor cost and a percentage of cost distribution. In addition, HR expense information may be provided, including HR facilities, HR travel, HR equipment, and other internal HR expenses, outsourcing contracts, consulting fees, legal/court fees, other external spending, and technology expense. The HR expense information may be provided as HR leadership expense, corporate HR expense, HR shared services center expense, field HR expense, HR technology expense, total expense cost, and a percentage of cost distribution.

FIG. 6 illustrates an exemplary user interface display showing an end-state summary. Information provided within the end-state summary may include a FTE summary at 602, cost per FTE summary at 604, HR operation cost summary at 606, and internal transformation cost at 608.

The FTE summary information at 602 may include FTE information regarding staffing/recruiting, employee relations, training/performance development, benefits, compensation, HR management, HR reporting and information systems, organization effectiveness, performance management, payroll, time & attendance/scheduling, and HR technology. The FTE summary information at 602 may be provided as a current state, outsource baseline, retained baseline, total baseline, retained end-state and retained change.

The information regarding cost per FTE summary at 604 may be broken down by organization entity and by process. Cost per FTE organization entity information may include overall HR average loaded cost per FTE, average HR leadership cost per FTE, average corporate HR cost per FTE, average HR shared services center cost per FTE, average field HR cost per FTE, and HR technology loaded cost. Cost per FTE by process information may include staffing/ recruiting, employee relations, training/performance development, benefits, compensation, HR management, HR reporting and information systems, organization effectiveness, performance management, payroll, time & attendance/scheduling, and HR technology.

The HR operating cost at 606 information may be provided by process areas corresponding to subfunctions of HR, and may include information regarding staffing/recruiting, employee relations, training/performance development, benefits, compensation, HR management, HR reporting and information systems, organization effectiveness, performance management, payroll, time & attendance/scheduling, and total HR labor cost information. HR operating cost summary may further include HR expenses such as expenses for facilities, travel, equipment, other retained HR, outsourcing, consulting fees, legal/court fees, other external HR spending, as well as a total HR expense cost. The HR operating cost summary may further include information regarding HR technology labor costs, HR technology non-labor cost, and total HR technology cost. The HR operating cost information at 606 may be provided as current state, outsourcer baseline, retained baseline, total baseline, retained end-state, and retained change costs, as well as retained costs over a particular period of time, for example year 1 thru year 3.

The internal transformation cost at 608 may include information regarding program work day cost, contingency, and total work day cost. The internal transformation cost at 608 may further include cost information regarding hardware/infrastructure, retained redeployment, retained severance, retained location, retained retention, retained recruiting cost, transformation team facilities, and travel/out-of-pocket expenses, as well as a total other costs information. Such information may be provided as a total transformation cost, as well as a transformation cost over a particular time period, for example year 1 thru year 3.

First Embodiment Modeling

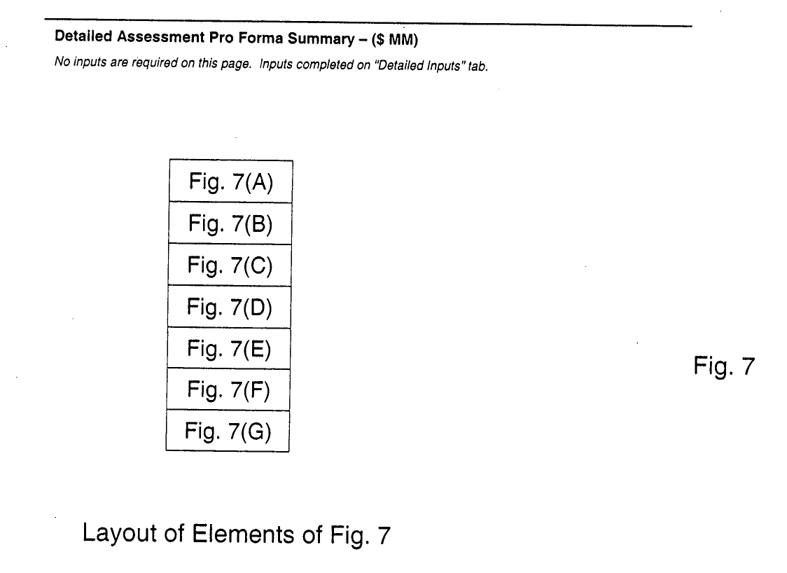

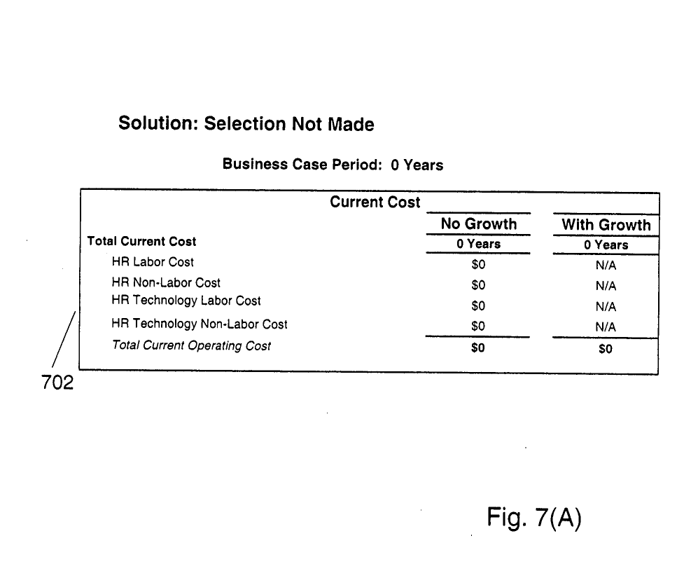

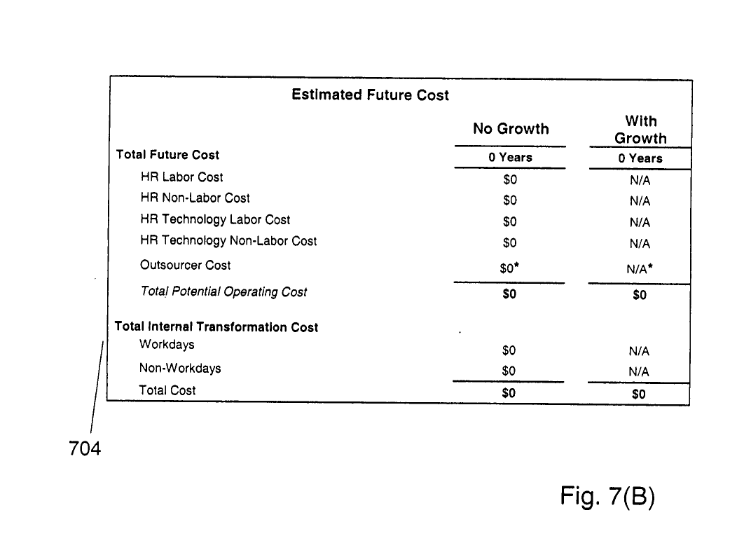

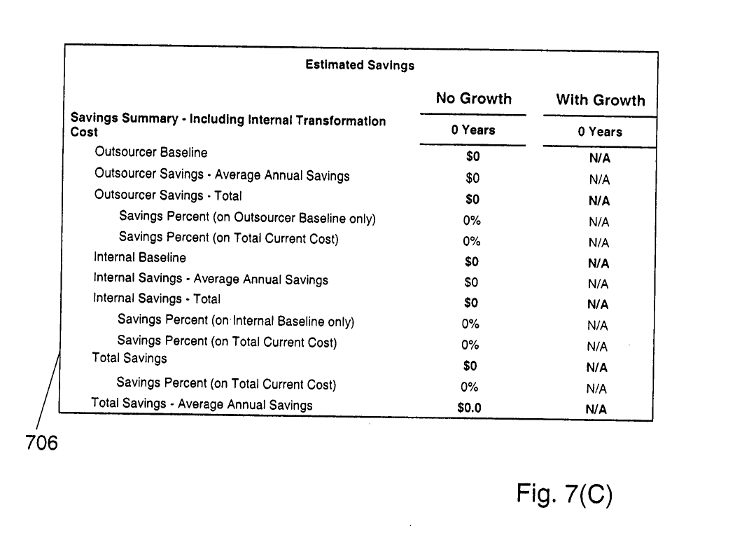

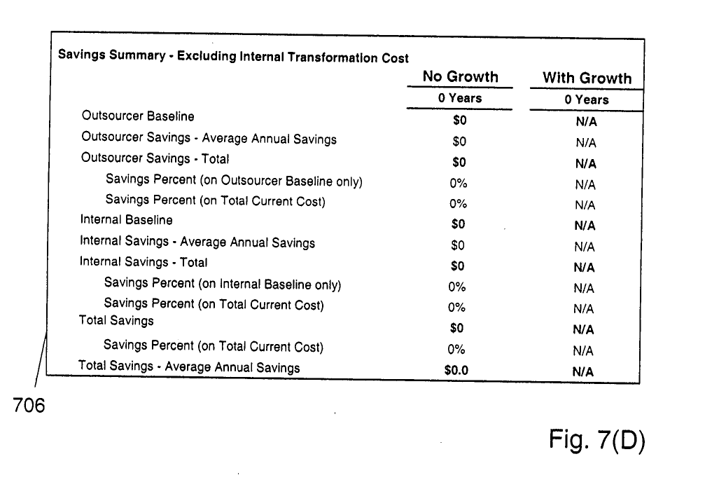

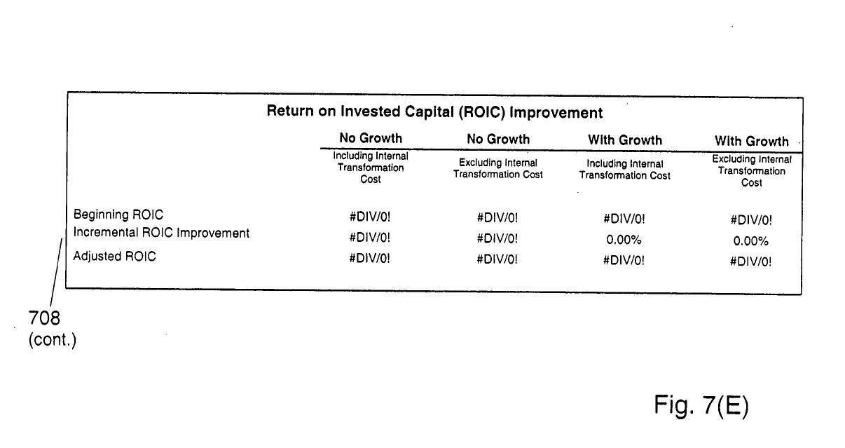

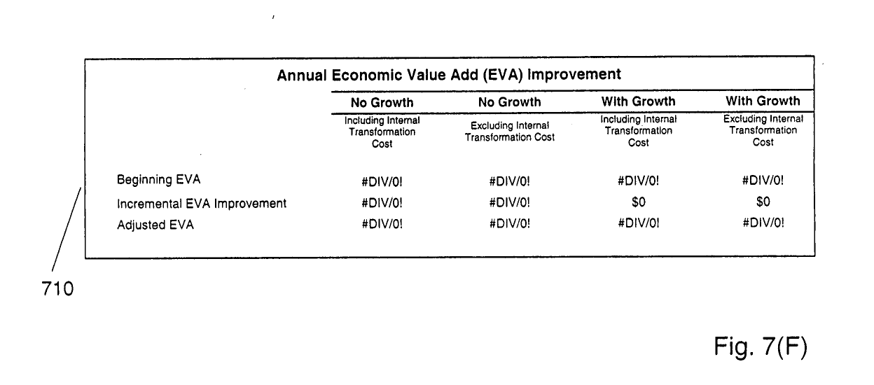

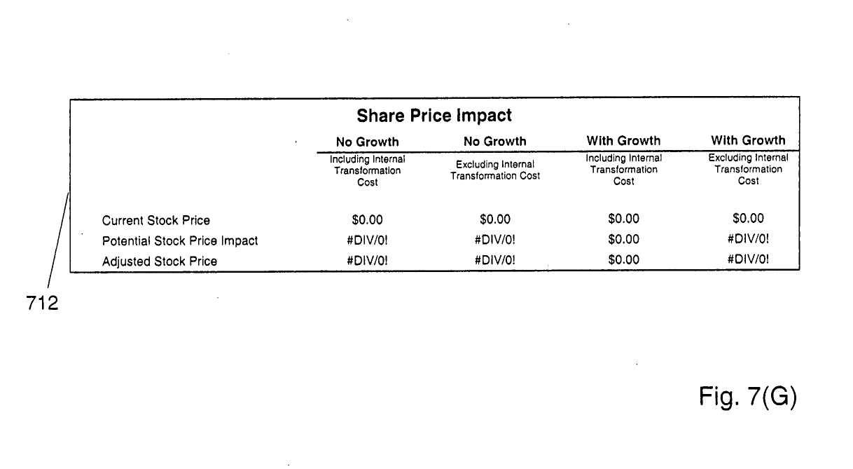

Once the analyzing of the at least one data input in light of at least one industry threshold has been accomplished at box 305 of FIG. 3, a transformation scenario may be modeled as shown at box 310. The transformation scenario model may be presented as a proforma summary, for example by the exemplary user interface display performance summary shown in FIG. 7, in accordance with the first embodiment of the invention. The detailed assessment pro forma summary may be based on the data received at the data inputs, for example of FIGS. 4A-4E, and presented to illustrate a comparison between the As-is and To-Be state of the business organization if the transformation model were to be implemented.

As shown in FIG. 7, the transformation scenario model may include business organization information regarding current costs at 702, estimated future costs at 704, estimated savings at 706, return on investment capital improvement at 708, annual economic value add improvement at 710, and share price impact at 712.

The current cost information at 702 may include total current cost as well as break downs for HR labor cost, HR non-labor cost, HR technology labor cost, HR technology non-labor cost, and total business organization current operating costs, for both no-growth and with growth contingencies.

The estimated future cost information at 704 may include a total future cost, broken down by various HR costs, such as labor cost, non-labor cost, technology labor cost, technology non-labor cost, and outsourcer cost. Further, the estimated future cost at 704 may include total internal transformation costs regarding work days, non-work days and total cost. The estimated future cost information at 704 may be provided for both growth and no growth scenarios.

The estimated savings at 706 may include a saving summary including internal transformation costs, and a saving summary excluding internal transformation costs. Regarding the savings summary including internal transformation costs, information regarding an outsourcer baseline (for example, where ‘baseline’=HR operating cost corresponding to the HR processes for which an outsourcing provider assumes responsibility from the client, for example, at contract signing), average annual savings and total savings are provided. Further, the savings summary including internal transformation costs may include information regarding an internal baseline, internal savings, average annual savings, and total internal savings. Further, the savings summary including internal transformation costs may include information regarding a total savings as well as an average annual savings.

Regarding the savings summary for excluding internal transformation costs, outsourcer baseline, average annual savings and total savings are provided, as well as internal baseline, average annual savings, and total savings may be provided. Further, a total savings as well as an average annual savings may be provided.

The return on invested capital improvement at 708 may include information regarding a beginning, incremental improvement, and adjusted return on invested capital information. Such information may be provided for both growth and no growth scenarios, and may be provided as excluding and including internal transformation costs.

Regarding the annual economic value add improvement at 710, information regarding a beginning, incremental improvement, and adjusted economic value add may be provided. Such information may be provided for both growth and no growth scenarios, and may be provided as excluding and including internal transformation costs.

Regarding the share price impact at 712, information regarding a current stock price, potential stock price impact, and adjusted stock price may be provided. Such information may be provided for both growth and no growth scenarios, and may be provided as excluding and including internal transformation costs.

Although not shown, any of the above information or summary of information, may be provided in graphical form, for example as pie, bar, or any other form of graph, chart or plot, to convey the respective information and data, as would be appreciated by one skilled in the art.

Thus, in accordance with the first embodiment of the invention, the business opportunity indicator is capable of providing a rapid and standardized approach for identifying an HR transformation opportunity. The spreadsheet may provide a plurality of standard input fields that may be used to drive established methods of calculation to generate a financial analysis. A transformation scenario may be modeled, and presented to a user showing various useful information in making a transformation decision for the business organization, including for example, business organization information regarding current costs, estimated future costs, estimated savings if the transformation scenario were to be adopted, as well as return on investment capital improvement, annual economic value add improvement, and share price impact information if the scenario were adopted. Further, the information may be provided for both business organization growth and no growth scenarios.

Because the various data inputs, analyzing and modeling may be provided as a common software tool (or a plurality of interlinked tools) the transformation opportunity indicator may be readily updated with up-to-date thinking and best practices regarding assessing HR transformation opportunities, thereby ensuring that the client receives an HR transformation opportunity scenario in accordance with current (and not outdated) HR transformation assessment strategic thinking. Further, such a software tool reduces chances of evaluation errors resulting from failure to examine or properly examine one or more of the data inputs to model a transformation scenario.

### SECOND EMBODIMENT OF THE INVENTION

In accordance with a second embodiment of the invention, a transformation opportunity indicator is provided as spreadsheet running on a spreadsheet program, for example, Micro Soft Excel. FIG. 8 is a flowchart illustrating operation of the business opportunity indicator of the system of FIG. 1 in accordance with the second embodiment of the invention.

As shown in FIG. 8, the transformation opportunity indicator is capable of identifying a business organization human resource transformation opportunity, including receiving a plurality of business organization data inputs at box 800, and at box 805, analyzing at least one of the business organization data inputs in accordance with at least one industry threshold, including generating information regarding at least one of As-Is cost, activity, and organization sizing analysis information. At box 810, the transformation opportunity indicator is capable of modeling a business organization transformation scenario responsive to the analysis. Business organization transformation opportunity scenarios that may be modeled may include, for example, a broad-outsourcing transformation scenario, and internal transformation scenario, and a mixed outsourcing/internal transformation scenario.

A particular transformation scenario may be further provided as a decision of the transformation opportunity indicator. In the alternative, the transformation opportunity indicator may model a particular specified scenario by providing information regarding the specified scenario. In the latter case, the user of the system 100 may provide the various scenarios to the business organization to be used in making a transformation decision.

Referring to FIG. 8, at box 800, a plurality of business organization data inputs are typically received at the transformation opportunity indicator by a user of the transformation opportunity indicator entering various information in data fields of spreadsheet, for example a spreadsheet running on MicroSoft Excel. The various information may be collected, for example, from annual reports published by the client, visits with and evaluations of the client (for example, a 6-8 week assessment of the client), or as provided by the client as a response to questionnaires, interviews and surveys provided to the client. The surveys may be provided, for example, in an HTML format prompting a user for information, for example, as discussed below. Upon completion of a survey, the information gathered by survey may be presented as a report, for later use in entering various information into data fields of a spreadsheet, or alternatively may be automatically downloaded (and tallied where necessary) into various data fields of a spreadsheet. One skilled would realize that any combination of manually entering spreadsheet results and automatic importing of spreadsheet results into a spreadsheet may occur. Similarly, information from questionnaires and/or written interviews may be solicited from the client in a similar fashion.

Upon receiving a plurality of business organization data inputs, the transformation opportunity indicator of the system 100 is capable, as shown at box 805, of analyzing at least one of the business organization data inputs in accordance with at least one industry threshold, as discussed further below. For example, in accomplishing this, the transformation opportunity indicator may determine an As-is cost analysis, As-Is activity analysis, and an organization sizing analysis utilizing at least some of the plurality of business organization data received in light of at least one industry threshold. The industry threshold information may be determined as internal benchmarks, for example based on experiences and best practices in similar previous situations, or may be provided by an external organization specializing in such thresholds and information, for example, as a Saratoga set of industry benchmarks, potentially for the particular function being analyzed for the business organization, here the human resource function.

Further, a solution summary may be generated based on at least one of the plurality of business organization data received in light of at least one industry threshold. The solution summary may summarize at a high level the transition of FTEs and cost from the client to the outsourcer (where outsourcing is examined) and the change from current to future FTEs and costs retained by the client (for both internal transformations and outsourcing transformation cases). The solution summary effectively provides a summary “before” and “after” picture of the solution only, rather than a detailed cash flow view.

The transformation opportunity indicator is capable, as shown at box 810, of generating a model for a particular business organization transformation opportunity scenario, that may providing current costs, estimated future costs, as well as estimated savings of the specified business organization transformation opportunity scenario were adopted.

Second Embodiment Data Inputs

Information regarding specified transformation scenario, along with information provided from the modeling of other transformation scenarios by the transformation opportunity indicator may be utilized in making a determination of whether transformation of a particular business organization services, for example human resource service, is desired. Further, the information provided by the modeled scenarios may be useful in determining to what extent outsourcing of the human resource services may be desirable, for example, whether broad outsourcing, internal transformation, or a mix of outsourcing and internal transformation is desirable.

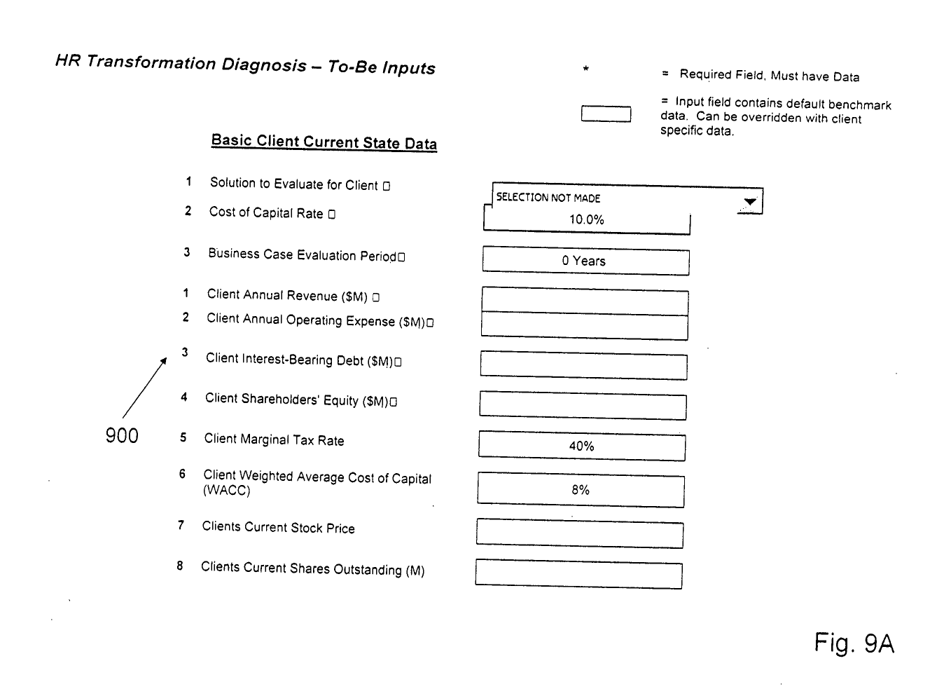

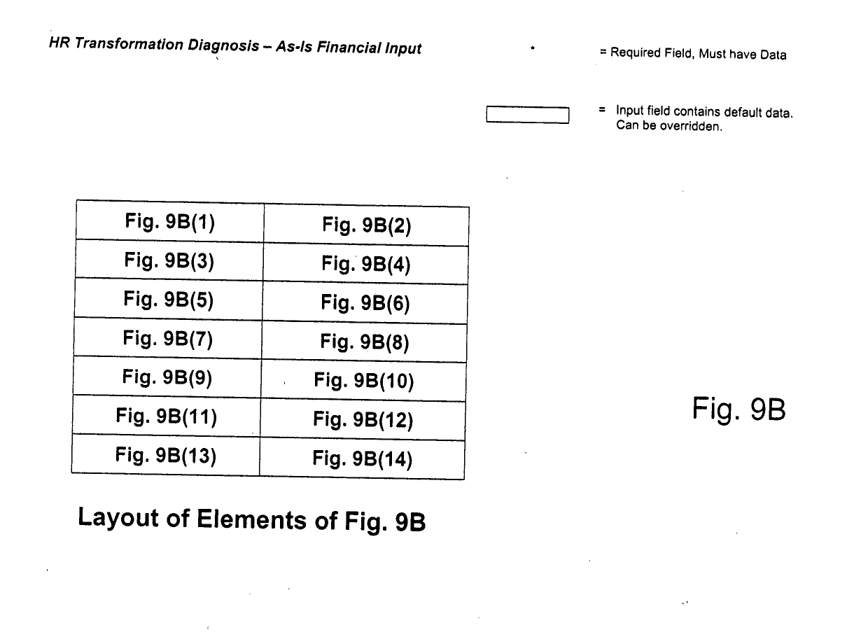

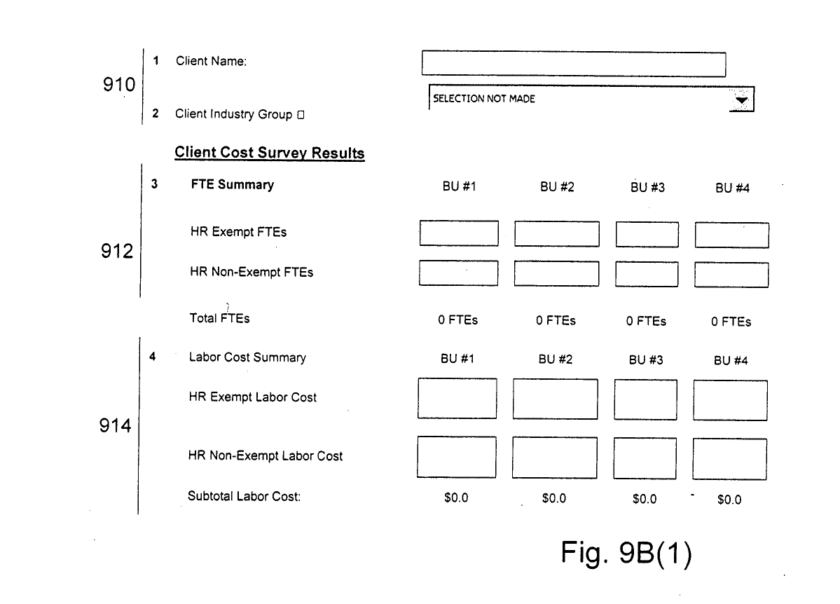

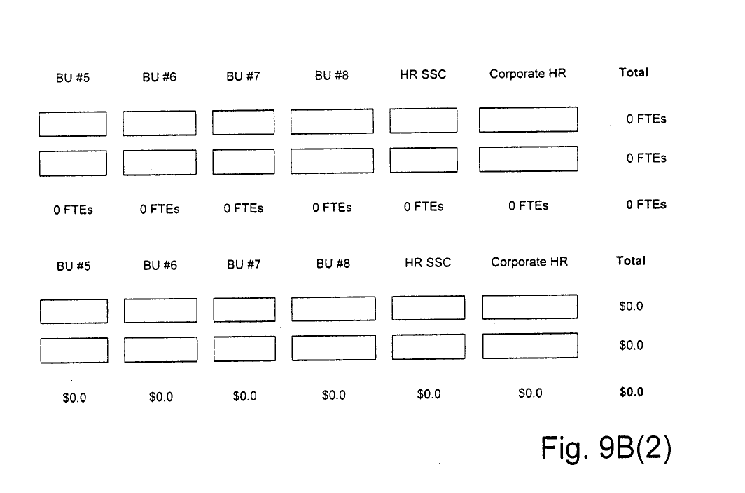

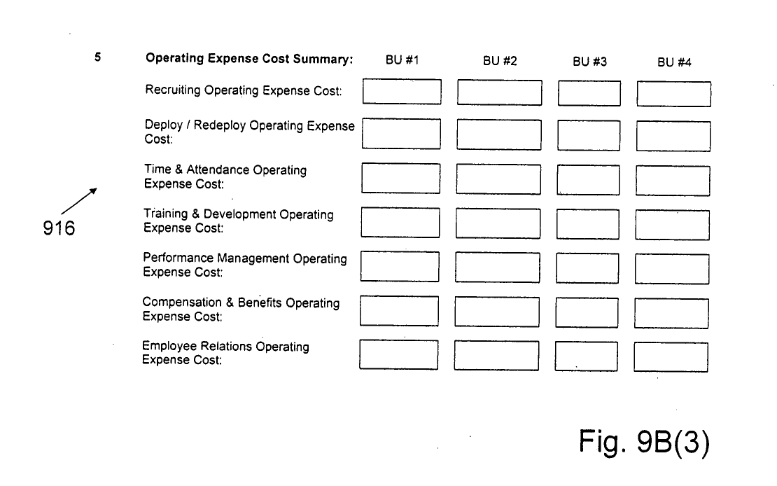

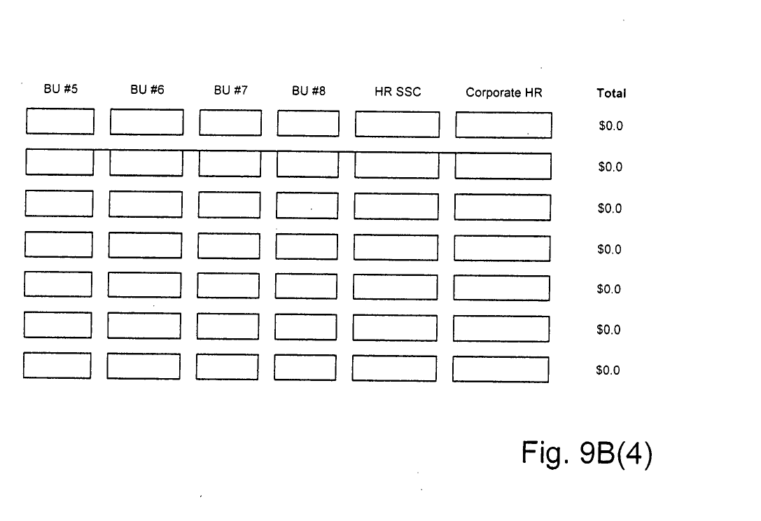

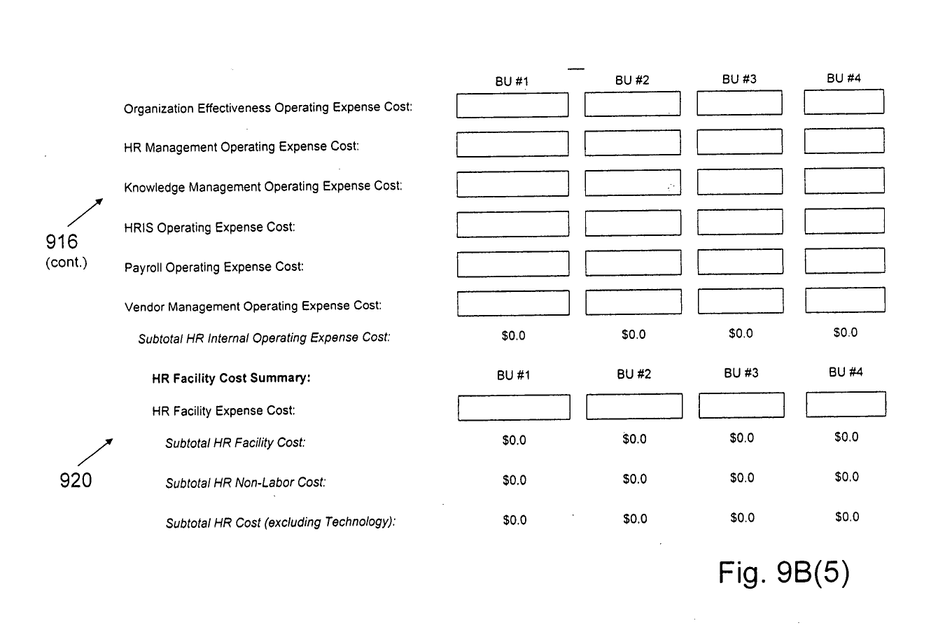

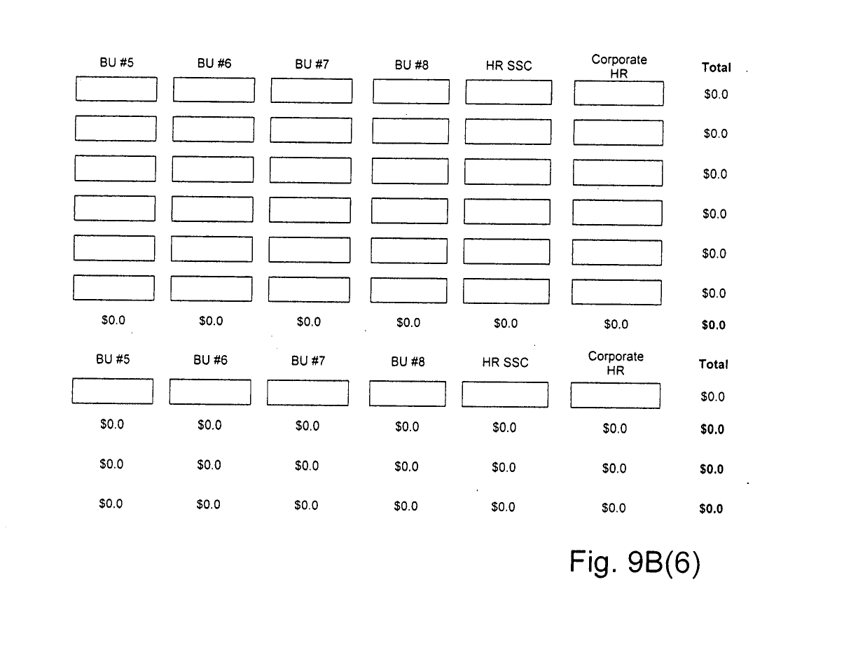

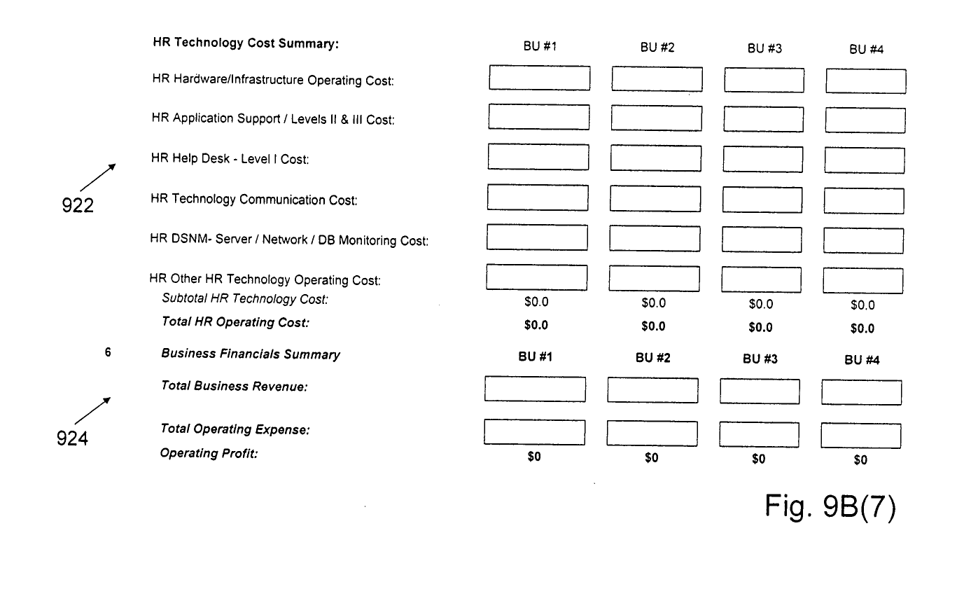

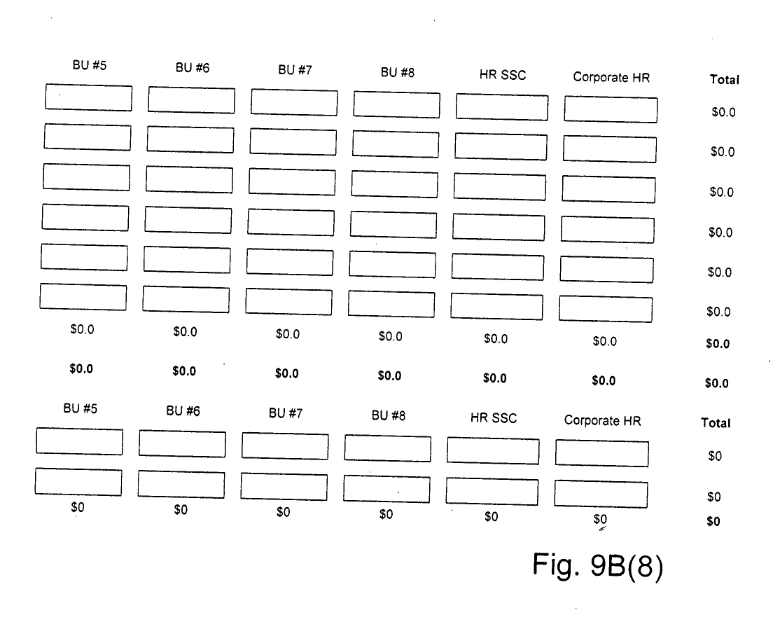

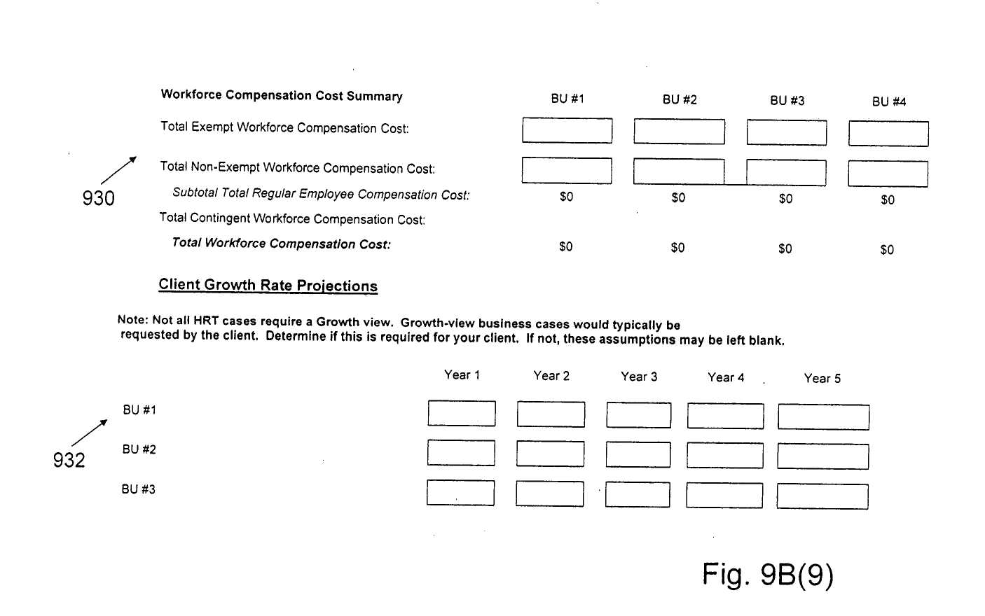

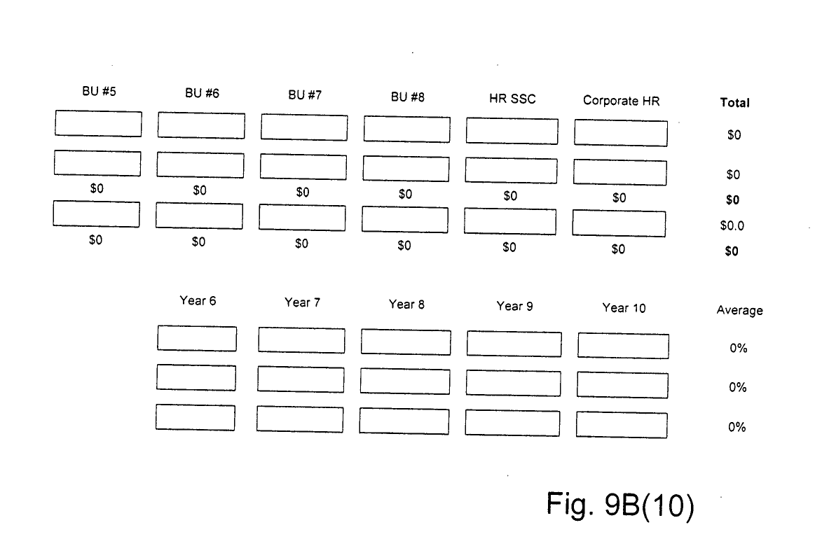

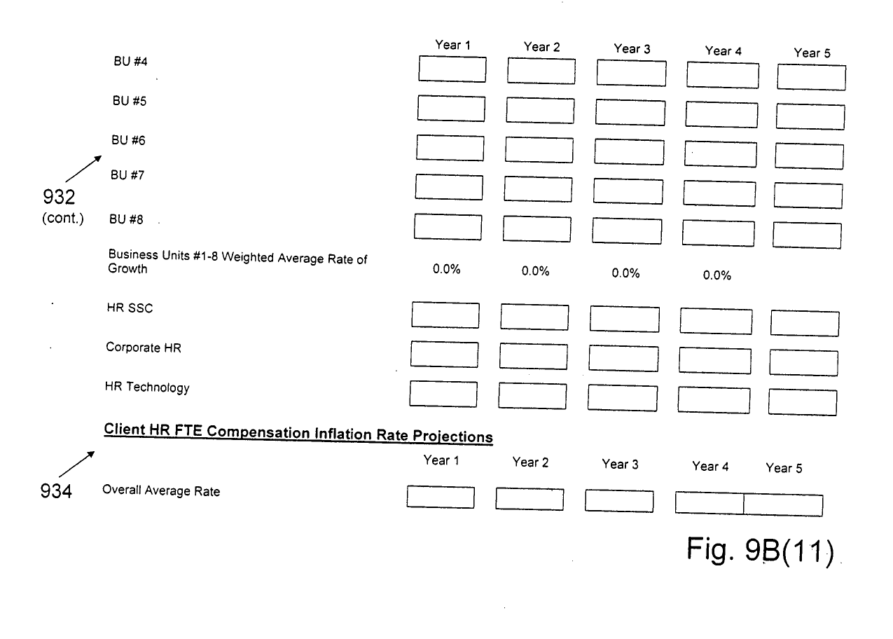

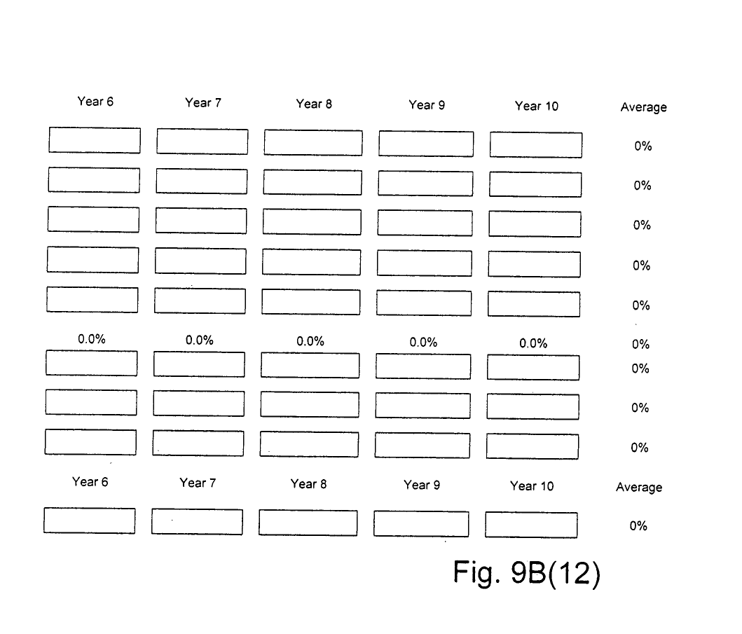

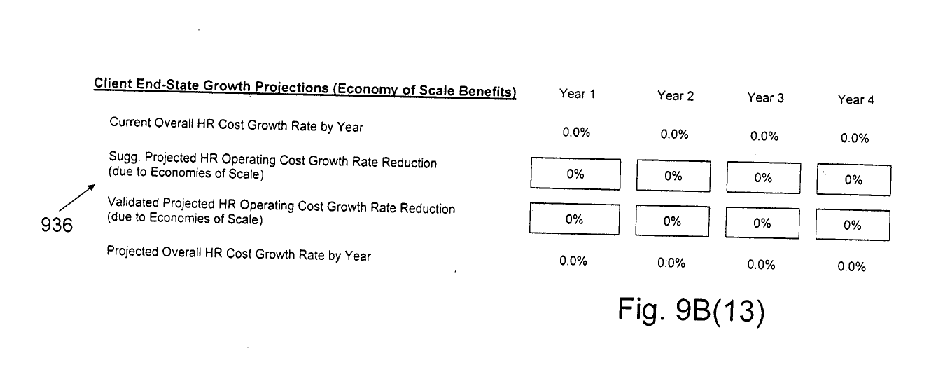

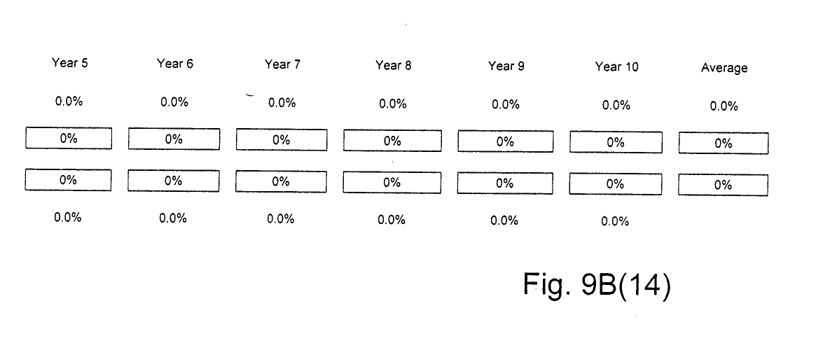

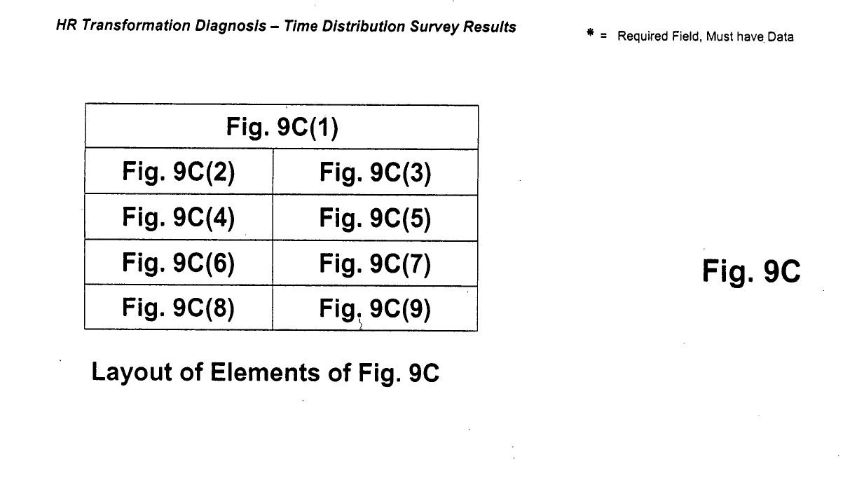

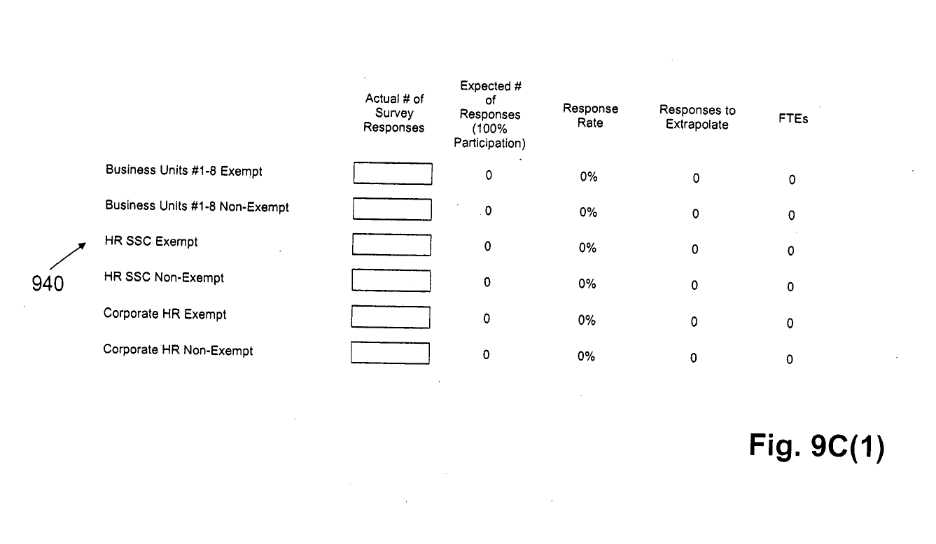

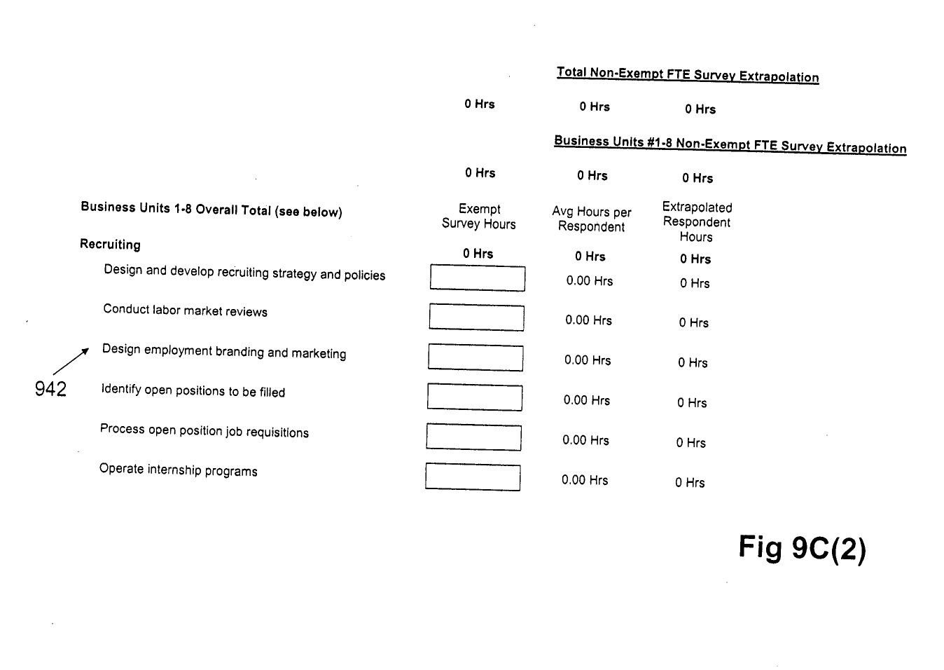

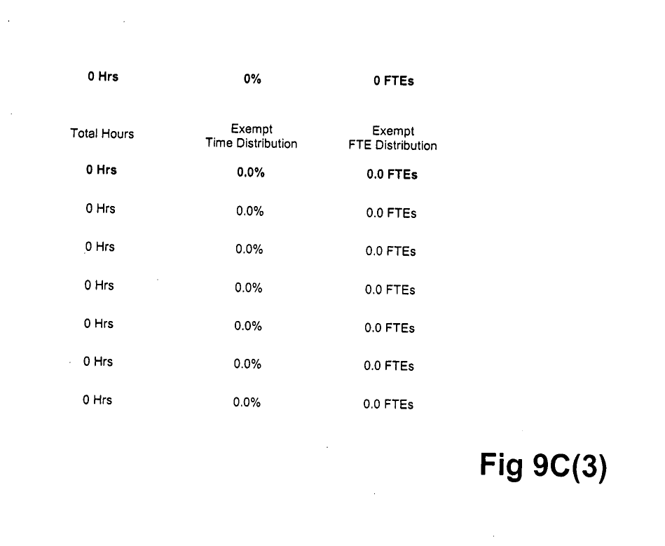

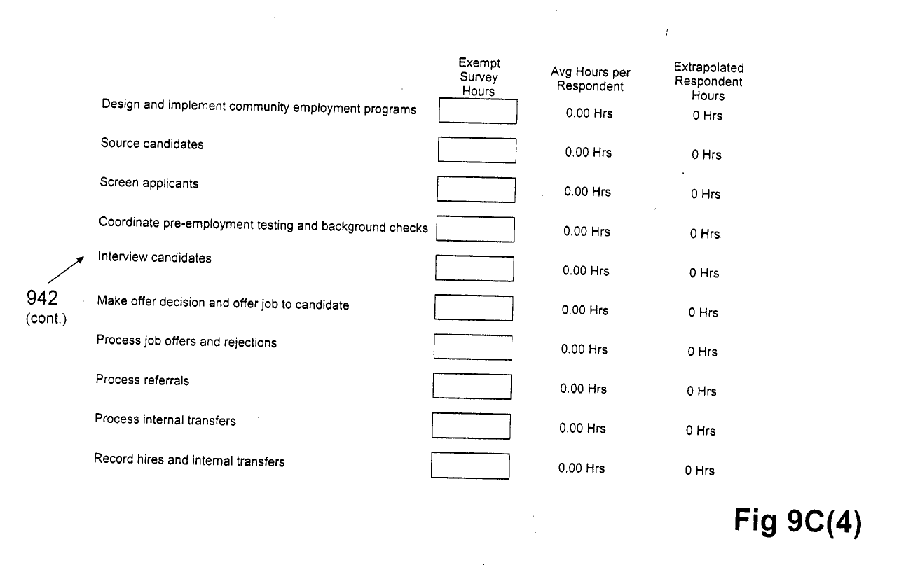

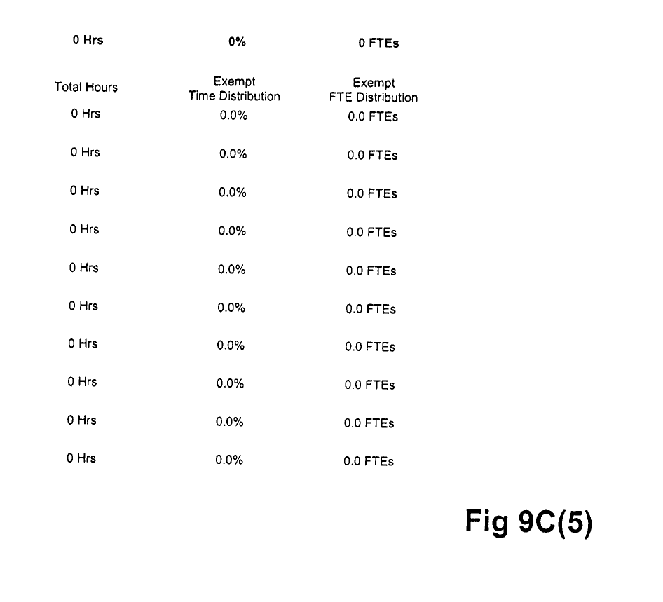

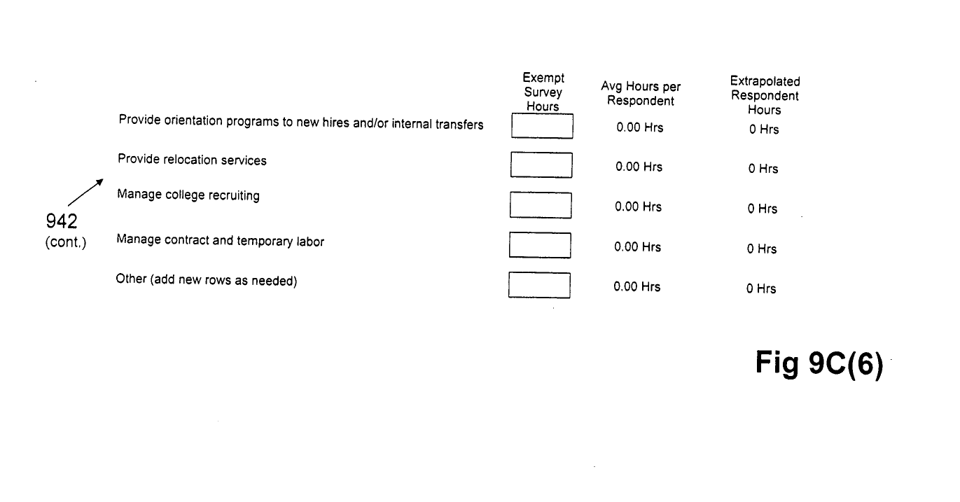

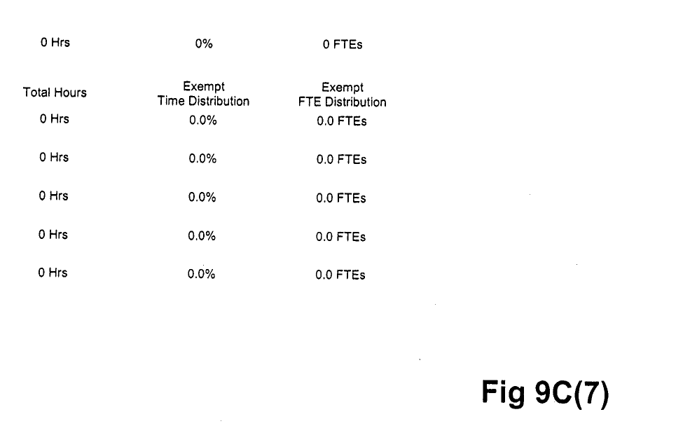

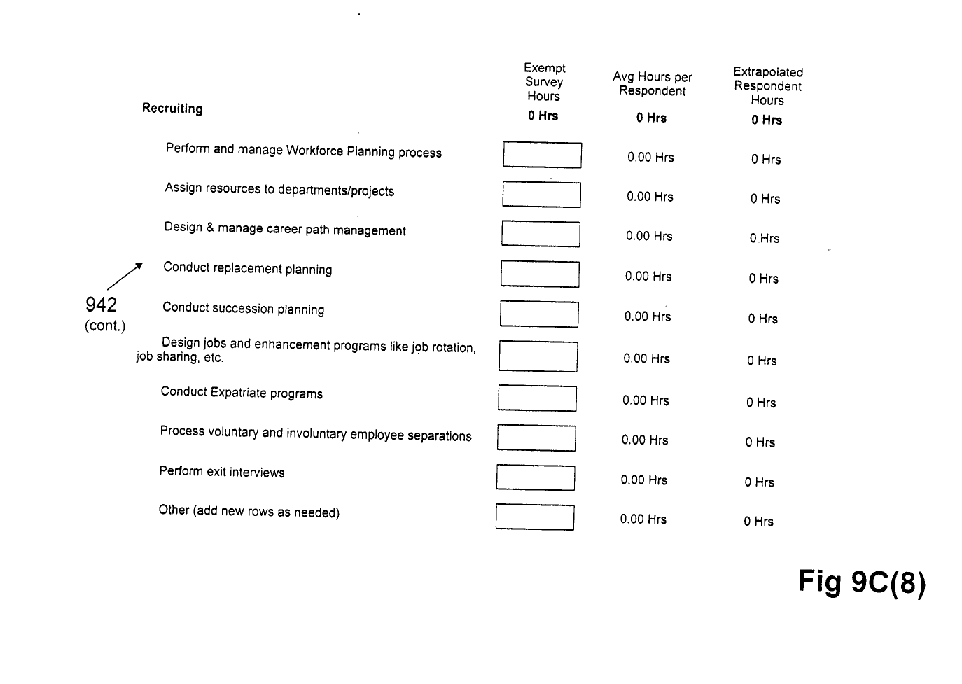

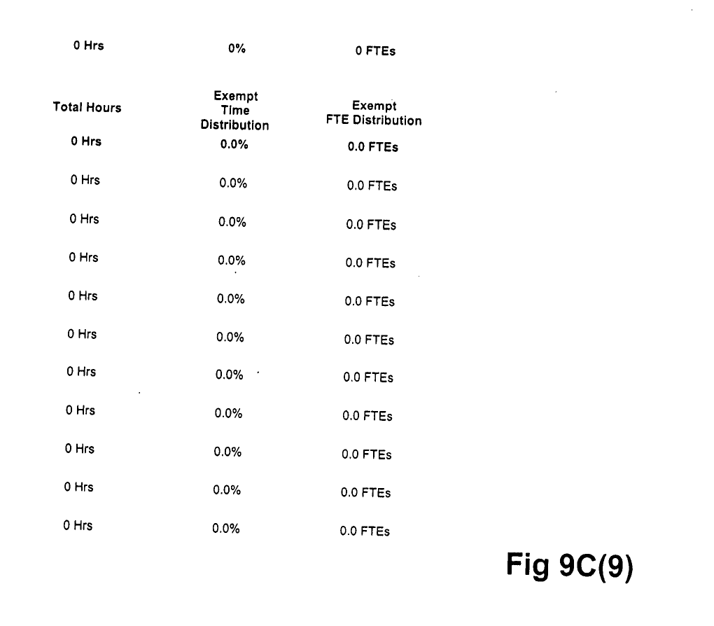

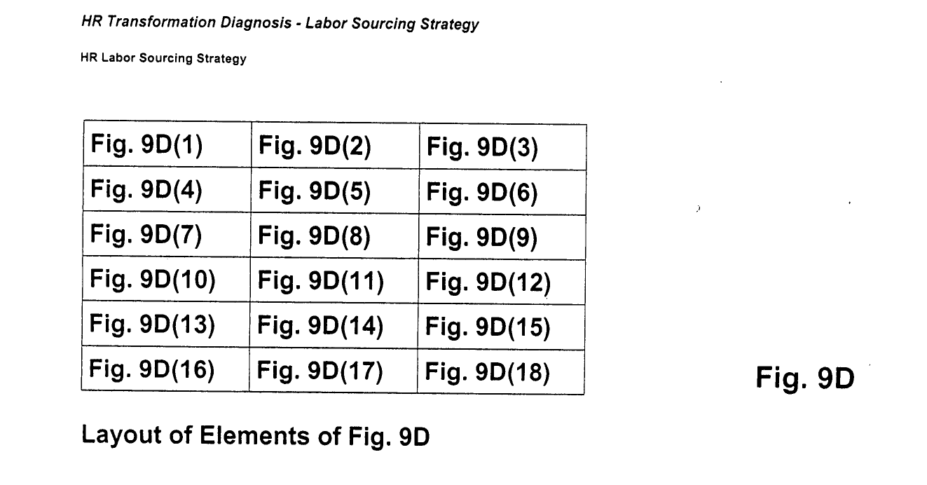

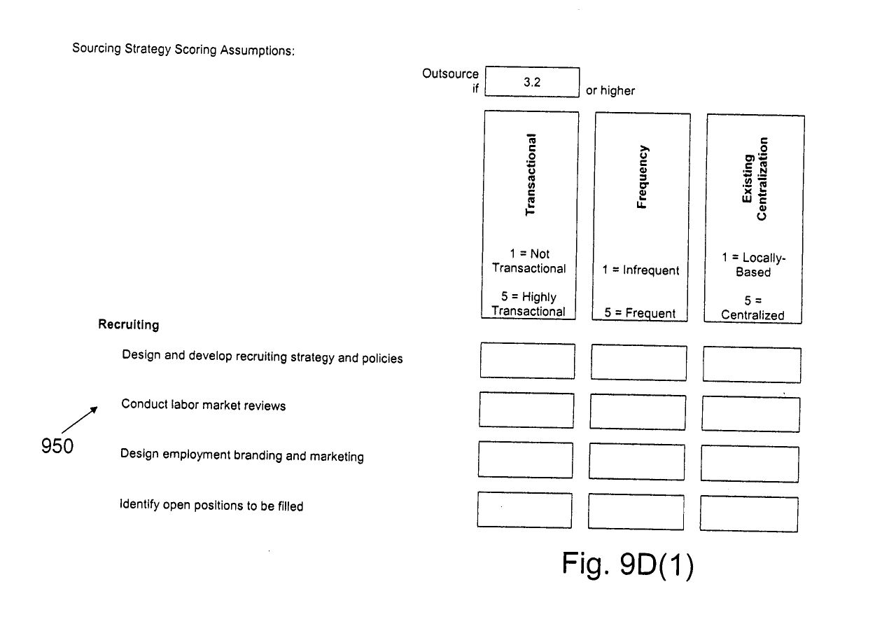

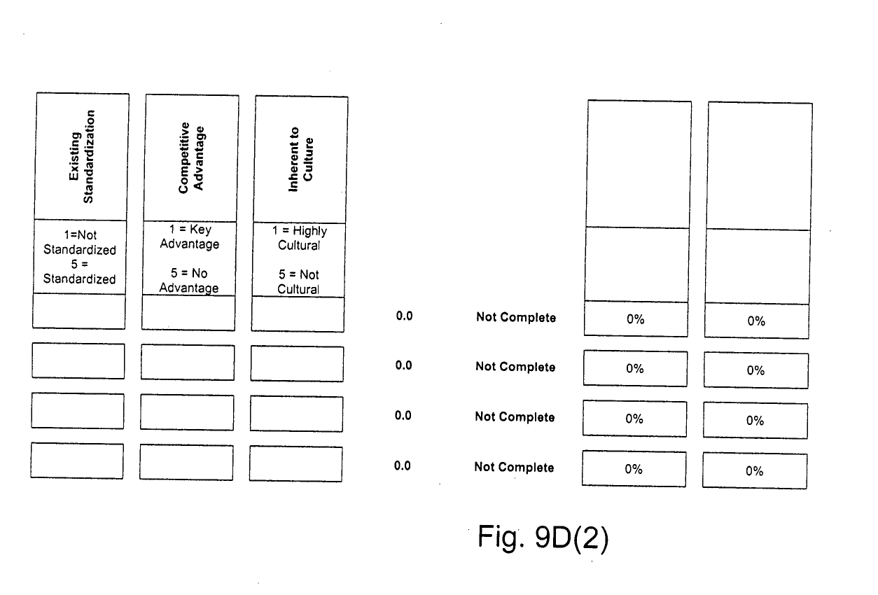

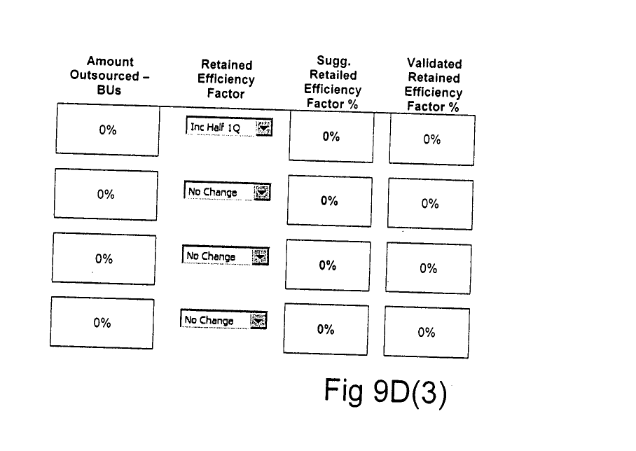

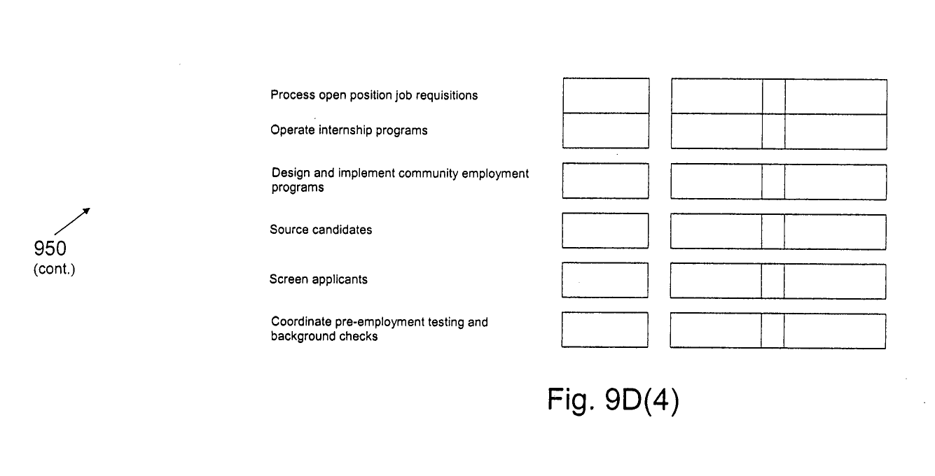

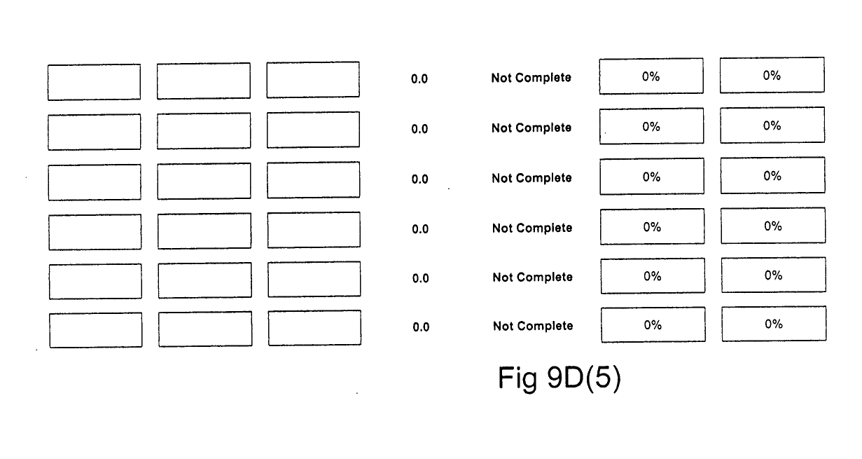

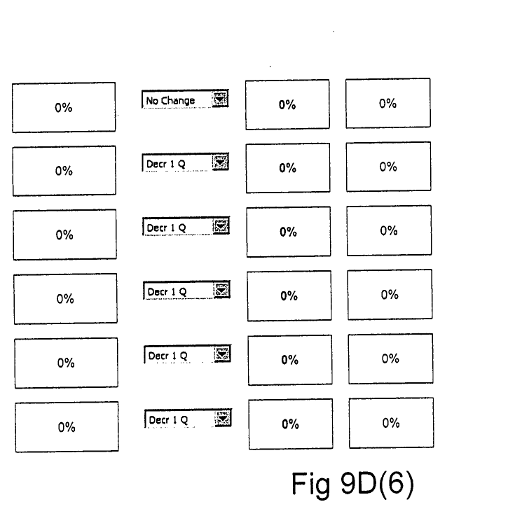

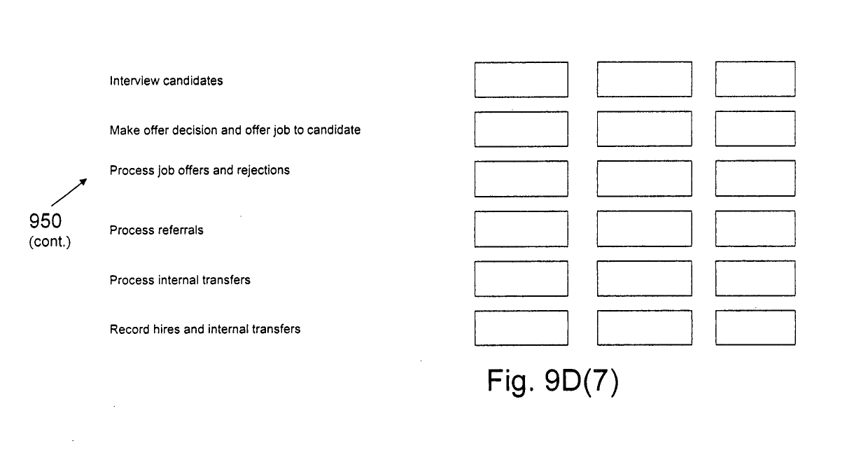

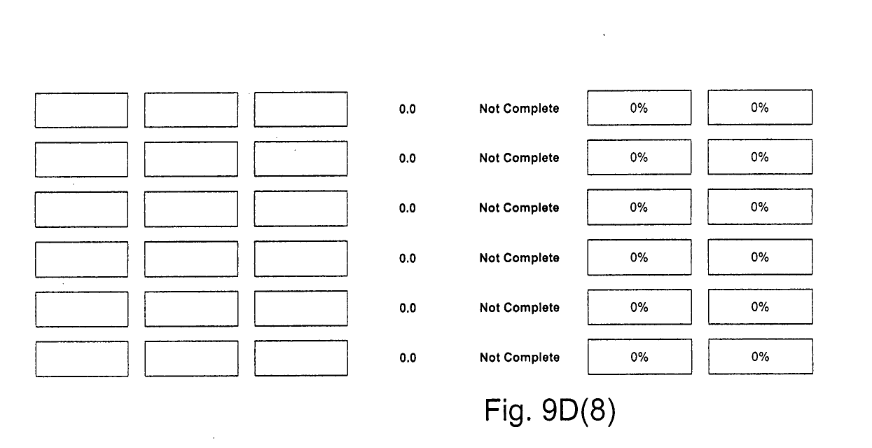

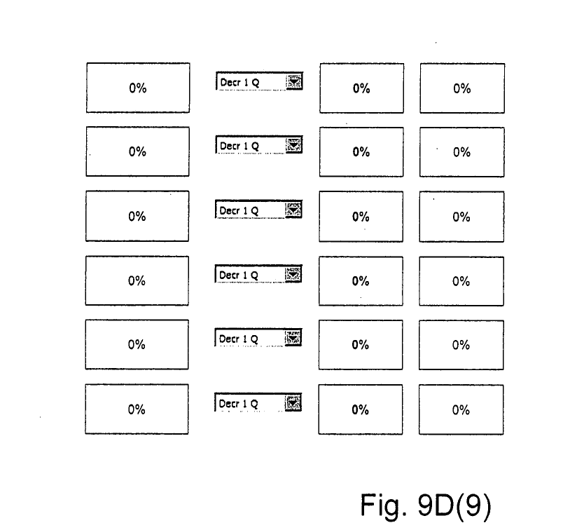

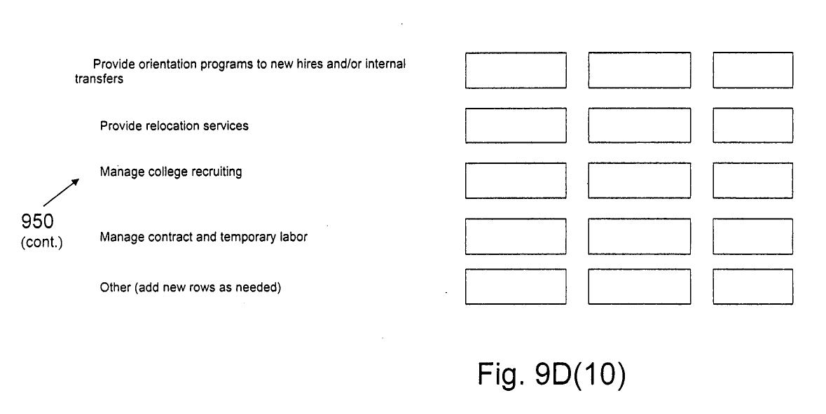

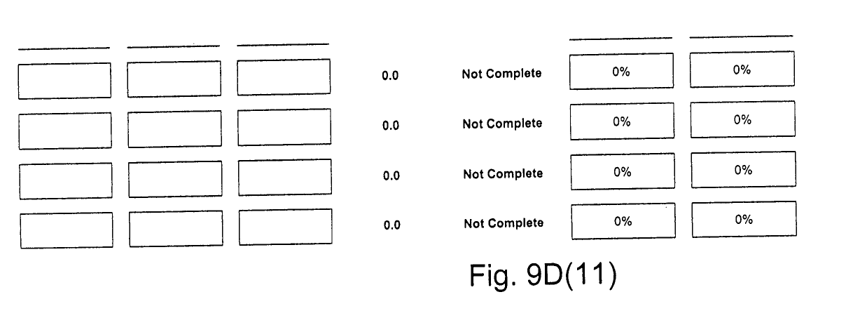

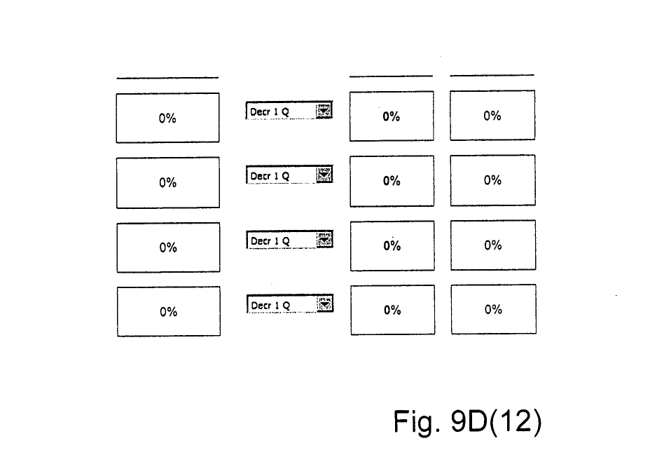

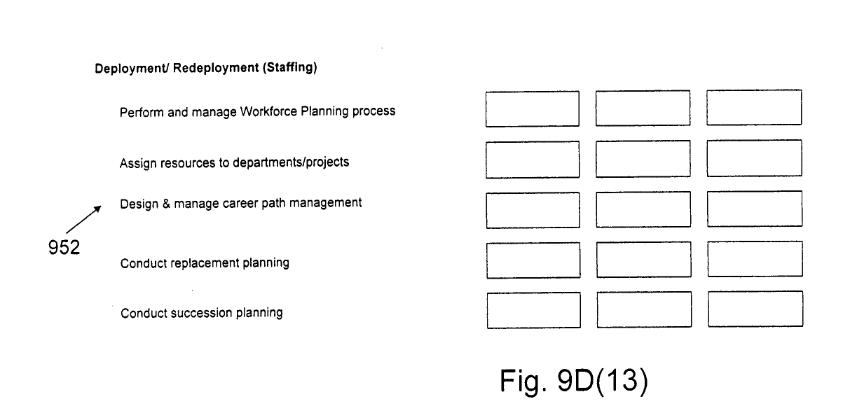

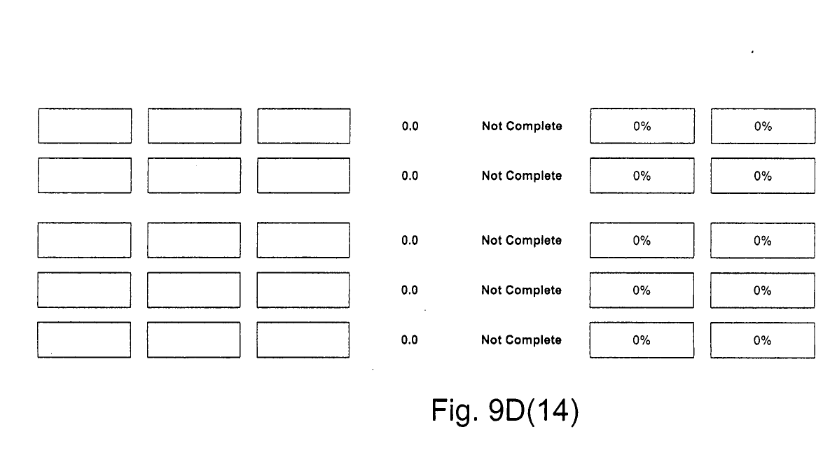

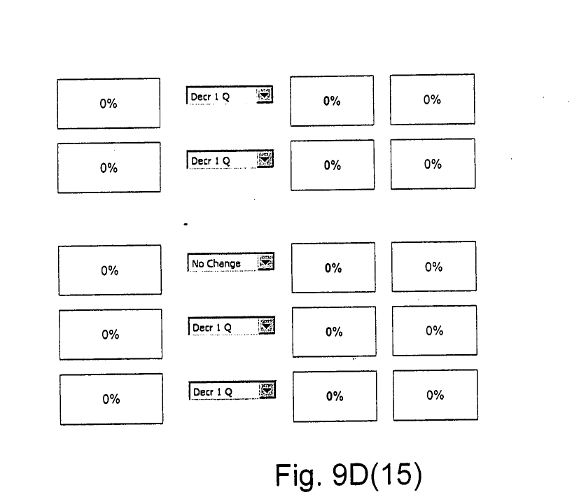

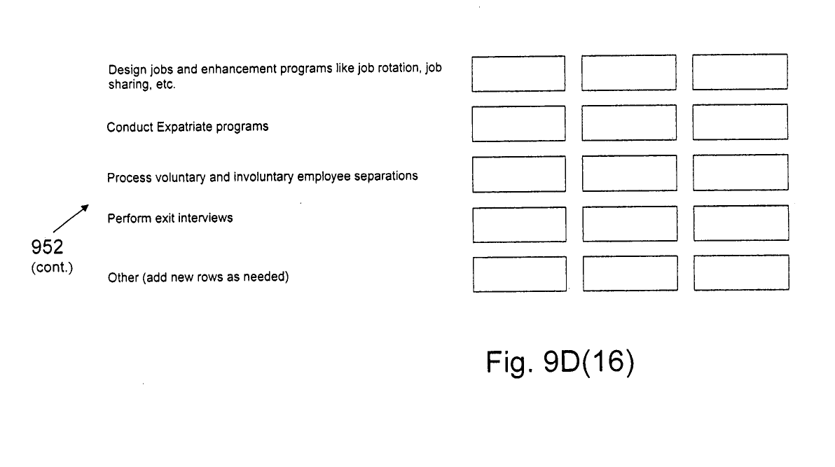

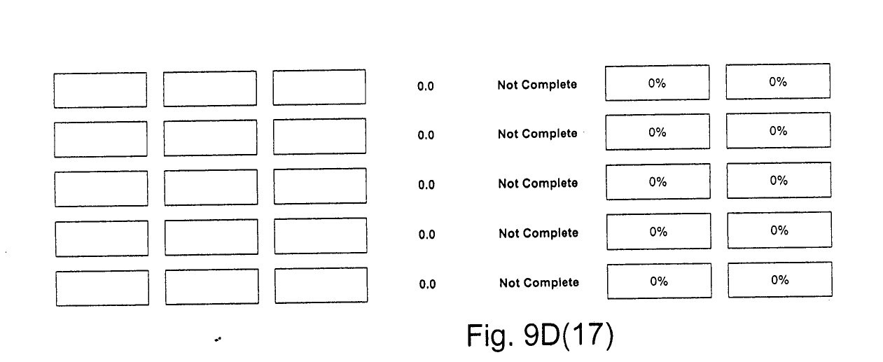

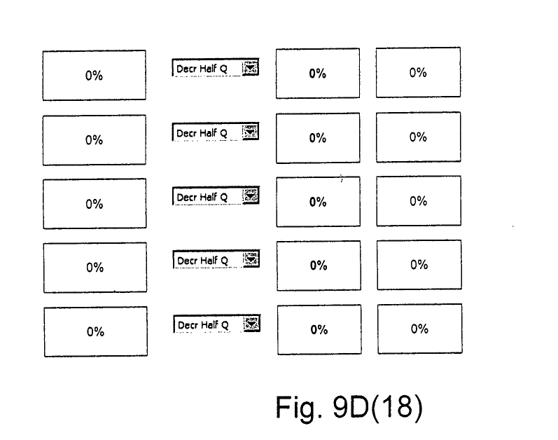

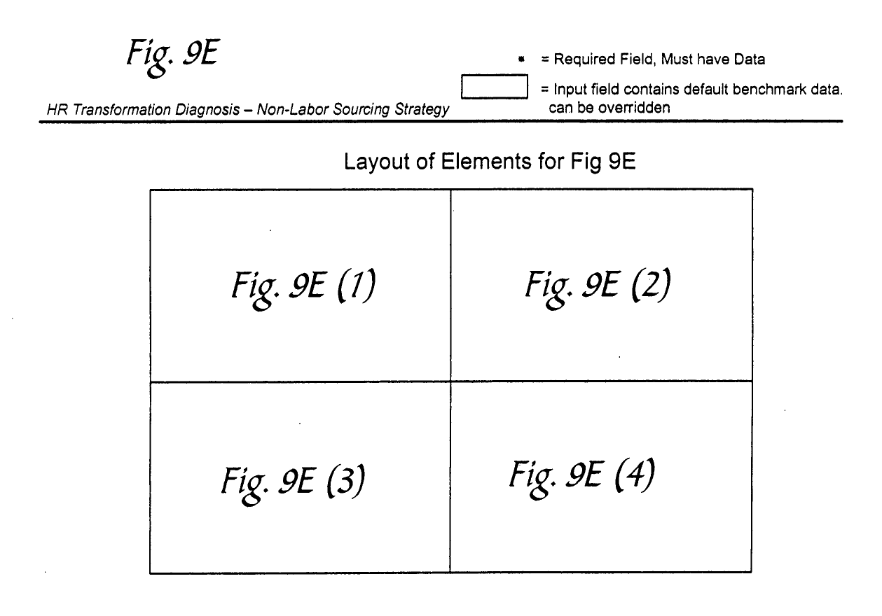

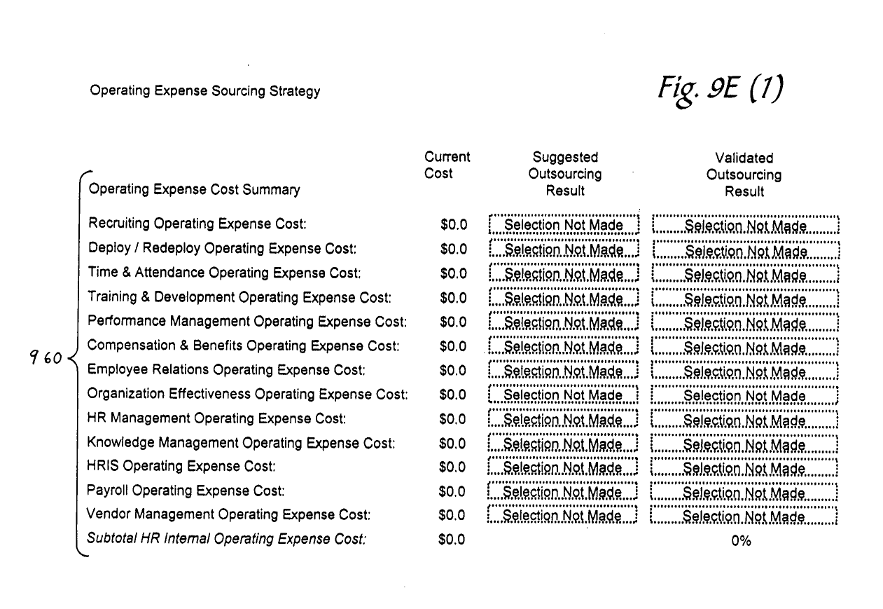

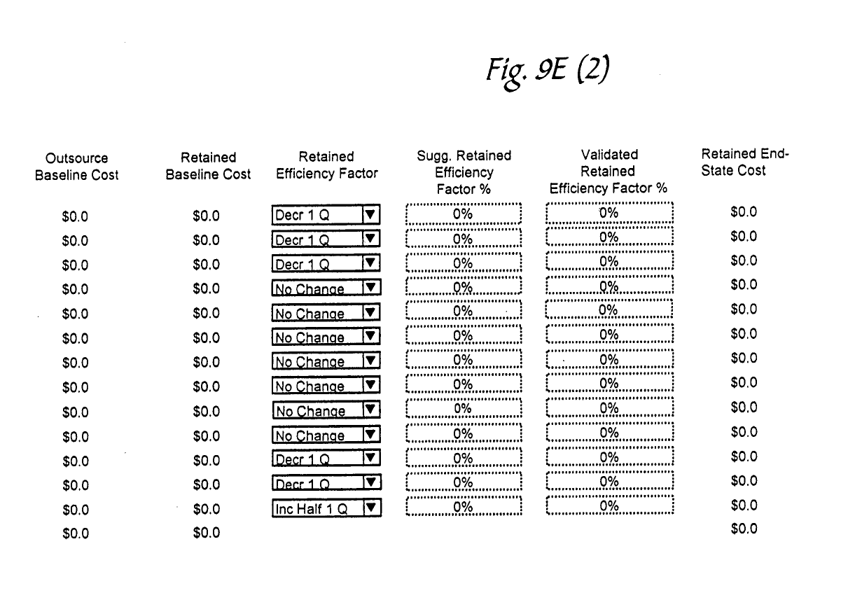

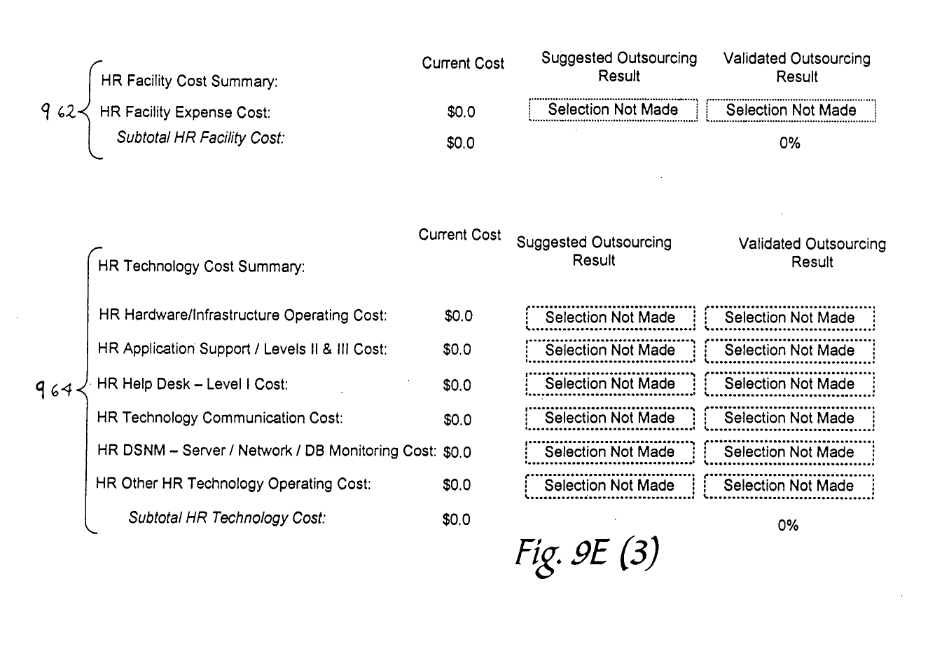

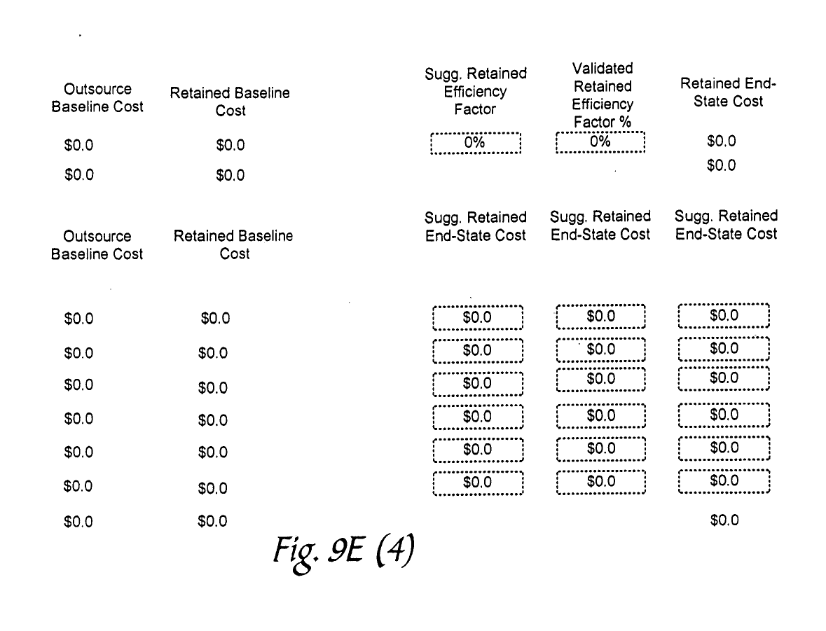

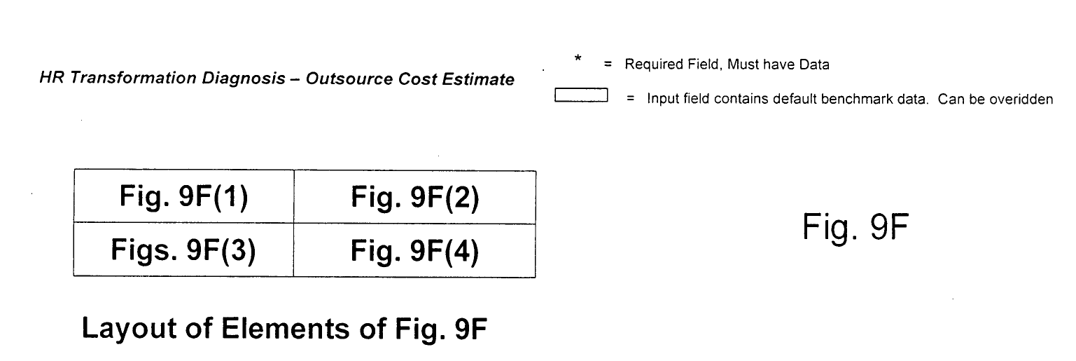

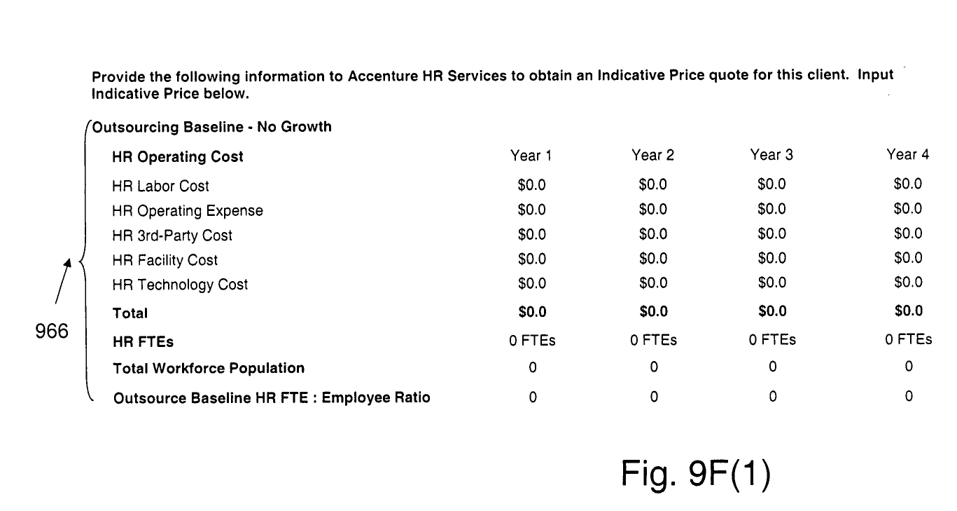

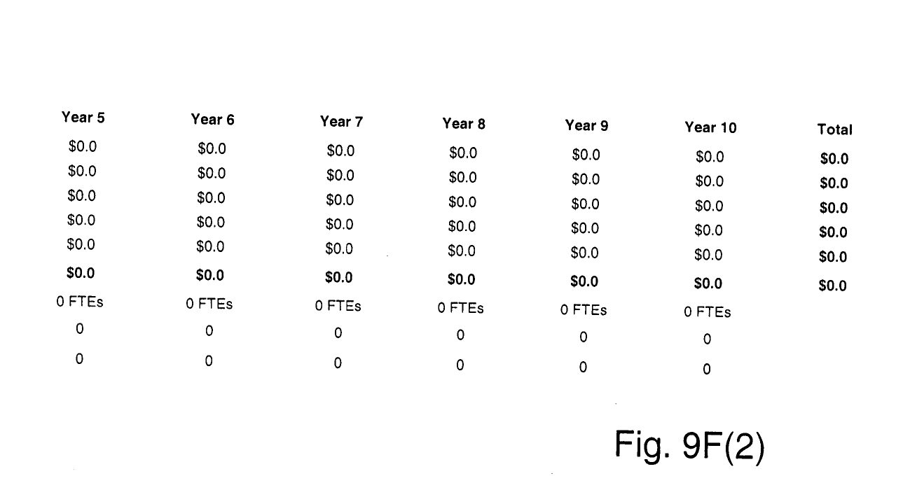

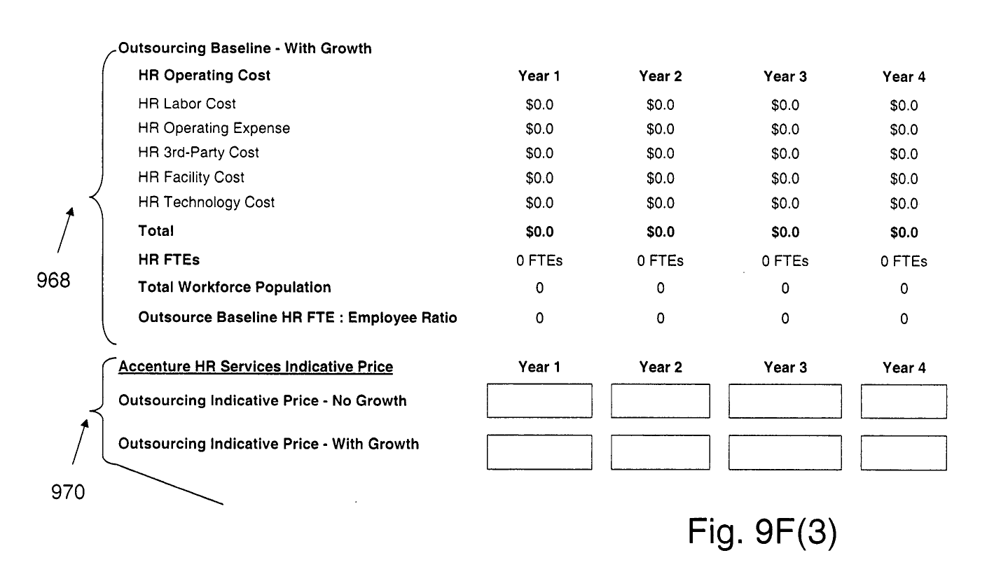

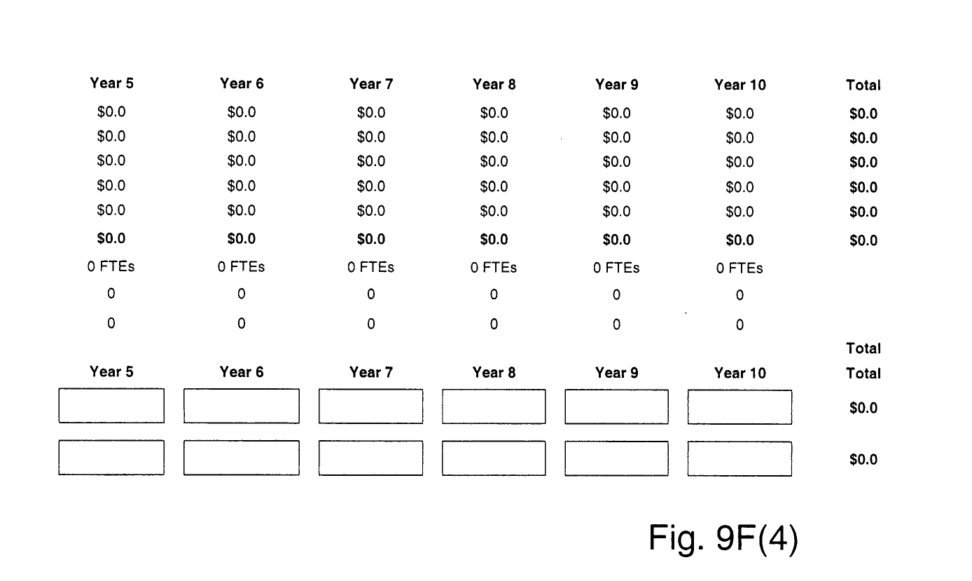

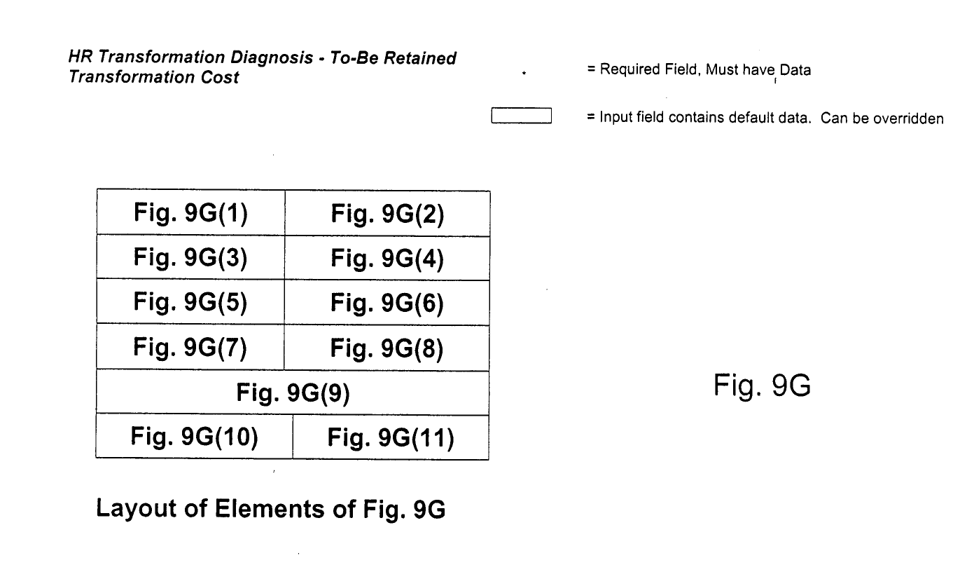

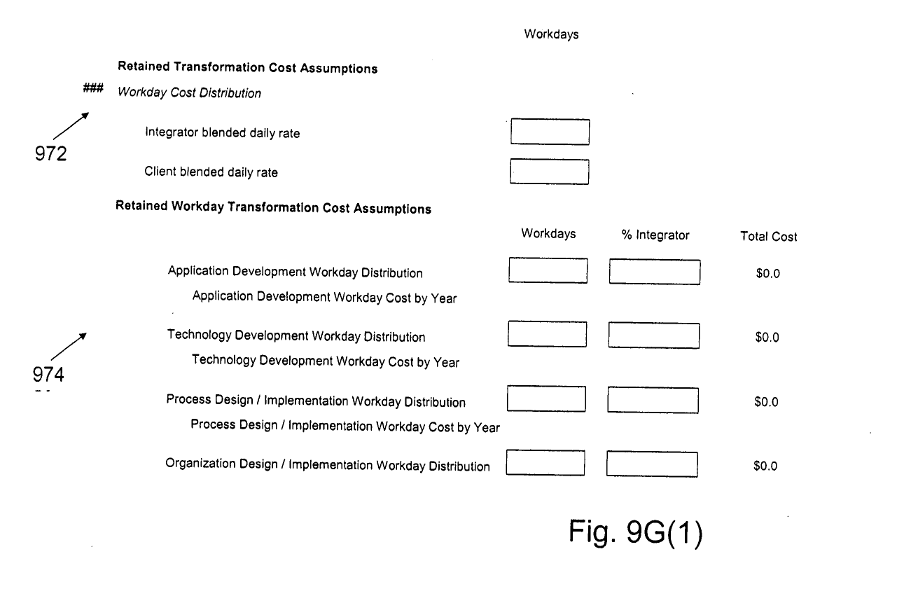

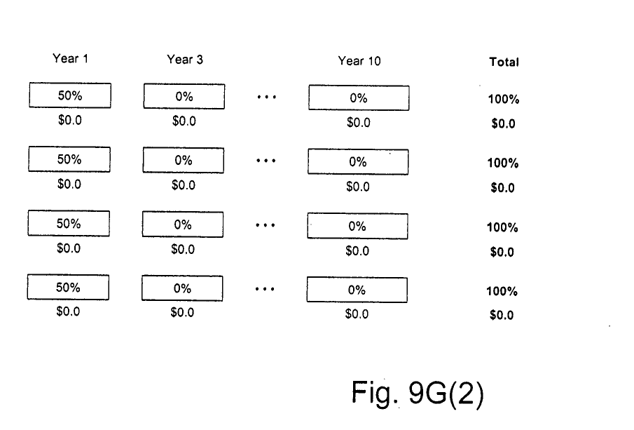

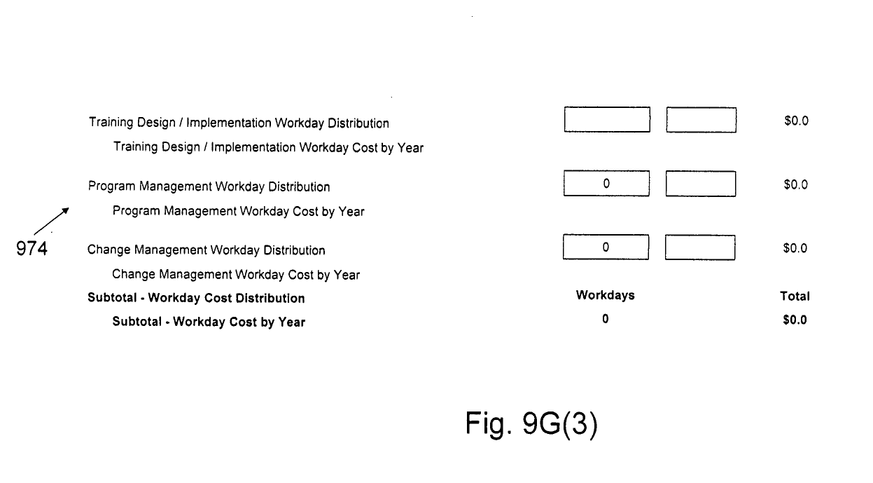

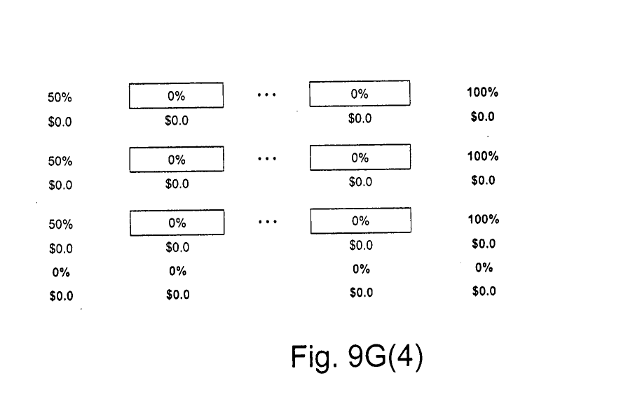

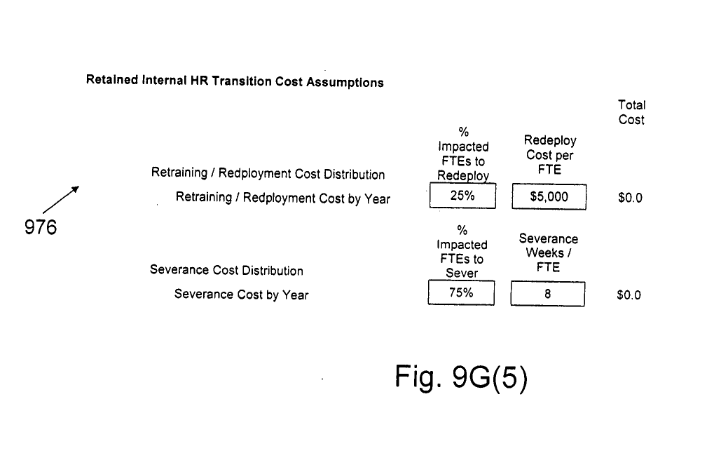

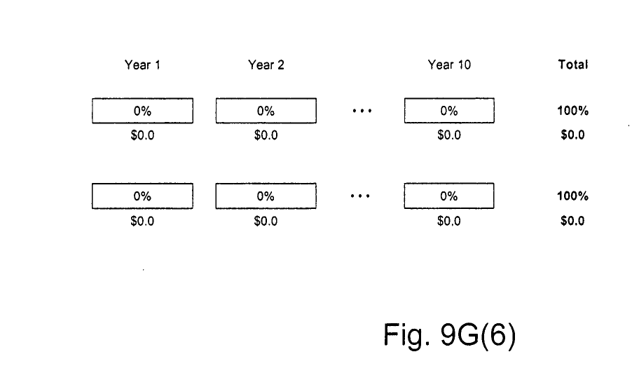

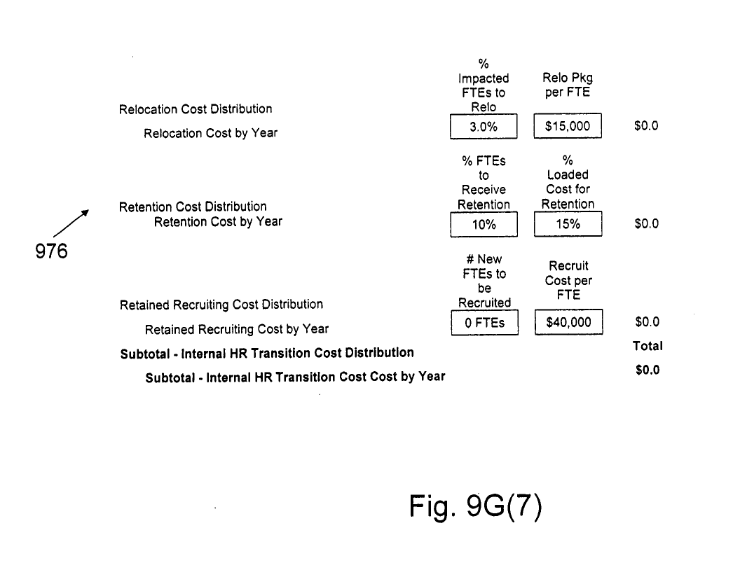

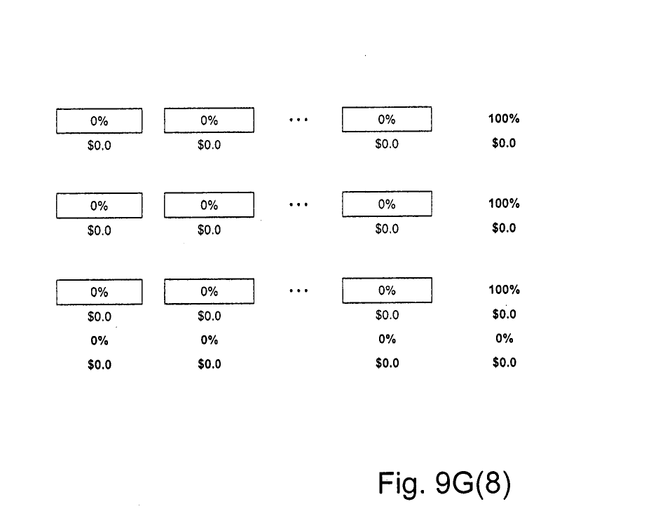

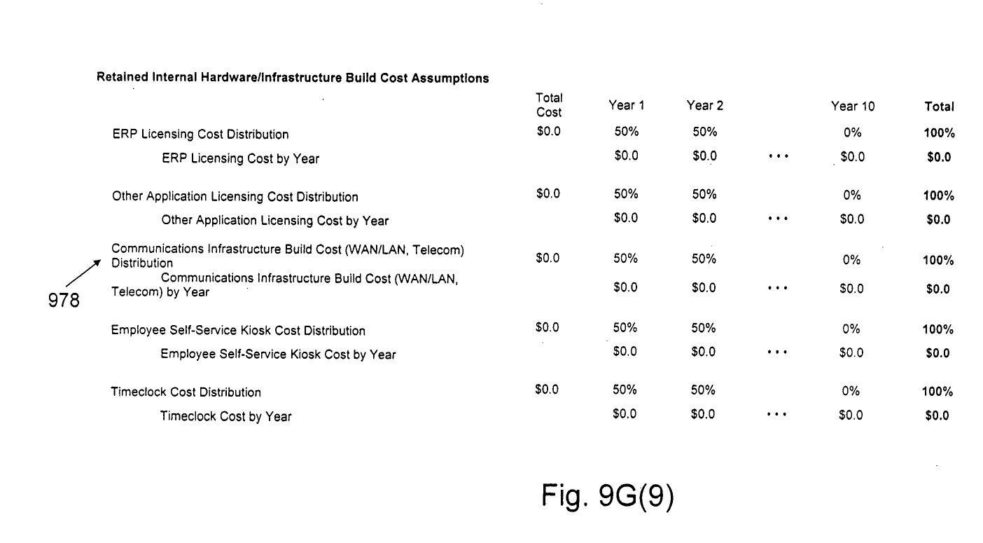

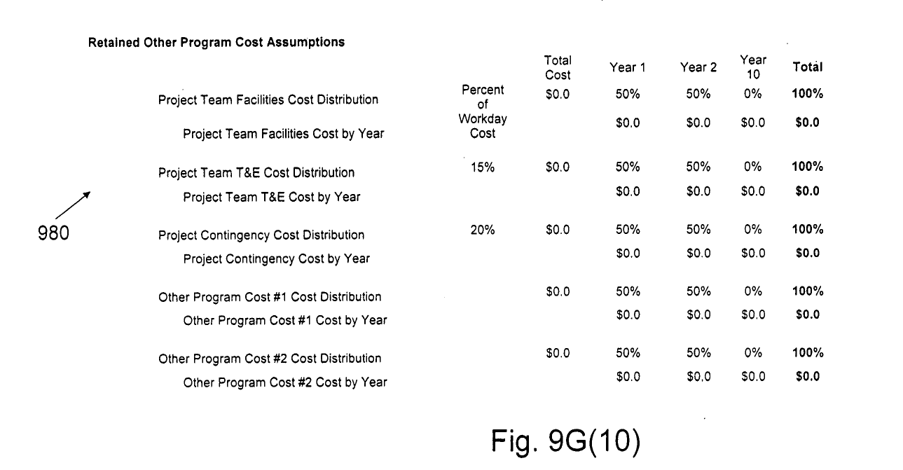

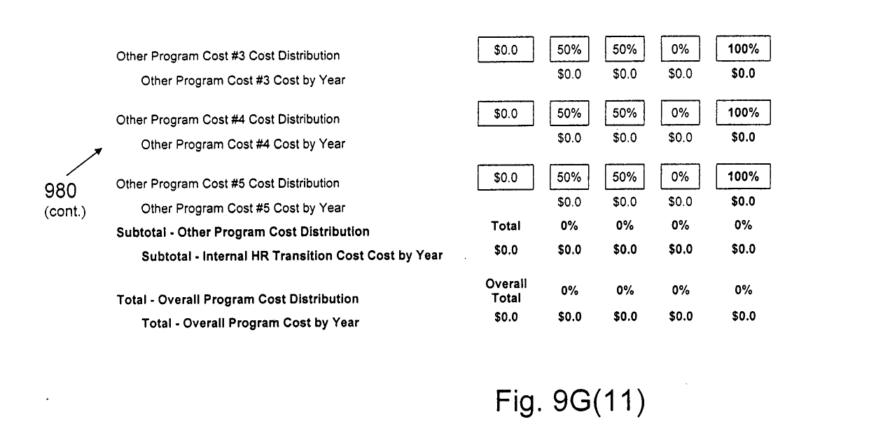

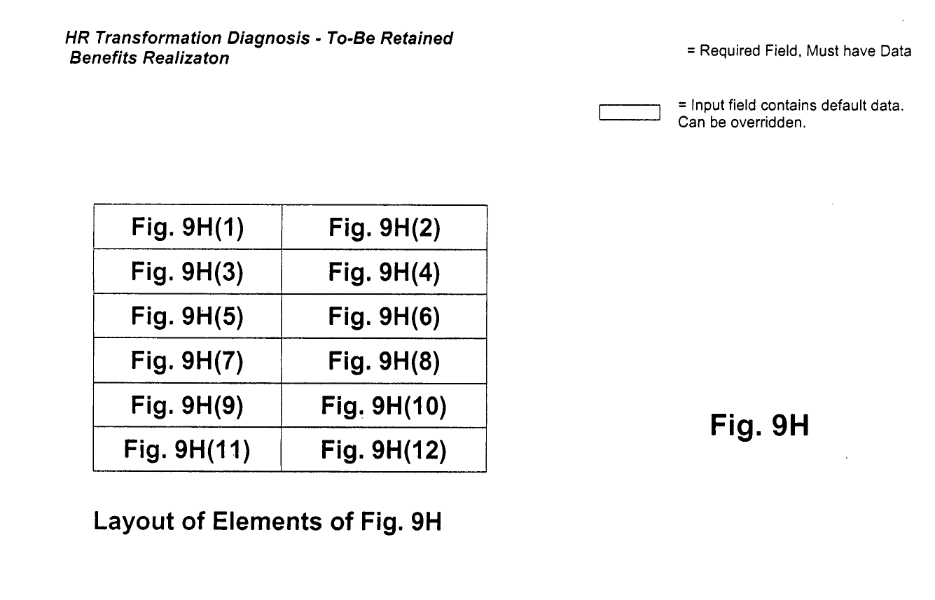

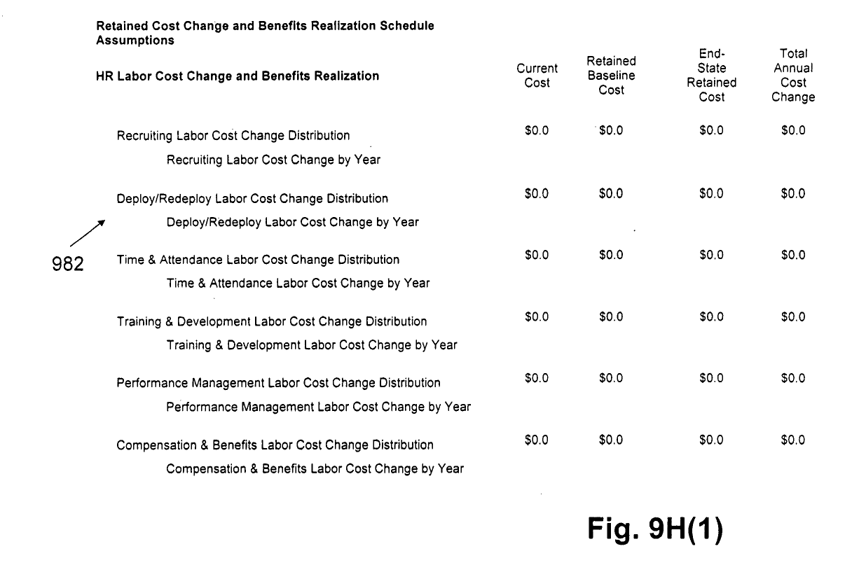

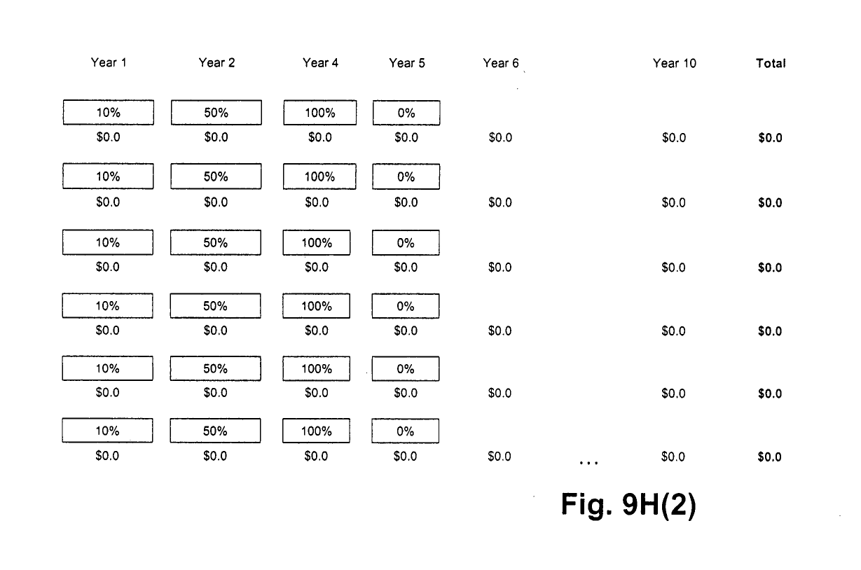

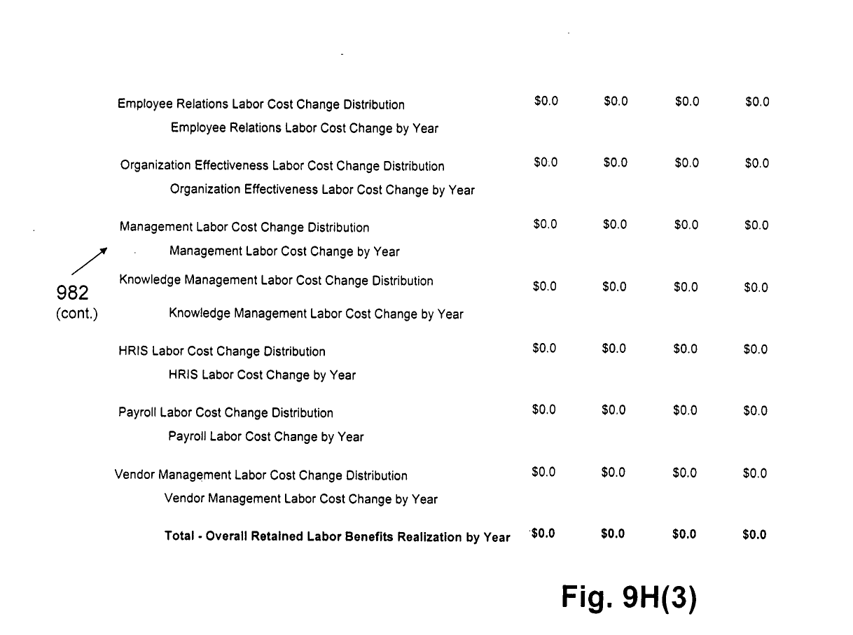

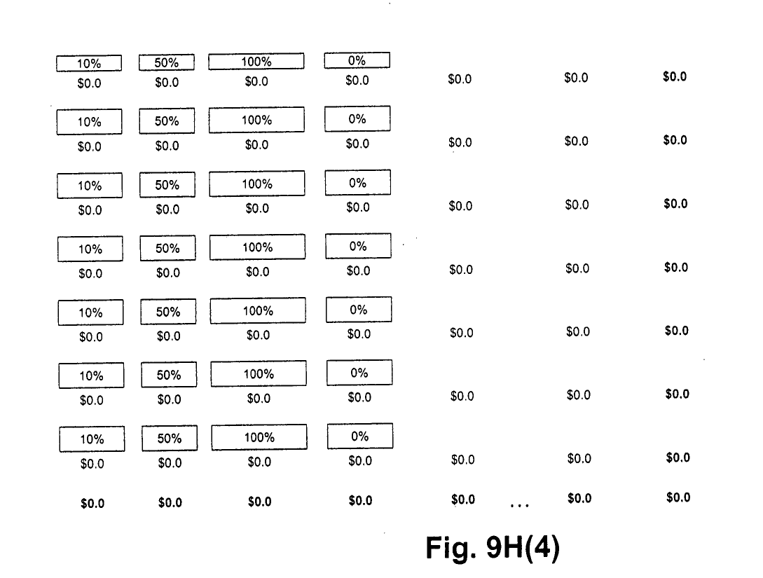

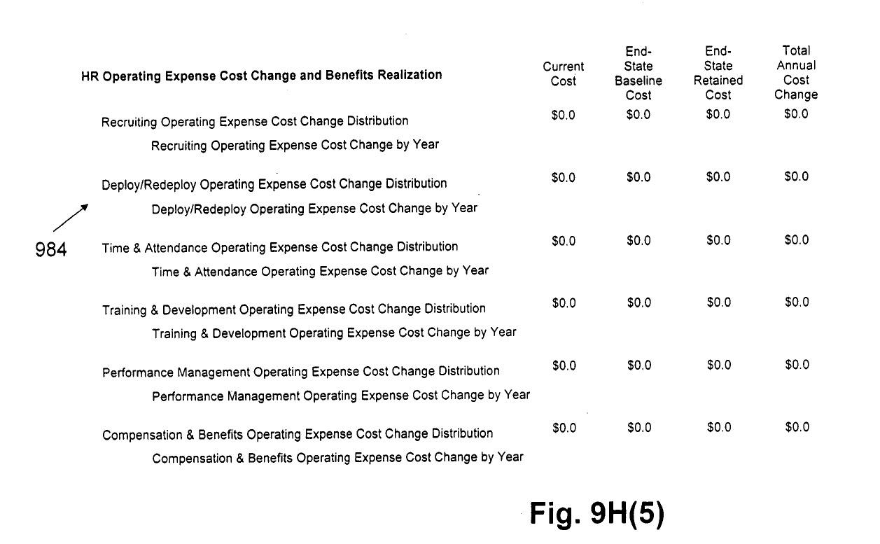

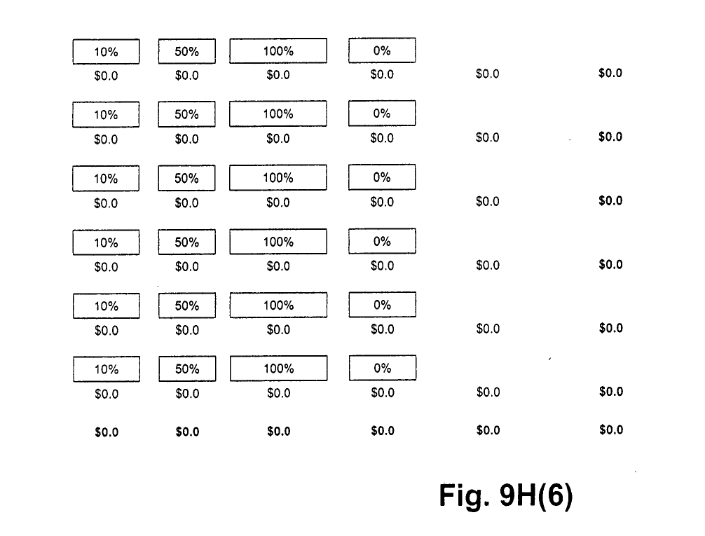

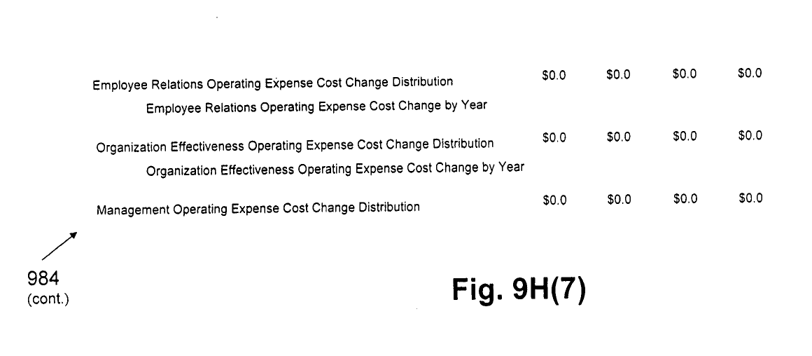

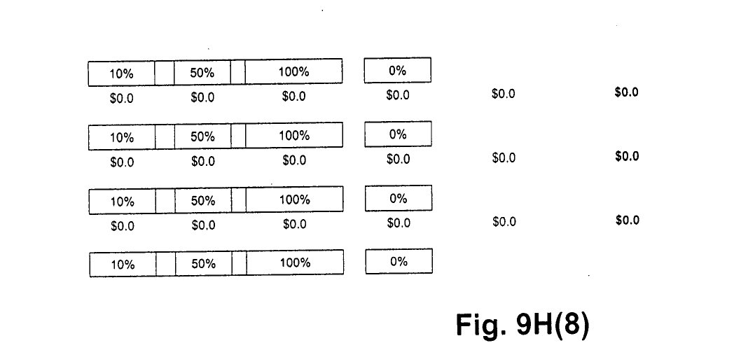

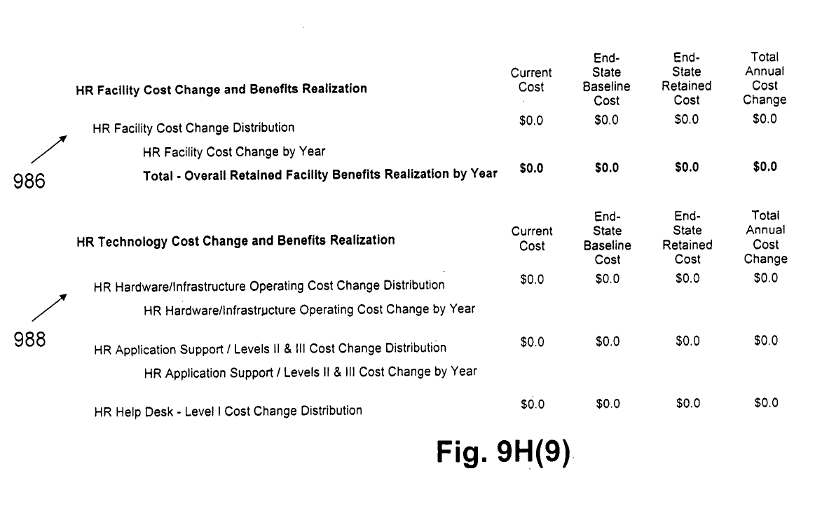

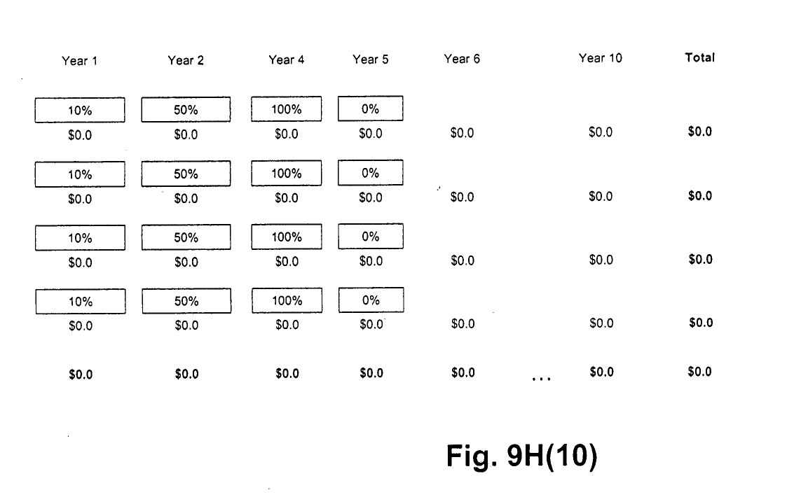

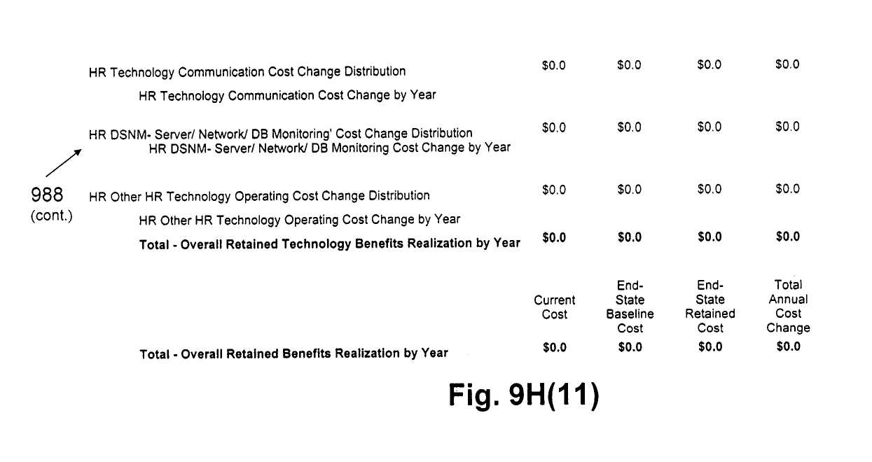

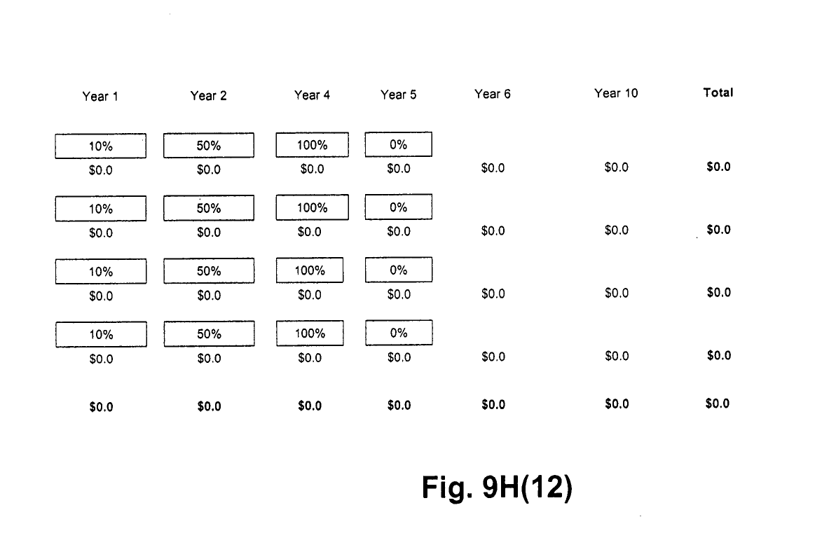

FIGS. 9A-9H illustrate exemplary user interface displays which illustrate various data that may be received at the transformation opportunity indicator represented by the system 100. Such information includes basic To-Be Basic data, As-is cost survey, As-Is time survey, To-Be labor sourcing data, To-Be non-labor sourcing data, To-Be outsource cost data, retained transition cost data, and retained benefits schedule data, which are discussed in detail below. The information representing the displays shown in FIGS. 9A-9H are merely exemplary, and more or less data may be utilized in modeling a business organization transformation scenario. Further, as will be described below, some of the data inputs illustrated in FIGS. 9A-9H may be utilized only where a particular business organization transformation scenario is being modeled. Further, the data and information may be provided by a business organization, or alternatively may be determined based on an assessment of the business organization, for example, as a result of a one to two week interaction with the business organization. Further, some of the assumptions (for example benchmarks) may be entered by a user of the system 100, or alternatively may be automatically imported into the transformation opportunity indicator.

As shown generally at 900 of FIG. 9A, basic client solution information may include a particular solution to evaluate for the client, the cost of capital rate, a business case evaluation period, a client annual revenue, a client annual operating expense, a client interest-bearing depth, a client shareholders' equity, a client marginal tax rate, a client weighted average cost of capital, a client's current stock price, and a client's current shares outstanding information. The solution to evaluate for the client may include a broad transformational HR outsourcing, internal HR transformation, and internal transformation with limited outsourcing solutions.

FIG. 9B illustrates various information and data regarding a client's current HR FTE population, HR operating cost (including, for example labor, non labor, and technology costs), and overall business information (i.e. revenue, operating costs, work force population, etc.). The information and data provided may be utilized to build a summary of current HR operating costs and allow activity-based costing based on time distribution data and information received, as discussed below.

As shown in FIG. 9B, As-Is cost information and data may include general client information at 910, client cost data including FTE information at 912, labor cost information at 914, operating expense information at 916, HR facility cost information at 920, HR technology cost information at 922, business financial information at 924, and work force compensation cost information at 930. Additional As-is cost information and data shown in FIG. 9B may include client growth rate projections at 932, client HR FTE compensation inflation rate projections at 934, and client end-state growth projections (economy scale benefits) shown generally at 936.

As shown at 910, general information regarding the client may include a client name, and a client industry group may be provided. The client industry group may include, for example, banking, chemicals/petroleum products, computer products, computer software/services, consumer products/food and beverage/retail, government agency/education, hospitals/healthcare, insurance-all lines & P, C, P, insurance-healthcare only, manufacturing, non-bank financial, pharmaceuticals/medical devices/R&D, semiconductors/electronics, services, telecommunications, and utilities. Alternative or additional client industry groups may be provided.

The FTE information at 912, may include FTE summary information, HR exempt and non-exempt FTEs information, and a total number of FTEs. The labor cost information at 914 may include HR exempt and non-exempt labor cost information. Operating expenses cost at 916 may include operating expenses regarding HR sub-functions such as recruiting, deployment/ redeployment, time & attendance, training & development, performance management, compensation & benefits, employee relations, organization effectiveness, HR management, knowledge management, HRIS information, payroll, and vendor management operating expense cost information.

HR facility cost information at 920 may include HR facility expenses including information regarding a subtotal HR facility cost, a subtotal HR non-labor cost and a subtotal HR cost excluding technology. HR technology cost summary at 922 may include an HR hardware/ infrastructure operating cost, HR application support/levels II &III costs (i.e. where a multi-tier support structure is available), HR help desk-level 1, HR technology communication, HR DSNM-server/network/DB monitoring costs, and HR other HR technology operating costs. Business financial summary at 924 may include a total business revenue and a total operating expense, including operating profit. Work force compensation costs information and data at 930 may include a total exempt work force cost, a total non-exempt work force compensation costs, and a total contingent work force compensation cost.

The client cost survey results information may be provided as a particular business unit, as well as HR shared service center (SSC), corporate HR, as well as providing a total.

Client growth rate projections at 932 indicate the client growth rate projections for various business units, for example business unit #1 thru #8, as well as a business unit #1-#8 weighted average rate of growth, HR SSC, corporate HR, and for HR technology. A Business unit, for example, may be considered to be an operational sub-unit within the client's organization for which costs and other information would be gathered for separate transformation analysis. Business unites may include, for example, different operational locations of the client.

The client HR FTE compensation inflation rate projections at 934 are provided for overall average rates.

The client end-state growth projections at 936 may include current overall HR cost growth trade by year, suggested projected HR operating cost growth rate reduction (i.e. due to economies of scale), validated projected HR operating cost growth trait reduction (i.e. due to economies of scale), and projected overall HR cost growth rate by year.

The client growth projection at 932, 934 and 936 may be provided by year, for example as information for year 1 thru year 10, as well as an average over year 1-year 10.

Although not shown, additional information may be included, such as, for example, 3rd-party cost information, business location information, and workforce population information. The 3rd-party cost information may include similar information as discussed above with respect to the operating cost expense information 916. Business location information may include a number of field locations, number or regional/district locations, and a number of centralized locations. Work force population information may include numbers of total regular exempt employees, regular non-exempt employees as well as provide a total for contingent employees.

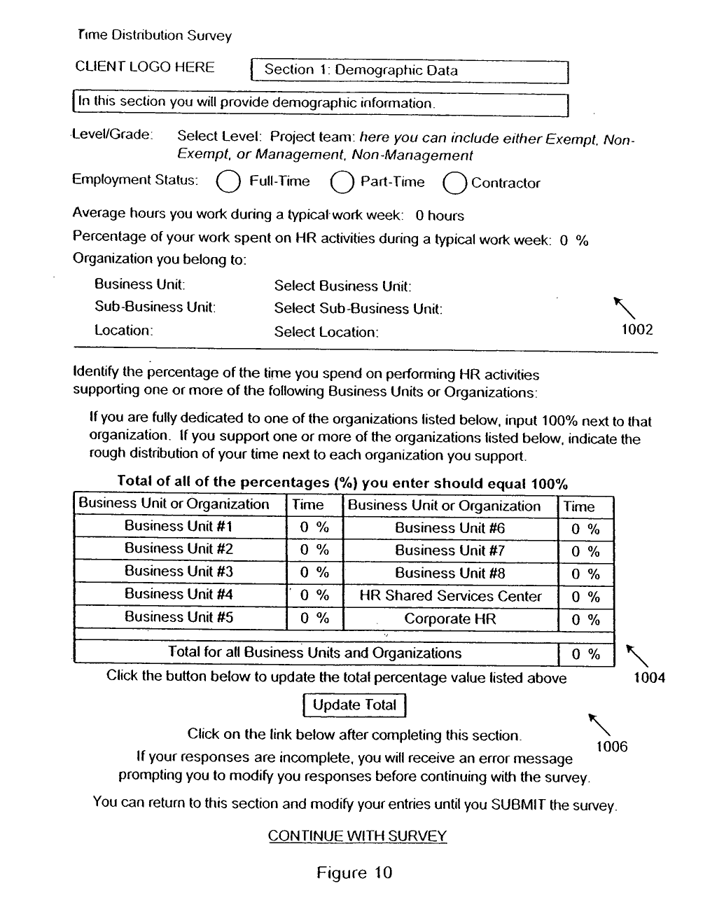

As discussed above, various information may be received via cost survey, or by a user directly entering information into the spreadsheet or other program implementing the transformation opportunity indicator. Where a survey is utilized, the information gathered by the survey may be directly imported into a particular portion of a spread sheet, for example into the particular data fields shown in FIG. 9B corresponding to the spreadsheet inputs. Alternatively, the spreadsheet may produce a report which may be utilized by a user of the business opportunity indicator in entering the various information and data for the various fields shown in FIG. 9B. The survey(s) may be provided, for example, as a survey implemented as a spreadsheet, or as a survey provided in an HTML format, for example as discussed below with respect to FIG. 9C and FIG. 10.

FIG. 9C illustrates an exemplary user interface showing various data inputs regarding a client's As-Is time information and data. The As-is time information and data provides the HR transformation model with information regarding how the work done by the client's HR FTE population is distributed across various HR processes and activities. Total hours information from, for example survey results or any other means of collecting data, as well as information on the total number of responses received, may be entered so that the model is capable of extrapolating data regarding FTEs for survey respondents who did not submit a response, and to calculate FTEs and labor cost for each HR activity. Such information may be utilized in calculating a business case based on an HR transformation scenario, for example, a broad-outsourcing, internal, and/or mixed outsourcing/internal transformation scenario. Such information may include general survey response information at 940, as well as recruiting information at 942.

As discussed above, surveys may be utilized in providing data and information for various subject areas which may be utilized in providing the model for a particular transformation scenario. FIG. 10 illustrates a portion of an exemplary user interface display for a HTML survey in accordance with the second embodiment of the invention.

As shown in FIG. 10, the HTML survey may be provided to solicit various information with regards to a particular function(s) and/or sub-function(s) of a business organization, here for example with regards to the human resource function. The survey(s) may be provided to individual employees of the business organization, to a designated employee of the business organization, or to a member of the transformation team, for entering information solicited by the survey. Where the survey is provided to various employees of the business organization, the survey may have capabilities of transmitting the information gathered into a database, for example at the storage device 110, where the storage device and/or controller 105 may be capable of receiving and tallying the information regarding the various information solicited. Further, the controller 105 may be capable of automatically populating various fields of one or more of the data inputs of FIGS. 9A-9H or any other data fields utilized in the business opportunity indicator responsive to the information received via the survey.

The survey of FIG. 10 is one that may be completed by one or more individual employees of the business organization, however, one skilled in the art would appreciate that other surveys, for example as discussed above could be provided in addition, or in the alternative. As shown in FIG. 10, general information regarding an employee's time distribution may be solicited. For example, general time distribution may be distributed, at 1002, including an employee's employment status (i.e. full or part time, or contractor), as well as average hours worked per week, percentage of time spent on the function being analyzed (i.e. HR), and information regarding the particular business unit of the business organization with which the employee is associated.

In addition, at 1004, the employee may indicate time allocation to HR across various business units of the business organization, for example business units #1-#8, as well as for an HR shared service center, and Corporate HR, or other organizational entities as required.

As indicated at 1006, upon entry of various information of the survey, the employee may select to update information entered, using for example a mouse, stylus, or alphanumeric keyboard of the user interface 115. Further, where the survey includes further information to solicit from the employee, the survey may present one or more additional user interface displays soliciting such information, until all information has been solicited.

Returning to FIG. 9C, general survey results at 940 from surveys completed by at least one of individual employees, a designated employee and a transformation team member(s) may include an actual number of survey responses, an expected number of responses, a response rate, responses to extrapolate, as well as FTEs, for exempt and non-exempt business units #1-#8, exempt and non-exempt HR SSC, and exempt and non-exempt corporate HR, or other organizational entities or classifications as required.

Recruiting information at 942 may include information regarding the amount of time recruiting takes with respect to the following activities: design and develop recruiting strategy and policies, conducting labor market reviews, designing employment branding and marketing, identifying open positions To-Be filled, processing open position job requisitions, operating internship programs, and designing and implementing community employment programs. The recruiting time information end data may further include time for: sourcing candidates, screening applicants, coordinating pre employment testing and background checks, interviewing candidates, making an offer decision and offering a job to a candidate, processing job offers and rejections, processing referrals, processing internal transfers, recording hires and internal transfers, providing orientation programs to new hires and/or internal transfers, providing relocation services, managing college recruiting, managing contract and temporary labor, and other recruiting information. Further, the recruiting information at 942 may include the time required for performing and managing work force planning processes, assigning resources to departments/projects, designing and managing career path management, conducting replacement planning, conducting succession planning, designing jobs and enhancement programs, conducting expatriate programs, processing voluntary and involuntary employee separations, performing exit interviews, and other recruiting information.

The recruiting information may be broken down by exempt survey hours, average hours per respondent, extrapolated respondent hours, total hours, exempt time distribution and exempt FTE distribution. Such information may be provided for both exempt and non-exempt FTE survey extrapolation for one or more of the business units, for example business units #1-#8.

Although not shown in FIG. 9C, additional information may be provided regarding As-is time allotment. Such information may be provided in a similar format as discussed above. Such As-Is time information and data may include information and data regarding time and attendance, training and development, performance management, compensation & benefits, employee relations, organization effectiveness, HR management, knowledge management, HR information systems and reporting, payroll, and vendor management.

The time & attendance information may account for various time requirements/guidelines to accomplish managing time and attendance processes, generating and analyzing time and labor reports, conducting shift scheduling, managing vacation time process/ policy, sick time process/policy, over time process/policy, leave of absence process/ policy, and application of labor rules/policy to scheduling process, as well as any other time & attendance information and data.

Training & development information may include time requirements/guidelines information for designing and developing training strategy and policies, developing curricula for a specific workforce(s), develop, implement and managing career development programs, designing and developing learning content, administering training delivery, delivering warning events, administering post-warning activities, planning and managing leadership development programs, and any other training and development information.

The performance management time information may include information regarding designing and developing performance management strategies and policies, and programs and tools, administering employee performance management programs, facilitating goal planning and management processes, developing and administering reward and recognition programs, conducting promotions/advancement processes, conducting talent assessments, and performing coaching and mentoring.

The compensation & benefits information may include design and developing compensation & benefit strategies and policies, as well as cash and non-cash compensation programs, administering cash and non-cash administration programs, designing and developing benefit programs, administering benefit program delivery, managing annual compensation and reward processes, managing company car programs, managing administration and repayment of individual loan programs, and administering contractual and non-contractual pay changes.

The employee relations time information and data may include designing and developing employee relations strategy and policies, facilitating employee “due process” and work place investigations, responding to HR legal issues, providing outplacement and career services, developing and implementing labor relations programs, negotiating and administering union contracts, developing and administering safety and loss prevention programs and coordinating workers compensation claims, as well as reporting and recordkeeping. The employee relations time information and data may further include designing and implementing government compliance plans and reporting, coordinating government compliances and recordkeeping, developing and implementing diversity management programs, developing and distributing employee communications, answering ad hock queries from employees, administering employee surveys, and designing and implementing work-life programs. The employee relations data and the information may further include participating in local community services events, providing associated activities, and administering alumni programs.

The organization effectiveness data and information may include time allocation for providing organization, process, and job design services, administering and managing competency management processes, creating and managing work force models for the company, providing business-culture alignment services, designing business performance measurement systems and providing change management services.

The HR management information and data may include time requirements/guidelines for managing the HR function and employees, creating, owning and managing the HR strategy, providing governance overall HR functions, monitoring overall HR operational metrics, and ensuring all HR functions are integrated and working together.

The knowledge management information and data may include managing the knowledge regarding capturing processes, creating processes, synthesis processes and deployment processes. The HR information systems and reporting information and data may include implementing HR information systems, maintaining HR information systems software and hardware (i.e. application management), maintaining HR website content and infrastructure, generating standard, ad hock, HR corporate, and government/statutory/tax reports, maintaining personal files, managing IT networks, and implementing and managing application integration.

The payroll information and data may include processing payroll, wages and salary adjustments, as well as deductions, dues and garnishments, auditing and transmitting payroll, distributing paychecks and wages, processing off-cycle payroll and adjustments and separation payments, performing periodic and statutory payroll reporting, and answering payroll questions.

The vendor management information and data may include managing the process for vendor selection from identification through CRP to contact, against pre-defined performance targets and SLA's, as well as managing the ongoing process of contract, terminations, renewals and updates.

FIG. 9D illustrates an exemplary user interface display for entering labor sourcing strategy information (To-Be labor sourcing data). In cases where HR outsourcing represents a component of a solution scenario to be profiled, the To-Be labor sourcing information may be utilized to determined which HR activities are transitioned to the outsourcer (HR outsourcing only) and how much of the labor effort for each outsourced HR activity may transition. Such information may be gathered through a facilitated sourcing discussion with the business organization/client. A change in HR FTEs may also be identified internally to the client that could result from HR transformation (i.e. for all cases-outsourcing and internal transformation). The To-Be labor sourcing information and data may be utilized in the organization sizing analyzing, and to identify labor savings in the business case, as described below.

As shown at 950, To-Be labor sourcing strategy information may be provided for recruiting, and for deployment/redeployment (staffing) at 952. The recruiting information at 950 may include information regarding designing and developing recruiting strategy and policies, conducting labor markets reviews, designing employment, branding and marketing, identifying open positions to be filled, processing open position job requisitions, operating internship programs, designing and implementing community employment programs, and sourcing candidates. Further, the recruiting information at 950 may include screening applicants, coordinating pre-employment testing and background checks, interviewing candidates, making offer decisions and offering jobs to candidates, processing job offers and rejections, referrals, internal transfers, recording hires and internal transfers, providing orientation programs to new hires and/or internal transfers as well as relocation services, managing college recruiting, and managing contract and temporary labor.

Typically, the transformation team member(s) enters information by rating on a scale of “1” to “5” the various information regarding recruiting in terms of transactional, frequency, existing centralization, existing standardization, competitive advantage, and inherent to culture. For transactional, a “1” indicates no transactional, where a “5” indicates highly transactional. For frequency, a “1” may indicate infrequent where a “5” indicates frequent. For existing centralization, a “1” indicates locally based, where a “5” indicates centralized. For existing standardization, a “1” indicates not standardized where a “5” indicates completely standardized. Regarding competitive advantage, a “1” indicates a key advantage where a “5” indicates no advantage. For inherent to culture, a “1” indicates highly cultural, whereas a “5” indicates not cultural for a particular area. Further, the recruiting at 715 may be broken down by amount outsource-corp HR, amount outsource-HR SSC, amount outsource-BUs, retained efficiency factor, suggested retained efficiency factor, as well as validated retained efficiency factor.

Further shown in FIG. 9D is a sourcing score, generally indicated at 954. The sourcing score provides an average of the various categories for a particular labor function. A sourcing score having a value greater than a predetermined threshold may indicate a desirability to outsource that particular function. Such a threshold, for example, may be 3.2, where a sourcing score for a particular function having a value of 3.2 or above indicates a desirability to outsource that particular sub-function of the HR function. For example, this score may serve as a guideline for discussion of outsourcing with a client.

In addition, as indicated at 952, deployment/redeployment (staffing) data may be illustrated. Deployment redeployment information at 952 may include information regarding performing and managing workforce planning processes, assigning resources to departments/projects, designing and managing career path management, conducting replacement and succession planning, designing jobs and enhancement programs, conducting expatriate programs, processing voluntary and involuntary employee separations, and performing exit interviews.

In addition, although not shown, similar information may be provided for other business organization areas, for example the areas discussed above with respect to FIG. 9C, including the information regarding time & attendance, training & development, performance management, compensation & benefits, employee relations, organization effectiveness, HR management, knowledge management, HR information systems and reporting, payroll, and vendor management.

FIG. 9E is an exemplary data input interface display which may utilized by the transformation opportunity indicator for receiving information regarding a non-labor sourcing strategy (To-Be non-labor sourcing strategy). In cases where HR outsourcing represents a component of a solution scenario to be profiled, the information entered may be utilized by the transformation opportunity indicator in determining which HR non-labor costs (i.e., operating expenses, 3rd-party spending, facility costs, and HR technology costs) may transition to the outsourcer and become part of the outsourcer's baseline costs (i.e., for HR outsourcing only). The transformation team may gather such information and data through a facilitated sourcing discussion with the client. Further, users of the transformation opportunity indicator may also identify the change in non-labor cost internal to the client which may result from HR transformation (i.e., here for all cases-outsourcing and internal transformation). The non-labor sourcing strategy information and data may be utilized in the solution summary, discussed further below, and may be utilized to identify non-labor savings in the business case.

As shown in FIG. 9E, To-Be non-labor sourcing strategy information may include operating expense cost information at 960, HR facility costs information at 962, and HR technology cost information at 964.

The operating expense cost information may include operating expense costs regarding recruiting, deployment/redeployment, time & attendance, training & development, performance management, compensation & benefits, employee relations, organization effectiveness, HR management, Knowledge management, HRIS, Payroll, and Vendor management, or other areas as required. The HR facility cost information at 962 may include information regarding HR facility expense costs, as well as a subtotal HR facility cost, or other areas as required. The HR technology cost information at 964 may include information regarding HR hardware/infrastructure operating costs, HR application support/levels II & III costs, information regarding HR helpdesk, HR technology communications, HR DSNM-server/network/DB monitoring, and HR other HR technology operating costs, or other areas as required. The HR DSNM-server/network/DB monitoring may represent, for example, the labor and non-labor cost associated with monitoring and maintaining the database servers associated with HR applications, as well as monitoring and maintaining networks and network capacities as these applications are used by end users of these applications.

The operating expense information 960, HR facility cost information at 962 and HR technology cost information at 964 maybe provided as a current cost, suggested outsourcing result, validated outsourcing result, outsourced baseline cost, retained baseline cost, retained efficiency factor, suggested retained efficiency factor, validated retained efficiency factor, and retained end-state cost.

Although not shown, one skilled would realize that additional information regarding non-labor sourcing strategy maybe provided as well. For example, 3rd-party cost information may be provided regarding recruiting, deployment/redeployment, time & attendance, training & development, performance management, compensation & benefits, employee relations, organization effectiveness, HR management, Knowledge management, HR information systems (HRIS), Payroll, and Vendor management 3rd-party costs, or other areas as required. Such additional information maybe presented in a similar fashion as described above with regards to the operating expense information 960, HR facility cost information 962 and HR technology cost information 964.

FIG. 9F illustrates an exemplary user interface display representing information which may be received regarding To-Be outsource cost information. Such information, for example, may be provided for transformation solution scenarios regarding outsourcing transformation cases. The information shown in FIG. 9F may summarize the cashflow view of an outsourcer's baseline cost for both no-growth and growth situations, and may include labor and non-labor costs, as well as a total HR FTEs associated with the baseline cost. This information may typically be provided to an Accenture HR services representative for the calculation of an indicative year-by-year outsourcing price to the client. After receiving the indicative price, transformation teams may enter the data so that it may be loaded and provided as part of the overall business case.

As shown in FIG. 9F, information may be provided including information regarding outsourcing baseline-no growth at 966, outsourcing baseline-with growth at 968, and Accenture HR services indicative price at 970. The outsourcing baseline-no growth information at 966 may include information regarding HR operating and labor costs, HR operating expenses, HR 3rd-party costs, HR facility costs and HR technology costs, as well as a total costs, number of HR FTEs, total workforce population, and outsourcer baseline HR FTE: employee ratio information. As shown at outsourcing baseline-with growth at 968, similar information may be provided as discussed above with respect to the outsourcing baseline-no growth at 966. The Accenture HR services indicative price at 970 may include information regarding outsourcing indicative price-no growth, and outsourcing indicative price-with growth.

The outsourcing baseline-no growth 966, outsourcing baseline-with growth 968 and Accenture HR services indicative price at 970 may be presented over a particular time span, for example years 1-years 10, as well as provided as a total over the particular time span.

FIG. 9G illustrates an exemplary user interface display which may be used by the business opportunity indicator in receiving information regarding retained transformation costs. Information may be entered allowing an estimate of the cost to be paid by the client in order to transition to a future-state solution (i.e., for any of the transformation scenarios). This information may include project workday costs for client or other resources, HR transition costs including such costs as severance, retention, recruiting, or other costs as required, technology build cost, as well as other program expenses. The transformation team may also identify the distribution of these costs across multiple years of a transformation program, so that a total cost may be distributed into the business case cashflow view. Transformation teams may need to perform an independent work planning effort in order to estimate these costs before providing them to the transformation opportunity indicator.

As shown in FIG. 9G, information may be provided regarding various cost assumptions, including cost assumptions for retained transformation at 972, retained workday transformation at 974, retained internal HR transition at 976, retained internal hardware/infrastructure build at 978 and retained other program cost assumptions at 980.

The retained transformation cost assumptions 972 may include information regarding workday cost distributions such as an integrator blended daily rate, and a client blended daily rate. Information regarding retained workday transformation cost assumptions at 974 may include workday distribution and cost information and assumptions regarding application development, technology, process design/implementation, organization design/implementation, training design/implementation, program management, change management, as well as a subtotal of workday cost distribution and costs. The retained workday transformation cost assumptions may be presented as breakdowns regarding workdays, % integrator, total cost, as well as costs over a particular period of time, for example, year 1-year 10, as well as a total over the particular period of time.

The retained internal HR transition cost assumptions and information at 976 may include information regarding cost distribution as well as cost by year for retraining/redeployment, severance, relocation, retention, and retained recruiting. The retained internal HR transition cost assumption and information at 976 may be presented as a breakdown by % impacted FTEs to redeploy, redeploy cost per FTE, total cost, as well as over a particular period of time, for example, year 1-year 10, and a total over the particular period of time.

The retained internal hardware/infrastructure build cost assumptions and information may include information regarding cost distribution and cost by year at 978 for ERP licensing, other application licensing, communications infrastructure build cost (i.e., WAN/LAN, telecom), employee self-service kiosk, and time clock, or other technology build costs as required. Although not shown, the retained hardware/infrastructure build cost assumption may include information regarding hardware cost (i.e., servers, routers, etc.), data center build cost, and additional categories of HR technology build cost as required which may be specific to a particular client technology solution situation and which terminology may be customized for use with the client. These customizable HR technology build cost categories are indicated by the items HR technology build #1, #2, #3, #4, and #5. Retained internal hardware/infrastructure build cost assumptions may be presented as a total cost, as well as a cost over a particular period of time, for example, year 1-year 10. The retained other program cost assumptions and information 980 may include cost distribution and cost by year information regarding transformation team facilities and T&E, project contingency cost, and additional categories of retained client transformation program cost as required which may be specific to a particular client transformation solution situation and which terminology may be customized for use with the client. These customizable HR program cost categories are indicated by the items other program costs #1, 2, 3, 4, and 5. Such information may be presented as a percent of workday cost, as well as a total cost, and costs over a predetermined amount of time, for example, year 1-year 10.

FIG. 9H illustrates an exemplary user interface display which may be used by the transformation opportunity indicator in receiving information regarding To-Be retained benefits information. The To-Be retained information benefits may include information allowing an estimate of the rate at which the client will achieve any cost savings (or cost increases) to a related operating cost as a result of the HR transformation program. Based on the total change and retained HR operating cost, the transformation team may identify the distribution of the change in the cost for each cost category across multiple years of a transformation program, so that a total cost may be distributed into the business case cashflow view. Transformation teams may need to perform an independent implementation and release planning effort in order to estimate a benefits realization schedule before loading information into the transformation opportunity indicator.

As shown in FIG. 9H, various information and data regarding To-Be retained benefits realization may be provided, including, for example, retained cost change and benefit realization schedule assumptions for HR labor cost change and benefits realization at 982, HR operating expense cost change and benefits realization at 984, HR facility cost change and benefits realization at 986, and HR technology costs change and benefits realization at 988.

Information regarding HR labor cost change and benefits realization at 982 may include labor cost change distribution and labor cost change by year for recruiting, deployment/redeployment, time & attendance, training & development, performance management, compensation & benefits, employee relations, organization effectiveness, management, knowledge management, HRIS, payroll, and vendor management, or other categories as required.

The HR operating expense cost change and benefits realization assumptions and information at 984 may include operating expense cost change distribution and cost change by year for recruiting/deployment/redeployment, time & attendance, training & development, performance, compensation & benefits, employee relations, organization effectiveness, and vendor management, or other categories as required.

The HR facility cost change and benefits realization assumptions and information at 986 may include information regarding HR facility cost change distribution as well as change by year.

The information regarding HR technology cost change and benefits realization at 988 may include assumptions and information regarding operating cost change distribution and operating cost change by year for HR hardware/infrastructure, HR applications support/levels II & III, HR helpdesk-level I, HR technology communication, HR DSNM-server/network/DB monitoring, as well as HR other HR technology operating cost charge distributions and charges by year.

The HR labor, operating expense, facility cost, and technology cost changes and benefit realization assumptions and information at 982, 984, 986 and 988 respectively may be presented as a current cost, retained baseline cost, end-state retained cost as well as a total annual cost change, and may further be presented over a particular period of time, for example, year 1-year 10, and a total over the particular period of time.

Second Embodiment Analyzing

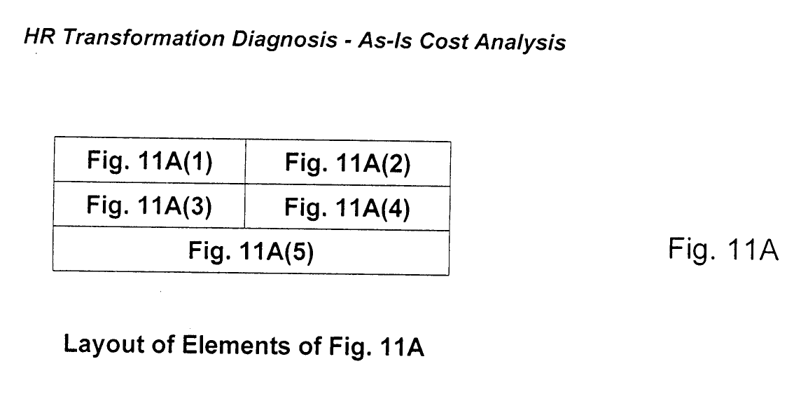

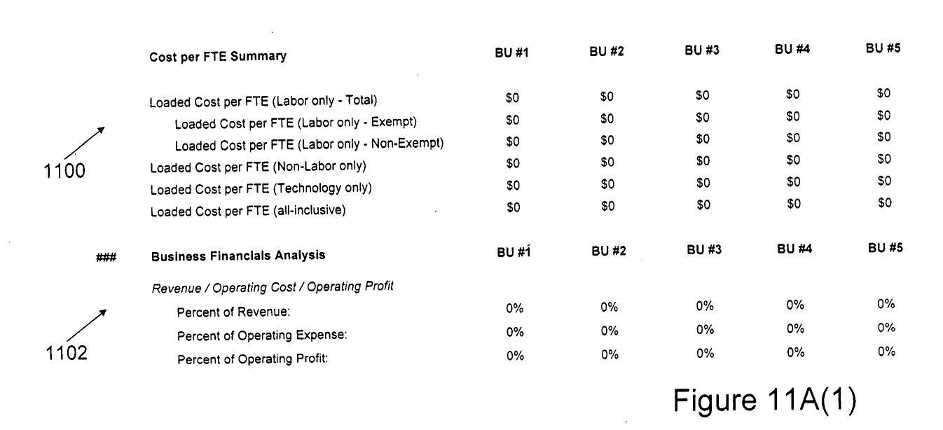

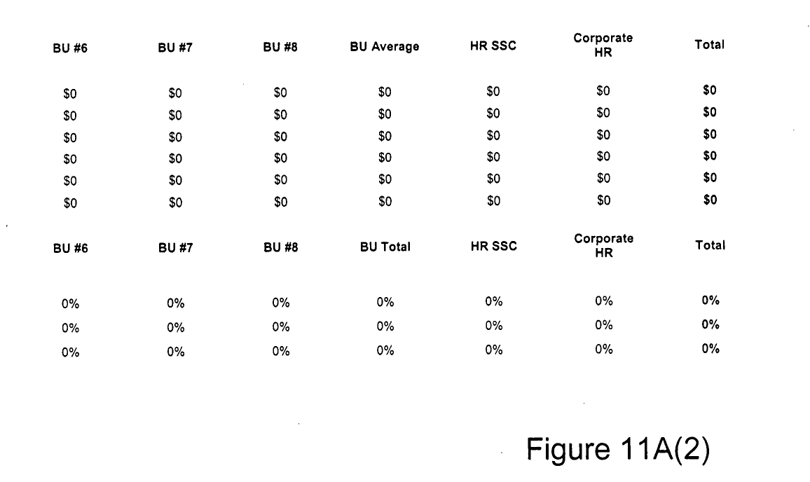

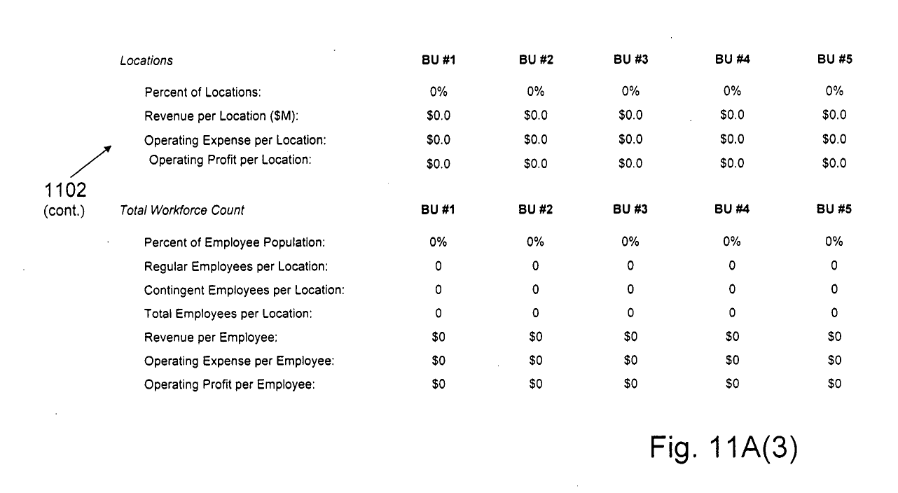

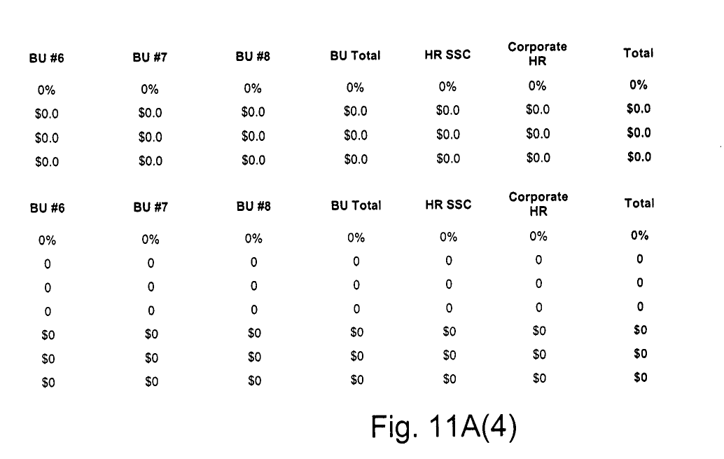

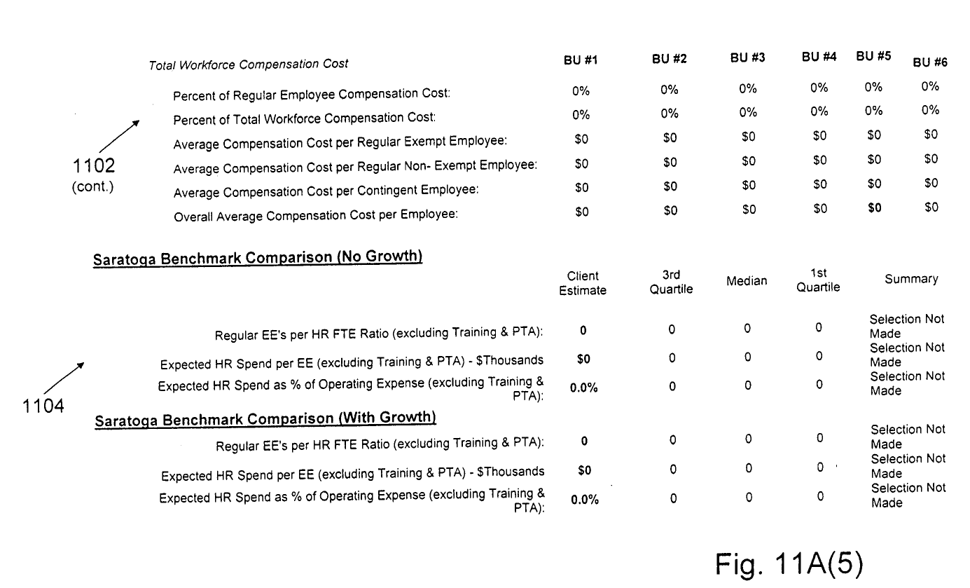

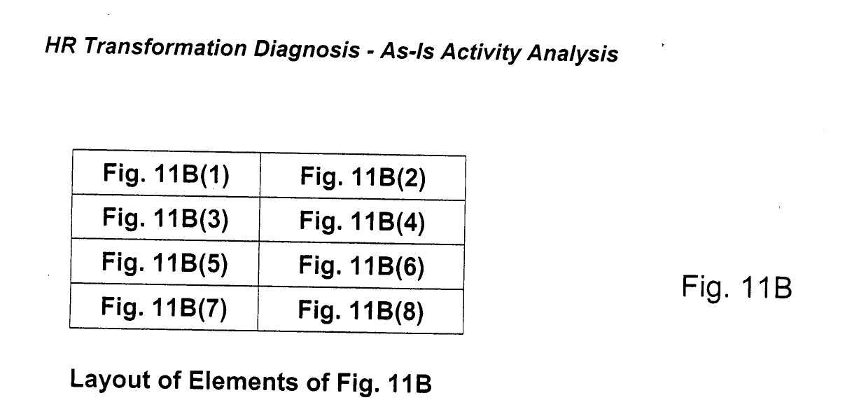

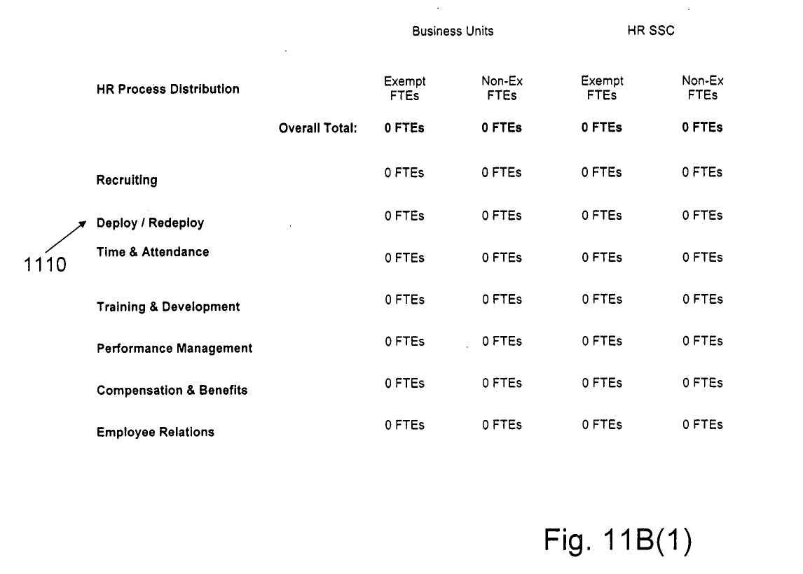

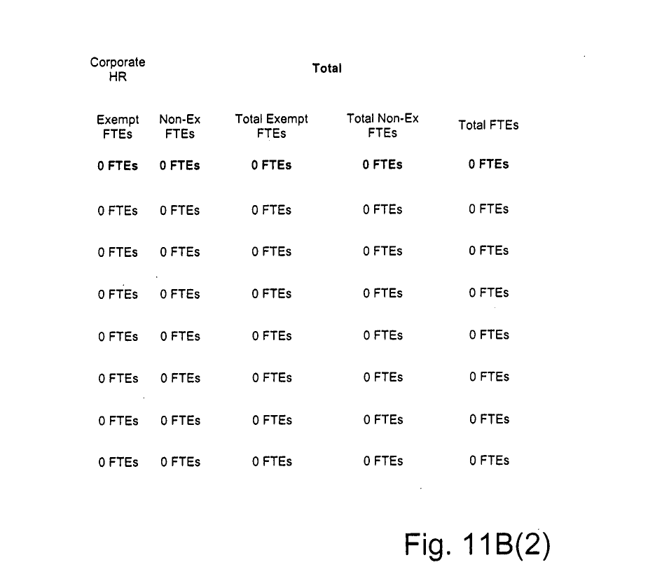

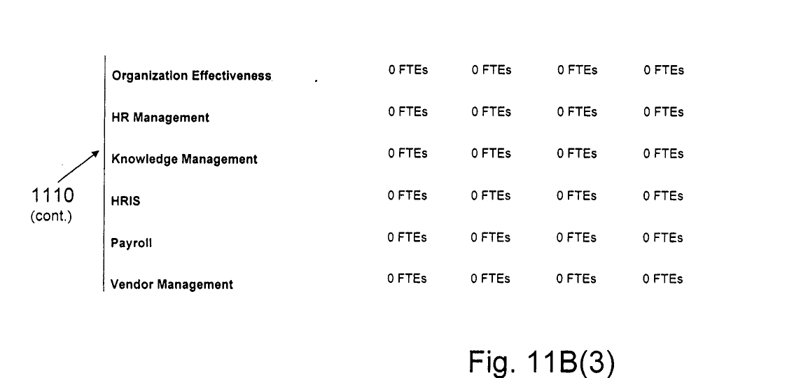

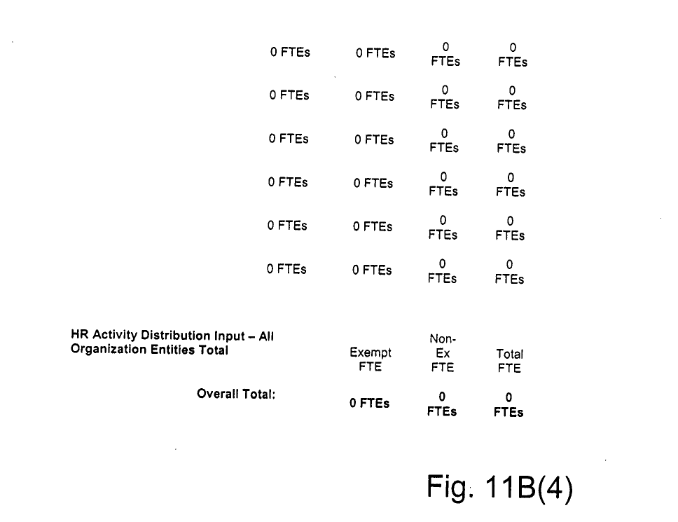

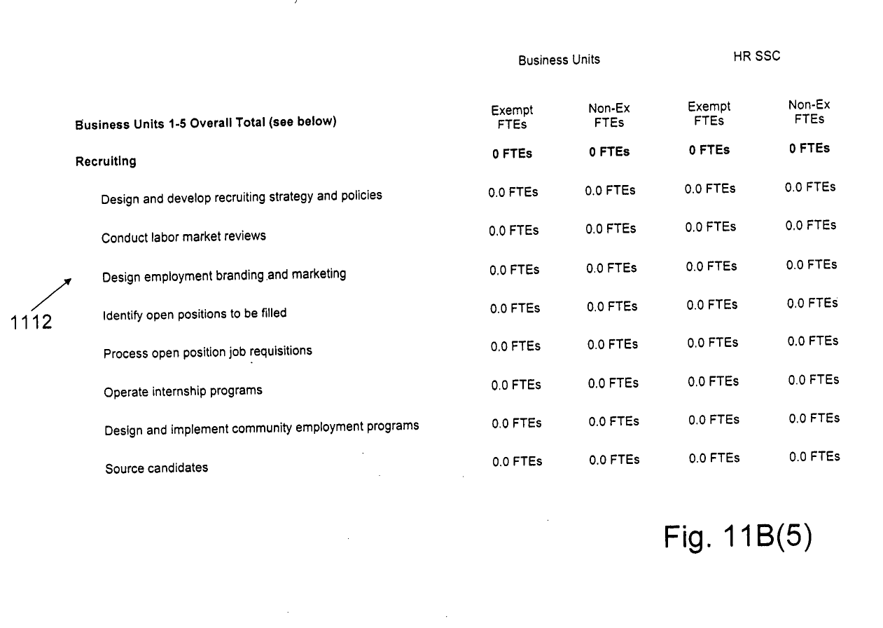

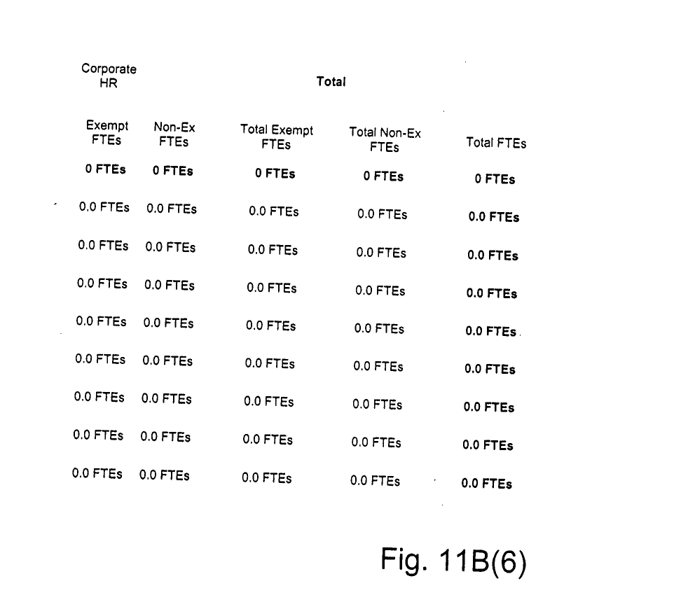

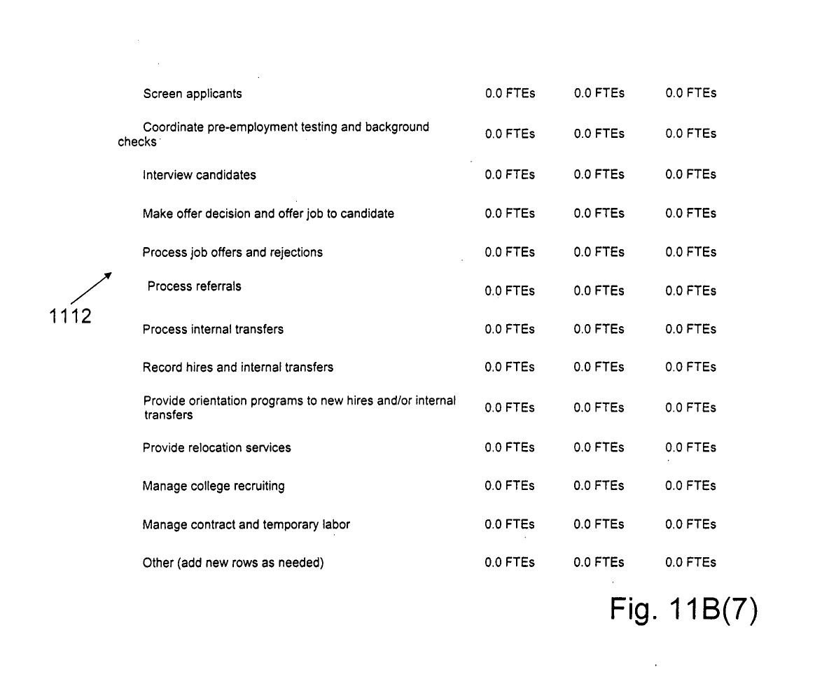

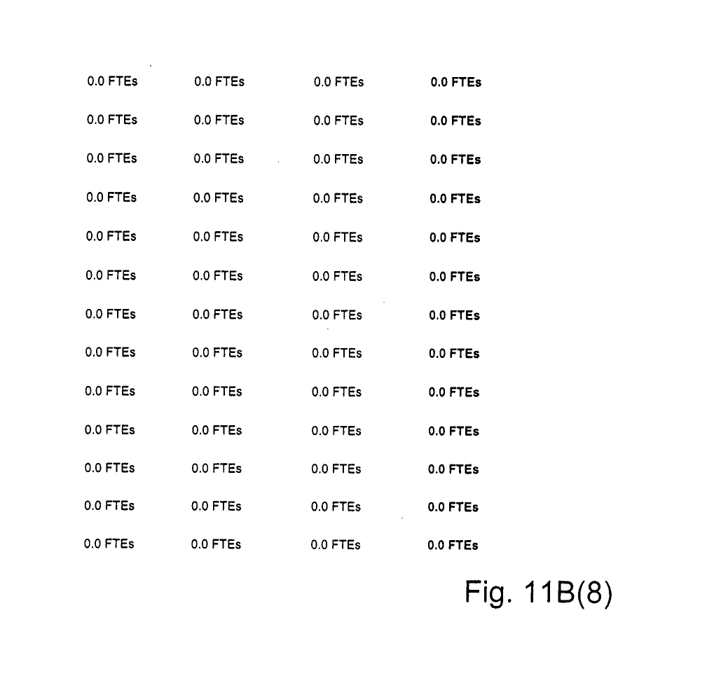

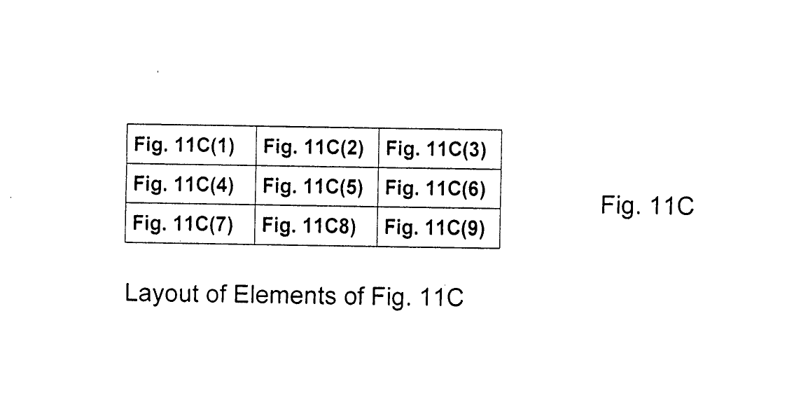

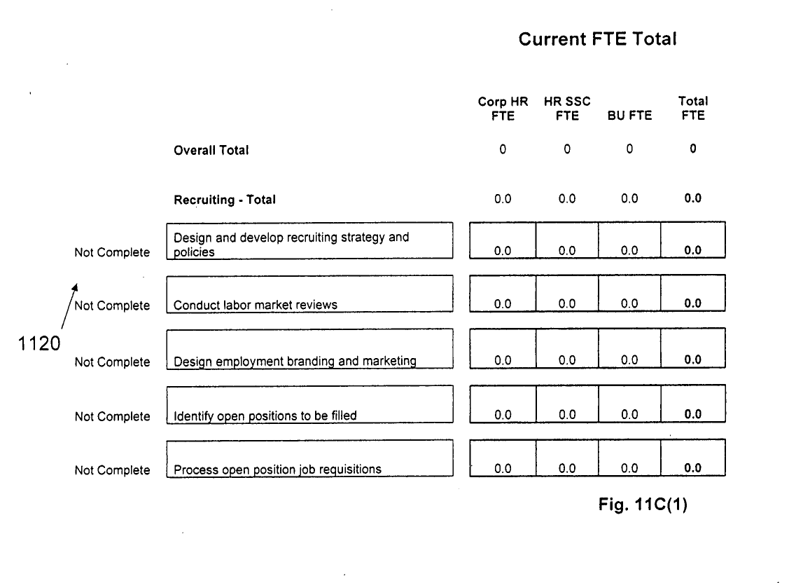

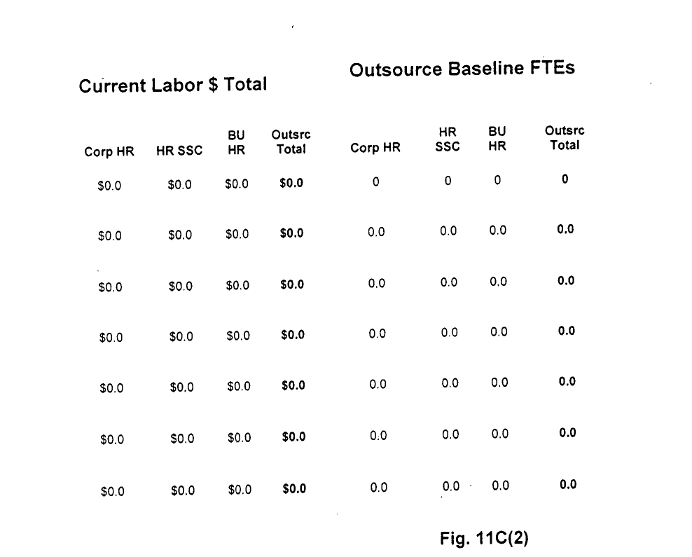

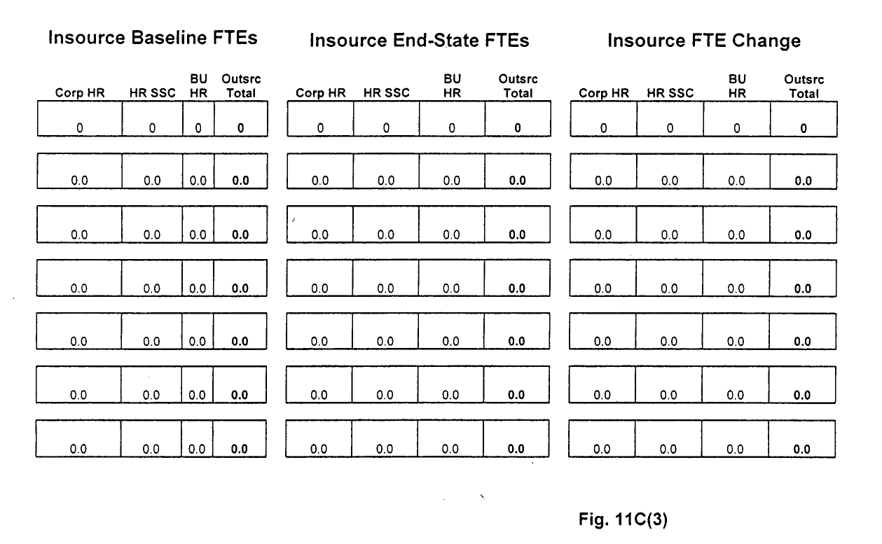

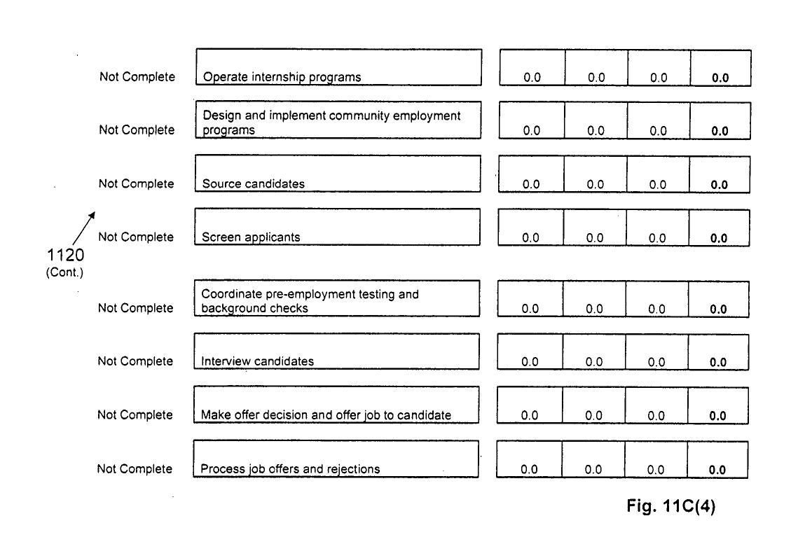

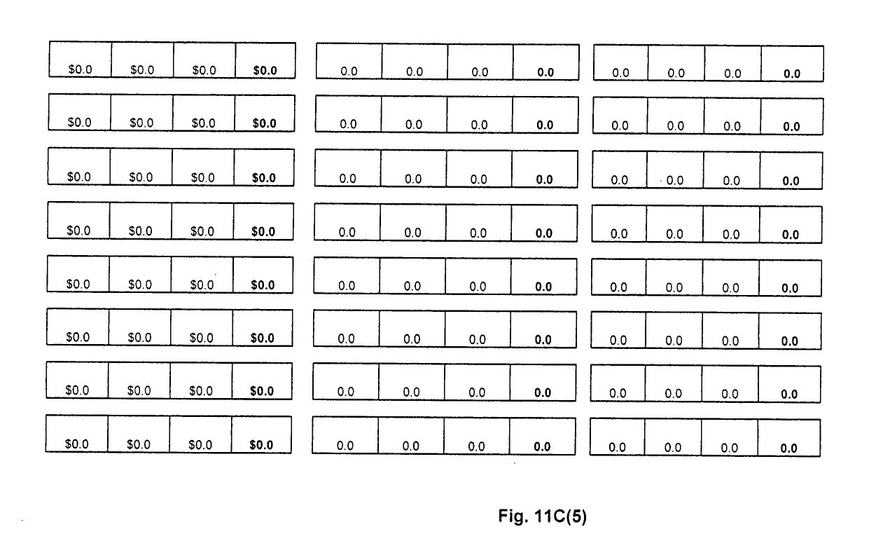

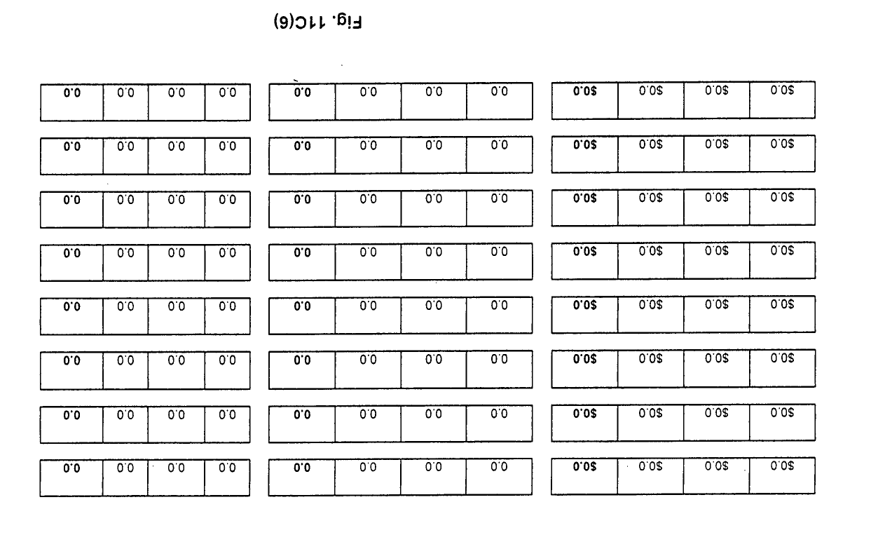

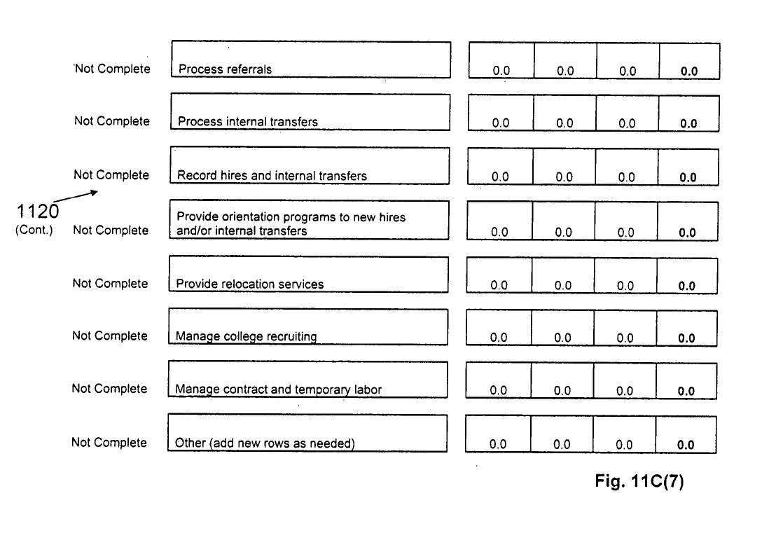

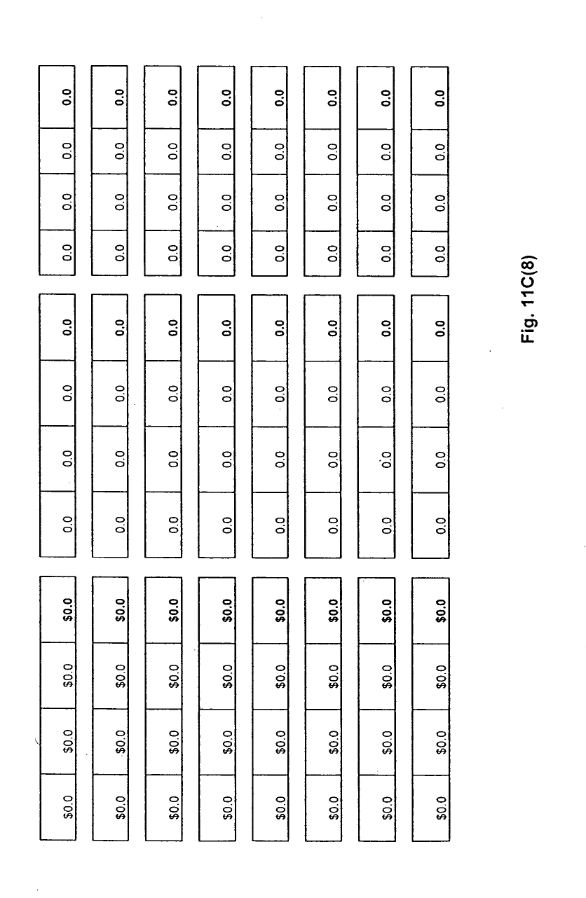

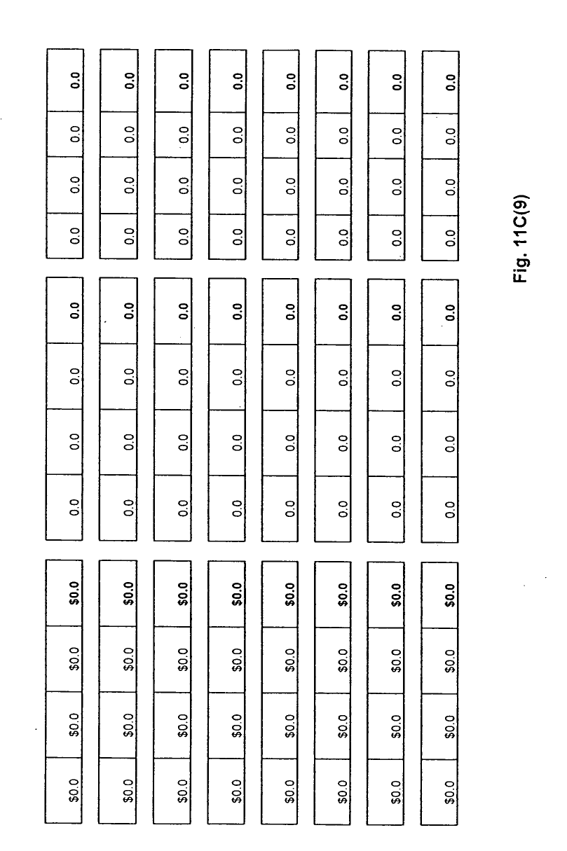

As discussed above with reference to FIG. 8, upon receiving data inputs 800, the system 100 is capable of analyzing at least one received data input in accordance with at least one industry threshold, at box 805. In accordance with the second embodiment of the invention, the analyzing of box 805 may be accomplished by the system 100 determining a business organization current state (As-is) cost analysis, activity analysis, and business organization sizing analysis as will be discussed below with reference to FIGS. 11A-11C.

Where the transformation opportunity indicator is implemented as a spreadsheet for execution on a spreadsheet program, the analyzing at 805 may include performing one or more calculations between at least one of the data inputs described above with respect to FIGS. 9A-9H and at least one internal or external industry threshold. The result of the calculation(s) may be placed in one of the fields of the As-is cost analysis, activity analysis and business organization sizing analysis user interfaces, described below, and may be used in providing a comparison between the As-Is condition of the business organization, with respect to the To-Be condition of the business organization.

FIG. 11A is an exemplary user interface display which may illustrate various information regarding an As-Is cost analysis performed by the transformation opportunity indicator. The As-Is cost information of FIG. 11A provides information regarding a summary of results of the data entries made in the As-is cost survey discussed above with respect to FIG. 9B, as estimates of the averages for cost per FTE, distribution of work locations, revenue and operating expense across in-scope business units and locations, and other key high-level financial metrics for the client. As shown in FIG. 11A, the information may include information regarding a cost per FTE at 1100, various business financial analysis information and data at 1102 including information regarding revenues/operating costs/operating profit, locations, total workforce count, and total workforce compensation cost, Saratoga benchmark comparison (no growth) information at 1104, and Saratoga benchmark comparison (with growth) at 1106.

The cost per FTE information 1100 may include information regarding loaded cost per FTE, including a loaded cost for both exempt and non-exempt labor, per FTE for non-labor, per FTE for technology, as well as all inclusive loaded cost per FTE. The business financial analysis information at 1102 includes information regarding revenue/operating cost/operating profit as a percent of revenue, percent of operating expense and percent of operating profit. The locations information includes information regarding percent of locations, revenue per location, operating expense per location and operating profit per location. The total workforce count includes information regarding percent of employee population, regular employees per location, contingent employees per location, total employees per location, a revenue per employee, operating expenses per employee and operating profit per employee. The total workforce compensation cost includes information regarding percent of regular employee compensation costs, percent of total workforce compensation costs, average compensation costs per regular exempt and non-exempt employee, average compensation costs per contingent employee as well as an overall average compensation cost per employee.

The Saratoga benchmark comparison (no growth) at 1104 may include information regarding regular employees per HR FTE ratio (i.e., excluding training & Payroll, Time & Attendance), expected HR spending per employee (i.e., excluding training & Payroll, Time & Attendance), as well as expected HR spending as a percentage of operating expense (excluding training & Payroll, Time & Attendance). The Saratoga benchmark comparison (with growth) at 1106 may include information regarding regular employee per HR FTE ratio, expected HR spending per employee, and expected HR spending as a percentage of operating expense, where the above information may be provided excluding training & Payroll, Time & Attendance information. The cost per FTE information at 1100 and business financial analysis information at 1102 may be provided, broken down by each business unit, for example, business unit #1-business unit #8, as a business unit average, as HR SSC, as corporate HR, and as a total. The information regarding the Saratoga benchmark comparisons at 1104 and 1106 may be provided, for example, as a client estimate, third quartile, median, and first quartile breakdown as well as a summary.

FIG. 11B is an exemplary user interface display which may be provided by the transformation opportunity indicator regarding the As-is activity analysis information. The As-is activity analysis may include information regarding a summary of the results of various data entered through the As-Is time survey inputs, discussed above with reference to FIG. 9C, and illustrates various calculations of the total HR FTEs and HR labor cost for each HR process and activity. For example, as shown in FIG. 11B, a summary of As-Is activity analysis information for the various HR activities is shown at 1110, as well as a breakdown for particular HR sub-functions shown at 1112.

For example, as illustrated at the summary 1110, general information regarding As-Is activity analysis is provided for HR sub-functions in summary format for recruiting, deployment/redeployment, time & attendance, training & development, performance management, compensation & benefits, employee relations, organization effectiveness, HR management, knowledge management, HR IS, payroll and vendor management activity areas for HR. Further, at 1112, summary information provided by 1110 may be further broken down by the particular HR sub-function. For example, at recruiting 1112, information regarding design and developing recruiting strategy and policies, conducting labor market reviews, design employment branding and marketing, identifying open positions to be filled, processing open position job requisitions, operating internship programs, designing and implementing community employment programs as well as sourcing candidates information may be provided. The recruiting sub-function information may further include screening applicants, coordinating re-employment testing and background checks, interviewing candidates, making offer decisions and offer jobs to candidates, processing job offers and rejections, referrals, internal transfers, recording hires and internal transfers, providing orientation programs to new hires and/or internal transfers, providing relocation services, managing college recruiting and contract and temporary labor. The summary information at 1110 as well as the breakdown for the particular HR activity at 1112, may be provided as exempt FTEs and non-exempt FTEs for the business units, HR SSC, corporate HR, as well as a grand total for both total exempt FTEs and total non-exempt FTEs, as well as a grand total FTEs. Further, costs may be provided for the summary 1110 and breakdown, for example, recruiting at 1112, information for both exempt and non-exempt costs regarding the business units, HR SSC, corporate HR, as well as total costs.

Although not shown in FIG. 11B, additional HR sub-functions may be broken down by each sub-function, similar to as discussed above with respect to the As-is recruiting sub-function 1112. For example, additional HR sub-function information regarding recruiting, time and attendance, training and development, performance management, compensation and benefits, employee relations, organization effectiveness, HR management, knowledge management, HR information systems and reporting, payroll and vendor management HR sub-functions may be provided, for example, as discussed above with respect to FIG. 9B.

FIG. 11C illustrates an exemplary user interface display which may be utilized by the business opportunity indicator to provide information and analysis regarding As-is organization sizing information. The As-is organization sizing information may be a summary of the results of various data entered with regards to the labor sourcing strategy information discussed above with regard to FIG. 9D. Such information may indicate a summary of the clients current state HR FTEs and labor costs, as well as HR activities, FTEs, and labor costs which may transition to the outsource (for outsourcing cases). The information may further provide a summary of various HR costs retained by the client, and a reduction in retained HR activities, FTEs, and labor cost achieved by the client as a result of internal transformation initiatives. The transformation team may provide this information to a client for a detailed client sourcing and FTE change review prior to finalizing business case estimate(s).

As shown in FIG. 11C, the As-is organization sizing information may include information regarding HR sub-functions, for example, the recruiting sub-function at 1120. The recruiting information 1120 may be broken-down as various recruiting sub-functions as discussed above with respect to the labor sourcing strategy of FIG. 9D. The various recruiting information at 1120 may be provided as a current FTE total, current labor cost total, outsource baseline FTEs, outsource baseline cost, insource baseline FTEs, insource end-state FTEs, and insource FTE change. Although not shown, the recruiting information at 1120 may also be provided with respect to insource baseline cost, insource end-state cost, and insource cost change.

Further, although not shown in FIG. 11C, information regarding additional HR functions and sub-function break-downs may further be provided, similar to those discussed above with respect to the labor sourcing strategy at FIG. 9D. For example, information regarding deployment/redeployment/staffing, time & attendance, training & development, performance management, compensation and benefits, employee relations, organization effectiveness, HR management, knowledge management, HR information systems and reporting, payroll and vendor management HR sub-functions may be provided.

Second Embodiment Modeling

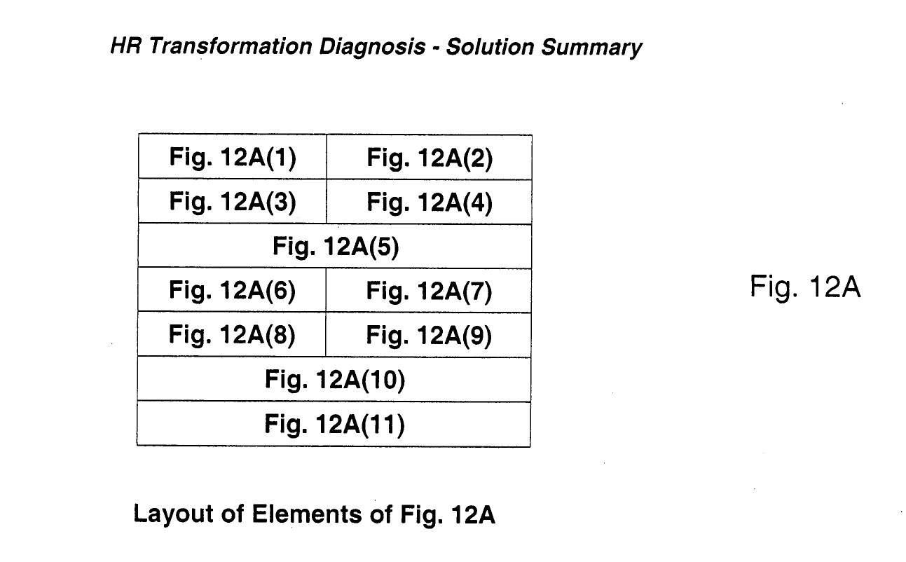

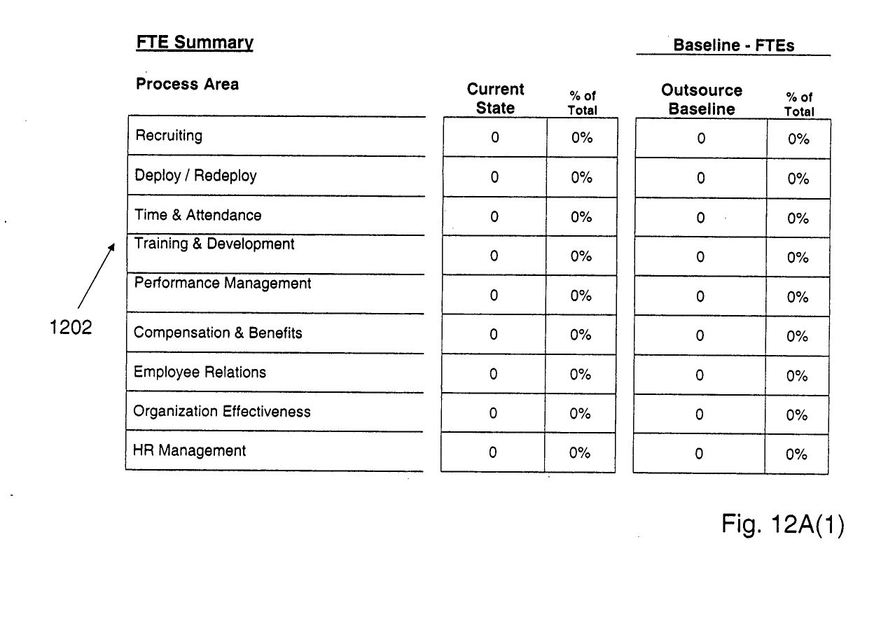

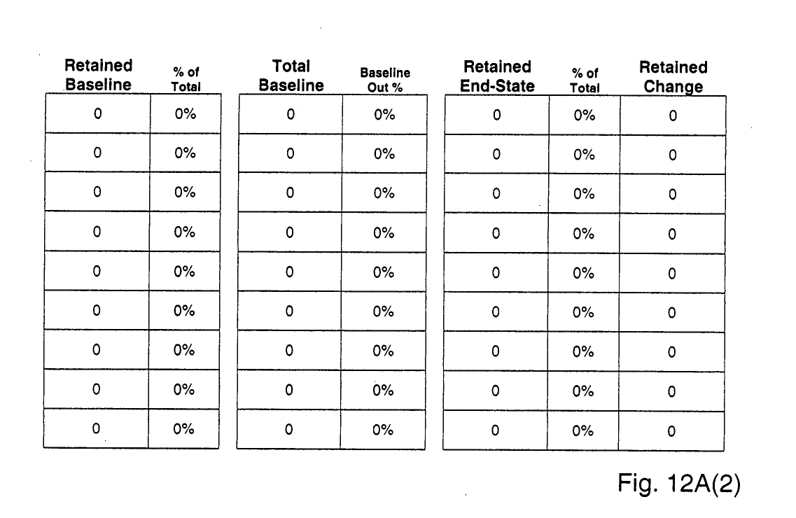

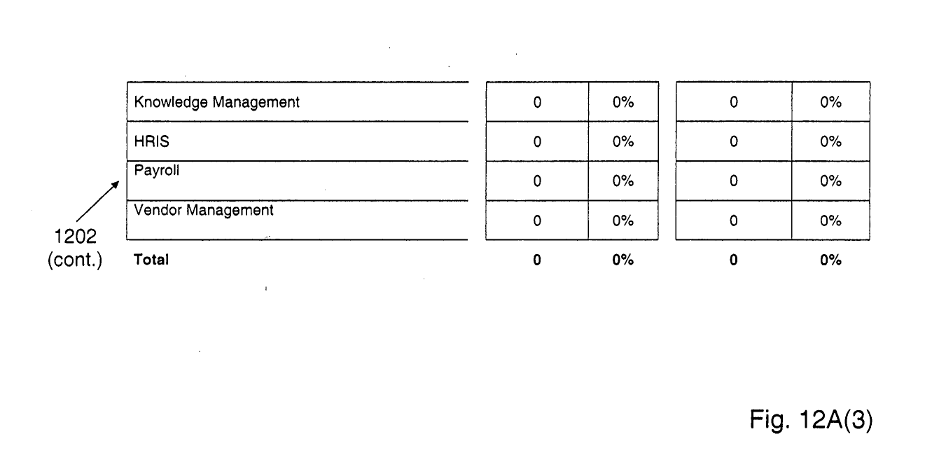

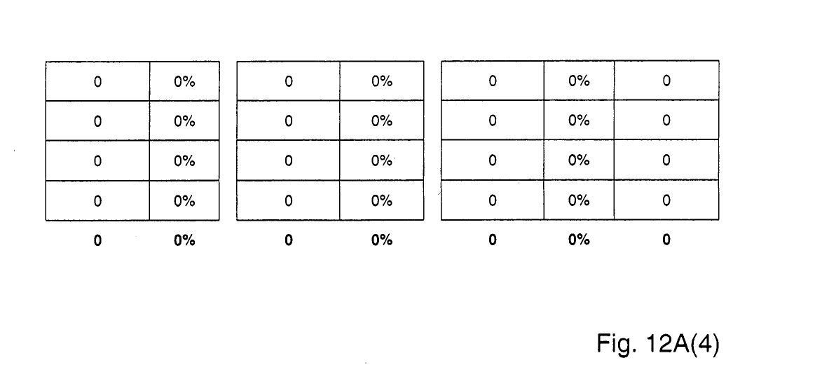

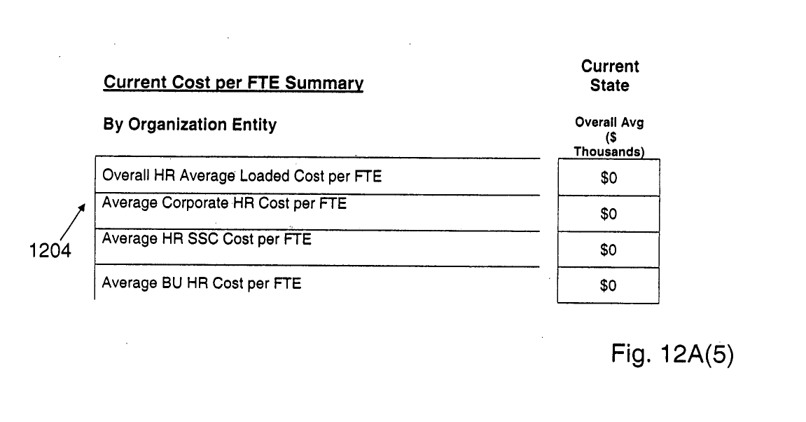

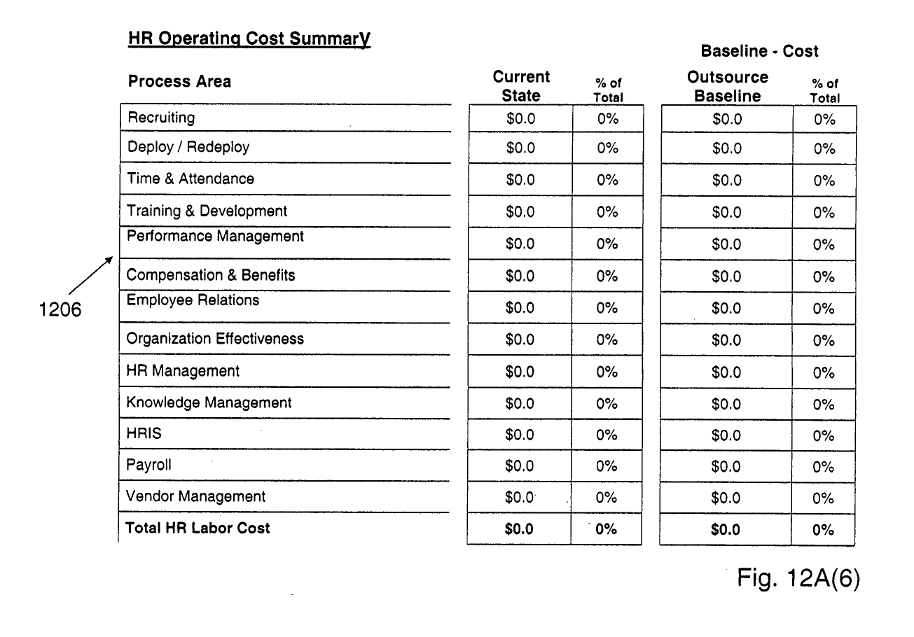

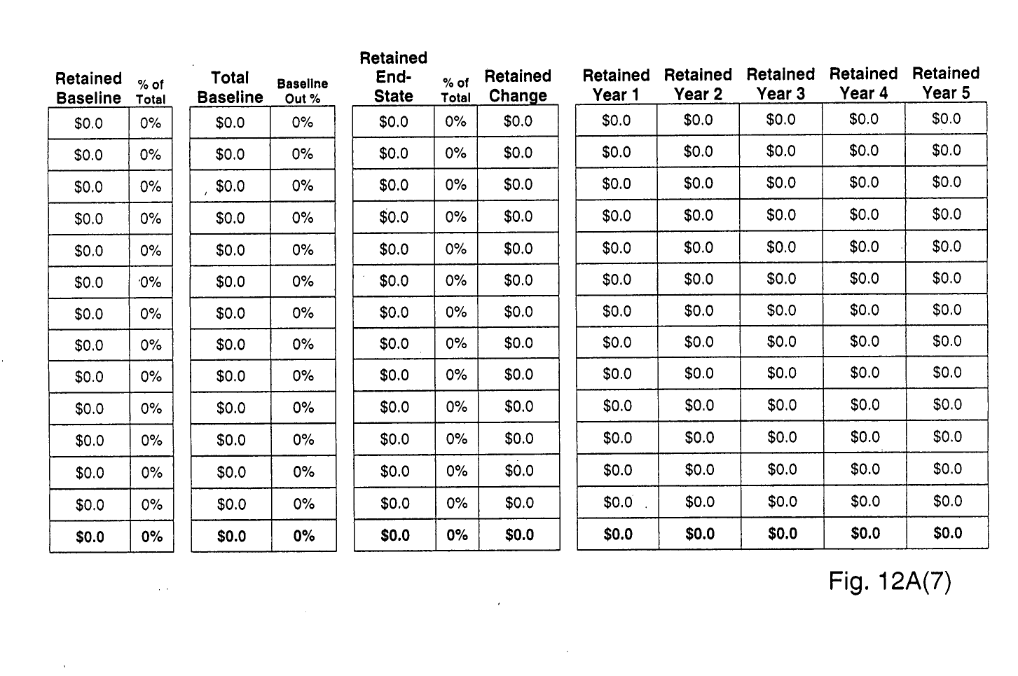

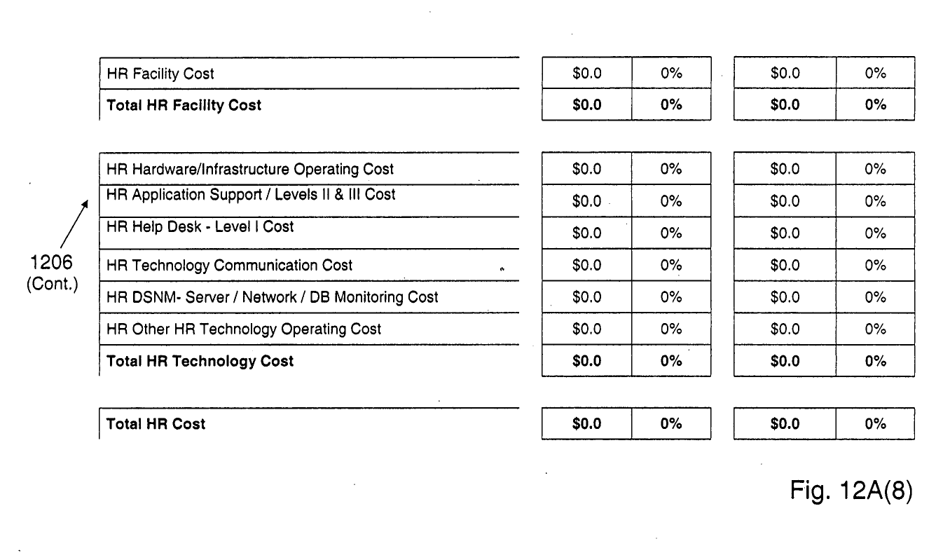

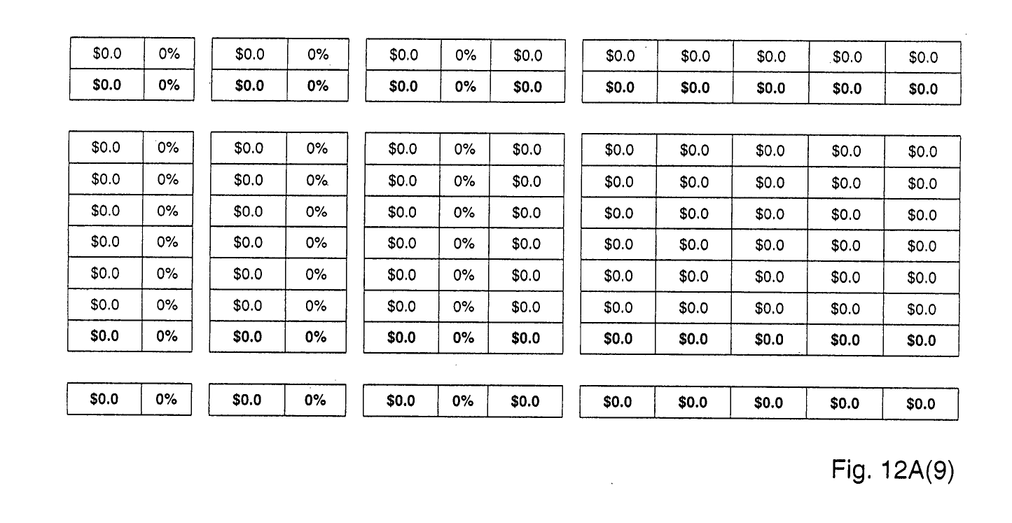

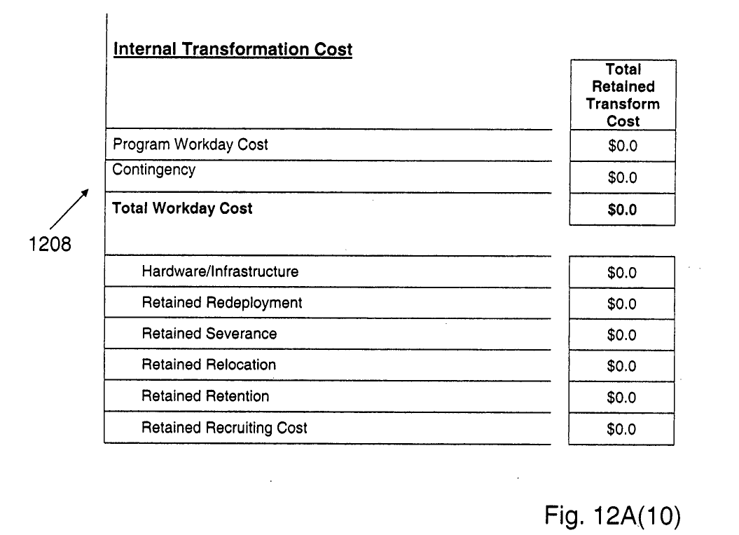

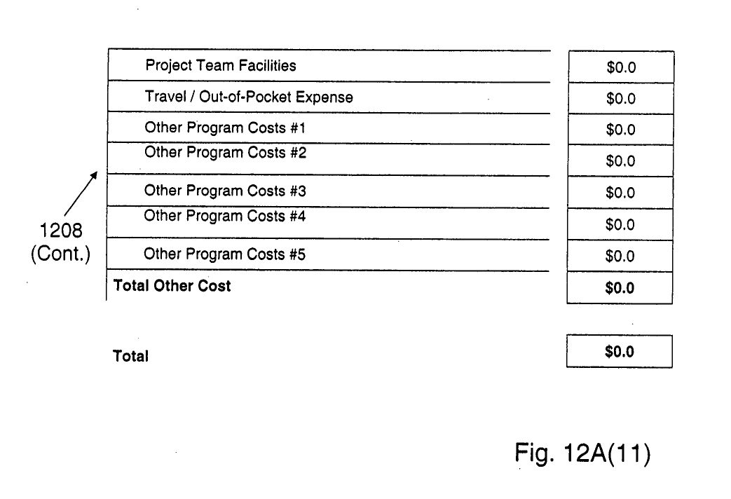

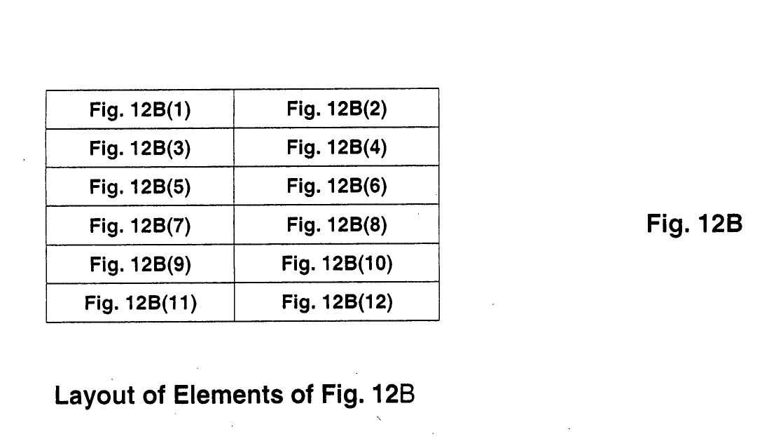

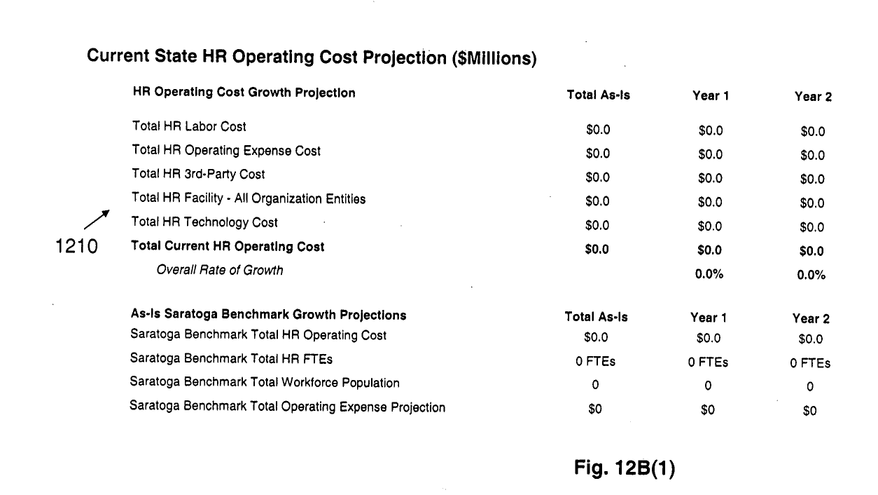

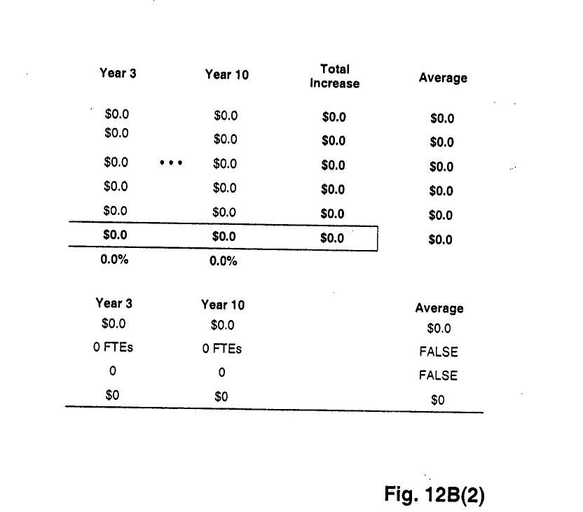

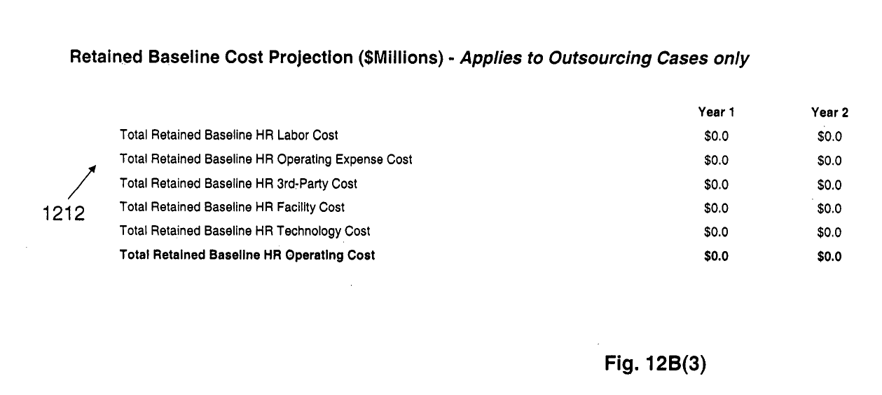

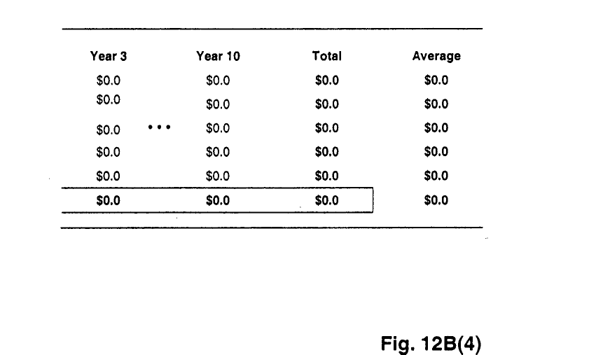

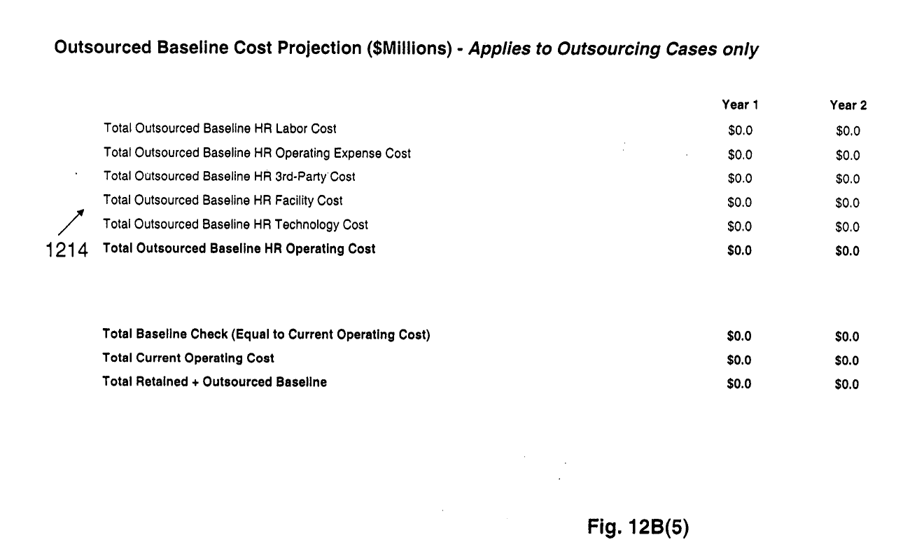

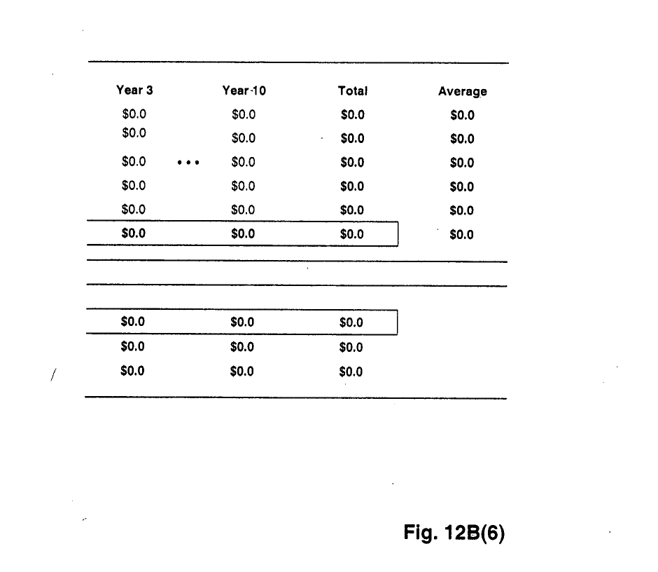

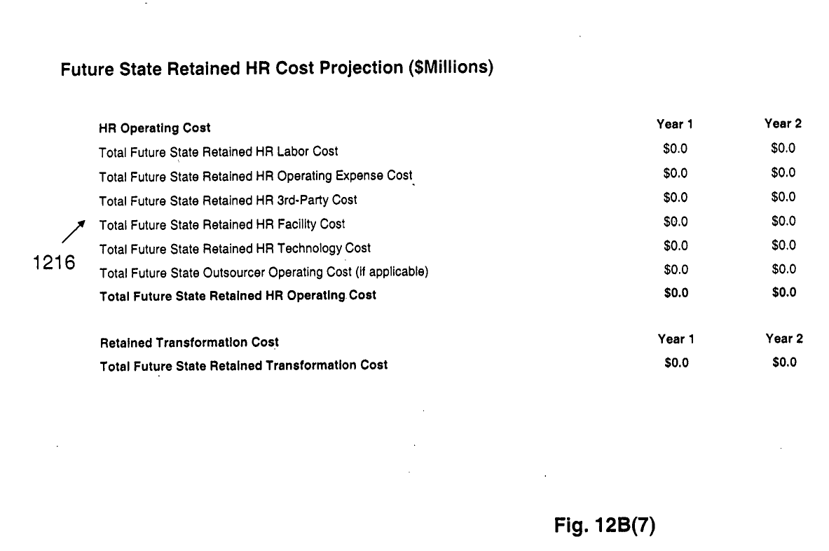

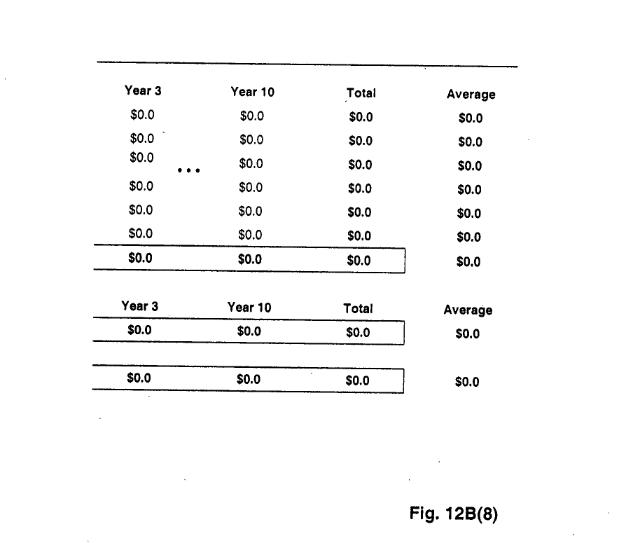

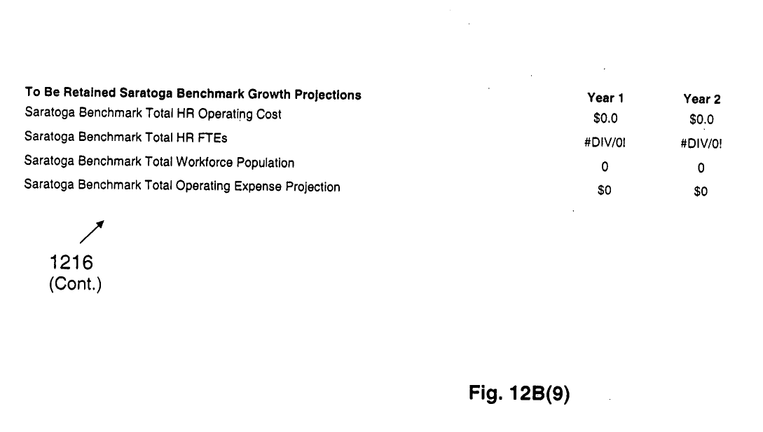

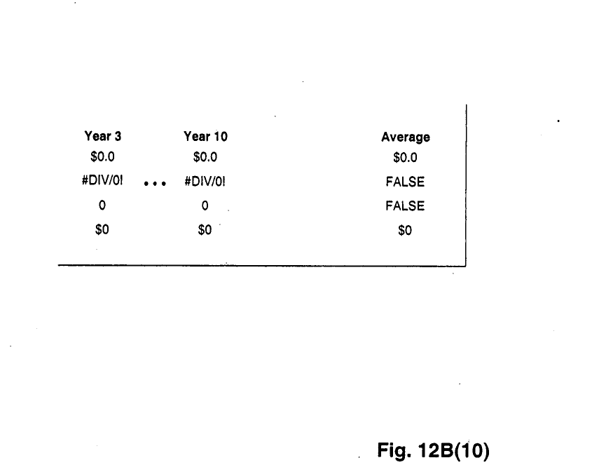

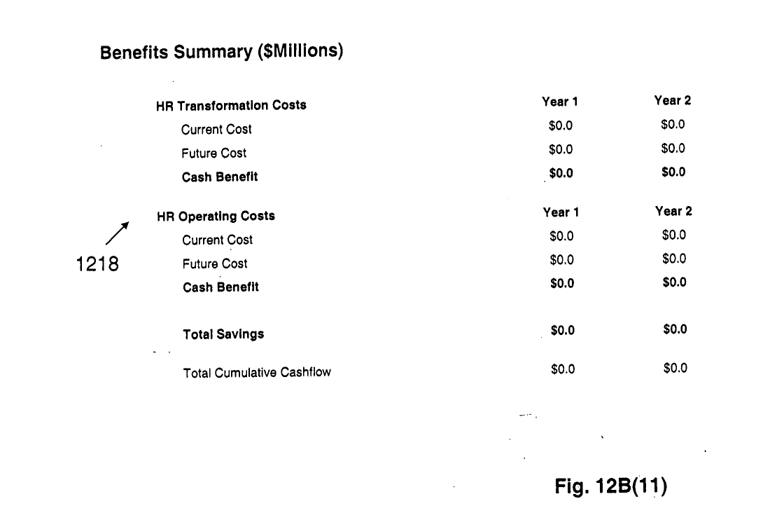

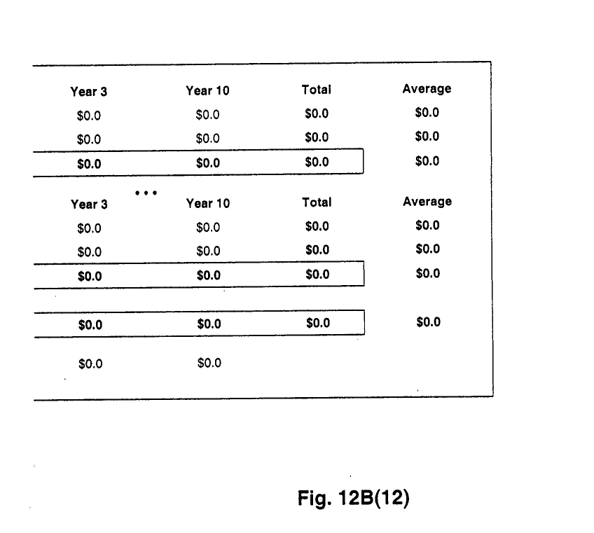

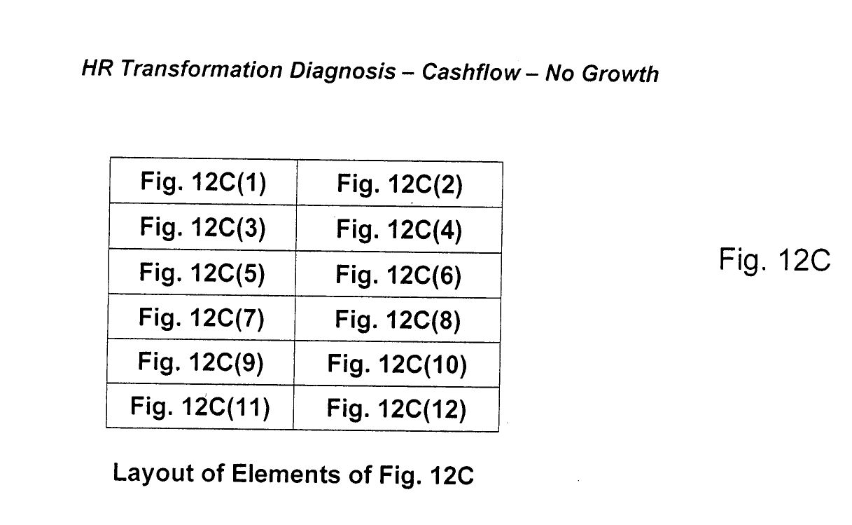

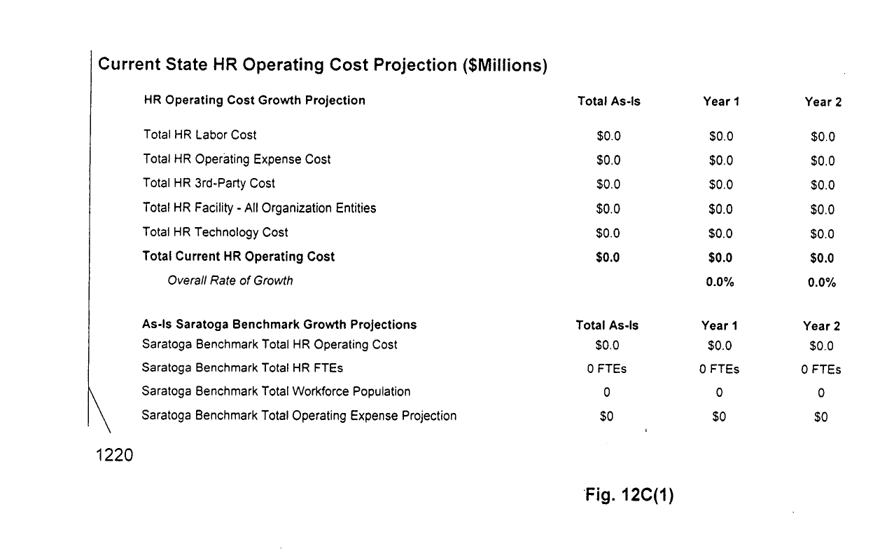

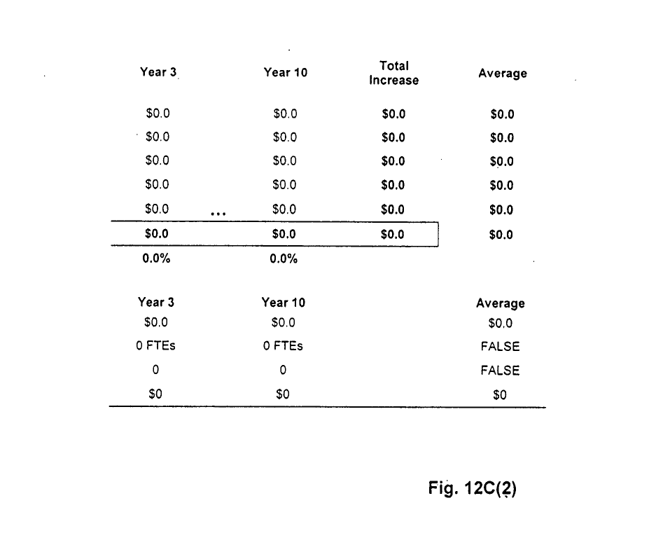

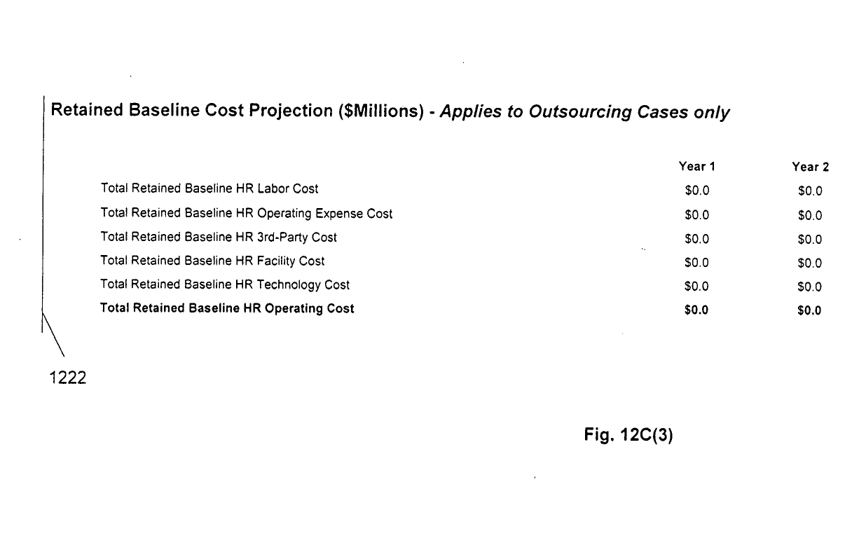

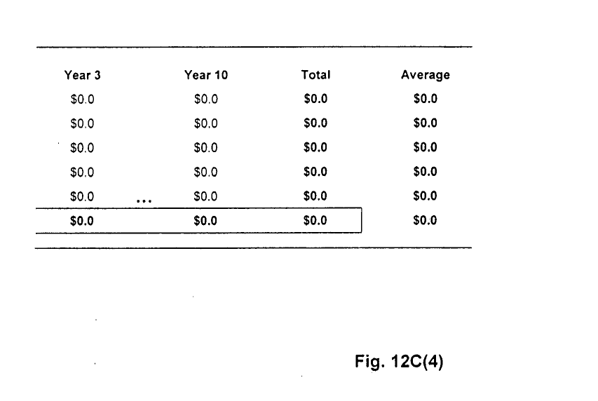

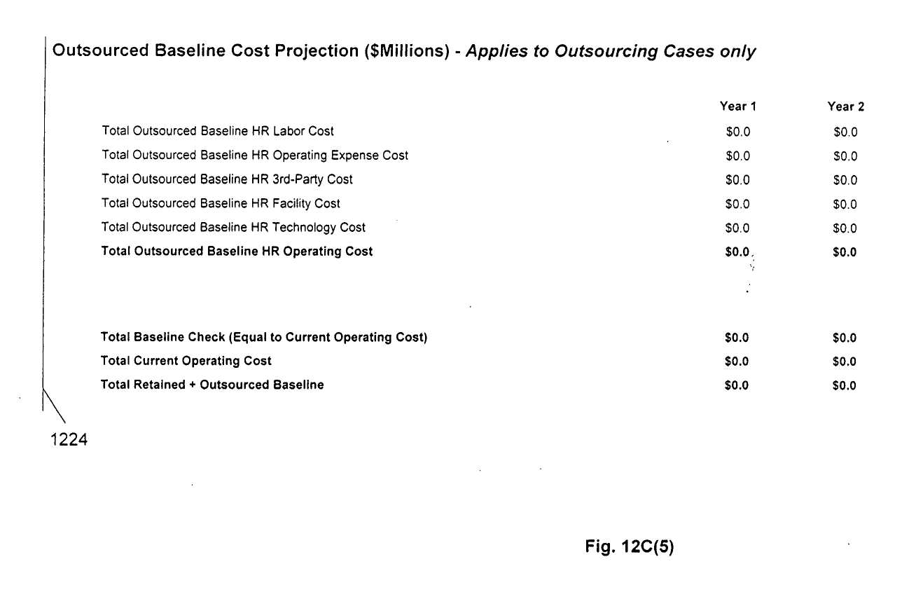

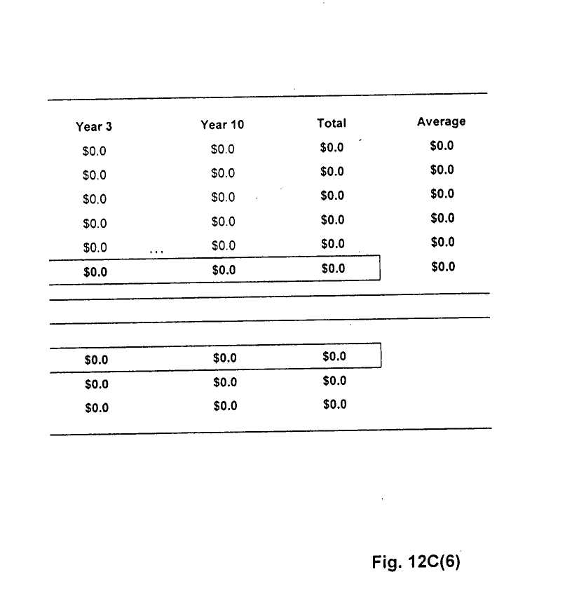

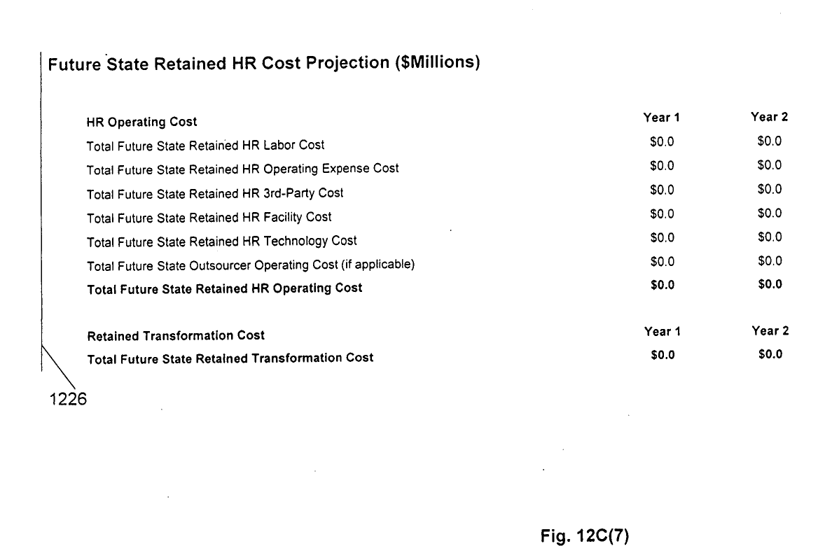

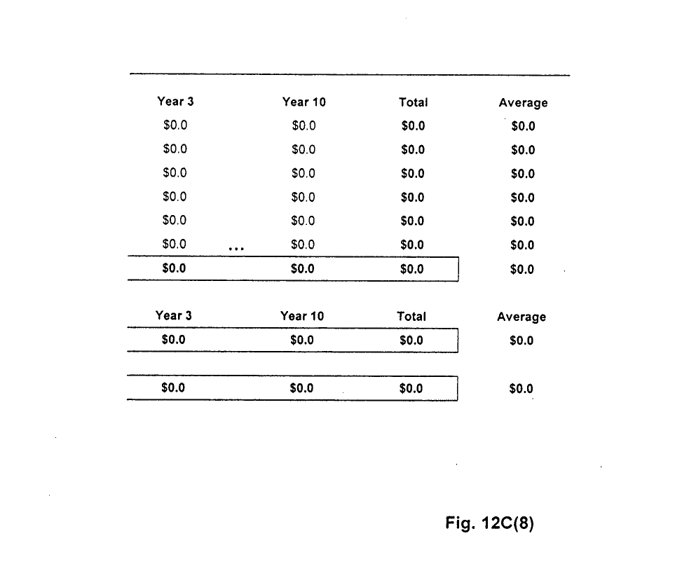

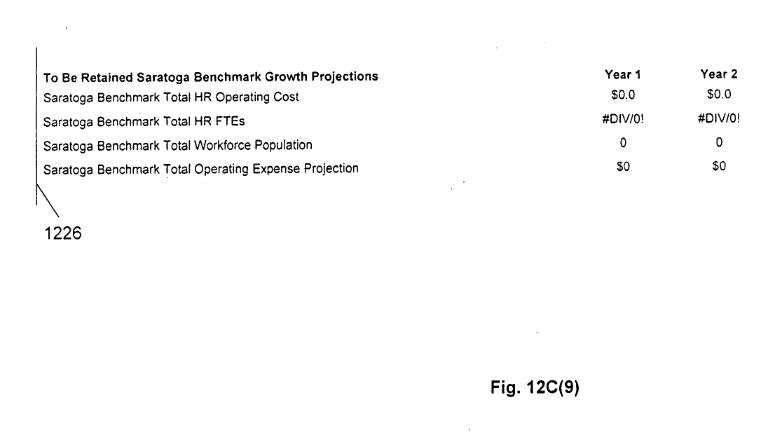

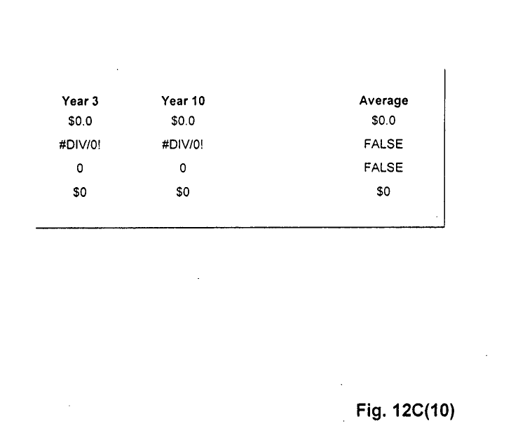

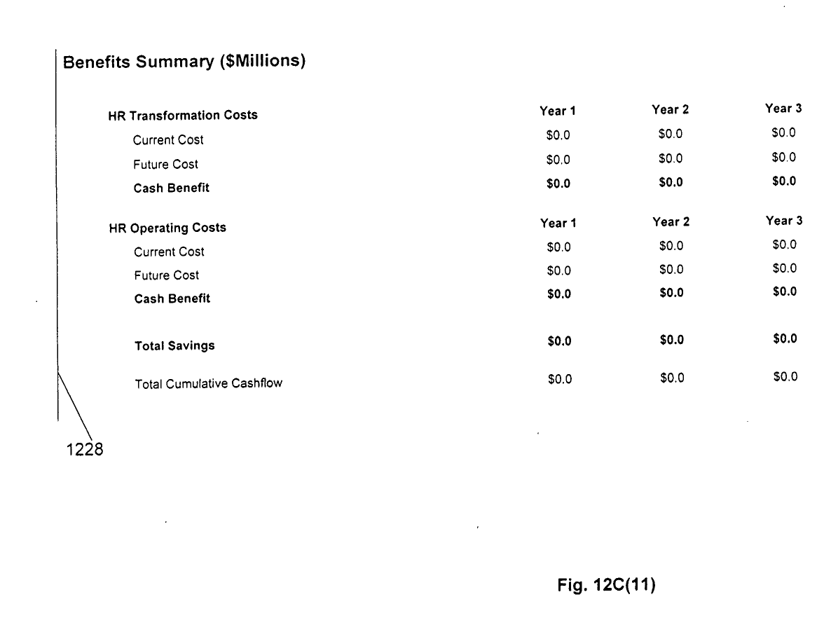

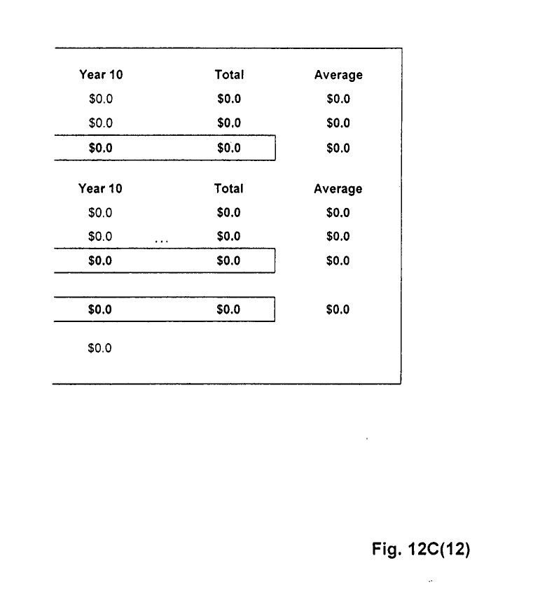

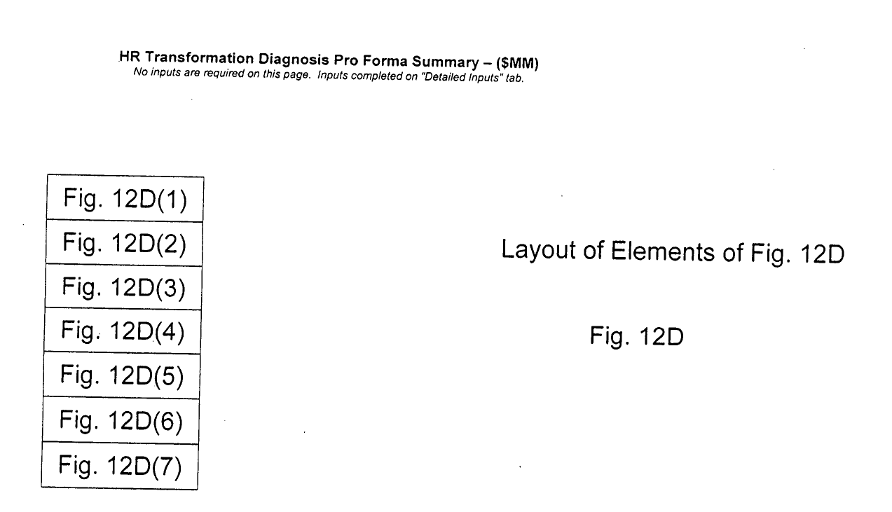

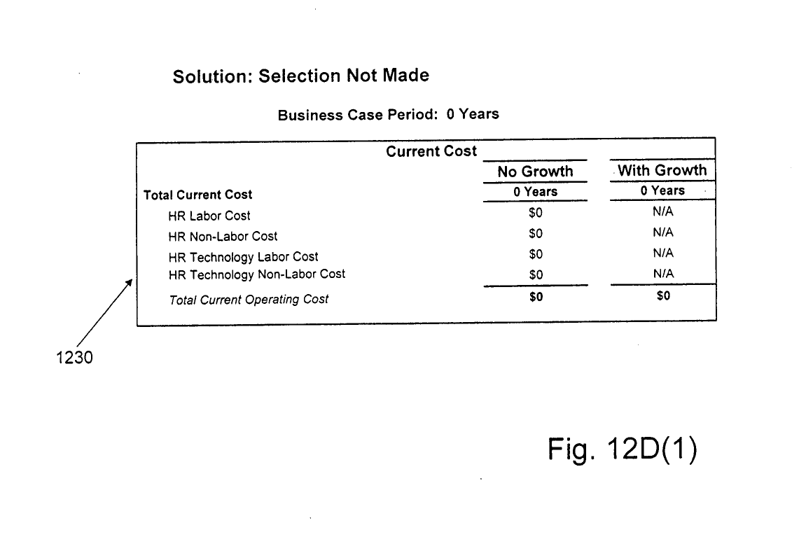

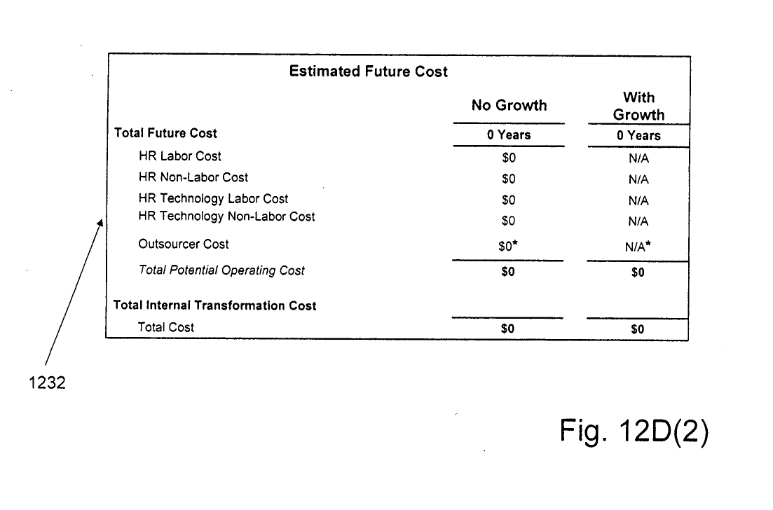

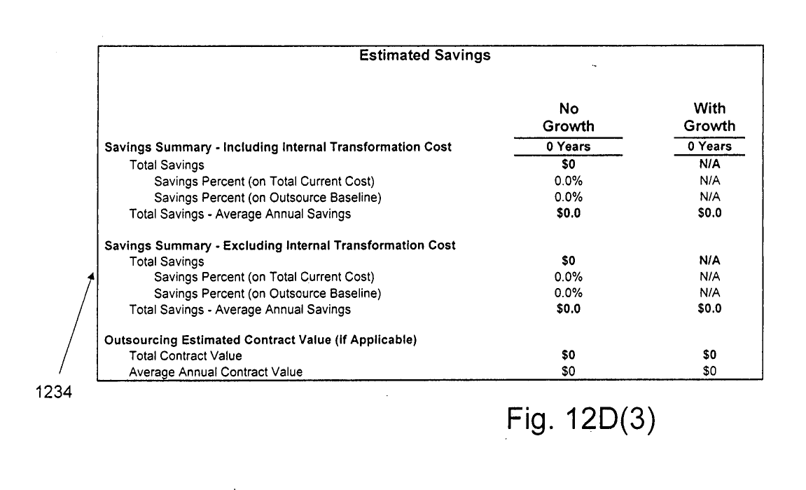

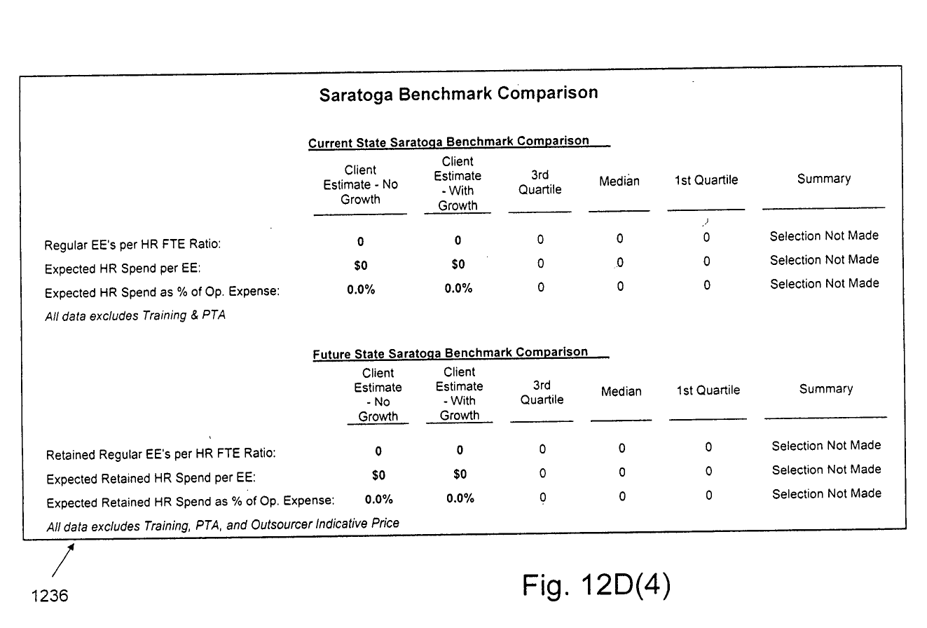

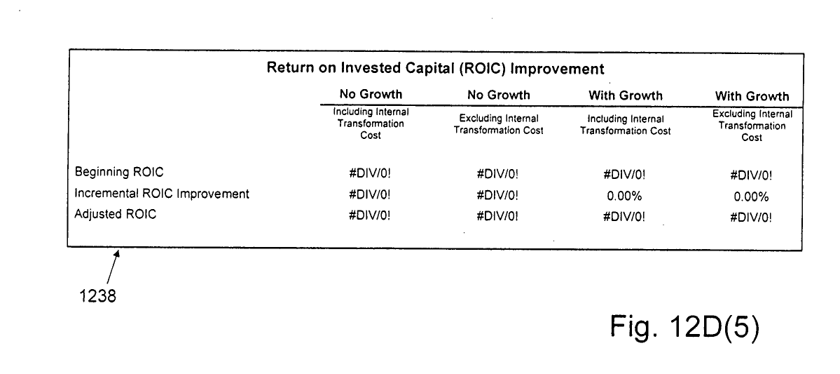

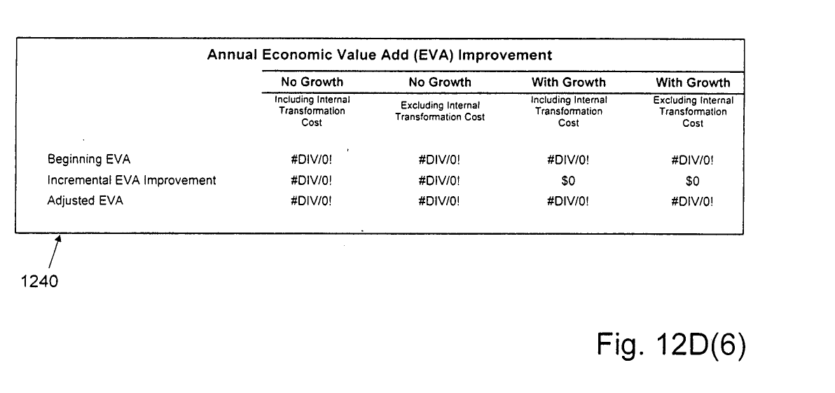

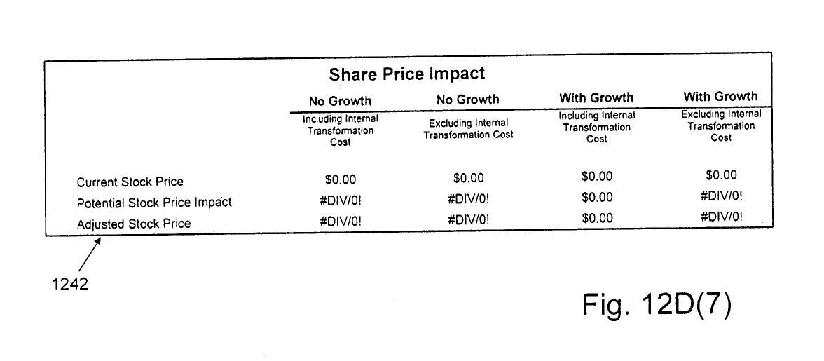

Once the analyzing of the at least one data input in light of at least one industry threshold has been accomplished at box 805 of FIG. 8, a transformation scenario is modeled as shown at box 810. The transformation scenario model may be presented as at least one of a solution summary, cash flow-with growth and cash flow-no growth summaries, and as a pro forma summary as will be discussed below with respect to FIGS. 12A-12D.

FIG. 12A is an exemplary user interface display which may be provided by the business opportunity indicator indicating a solution summary. The solution summary may summarize at a high level the transition of FTEs and cost from the client to the outsource (i.e., for outsourcing cases), and the change from current to future FTEs and costs retained by the client (i.e., for both internal transformation and outsourcing transformation), effectively providing a summary “before” and “after” picture of the particular transformation scenario, rather than a detailed cash flow view.

As shown in FIG. 12A, the solution summary may include information regarding an FTE summary for process area indicated at 1202, a current cost per FTE summary indicated at 1204, an HR operating cost summary at 1206, and an internal transformation cost at 1208.

The FTE summary at 1202 may include information regarding HR process areas such as recruiting, deploy/redeploy, time & attendance, training & development, performance management, compensation & benefits, employee relations, organization effectiveness, HR management, knowledge management, HR IS, payroll and vendor management sub-functions. The FTE summary at 1202 for each process area may be provided as a break-down by current state, and baseline-FTEs regarding outsource baseline and percentage of total, retained baseline and percentage of total, as well as total baseline and baseline outsource percentage. The FTE summary information may further be broken down by retained and state, a percentage of the total, and retained change.

The current cost per FTE summary at 1204 may include current state costs by organization, for example, overall HR average loaded cost per FTE, average corporate HR cost per FTE, average HR SSC cost per FTE, and average business unit HR cost per FTE.

The HR operating cost summary at 1206 may include information regarding various process areas and costs related thereto. For example, information regarding the HR sub-functions of recruiting, deploy/redeploy, time & attendance, training & development, performance management, compensation & benefits, employee relations, organization effectiveness, HR management, knowledge management, HR IS, payroll and vendor management may be provided. Further, although not shown in FIG. 12A, additional information regarding the above-discussed process areas/sub-functions may further be provided for operating expenses and 3rd-party expenses as well. The HR operating cost summary at 1206 may further include HR facility costs, as well as HR hardware/infrastructure operating costs, HR application support/levels II & III cost, HR helpdesk-level I cost, HR technology communication costs, HR DSNM-server/network/DB monitoring cost, as well as other HR technology operating costs.

The information regarding the HR operating cost summary at 1206 may be provided as a current state, and a percentage of total, as baseline-costs, including outsource baseline and percentage of total, retained baseline and percentage of total, total baseline and baseline outsource percent. Further, the HR operating cost summary information at 1206 may be provided as a retained and state and percent of total, retained change, and retained costs over a particular number of years, for example, year 1-year 5.

The internal transformation cost at 1208 may include information regarding program workday cost, contingency, hardware/infrastructure, retained costs such as retained deployment, severance, relocation, retention and recruiting costs, cost information regarding transformation team facilities, travel/out-of-pocket expenses, as well as other program costs regarding #1, #2, #3, #4, and #5. The internal transformation costs at 1206 may be presented as a total retained transformation cost.

FIG. 12B is an exemplary user interface display which may be utilized in providing information regarding a cash flow-with growth for the business organization. The cash flow-with growth information may summarize the detailed “growth” cash flow view of a business case for the business organization based on various inputs made in the transformation opportunity indicator. Cash flow-growth shows information regarding the impact to operating costs caused by business growth cycles during the business case period. This view may include current, outsource/retained baseline costs, future state retained costs, transformation costs, and savings estimates.

As shown in FIG. 12B, cash flow with growth information may be provided including a current state HR operating cost projection at 1210, retained baseline costs projection at 1212, outsourced baseline cost projection at 1214, future state retained HR cost projections at 1216, and a benefit summary at 1218.

The current state HR operating cost projection at 1210 may include information regarding HR operating cost growth projection, such as total HR labor costs, operating expense costs, 3rd-party costs, facility-all organization entities costs, and technology costs. Further, the current state HR operating cost projections may include As-is Saratoga benchmark growth projections, including Saratoga benchmark total HR operating costs, total HR FTEs, total workforce population, and total operating expense projections.

The current state operating cost projections at 1210 may be provided as a total As-Is, as well as a breakdown over a particular period of time, for example, year 1-year 10, and as a total increase, and an average.

The retained baseline costs projection at 1212, may include information regarding total retained baseline costs such as for HR labor, HR operating expenses, HR 3rd-party, HR facility and HR technology costs. Such information may be provided over a particular period of time, for example, year 1-year 10, as a total, and as an average.

The outsourced baseline cost projections at 1214 may be provided, for example, as a total outsourced baseline costs for HR labor, HR operating expenses, HR 3rd-party, HR facility and HR technology costs, as well as total current operating costs and total retained plus total outsourced baselines. Such information may be provided over a predetermined amount of time, for example, year 1-year 10, as well as a total and average.

The future state retained HR cost projection may include information regarding HR operating costs such as total future state retained costs regarding HR labor, HR operating expenses, HR 3rd-party, HR facility, HR technology as well as a total future state outsource or operating cost (i.e., where applicable). Further, the future state retained HR cost projections at 1216 may further include information regarding To-Be retained Saratoga benchmark growth projections, such as Saratoga benchmark totals regarding HR operating costs, HR FTEs, workforce population, and operating expense projection. The information for the future state retained HR cost projections at 1216 may be presented over a period of time, for example, year 1-year 10, as well as providing a total and average cost.

The benefit summary information at 1218 may be provided as current and future costs for HR transformation, HR operating, as well as providing cash benefit and total savings where a particular business case solution scenario recommendation is utilized. Such information may be presented over a particular period of years, for example, year 1-year 10, as well as provided as a total and average cost.

FIG. 12C is an exemplary interface display which may provide information regarding cash flow-no growth analysis. The cash flow-no growth information may summarize the detailed “no growth” cash flow view of the particular business case for the client which may be based on various information received at the transformation opportunity indicator. No impact to operating costs caused by the business growth cycles is typically assumed during the business case period. This cash flow-no growth view may include current, outsource/retained baseline costs, future state retained cost, transformation cost and savings estimates.

As illustrated in FIG. 12C, the cash flow-no growth information may include information regarding a current state HR operating cost projection at 1220, retained baseline cost projection at 1222, outsourced baseline cost projection at 1224, future state retained HR cost projection at 1226, and benefits summary information at 1228. The information provided at each of the current state HR operating cost projection 1220, retained baseline cost projection 1222, outsourced baseline cost projection 1224, future state retained HR cost projection 1226 and benefits summary information at 1228 is similar to those discussed above at FIG. 12B and generally shown at 1210, 1212, 1214, 1216, and 1218, and will not be discussed in detail.

FIG. 12D illustrates an exemplary user interface display illustrating a pro forma summary for a particular transformation scenario solution. The pro forma summary may summarize the overall business case for the client based on various data received at the transformation opportunity indicator. The pro forma business case estimate may summarize a total current cost for the business case period, total future cost (including retained and outsourcing costs, for example, in the case of HR outsourcing), transformation costs, as well as savings. The estimates may be included for “no growth” and “growth” scenarios. Further, a comparison against industry threshold, for example, Saratoga benchmarks, before and after the transition may be provided.

As shown in FIG. 12D, the pro forma summary may include information regarding a current cost at 1230, estimated future cost at 1232, estimated savings at 1234, Saratoga benchmark comparison at 1236, return on invested capital improvement at 1238, annual economic value added improvement at 1240 and share price impact information at 1242.

Current cost information 1230 may include information regarding total current costs and expenses for HR labor, HR operating, HR 3rd-party, HR facility, HR technology, as well as retained baseline and outsourced baseline costs. Such costs may be provided for both no growth and with growth scenarios.

The estimated future costs information 1232 may include total future retained costs for HR labor, HR operating, HR 3rd-party, HR facility, HR technology, and outsourcing costs and expenses. The estimated future costs may be provided for both no growth and with growth scenarios.

The estimated savings information at 1234 may include information regarding a savings summary for the including and excluding internal transformation costs, regarding total savings, savings as a percent (i.e., for total current costs), savings as a percent (for outsourcing baselines), as well as a total average annual savings. Further, outsourcing estimated contract value (i.e., where applicable) may be provided including a total contract value and an average annual contract value. The estimated savings information may be presented for both no growth and with growth scenarios.

The Saratoga benchmark comparison information at 1236 may be provided as a current state Saratoga benchmark comparison with regards to regular employees per HR FTE ratio, expected HR spending per employee, expected HR spending as a percentage of operational expenses, (and for example, may exclude any training and Payroll, Time and Attendance expenses). Further, the Saratoga benchmark comparison information may include future state Saratoga benchmark comparison information, such as information regarding retained regular employees per HR FTE ratio, expected retained HR spending per employee, and expected retained HR spending as a percentage of operational expenses. Similarly, the future state Saratoga benchmark comparison may be made by excluding data regarding training, Payroll, Time & Attendance, and outsourcer indicative pricing. The current state and future state Saratoga benchmark comparison information may be provided as client estimate-no growth, client estimate-with growth, as a third quartile, median, first quartile and summary.

The return on invested capital improvement information at 1238 may include information regarding a beginning, incremental improvement and adjusted return on invested capital improvement. The return on invested capital improvement information at 1238 may be provided as both no growth both including and excluding internal transformation costs, as well as with growth for both including and excluding internal transformation costs.

The annual economic value add improvement at 1240 may be provided as a beginning, incremental improvement and adjusted annual economic value add improvement. The annual economic value add improvement at 1240 may be provided for both no growth and with growth scenarios, in each case including and excluding internal transformation costs.

The share price impact information at 1242 may be provided as a current, potential impact on, and adjusted stock price. Such information may be provided for both no growth and with growth scenarios, and may account for both included and excluded internal transformation costs.

Thus, in accordance with the second embodiment of the invention, the business opportunity indicator is capable of providing a rapid and standardized approach for identifying an HR transformation opportunity. The spreadsheet may provide a plurality of standard input fields that may be used to drive established methods of calculation to generate a financial analysis. A transformation scenario may be modeled, and presented to a user showing various useful information in making a transformation decision for the business organization, including for example, business organization information regarding current costs, estimated future costs, estimated savings if the transformation scenario were to be adopted, an industry benchmark comparison, as well as return on investment capital improvement, annual economic value edit improvement, and shared price impact information if the scenario were adopted. Further, the information may be provided for both business organization growth and no growth scenarios. Such a software tool may reduce the chance of evaluation errors resulting from failure to examine or properly examine one or more of the data inputs used to model a transformation scenario.

Further, surveys may be utilized in soliciting various information from individual or designated employees of the business organization, and/or from transformation team members, for use in modeling the HR transformation scenario. Such survey responses may be collected and tallied at a common location, and may be further automatically provided to the transformation opportunity indicator, for example by populating various data fields of the data inputs for example discussed above with respect to FIGS. 9A-9H.

Because the various data inputs, analyzing and modeling may be provided as a common software tool (or a plurality of inter-linked tools) the transformation opportunity indicator may be readily updated with up-to-date thinking and best practices regarding assessing HR transformation opportunities, thereby ensuring that the client receives an HR transformation opportunity scenario in accordance with current (and not outdated) HR transformation assessment strategic thinking.

The above embodiments may include additional features consistent with the detailed description that illustrates various aspects and details of the invention and its preferred implementation. This detailed description is intended to illustrate, but not to limit the invention. One of ordinary skill in the art may modify these embodiments in view of the following techniques and be within the intended scope of the invention. The above-discussed written description, which is directed mainly to modeling a transformation scenario by a transformation opportunity indicator and/or providing a transformation opportunity indication, may be readily adapted for use in any business industry/organization, based on the particular needs of the organization. Thus, this description may be applied to, and implemented in any business industry/organization using the teachings described herein.

The benefits just described are merely exemplary, as further benefits and advantages may be gained from utilizations of the teachings described herein. Further, in some circumstances, less than all of the teachings may be utilized while still attaining benefits and advantages.

The above description was mainly directed to multiple embodiment of the invention of a business opportunity indicator, where the business opportunity indicator is capable of receiving at least one business organization data input, analyzing the at least one data input in accordance with at least one industry threshold, and modeling a transformation opportunity scenario responsive to the modeling. However, one skilled would realize that some or all of the teachings, analyzing, modelings, etc. described herein could be applied to, and used for, modeling a transformation opportunity scenario for any business process software for any business industry/organization in accordance with the methodologies described herein, and still fall within the scope of the invention.

While this invention has been shown and described in connection with a preferred embodiment, it is apparent that certain changes and modifications in addition to those mentioned above may be made from the basic features of this invention. In addition, there may be many different types of computer software and hardware that may be utilized for practicing the invention, and the invention is not limited to the examples described above. Accordingly, the described embodiments are to be considered in all respects only as illustrative and not restrictive, and the scope of the invention is therefore indicated by the appended claims rather than the foregoing description. All changes that come within the scope and range of the equivalency of the claims are to be embraced within their scope.

1. A system for identifying a business organization transformation opportunity, comprising:
a controller programmed for receiving at the system a plurality of business organization data inputs, analyzing at least one of the business organization data inputs in accordance with at least one industry threshold, and modeling a business organization transformation opportunity scenario with respect to a particular function of the business organization responsive to the analysis;
a storage device coupled with the controller for storing at least one business organization data input received at the controller; and
a user interface coupled with the controller for receiving and presenting data and information to a user of the business opportunity indicator.

2. The system of claim 1, wherein the controller being programmed for modeling a business organization transformation opportunity scenario includes the controller being programmed for modeling a business organization human resources transformation scenario.

3. The system of claim 1, wherein the controller being programmed for modeling a business organization transformation opportunity scenario includes the controller being programmed for modeling a business organization transformation scenario including at least one of a broad-outsourcing transformation scenario, an internal transformation scenario, and a mixed outsourced and internal transformation scenario.

4. The system of claim 1, wherein the controller is further programmed for providing a cost savings estimate corresponding to implementation of the modeled transformation scenario.

5. The system of claim 1, wherein the controller being programmed to receive at least one business organization data input includes the controller being programmed to receive at least one of the plurality of business organization data inputs from a survey.

6. The system of claim 5, wherein the controller being programmed to receive at least one of the plurality of business organization data inputs from a survey includes the controller for being programmed for receiving at least one of the plurality of business organization data inputs from an HTML survey.

7. The system of claim 1, wherein the controller includes a microprocessor for executing programmed code stored at the storage device.

8. The system of claim 7, wherein the programmed code is a spreadsheet for execution on a spreadsheet program.

9. The system of claim 1, wherein the at least one industry threshold includes information regarding at least one of a number of employees desired for performing a particular function of the business organization, cost information for transforming the particular function, labor information for transforming the particular function, and technology information for transforming the particular function.

10. A system for human resource transformation analysis, comprising:
means for receiving information associated with a plurality of financial and business organization function-based metrics of a business organization;
means for providing responses to a set of queries associated with the metrics;
means for comparing at least one metric at least one with industry threshold for an industry associated with the business organization; and
means for modeling a transformation scenario with respect to a particular function of the business organization responsive to the means for comparing.

11. The system of claim 10, wherein the business organization function-based metrics include business organization human resources function metrics.

12. The system of claim 10, further comprising means for determining a savings estimate for the business organization if the modeled transformation scenario is adopted.

13. The system of claim 10, further comprising:
means for identifying a plurality of differences between the metrics and the industry thresholds;
wherein the means for modeling the transformation scenario includes means for modeling the transformation scenario responsive to at least one of the plurality of differences between the metrics and the industry thresholds.

14. The system of claim 10, wherein the at least one industry threshold includes information regarding at least one of a number of employees desired for performing a particular function of the business organization, cost information for transforming the particular function, labor information for transforming the particular function, and technology information for transforming the particular function.

15. A memory embodied on a computer readable media programmed for use on a suitable processor and capable of modeling a business organization transformation scenario, the memory comprising:
a first memory portion programmed for receiving a plurality of business organization data inputs;
a second memory portion programmed for analyzing at least one of the business organization data inputs in accordance with at least one industry threshold; and
a third memory portion programmed for modeling a business organization transformation opportunity scenario with respect to a particular function of the business organization responsive to the analysis.

16. The memory of claim 15, wherein the third memory portion programmed for modeling a business organization transformation opportunity scenario includes being programmed for modeling a business organization human resource transformation opportunity scenario responsive to the analysis.

17. The memory of claim 15, wherein the third memory portion programmed for modeling a business organization transformation opportunity scenario includes being programmed for modeling at least one of a broad-outsourcing, internal, and mixed outsourcing and internal transformation scenario responsive to the analysis.

18. The memory of claim 15, further comprising a fourth memory portion programmed for providing a savings estimate for the business organization if the modeled transformation scenario is implemented.

19. The memory of claim 15, wherein the second memory portion being programmed to analyze at least one business organization data input in accordance with an industry threshold includes the second memory portion being programmed to analyze at least one of the business organization data inputs in accordance with information including at least one of a number of employees desired for performing a particular function of the business organization, cost information for transforming the particular function, labor information for transforming the particular function, and technology information for transforming the particular function.

20. A method of identifying a business organization transformation opportunity using a software tool operating on a computer, comprising:
receiving at the software tool a plurality of business organization data inputs;
analyzing at least one of the business organization data inputs in accordance with at least one industry threshold; and
modeling a business organization transformation opportunity scenario with respect to a particular function of the business organization responsive to the analysis.

21. The method of claim 20, wherein the receiving business organization data inputs includes receiving data including at least one of current general client data, client growth rate assumptions, client human resource operating cost data, client activity analysis information, and implementation cost estimate assumptions.

22. The method of claim 20, wherein the receiving a plurality of business organization data inputs includes receiving at least one business organization input from a user entering the at least one business organization data input at the software tool.

23. The method of claim 20, wherein the receiving a plurality of business organization data inputs includes receiving at least one business organization input from a tool related to the software tool.

24. The method of claim 23, wherein the receiving at least one business organization input from the related tool includes receiving at least one business organization input from an HTML survey.

25. The method of claim 24, wherein the receiving at least one business organization input from an HTML survey includes prompting a user of the HTML survey for at least one of the business organization data inputs.

26. The method of claim 23, further comprising providing to the software tool the at least one business organization data input received at the related tool.

27. The method of claim 26, wherein the providing to the software tool the at least one business organization data input received at the related tool includes:
receiving at a database the at least one business organization data input; and
receiving at the software tool the at least one business organization data input from the database.

28. The method of claim 26, wherein the providing to the software tool the at least one business organization data input received at the related tool includes:
generating a related tool report responsive to at least one business organization data input received at the related tool; and
entering information regarding at least one business organization data input from the related tool report at the software tool.

29. The method of claim 20, wherein the analyzing the at least one of the business organization data inputs in accordance with at least one industry threshold includes:
generating at the software tool current metric information indicating a current state of the business organization; and
generating at the business organization opportunity indicator end-state summary information indicating a state of the business organization if a modeled transformation scenario is initiated.

30. The method of claim 20, wherein the modeling the business organization transformation opportunity scenario includes modeling at least one of a broad-outsourcing transformation scenario, internal transformation scenario, and a mixed transformation scenario for the particular function of the business organization.

31. The method of claim 30, wherein:
modeling the broad-outsourcing transformation scenario includes modeling the broad-outsourcing transformation scenario to outsource at least a pre-selected upper bound of a particular function of the business organization;
modeling the mixed transformation scenario includes modeling the mixed transformation scenario to outsource between a pre-selected lower bound and the pre-selected upper bound of the particular function of the business organization; and
modeling the internal transformation scenario includes modeling the internal transformation scenario to outsource less than the pre-selected lower bound of the particular function of the business organization.

32. The method of claim 31, wherein the modeling of the at least one of a broad-outsourcing transformation scenario and a mixed transformation scenario for the particular function of the business organization includes outsourcing at least one sub-function of the particular function of the business organization.

33. The method of claim 31, wherein the modeling of the at least one of the mixed and internal transformation scenarios includes internally restructuring at least some of a remaining portion of the particular function of the business organization.

34. The method of claim 33, wherein the restructuring of the at least one of the mixed and internal transformation scenarios for the particular function of the business organization includes restructuring at least one sub-function of the particular function of the business organization.

35. The method of claim 20, wherein the modeling the business organization transformation opportunity scenario with respect to a particular function of the business organization includes modeling a human resources business organization transformation opportunity scenario.

36. The method of claim 20, wherein the modeling the business organization transformation opportunity scenario with respect to a particular function of the business organization comprises modeling the business organization transformation opportunity scenario including model information regarding at least one sub-function of the particular function.

37. The method of claim 36, wherein the particular function is a human resource function, and the modeling the business organization transformation opportunity scenario including model information regarding at least one sub-function of the particular function includes modeling the business organization transformation opportunity scenario including information regarding at least one of a recruiting, time and attendance, training and development, performance management, compensation and benefits, employee relations, organization effectiveness, human resources management, knowledge management, human resources information systems and reporting, payroll and vendor management sub-function of the human resource function.

38. The method of claim 20, further comprising:
providing a cost-savings estimate corresponding to use of a modeled business organization transformation opportunity scenario.

39. The method of claim 20 further comprising:
providing alternative modeled business organization transformation opportunity scenarios responsive to the analysis.

40. The method of claim 20, wherein the receiving business organization data inputs includes receiving at least one of business organization data regarding As-is cost data, As-Is time data, To-Be basic data, To-Be labor sourcing data, To-Be non-labor sourcing data, To-Be outsource cost data, retained transition cost data, and retained benefits schedule data.

41. The method of claim 20, wherein the analyzing at least one data input in accordance with at least one industry threshold includes generating at least one of generating As-Is cost analysis information, activity analysis information, and business organization sizing analysis information.

42. The method of claim 20, wherein the modeling a transformation opportunity scenario includes generating at least one of solution summary information, cash flow with growth information, cash flow no growth information, and pro forma summary information.

43. The method of claim 20, wherein the software tool is implemented as a spreadsheet executed in conjunction with a spreadsheet program, and where:
the receiving a plurality of business organization data inputs includes receiving a plurality of business organization data inputs at a data input field of the spreadsheet;
the analyzing at least one of the business organization data inputs in accordance with at least one industry threshold includes performing a calculation between at least one data input field of the spreadsheet, and at least one industry standard provided at an industry standard field of the spreadsheet, the calculation being placed at a respective result field of the spreadsheet corresponding to at least one of the data input and the industry threshold; and
the modeling a business organization transformation opportunity scenario with respect to a particular function of the business organization responsive to the analysis includes providing comparison information between at least one of a business organization data input and an industry threshold, and at least one calculation of corresponding result field.

44. The method of claim 20, wherein the analyzing at least one of the business organization data inputs in accordance with at least one industry threshold includes analyzing at least one of the business organization data inputs in accordance with information regarding at least one of a number of employees desired for performing a particular function of the business organization, cost information for transforming the particular function, labor information for transforming the particular function, and technology information for transforming the particular function.

45. The method of claim 20, wherein the analyzing at least one of the business organization data inputs in accordance with at least one industry threshold includes analyzing at least one of the business organization data inputs in accordance with at least one of an internal threshold regarding information from a transformation organization performing the analysis of the business organization for transformation, and an external industry threshold provided by an external organization specializing in providing industry thresholds.

46. The method of claim 45, wherein the analyzing at least one of the business organization data inputs in accordance with at least one internal threshold includes analyzing at least one of the business organization data inputs in accordance with at least one of assumptions regarding a number of employees desired for performing a particular function of the business organization, cost information for transforming the particular function, labor information for transforming the particular function, and technology information for transforming the particular function.

47. A method of identifying a business organization transformation opportunity using a software tool operating on a computer, comprising:
receiving at the software tool a plurality of business organization data inputs;
analyzing at least one of the business organization data inputs in accordance with at least one industry threshold, by generating at least one of
current metric information indicating a current state of the business organization, and
end-state summary information indicating a state of the business organization if a modeled transformation scenario is initiated; and
modeling a business organization transformation opportunity scenario with respect to a particular function of the business organization responsive to the analysis.

48. The method of claim 47, wherein the receiving business organization data inputs includes receiving data including at least one of current general client data, client growth rate assumptions, client human resource operating cost data, client activity analysis information, and implementation cost estimate assumptions.

49. The method of claim 47, wherein the receiving a plurality of business organization data inputs includes receiving at least one business organization input from a user entering the at least one business organization data input at the software tool.

50. The method of claim 47, wherein the modeling the business organization transformation opportunity scenario includes modeling at least one of a broad-outsourcing transformation scenario, internal transformation scenario, and a mixed transformation scenario for the particular function of the business organization.

51. The method of claim 50, wherein:
modeling the broad-outsourcing transformation scenario includes modeling the broad-outsourcing transformation scenario to outsource at least a pre-selected upper bound of a particular function of the business organization;
modeling the mixed transformation scenario includes modeling the mixed transformation scenario to outsource between a pre-selected lower bound and the pre-selected upper bound of the particular function of the business organization; and
modeling the internal transformation scenario includes modeling the internal transformation scenario to outsource less than the pre-selected lower bound of the particular function of the business organization.

52. The method of claim 51, wherein the modeling of the at least one of a broad-outsourcing transformation scenario and a mixed transformation scenario for the particular function of the business organization includes outsourcing at least one sub-function of the particular function of the business organization.

53. The method of claim 51, wherein the modeling of the at least one of the mixed and internal transformation scenarios includes internally restructuring at least some of a remaining portion of the particular function of the business organization.

54. The method of claim 53, wherein the restructuring of the at least one of the mixed and internal transformation scenarios for the particular function of the business organization includes restructuring at least one sub-function of the particular function of the business organization.

55. The method of claim 47, wherein the modeling the business organization transformation opportunity scenario with respect to a particular function of the business organization includes modeling a human resources business organization transformation opportunity scenario.

56. The method of claim 47, wherein the modeling the business organization transformation opportunity scenario with respect to a particular function of the business organization comprises modeling the business organization transformation opportunity scenario including model information regarding at least one sub-function of the particular function.

57. The method of claim 56, wherein the particular function is a human resource function, and the modeling the business organization transformation opportunity scenario including model information regarding at least one sub-function of the particular function includes modeling the business organization transformation opportunity scenario including information regarding at least one of a recruiting, time and attendance, training and development, performance management, compensation and benefits, employee relations, organization effectiveness, human resources management, knowledge management, human resources information systems and reporting, payroll and vendor management sub-function of the human resource function.

58. The method of claim 47, further comprising:
providing a cost-savings estimate corresponding to use of a modeled business organization transformation opportunity scenario.

59. The method of claim 47 further comprising:
providing alternative modeled business organization transformation opportunity scenarios responsive to the analysis.

60. The method of claim 47, wherein the software tool is implemented as a spreadsheet executed in conjunction with a spreadsheet program, and where:
the receiving a plurality of business organization data inputs includes receiving a plurality of business organization data inputs at a data input field of the spreadsheet;
the analyzing at least one of the business organization data inputs in accordance with at least one industry threshold, includes generating at least one of current metric information and end-state summary information by performing a calculation between at least one data input field of the spreadsheet, and at least one industry standard provided at an industry standard field of the spreadsheet, the calculation being placed at a respective result field of the spreadsheet corresponding to at least one of the current metric information and end-state summary information; and
the modeling a business organization transformation opportunity scenario with respect to a particular function of the business organization responsive to the analysis includes providing comparison information between at least one of a business organization data input and an industry threshold, and at least one calculation of corresponding result field.

61. The method of claim 47, wherein the analyzing at least one of the business organization data inputs in accordance with at least one industry threshold by generating at least one of current metric information and end-state summary information includes analyzing at least one of the business organization data inputs in accordance with information regarding at least one of a number of employees desired for performing a particular function of the business organization, cost information for transforming the particular function, labor information for transforming the particular function, and technology information for transforming the particular function.

62. A method of identifying a business organization transformation opportunity using a software tool operating on a computer, comprising:
receiving at the software tool a plurality of business organization data inputs;
analyzing at least one of the business organization data inputs in accordance with at least one industry threshold, by generating at least one of As-Is cost analysis information, activity analysis information, and business organization sizing analysis information; and
modeling a business organization transformation opportunity scenario with respect to a particular function of the business organization responsive to the analysis.

63. The method of claim 62, wherein the receiving business organization data inputs includes receiving at least one of business organization data regarding As-Is cost data, As-Is time data, To-Be basic data, To-Be labor sourcing data, To-Be non-labor sourcing data, To-Be outsource cost data, retained transition cost data, and retained benefits schedule data.

64. The method of claim 62, wherein the receiving a plurality of business organization data inputs includes receiving at least one business organization input from a user entering the at least one business organization data input at the software tool.

65. The method of claim 62, wherein the receiving a plurality of business organization data inputs includes receiving at least one business organization input from a tool related to the software tool.

66. The method of claim 65, wherein the receiving at least one business organization input from the related tool includes receiving at least one business organization input from an HTML survey.

67. The method of claim 66, wherein the receiving at least one business organization input from an HTML survey includes prompting a user of the HTML survey for at least one of the business organization data inputs.

68. The method of claim 65, further comprising providing to the software tool the at least one business organization data input received at the related tool.

69. The method of claim 68, wherein the providing to the software tool the at least one business organization data input received at the related tool includes:
receiving at a database the at least one business organization data input; and
receiving at the software tool the at least one business organization data input from the database.

70. The method of claim 68, wherein the providing to the software tool the at least one business organization data input received at the related tool includes:
generating a related tool report responsive to at least one business organization data input received at the related tool; and
entering information regarding at least one business organization data input from the related tool report at the software tool.

71. The method of claim 62, wherein the modeling the business organization transformation opportunity scenario includes modeling at least one of a broad-outsourcing transformation scenario, internal transformation scenario, and a mixed transformation scenario for the particular function of the business organization.

72. The method of claim 71, wherein:
modeling the broad-outsourcing transformation scenario includes modeling the broad-outsourcing transformation scenario to outsource at least a pre-determined upper bound of a particular function of the business organization;
modeling the mixed transformation scenario includes modeling the mixed transformation scenario to outsource between a pre-determined lower bound and the pre-determined upper bound of the particular function of the business organization; and
modeling the internal transformation scenario includes modeling the internal transformation scenario to outsource less than the pre-determine lower bound of the particular function of the business organization.

73. The method of claim 72, wherein the modeling of the at least one of a broad-outsourcing transformation scenario and a mixed transformation scenario for the particular function of the business organization includes outsourcing at least one sub-function of the particular function of the business organization.

74. The method of claim 72, wherein the modeling of the at least one of the mixed and internal transformation scenarios includes internally restructuring at least some of a remaining portion of the particular function of the business organization.

75. The method of claim 74, wherein the restructuring of the at least one of the mixed and internal transformation scenarios for the particular function of the business organization includes restructuring at least one sub-function of the particular function of the business organization.

76. The method of claim 62, wherein the modeling the business organization transformation opportunity scenario with respect to a particular function of the business organization includes modeling a human resources business organization transformation opportunity scenario.

77. The method of claim 62, wherein the modeling the business organization transformation opportunity scenario with respect to a particular function of the business organization comprises modeling the business organization transformation opportunity scenario including model information regarding at least one sub-function of the particular function.

78. The method of claim 62, further comprising:
providing a cost-savings estimate corresponding to use of a modeled business organization transformation opportunity scenario.

79. The method of claim 62 further comprising:
providing alternative modeled business organization transformation opportunity scenarios responsive to the analysis.

80. The method of claim 62, wherein the modeling a transformation opportunity scenario includes generating at least one of solution summary information, cash flow with growth information, cash flow no growth information, and pro forma summary information.

81. The method of claim 62, wherein the software tool is implemented as a spreadsheet executed in conjunction with a spreadsheet program, and where:
the receiving a plurality of business organization data inputs includes receiving a plurality of business organization data inputs at a data input field of the spreadsheet;
the analyzing at least one of the business organization data inputs in accordance with at least one industry threshold includes generating at least one of As-is cost analysis information, activity analysis information, and business organization sizing analysis information by performing a calculation between at least one data input field of the spreadsheet, and at least one industry standard provided at an industry standard field of the spreadsheet, the calculation being placed at a respective result field of the spreadsheet corresponding to at least one of the As-Is cost analysis information, activity analysis information, and business organization sizing analysis information; and
the modeling a business organization transformation opportunity scenario with respect to a particular function of the business organization responsive to the analysis includes providing comparison information between at least one of a business organization data input and an industry threshold, and at least one calculation of corresponding result field.

82. The method of claim 62, wherein the analyzing at least one of the business organization data inputs in accordance with at least one industry threshold by generating at least one of As-is cost analysis information, activity analysis information, and business organization sizing analysis information, includes analyzing at least one of the business organization data inputs in accordance with information regarding at least one of a number of employees desired for performing a particular function of the business organization, cost information for transforming the particular function, labor information for transforming the particular function, and technology information for transforming the particular function.

83. A user interface for a software tool, the software tool useful for modeling a transformation scenario for a business organization, the user interface presented to an individual user using a computer executing the software tool, the user interface comprising:
a first component including a first set of data fields for receiving a plurality of business organization data inputs;
a second component including a second set of data fields for providing information about an analysis of the plurality of data fields in accordance with at least one industry threshold;
a third component including a third set of data fields for providing information about a modeled transformation scenario for the business organization;
wherein at least one of the data fields providing information regarding the modeled transformation scenario is updated as additional of the plurality of business organization data inputs are received at the software tool.

84. The user interface of claim 83, wherein the third component including a third set of data fields for providing information about a modeled transformation scenario includes the third set of data fields for providing information about a modeled human resources transformation scenario for the business organization.

85. The user interface of claim 83, wherein the third component including a third set of data fields for providing information about a modeled transformation scenario, includes the third set of data fields for providing information about at least one of a broad-outsourcing transformation, internal transformation, and mixed outsourcing and internal transformation modeled transformation scenarios.

86. The user interface of claim 83, further including a fourth component having a fourth set of data fields for receiving a plurality of business organization data inputs from a related software tool running on the computer.
